(19) United States
(12) Patent Application Publication
(10) Pub. No.: US 2026/0149594 A1
(43) Pub. Date: May 28, 2026

(54) PRIVACY-PRESERVING BIOMETRIC MATCHING USING REMOTE USER-TRUSTED ENVIRONMENTS

(71) Applicant: KEYLESS TECHNOLOGIES LIMITED, London (GB)

(72) Inventors: Jaroslav Sedenka, Hranice (CZ); Paolo Gasti, New York, NY (US); Maksym Bodnar, Rome (IT); Dario Sechi, Porto Torres (IT)

(73) Assignee: KEYLESS TECHNOLOGIES LIMITED, London, GB (GB)

(21) Appl. No.: 19/399,787

(22) Filed: Nov. 25, 2025

Related U.S. Application Data
(60) Provisional application No. 63/724,559, filed on Nov. 25, 2024.
(60) Provisional application No. 63/790,407, filed on Apr. 17, 2025.
(60) Provisional application No. 63/901,213, filed on Oct. 17, 2025.

(51) Int. Cl. H04L 9/32; H04L 9/08; H04L 9/30

(52) U.S. Cl. CPC H04L 9/3231; H04L 9/0866; H04L 9/3073; H04L 9/3263

(57) ABSTRACT

Systems, methods, and computer-readable media for privacy-preserving biometric matching using remote user-trusted environments are provided.

### CROSS-REFERENCE TO RELATED APPLICATION(S)

This application claims the benefit of prior filed U.S. Provisional Patent Application No. 63/724,559, filed Nov. 25, 2024, prior filed U.S. Provisional Patent Application No. 63/790,407, filed Apr. 17, 2025, and prior filed U.S. Provisional Patent Application No. 63/901,213, filed Oct. 17, 2025, each of which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to biometric authentication systems and methods, and, more particularly, to systems, methods, and computer-readable media for privacy-preserving biometric matching using remote user-trusted environments.

### BACKGROUND OF THE DISCLOSURE

Biometric authentication systems have become increasingly popular as a secure and convenient tool for verifying an individual's identity. However, the security of these systems can be impacted when sensitive user information is accessed by various entities.

### SUMMARY OF THE DISCLOSURE

This document describes systems, methods, and computer-readable media for privacy-preserving biometric matching using remote user-trusted environments.

For example, a method is provided for privacy-preserving biometric matching using remote user-trusted environments as described herein.

As another example, a system is provided for privacy-preserving biometric matching using remote user-trusted environments as described herein.

As yet another example, anon-transitory computer-readable storage medium is provided for storing at least one program, the at least one program including instructions, which, when executed by at least one processor of an electronic subsystem, cause the at least one processor to carryout privacy-preserving biometric matching using remote user-trusted environments as described herein.

As yet another example, a method is provided for enrolling a user of a user electronic device using a fortress solution that is remote from the electronic device and a biometric authentication subsystem, the method may include receiving, at the fortress solution, an enrollment attempt message including a username identifier of the user, receiving, at the fortress solution from the user electronic device, a wrapped image encryption key that includes an image encryption key encrypted with a public image encryption wrapping key of an image encryption wrapping keypair, generating, at the fortress solution, a user data key, defining, at the fortress solution, a wrapped user data key by encrypting the user data key with a user data wrapping key, obtaining, at the fortress solution, a seed, generating, at the fortress solution, a private user key of a user keypair using the seed, generating, at the fortress solution, a public user key of the user keypair, generating, at the fortress solution, a device signing keypair including a private device signing key and a public device signing key, generating, at the fortress solution, a device encryption keypair including a private device encryption key and a public device encryption key, defining, at the fortress solution, a wrapped private device signing key by encrypting the private device signing key with the user data key, defining, at the fortress solution, a wrapped private device encryption key by encrypting the private device encryption key with the user data key, defining, at the fortress solution, a unique authentication process identifier using the username identifier, defining, at the fortress solution, session user profile data including the wrapped private device signing key, the wrapped private device encryption key, and the wrapped user data key, storing, at the fortress solution, the session user profile data against the unique authentication process identifier as user profile look-up data, obtaining, at the fortress solution, the image encryption key by decrypting the wrapped image encryption key with a private image encryption wrapping key of the image encryption wrapping keypair, receiving, at the fortress solution from the user electronic device, encrypted enrollment biometric data that includes user enrollment biometrics of the user encrypted with the image encryption key, obtaining, at the fortress solution, the user enrollment biometrics by decrypting the encrypted enrollment biometric data with the image encryption key, generating, at the fortress solution, an enrollment biometric template indicative of the user enrollment biometrics, running, at the fortress solution, an instance of a privacy-preserving enrollment protocol with the biometric authentication subsystem using privacy-preserving protocol data including the seed and the enrollment biometric template, and deleting, from the fortress solution, sensitive enrollment data including the seed, the private user key, the private device signing key, the private device encryption key, the user data key, the user enrollment biometrics, and the enrollment biometric template.

As yet another example, a method is provided for authenticating a user of a user electronic device using a fortress solution remote from the electronic device and a biometric authentication subsystem, the method may include receiving, at the fortress solution, an authentication attempt message including a username identifier of the user, receiving, at the fortress solution from the user electronic device, a wrapped image encryption key that includes an image encryption key encrypted with a public image encryption wrapping key of an image encryption wrapping keypair, identifying, at the fortress solution, a unique authentication process identifier using the username identifier, identifying, at the fortress solution, session user profile data stored against the unique authentication process identifier as user profile look-up data, wherein the session user profile data includes a wrapped private device signing key, a wrapped private device encryption key, and a wrapped user data key, obtaining, at the fortress solution, a user data key by decrypting the wrapped user data key with a user data wrapping key, obtaining, at the fortress solution, a private device signing key by decrypting the wrapped private device signing key with the user data key, obtaining, at the fortress solution, a private device encryption key by decrypting the wrapped private device encryption key with the user data key, obtaining, at the fortress solution, the image encryption key by decrypting the wrapped image encryption key with a private image encryption wrapping key of the image encryption wrapping keypair, receiving, at the fortress solution from the user electronic device, encrypted authentication biometric data that includes user authentication biometrics of the user encrypted with the image encryption key, obtaining, at the fortress solution, the user authentication biometrics by decrypting the encrypted authentication biometric data with the image encryption key, generating, at the fortress solution, an authentication biometric sample indicative of the user authentication biometrics, running, at the fortress solution, an instance of a privacy-preserving authentication protocol with the biometric authentication subsystem using privacy-preserving protocol data including the private device encryption key and the authentication biometric sample, and deleting, from the fortress solution, sensitive authentication data including the private device signing key, the private device encryption key, the user data key, the user authentication biometrics, and the authentication biometric sample.

As yet another example, a method is provided for authenticating a user of a user electronic device running a web browser presenting a website of a third party subsystem using a fortress solution and a biometric authentication subsystem, the method may include obtaining, at the user electronic device from the third party subsystem, session entity data including a username identifier of the user and a customer identifier of the third party subsystem, generating, at the user electronic device, an image encryption key, defining, at the user electronic device, a wrapped image encryption key by encrypting the image encryption key with a public image encryption wrapping key, sending, from the user electronic device to the fortress solution, an attempt message including the username identifier and the customer identifier, sending, from the user electronic device to the fortress solution, the wrapped image encryption key, receiving, at the user electronic device from the fortress solution, a request for user biometric data, capturing, at the user electronic device, user biometrics from the user, defining, at the user electronic device, encrypted biometric data by encrypting the captured user biometrics with the image encryption key, sending, from the user electronic device to the fortress solution, the encrypted biometric data, and receiving, at the user electronic device from the fortress solution, verification of a successful privacy-preserving protocol run between the fortress solution and the biometric authentication subsystem using the captured user biometrics.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system for providing an authentication processing service, according to one or more embodiments of the disclosure;

FIG. 1A is a more detailed schematic view of a user device of the system of FIG. 1, according to one or more embodiments of the disclosure;

FIG. 1B is a more detailed schematic view of a network node of the system of FIG. 1, according to one or more embodiments of the disclosure;

FIG. 1C is a more detailed schematic view of a repository of the system of FIG. 1, according to one or more embodiments of the disclosure;

FIG. 1D is a more detailed schematic view of a third party subsystem of the system of FIG. 1, according to one or more embodiments of the disclosure;

FIG. 1E is a more detailed schematic view of an authentication processing service (“APS”) subsystem of the system of FIG. 1, according to one or more embodiments of the disclosure;

FIG. 1F is a more detailed schematic view of an AuthService subsystem of the system of FIG. 1, according to one or more embodiments of the disclosure;

FIG. 1G is a more detailed schematic view of a key management service (“KMS”) subsystem of the system of FIG. 1, according to one or more embodiments of the disclosure;

FIG. 1H is a more detailed schematic view of an enclave subsystem of the system of FIG. 1, according to one or more embodiments of the disclosure;

FIG. 1I is a more detailed schematic view of a portion of the system of FIG. 1, according to one or more embodiments of the disclosure;

FIGS. 2A and 2B illustrate a flowchart of an exemplary process for enrolling a user device and a user thereof with an authentication processing service (“APS”) platform, according to one or more embodiments of the disclosure;

FIG. 3 illustrates a flowchart of an exemplary process for generating one or more sets of authentication circuit information for a set of network nodes using secure multi-party computation, according to one or more embodiments of the disclosure;

FIGS. 4A-4C illustrate a flowchart of an exemplary process for authenticating an enrolled APS user of an enrolled APS user device with the APS platform, according to one or more embodiments of the disclosure;

FIG. 5 illustrates a flowchart of an exemplary process for registering a third party service with an enrolled APS user of an enrolled APS user device, according to one or more embodiments of the disclosure;

FIG. 6 illustrates a flowchart of an exemplary process for authenticating an enrolled APS user of an enrolled APS user device with a registered third party service using the APS platform, according to one or more embodiments of the disclosure;

FIGS. 7A-7AE illustrate exemplary screens of graphical user interfaces (“UIs”) of one or more user devices carrying out the processes of FIGS. 2A-6 and 8-15, according to one or more embodiments of the disclosure;

FIGS. 8-16 illustrate flowcharts of other exemplary processes for using an authentication processing service, according to one or more embodiments of the disclosure; and

FIG. 17 illustrates a diagram of an exemplary website to be used by an authentication processing service, according to one or more embodiments of the disclosure.

### DETAILED DESCRIPTION OF THE DISCLOSURE

The present disclosure relates generally to authentication processing service (e.g., biometric authentication) systems, methods, and computer-readable media, and, more particularly, to systems, methods, and computer-readable media for privacy-preserving biometric matching using remote user-trusted environments.

The use of biometric authentication can be useful in various industries, including, but not limited to, finance, healthcare, border control, and banking. Biometric authentication may involve the use of unique physical and/or behavioral characteristics, such as facial images, fingerprints, or iris scans, to verify an individual's identity.

Through application of privacy-preserving biometric matching (e.g., zero-knowledge biometrics (“ZKB”)) using any suitable secure multi-party computation (“SMPC”) techniques (e.g., as may be described by U.S. Pat. Nos. 11,101,986 and/or 11,936,775, each of which is hereby incorporated by reference herein in its entirety), this disclosure may provide a multi-factor biometric authentication system or an authentication processing service (“APS”) or APS platform (“APSP”), which may be referred to herein as an APS protocol or APSP protocol or a Keyless service or Keyless protocol or Keyless platform or Keyless or the like, that can offer privacy without compromising on user experience. This approach may address certain previously intractable problems around traditional authentication. Biometric authentication may use a user's unique physical characteristics, such as their face or fingerprint, to verify their identity. The APS may be configured to eliminate the need to centrally store and manage passwords.

The biometric authentication industry may use one of various distinct approaches for storing and processing biometric data, such as device-native biometrics or server-side biometrics. Device-native (e.g., “local”) biometric systems may be configured to store and process biometric data on a user's device, such as without relying on an external cloud provider. Local biometrics may ensure that a user's biometric template never leaves the device, thereby ensuring certain privacy. However, this may come at the cost of usability. If such a user's device is lost, any biometric template is lost with it and the user will need to re-enroll. It also may not support identity portability, as a user may not be enabled to enroll on a first user device and then use their biometrics to log into another user device. For that reason and because only the user's device, instead of a third party, can attest that the authentication was successful, the biometric template may not be tied to the user's identity but instead to the user's device. Server-side (e.g., “centralized”) biometric systems may be configured to store and process biometric data on remote servers. When a user enrolls, their device may upload their biometric template to a cloud server. Such a biometric template may be stored and compared to new biometric templates taken when the user attempts to authenticate. Such an authentication system may be more convenient for the user than local biometrics. If a user loses their device, they can retrieve their biometrics from the cloud. Centralized biometrics may also be device-agnostic, as a user may be enabled to enroll on one device and authenticate on any other suitable device (e.g., a device with a front-facing camera). Moreover, a trusted third party may be able to verify that the biometric templates match in a centralized biometric system, as opposed to local biometric systems where the user device, which could be tampered with, does the biometric matching. However, server-side biometrics may come at the cost of privacy. For example, the entity that manages the cloud may have access to all of the user's biometrics. Although such data when at rest can be encrypted, such data in use cannot be encrypted with traditional methods. Moreover, a decryption key may be needed to be stored on the system and any unencrypted biometrics taken during authentication may exist in memory. Therefore, such local biometrics may favor privacy, while such centralized biometrics may favor usability. Prior to the APS of this disclosure, certain systems were unable to achieve both.

To address this gap, the APS of this disclosure may be configured to use ZKB, which may offer the privacy of local biometrics (e.g., the user's biometric data may not leave the user's device (e.g., any suitable biometric enrollment and/or authentication signal(s) (e.g., ub, ueb, uab, etc.))) with the usability, security and flexibility of centralized biometrics. In addition to combining the benefits of both device-native biometrics and server-side biometrics, ZKB may be configured to provide an APS that may not store biometric data anywhere (e.g., neither on a user's device nor in the cloud). Such ZKB of an APS of the disclosure may be configured to transform biometric data in such a way that may allow the APS to process the biometric data in zero knowledge form without being able to access the biometric data. This means that, aside from learning whether a match occurs during authentication, a cloud service of the APS (e.g., a Keyless Cloud Service, an APS subsystem, one or more nodes, a repository, and/or the like) may be configured to learn no more information about the biometric data than if it were instead receiving random noise. This may ensure the privacy of the user's biometric data.

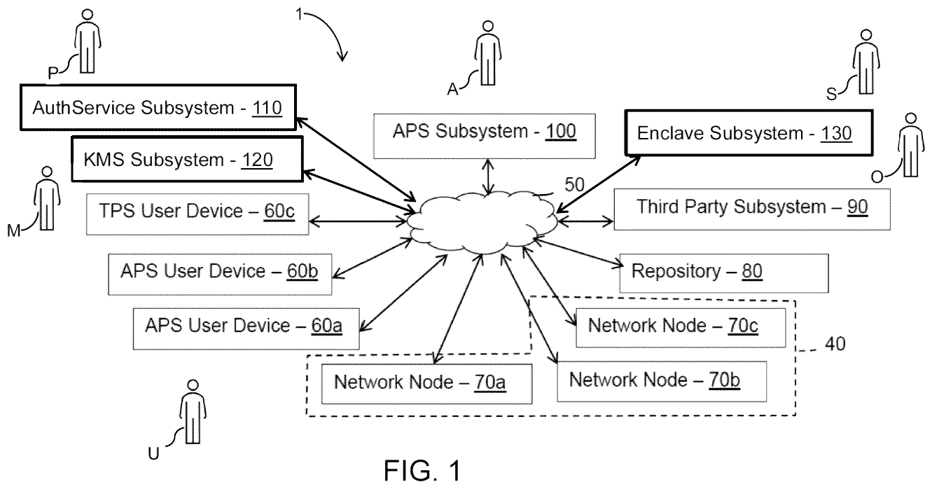

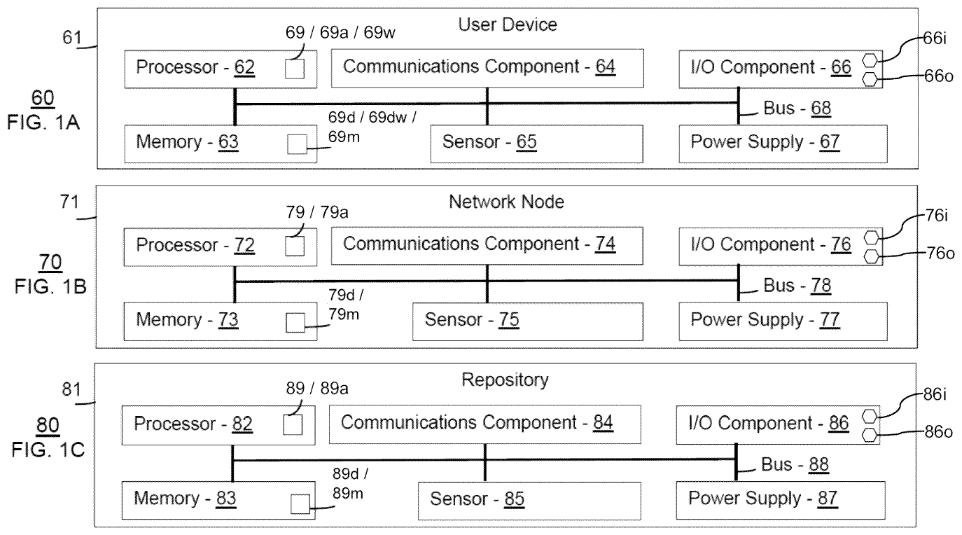

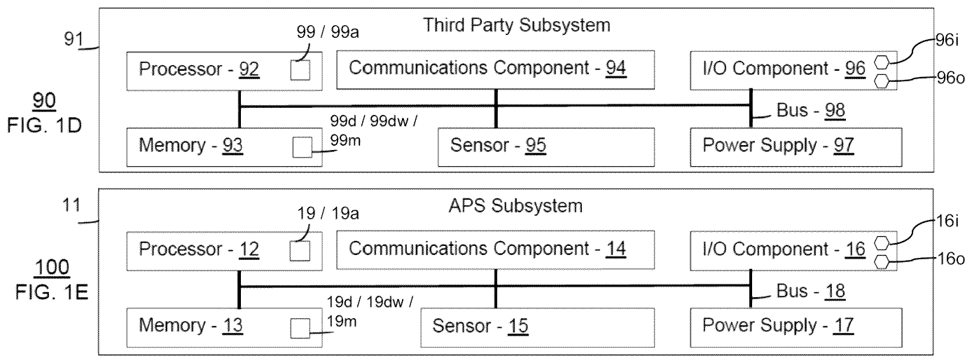

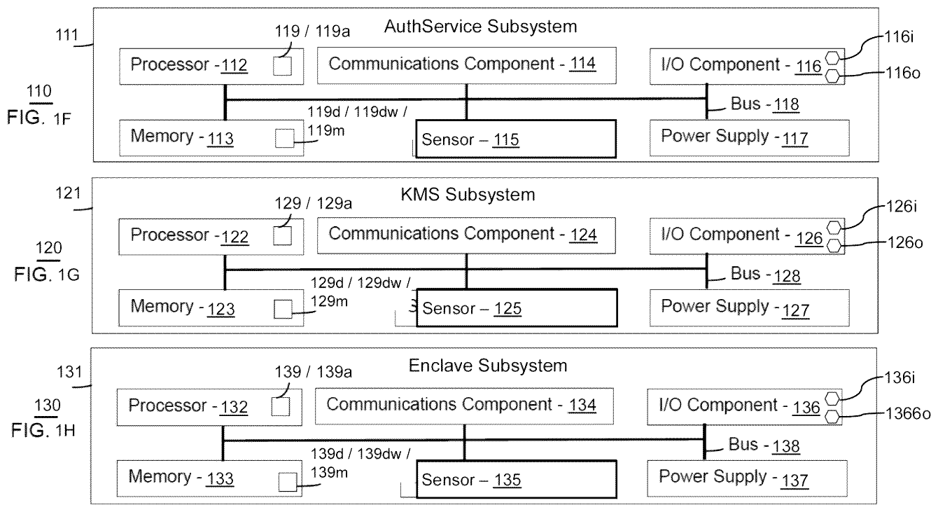

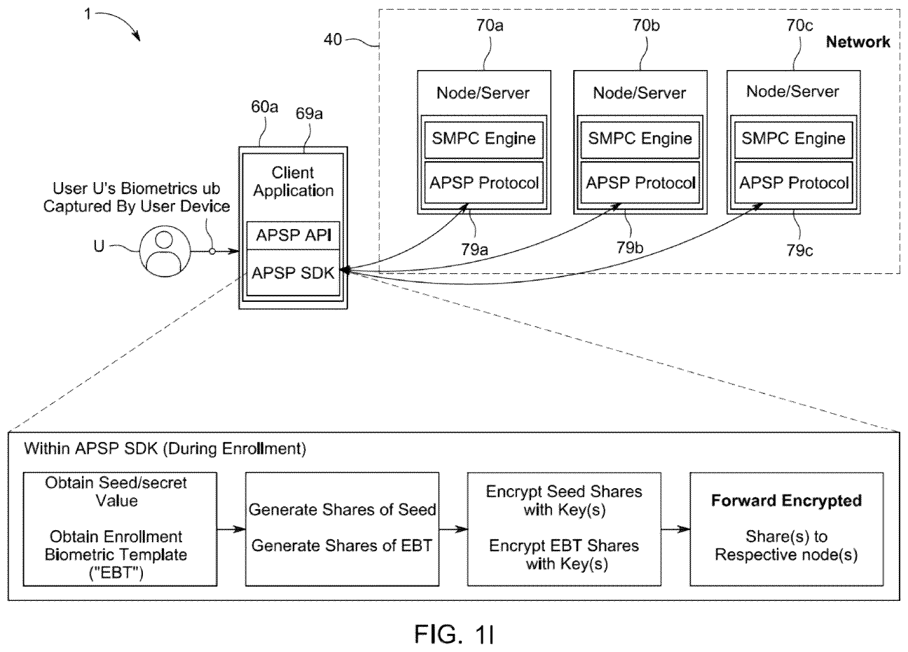

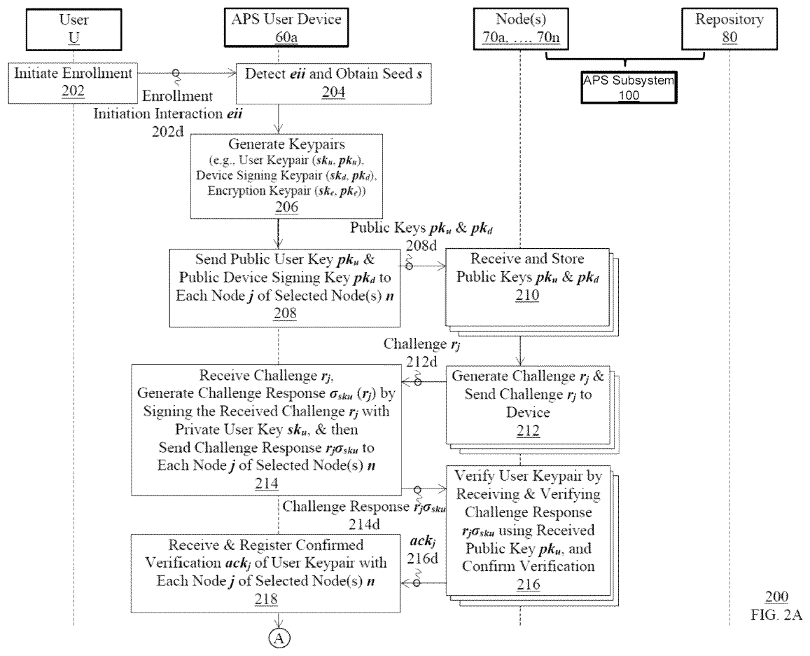

An APSP protocol may involve a user interacting with an APS cloud service using one or more user devices or clients (e.g., a laptop, a smartphone, etc.), such as shown in FIG. 1, where such a protocol may be configured to protect a cryptographic key that belongs to the user. This key can be generated as part of an enrollment process, or can be imported from another application. The key may be recovered by the user after a successful authentication. The key can be used to generate an arbitrary number of derived keys. These keys can be used, for example, to manage Decentralized Identities (“DID”), to issue digital signatures on any suitable documents and/or claims, to authenticate against any suitable identity and access management (“IAM”) systems, and/or the like. Customer integration may be configured in any suitable manner, which may be subject to scope and customer specific requirements. For example, a high level architecture for a sample APS customer integration may include enabling a user to access a service via an APS customer application (e.g., as may be running on a user device), which may trigger an authentication request that can be communicated to both a customer backend (e.g., orchestration/identity provider (“IDP”), risk platform, etc.) and an APS software development kit (“SDK”) that may be on the user's device, such as via native push notification. The user may complete the biometric authentication via the APS SDK, which may initiate an APSP protocol (e.g., an SMPC protocol) with an APS subsystem (e.g., an APS or Keyless cloud service, which may be configured to communicate the result of the protocol to the customer backend (e.g., using security representational state transfer (“REST”) application programming interfaces (“APIs”))). As a result, the user may gain access to the service.

An APSP protocol may include various phases, such as an enrollment phase and an authentication phase. During the enrollment phase, an enrollment template may be transformed so that it is zero knowledge and registered alongside the user device, and an encrypted cryptographic key may be created. The user device may send the transformed template and encrypted key to the APS cloud service and then may immediately delete both. During authentication, the user may first send a digital signature to the APS cloud service to authenticate the user device, and then may take a selfie or other suitable authentication biometric template. Using ZKB, the device may then transform the authentication selfie and the APS cloud service may use SMPC to check and confirm both the enrollment template and the authentication template match without seeing the template data itself. If both templates match, the APS cloud service may be configured to send the reconstructed encrypted key back to the device.

As with centralized biometrics, data of the APSP protocol may leave the user device. However, unlike other centralized systems, this data may be zero knowledge, which may mean that it may fully preserve the privacy of the biometric data within. As it is cloud-based, the APSP protocol may also support identity portability. A user can authenticate on any device (e.g., any device with a front-facing camera, such as a smartphone, laptop, kiosk, etc.). The APSP may be configured to support both native integrations (e.g., via its mobile SDKs or DeviceSDKs (e.g., Android SDKs, iOS SDKs, etc.)) and browser-based integrations (e.g., via its WebSDKs). APS mobile SDKs and/or APS WebSDKs may be designed to uphold the highest of security and privacy principles.

An APSP protocol may remain secure if the APS cloud service or user device is compromised. Specifically, no secret user information (e.g., biometric data, cryptographic keys, etc.) may be disclosed if an adversary is able to control the APS cloud service or the user device. If any of the algorithms used in certain instantiations of the APSP protocol may not be secure against quantum computers, they can be easily replaced with post-quantum alternatives, if the need arises. This does not require any effort on the user's part.

In case of lost, damaged, or stolen devices, the APSP protocol may support various flexible recovery mechanisms. A first mechanism may rely on the use of multiple devices associated with the same user (e.g., if the user loses one of their devices (e.g., their smartphone), they can use another device (e.g., their laptop) to revoke the lost device and to authorize a new one). A second mechanism may rely on saving data that represents the user's trusted device to a safe location. The safe location could be managed by a customer of the APSP (e.g., a service the user is authenticating in order to access). Alternatively, it could be the user's cloud account. This data may allow the user to recover a lost or stolen device after successful biometric authentication.

An APS of the disclosure may combine an APSP protocol and an APS biometric pipeline and/or APS liveness detection (e.g., as may be described by U.S. patent application Ser. No. 19/217,833, which is hereby incorporated by reference herein in its entirety). For example, an APS biometric pipeline may be configured to ensure that the quality of the signals is sufficient to reliably extract a compact biometric representation (e.g., biometric features), such as for an enrollment template and/or for an authentication template. This stage may be configured to identify any suitable or specific issues with the biometric signals (e.g., “there is not enough light” with face recognition), and provide feedback to the user so that the user can perform corrective actions. Further, the biometric pipeline may be configured to ensure that the biometric signals are coming from a live user. This may mitigate a wide range of potential presentation attacks.

After such a biometric pipeline has extracted and processed biometric features, the authentication process may continue via an APSP protocol (e.g., an SMPC protocol), which may involve the user device and the APS cloud service. In some embodiments, the APS cloud service and the user device(s) may communicate securely over any suitable transport layer security (“TLS”) channels (e.g., the APS cloud service may be configured to authenticate to the user device(s) via standard TLS (X509) certificates). An APSP protocol may be configured to use any suitable ZKB protocol to harness the privacy benefits that may come with local biometrics on top of the usability benefits that may come with centralized biometrics. With a ZKB protocol, an APS cloud service may be configured to process data in zero knowledge form (e.g., the cloud service can perform computations without seeing the actual data). ZKB can be achieved using any suitable SMPC. An APSP protocol may be configured to protect a cryptographic key that may allow a user to authenticate to a particular service. After a successful authentication by the user, they may be able to learn this key, and, for example, may be able to use this key to log into their banking app or access any other suitable service (e.g., of any suitable third party or otherwise).

During enrollment, a user may register themself and a primary user device with the APSP and take a selfie or otherwise make accessible any suitable enrollment biometrics for user as their enrollment biometric template. The user can either import an existing cryptographic key or generate the cryptographic key during enrollment. An APSP protocol may be configured to use ZKB so that the enrollment biometrics can be transformed on the user's device so that it is zero knowledge. In some embodiments, the cryptographic key may be encrypted using two keys, such as a random symmetric key that may be generated by the user device and a key that may be disclosed by the authentication protocol after successful authentication. The latter key may be unknown to the APS cloud service until the user successfully authenticates, and/or may change with each authentication attempt. The zero knowledge enrollment biometrics can be sent alongside the encrypted cryptographic key to the APS cloud service. The user device may then automatically delete the biometrics and cryptographic key.

During authentication, the user may first authenticate their device, such as by sending a digital signature to the APS cloud service and then may sample the authentication biometric template. The user device may then transform the authentication template in the same way as the enrollment template was transformed during enrollment. The APS cloud service may then check whether the zero knowledge authentication biometric sample matches the zero knowledge enrollment biometric template stored from enrollment without accessing the original biometric data. This may indicate that, with high probability, the user's enrollment sample and the authentication sample are from the same person. Additionally, a match may also allow for the APS cloud service to remove a layer of encryption from the cryptographic key. The APS cloud service can then forward the cryptographic key (e.g., a key that may still be encrypted under the device key) to the user as part of the authentication process. The user can decrypt the key with the symmetric key held on their device. The user can perform any suitable actions using the key, including, but not limited to, deriving a DID key and issuing a signed claim associated with their identity, deriving a signing key to sign a document, authenticating (e.g., to any suitable IAM system), adding a trusted device, revoking one of the devices, and/or the like. Therefore, a system of the APSP may be configured to combine an APSP protocol and a biometric pipeline, whereby, after a user's device captures user biometrics (e.g., after a user's device's front-facing camera captures a sequence of images of the user), a series of modules may be configured to check the quality of the images and whether they are coming from a live human or from a photograph or video or the like. If these modules detect any problem with the incoming images, they may be configured to provide feedback to the user for recapturing better biometrics (e.g., use more backlighting). Then, one or more modules may be configured to extract and process biometric features that may be fed to an APSP protocol (e.g., an SMPC protocol) to complete the authentication process. The APSP protocol may be configured to check whether ZKB templates originate from the same person and also to authenticate the user device. If successful, a Keyless SDK may be configured to reconstruct the user keypair such that the user may be granted access to a service provided by a customer of the APSP.

An APSP protocol of this disclosure may be configured to meet tight security and privacy goals. This may be done through an adversary model, where the security may be considered when the biometrics have been corrupted by an adversary, when the APS cloud service has been corrupted by an adversary, when a user device has been corrupted by an adversary, or any other suitable adversary corruption scenario.

In a biometrics corruption scenario, an adversary might fully corrupt the user's biometrics but does not corrupt the user's device and/or the APS cloud service. The user's device may be authenticated via a signature before the user is allowed to provide any biometric information to the APS cloud service, whereby such an adversary may not be able to authenticate or learn the cryptographic key. All communication may be performed over TLS channels, which may implement countermeasures against replay attacks. This may mitigate attacks that might leverage low-entropy or spoofed biometric signals.

In an APS cloud service corruption scenario, an adversary might corrupt the APS cloud service but does not corrupt the user's device or biometrics. In this setting, the user's biometric information and cryptographic key may be protected because they may be only stored on the APS cloud service in zero knowledge form and encrypted form. The APS cloud service may be configured not to be able to tell the difference between the zero knowledge biometrics or a random string of bits.

In a user device corruption scenario, an adversary might be able to corrupt the user's device but does not corrupt the APS cloud service or the user's biometrics. In this setting, it ought to be ensured that the adversary cannot learn anything about the honest user's biometrics and that the adversary cannot successfully authenticate for learning the cryptographic key. Immediately after the enrollment phase completes, or immediately after the client has used the key, it may automatically discard the key and all biometric data. Therefore, if the user's device is lost or stolen, it may contain no information about the key or the user's biometrics. The ZKB matching may output a valid decryption key (e.g., a key that may allow for the cryptographic key to be decrypted) only if the authentication sample is close to the biometric template. The security properties of the ZKB protocol may be defined to guarantee that no output can be recovered if there is no biometric match. Therefore, the device may be configured to learn only the cryptographic key and successfully authenticate if the device can guess the user's biometrics. However, because authentication may be configured as an online process, the APS cloud service (e.g., nodes) may be configured to implement rate-limiting policies, which may stop the corrupted device from guessing the biometrics via a brute force attack.

Many organizations may require secure biometric authentication capabilities within web browsers, without the need to download additional software or to install custom browser extensions. An APS WebSDK may be configured to address such a requirement while following the security and privacy principles of an APSP protocol that may use an APS mobile SDK. An APS WebSDK may be configured to be split between a browser client (e.g., on a device accessible by a user) and a remote user-trusted environment (e.g., an APS authorization server and/or any suitable trusted or isolated execution environment (e.g., an enclave (e.g., an Amazon Web Services (“AWS”) Nitro enclave)).

Browser limitations may prevent a full APS mobile or client SDK implementation from running directly in a web context. To overcome this constraint, an APS WebSDK implementation may be configured to split the client functionality into multiple components of the WebSDK architecture, such as a JavaScript SDK (e.g., a lightweight component that may be configured to run directly in the browser as part of the customer's website, where the component may be configured to handle user interaction, camera access, initial image processing, and/or the like) and an AuthService subsystem or some other trusted execution environment (“TEE”) (e.g., the core APS mobile or client SDK functionality may operate within any suitable enclave (e.g., an AWS Nitro Enclave), which may provide hardware-level isolation and security guarantees for biometric processing). Such an architectural split may maintain the zero-knowledge principles of an APS protocol while enabling browser-based authentication flows.

A challenge in web environments may be to securely transfer biometric data from the browser to the trusted execution environment. A solution may employ a multi-layered encryption strategy that may be designed to protect biometric data at every stage of communication. When an authentication process begins, the JavaScript SDK may be configured to capture biometric images from the device's camera or otherwise, and generate a random AES encryption key for the current session. The images may be immediately encrypted with this AES key. The AES key may then be wrapped (e.g., encrypted) using the public key from an RSA keypair (e.g., an image encryption/decryption key). The corresponding private key may be accessible only within the enclave through any suitable key management service (“KMS”) (e.g., an AWS Nitro Enclave through any suitable AWS KMS (e.g., any suitable KMS subsystem (e.g., one or more suitable KMS servers))). The encrypted images and wrapped key may then be transmitted to enclave, thereby ensuring that biometric data may remain encrypted throughout transmission, and temporarily decrypted only within the isolated TEE. As a result, no biometric data may be exposed to the APS subsystem (e.g., to an AuthService subsystem in certain embodiments).

An APS WebSDK may use any suitable enclave(s) (e.g., AWS Nitro Enclaves) to provide hardware-level isolation for sensitive operations. To create a truly isolated execution environment, an enclave may be configured to operate in a separate virtual machine with no persistent storage, shared memory, or networking capabilities. The enclave may have exclusive access to the image encryption/decryption key. This may be enforced via any suitable KMS (e.g., AWS KMS) and may prevent any other software and cloud component, including a parent elastic compute cloud (“EC2”) virtual machine instance, from accessing the key. Additionally, an APS WebSDK may be configured to use cryptographic attestation to verify the identity and integrity of the code running in the enclave. Within this secure environment, the APS client may be enabled to perform a series of protocol operations (e.g., decrypting the images it received, performing liveness detection, extracting biometric features, transforming those features into APS zero-knowledge templates, executing the enrollment or authentication protocol with the APS cloud service, and/or the like).

In addition to the adversary models described above, an APS WebSDK implementation may be configured to consider a host system corruption scenario, where an adversary may control an EC2 host but not the enclave. In such a scenario, the hardware isolation properties of the enclave may prevent the host from accessing the enclave's memory or the AWS KMS decryption key. An APS WebSDK may be configured to extend the APS zero-knowledge biometric authentication system to browser environments while maintaining its core security and privacy principles. This may enable more flexible deployment options for customers while protecting sensitive biometric data throughout the authentication process.

Therefore, an APS protocol may be any suitable protocol, such as SMPC, which may be a cryptographic technique that may enable multiple parties to jointly perform a computation on private inputs without revealing their individual contributions. SMPC may provide for numerous applications in privacy-preserving data analysis, secure outsourcing of computations, and confidential communication. However, traditional thin clients, such as web browsers or wearable devices, often lack the necessary resources (e.g., processing power, memory, storage, etc.) to execute computationally intensive tasks, including SMPC protocols. These limitations may pose significant challenges for users who need to perform private computations on sensitive data, such as medical records, biometric data, financial information, and confidential communication. Moreover, temporary clients, like kiosks or web apps on a borrowed device, may not have the ability to store long-term state, making it even more difficult for them to execute SMPC. In these cases, users may be forced to rely on local computations or server-side processing that can be vulnerable to data breaches and unauthorized access.

To address these challenges, TEEs, such as Intel's Software Guard Extensions (“SGX”) or Advanced Micro Devices, Inc. (“AMD”)'s Secure Processor, may be used as trustworthy computing platforms for secure outsourcing of computations. Other trusted execution environments may include, but are not limited to, cloud-based solutions, such as AWS Nitro Enclaves, Google Cloud Platform confidential virtual machines (“CVMs”), Microsoft Azure Attested and Confidential VMs, IBM Cloud Confidential Computation, and/or other similar solutions. Also, some distributed blockchain-based systems, such as zero-knowledge Ethereum Virtual Machines (“zkEVMs”), may be configured to provide secure computation environments for sensitive tasks. These TEEs may provide a secure, isolated environment within which sensitive computations can be performed without exposing private data to the host operating system.

The importance of SMPC and the presence of TEEs in various industries may enable the secure transfer of computationally intensive tasks from thin clients to trusted cloud environments. An APSP of this disclosure may provide novel methods for moving computations from user-controlled clients to trusted cloud environments, ensuring secure computation while minimizing data breaches. For example, an APSP of this disclosure may provide a framework optimized for reliable and trusted remote execution of secure services (“FORTRESS”), which may provide methods for using a TEE to perform some or all of the computation associated with one or more instances of a SMPC computation from a client to a server-side TEE in order to perform secure biometric authentication. This may have applications in multiple areas, including, but not limited to, healthcare, finance, biometric authentication, and/or the like. The term FORTRESS may be used to denote any suitable solution or framework provided by any suitable APSP of this disclosure, which may include, but is not limited to, the combination of TEE, any suitable software application that may act as a client party in SMPC computation running inside the TEE, and any other component(s) that may be used, such as services used for attestation of integrity of the application.

Biometric authentication has become increasingly prevalent in various industries, including finance, healthcare, and government, due to its convenience and perceived security benefits. Biometric data, such as facial features, iris patterns, or fingerprints, may provide a unique identifier for individuals, thereby offering a secure and easy-to-use alternative to traditional password-based authentication methods. Some biometric systems may be based on deep learning and may achieve remarkable accuracy rates, often outperforming human experts under ideal conditions. However, this level of performance may come at the cost of substantial computational and storage resources. This makes some accurate models unsuitable to run on edge devices, such as smartphones, internet of things (“IoT”) devices, industrial control systems, and/or the like. To address this issue, server-side biometric systems may be used. These systems may offload complex computations from client-side devices by receiving biometric data from the client, and performing heavy computations on a server. This type of architecture may allow the client to be simple and light-weight, as it may not require the client to download and evaluate large machine learning (“ML”) or artificial intelligence (“AI”) models. At the same time, it can reduce authentication time by running complex models on powerful servers, which may be capable of evaluating those models almost in real time and/or may not have the same energy constraints as consumer devices, such as smartphones. However, server-side biometrics may introduce new security concerns related to data transmission and storage on central servers, which may be potentially attractive honeypots for malicious actors. For instance these concerns may include, but are not limited to, data breaches (e.g., centralized databases storing biometric data may be attractive targets for hackers, compromising sensitive user information), unauthorized access (e.g., insider attacks or system compromises can lead to unauthorized access to stored biometric data, enabling malicious activities like identity theft), biometric data misuse (e.g., without adequate safeguards, collected biometric data may be used for unintended purposes, such as secondary profiling or targeted advertising), and/or the like. To address these concerns, encryption and secure storage protocols may be employed to protect biometric data on the server-side. However, these measures may fall short in providing comprehensive security, as server-side encryption may not prevent insider attacks or data exposure during processing. Another way to address this problem may be to use SMPC techniques, which may include tools such as homomorphic encryption (see, e.g., U.S. Patent Application Publication No. 20140281567) and other secure function evaluation constructions that may allow a client to generate encrypted data representing their biometric identity, and a server to process the data without having access to it. Such computation may be resource intensive on the client side both in terms of computation, storage, and communication. Therefore, there may be multiple settings where this approach may not be feasible (e.g., applications running in the browser, wearable devices, medical devices, IoT devices, etc.).

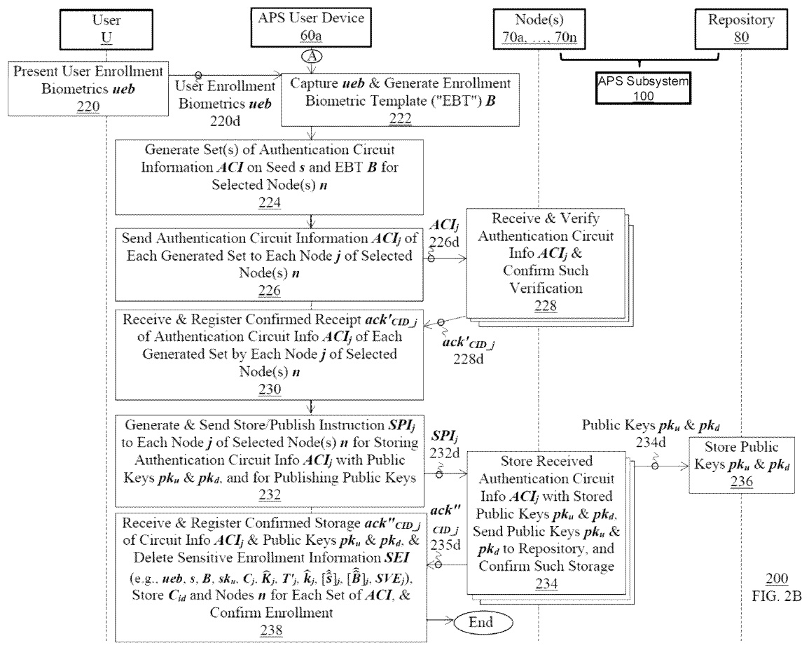

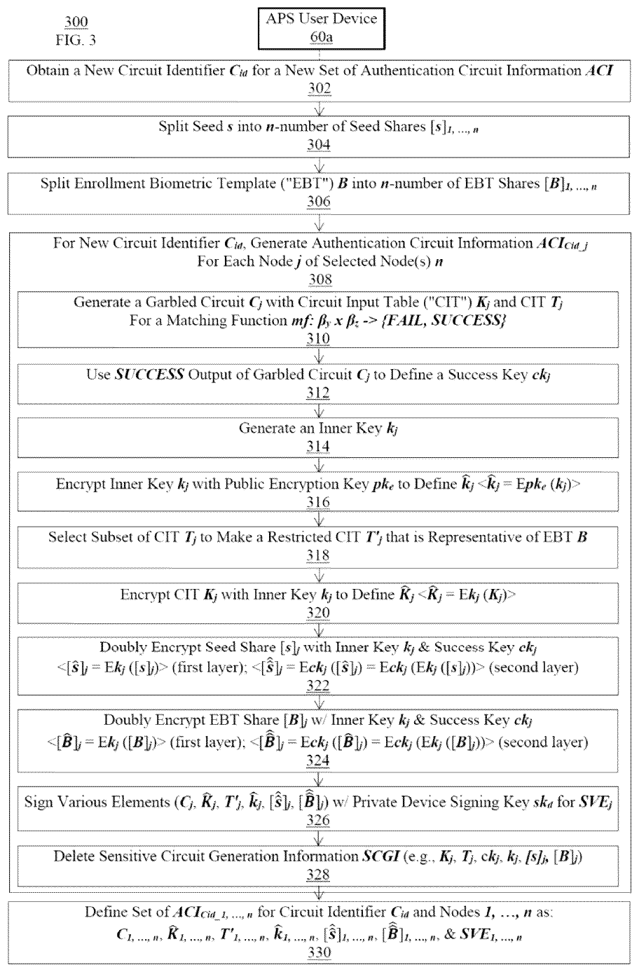

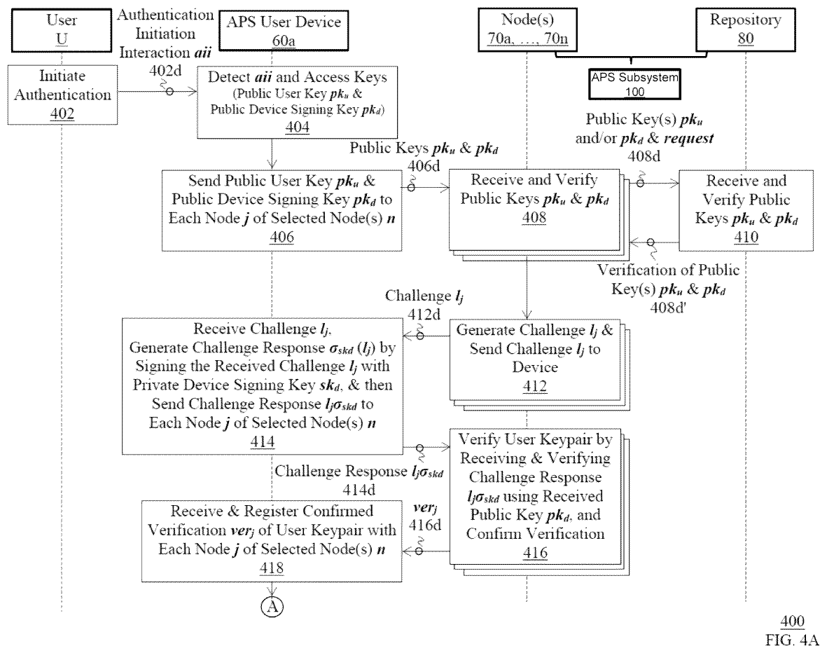

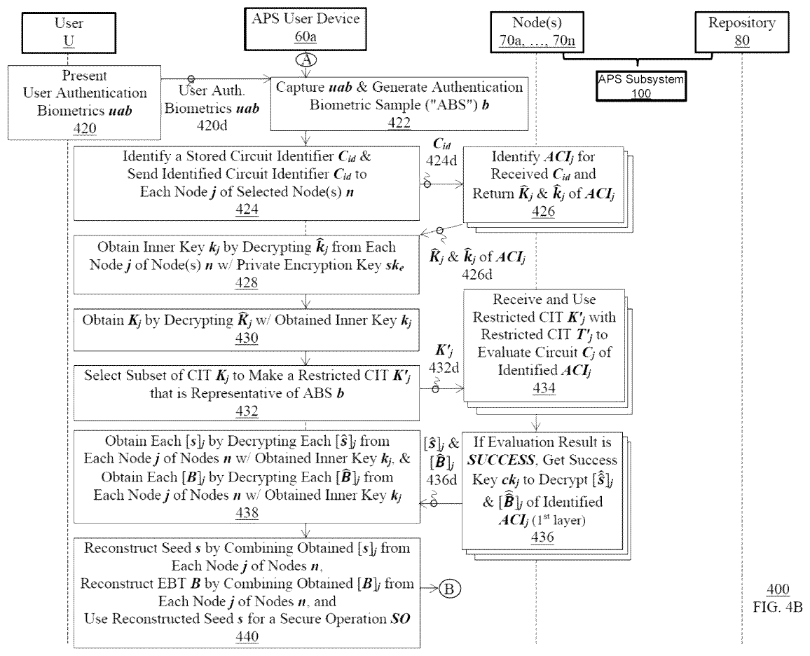

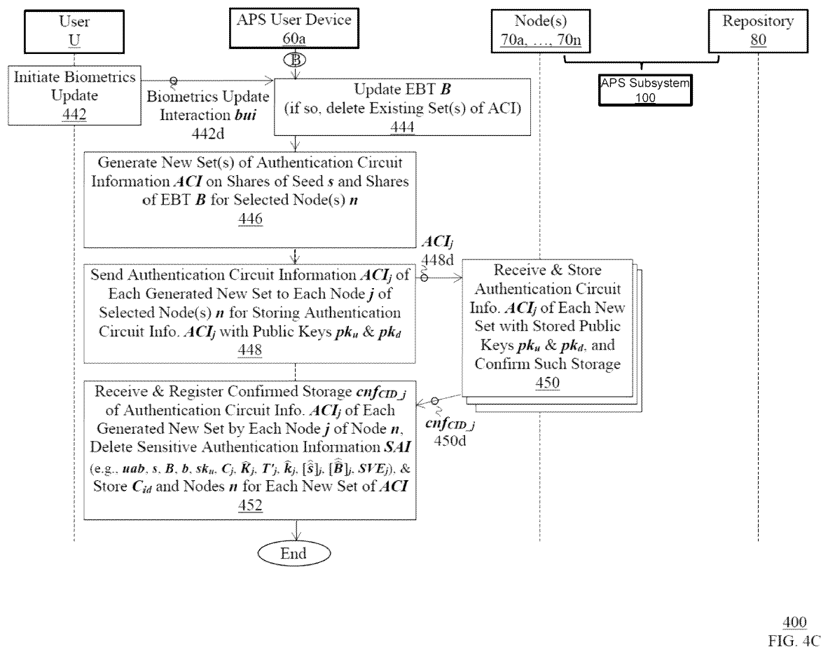

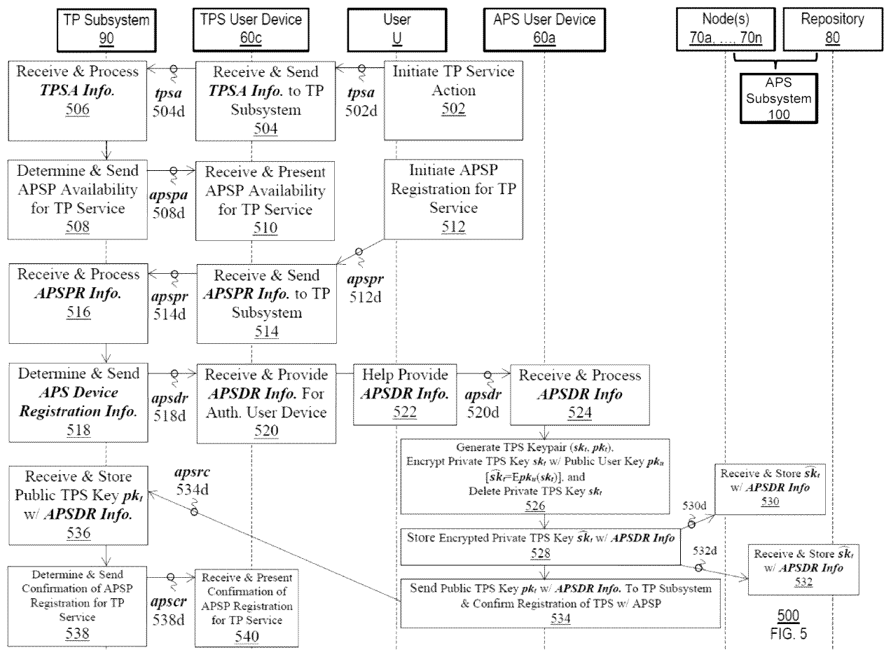

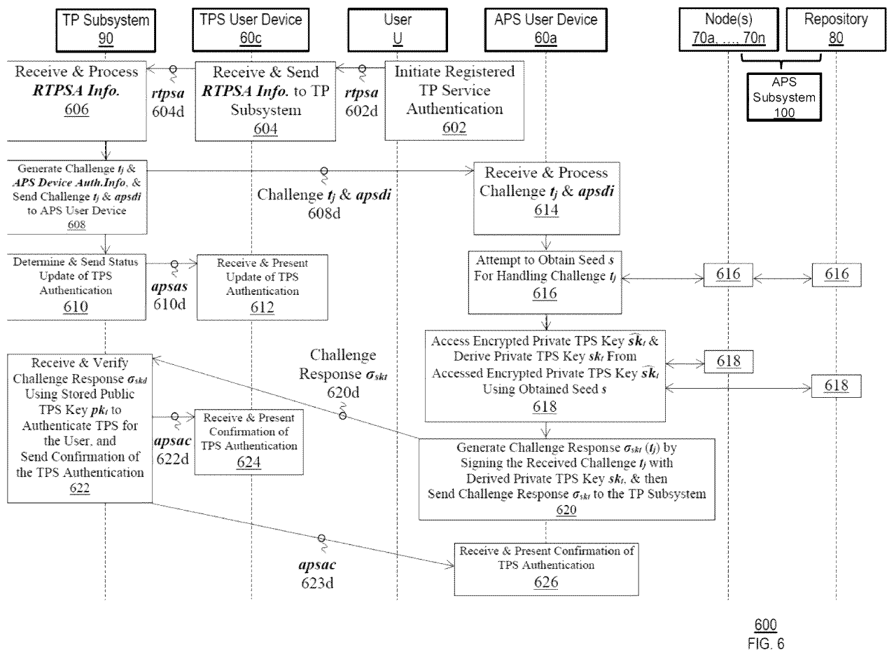

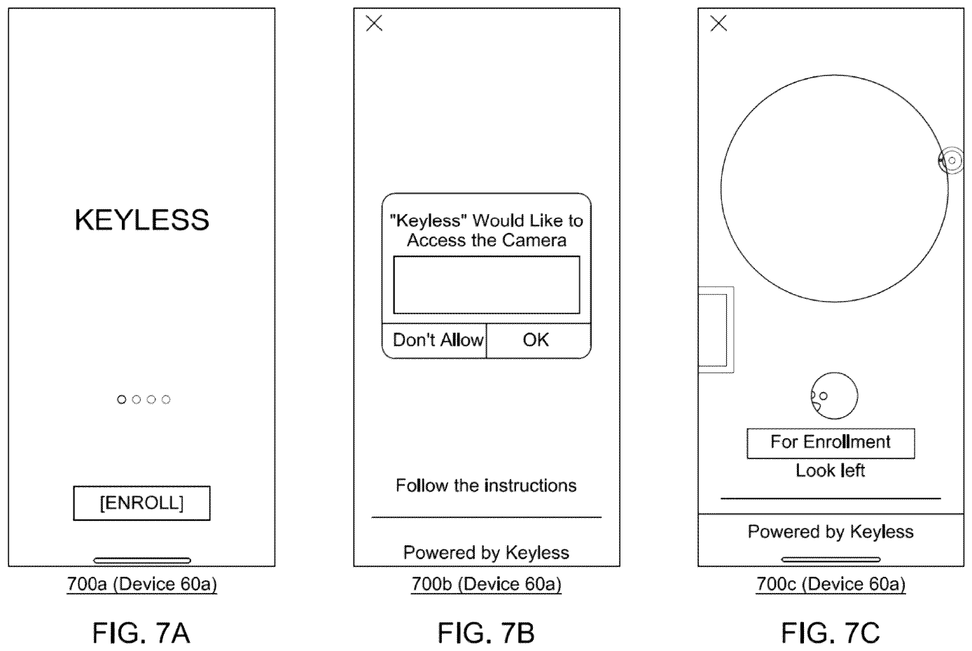

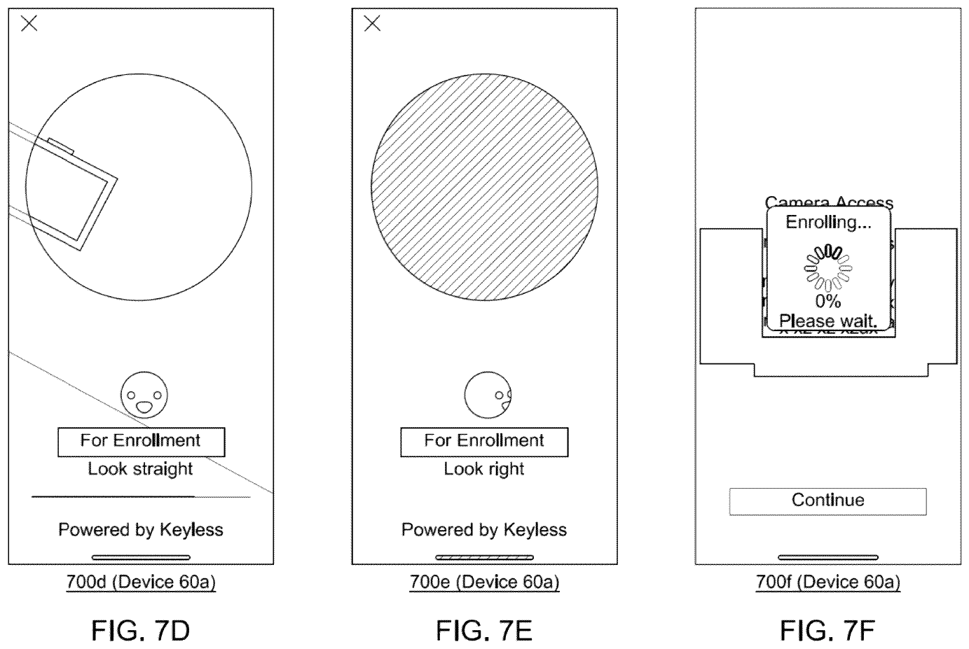

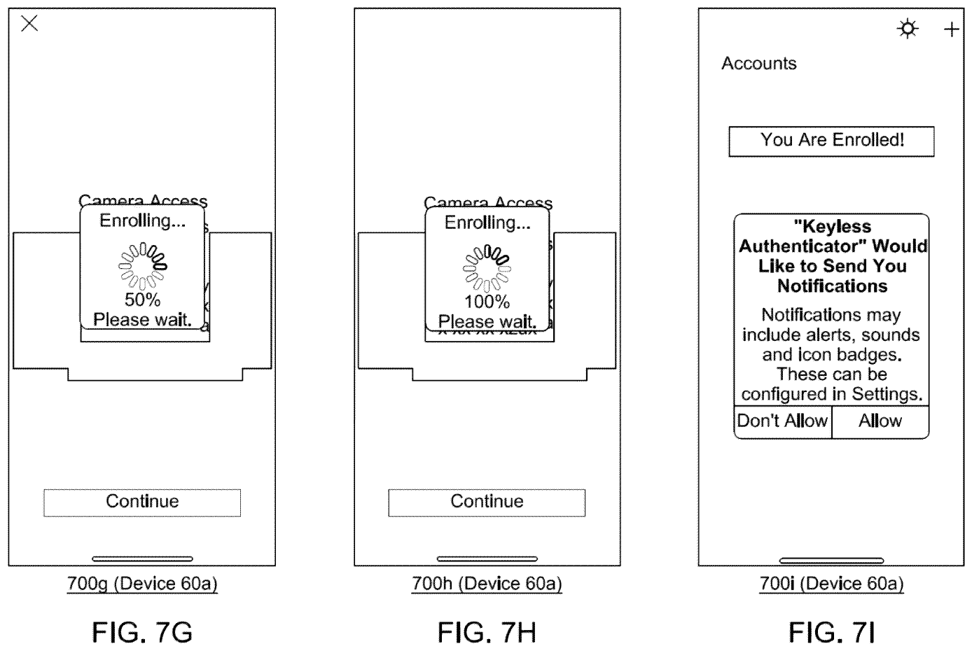

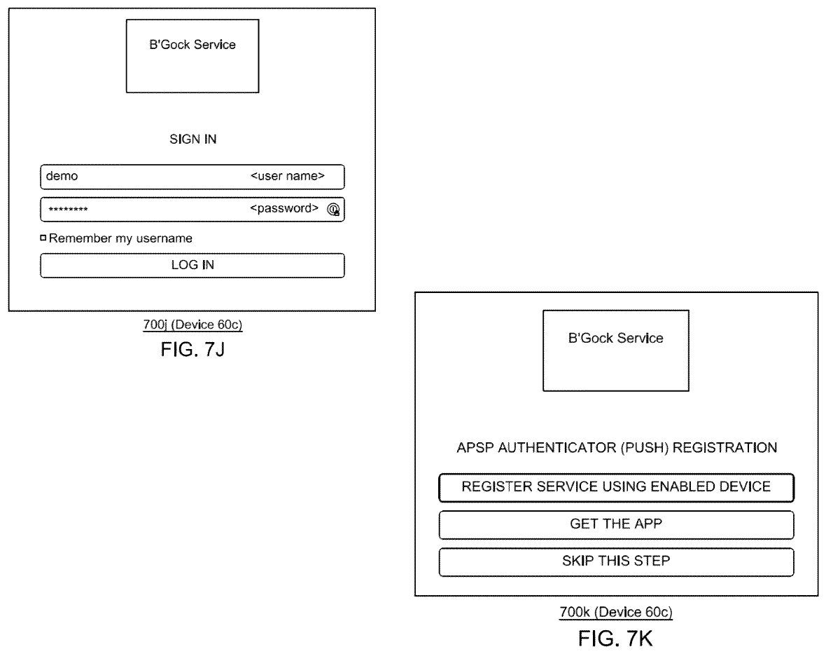

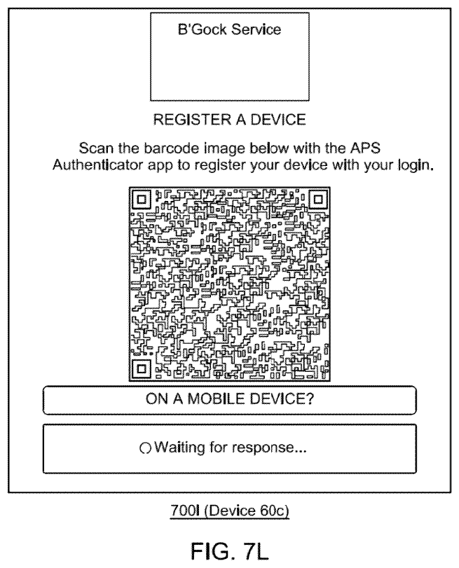

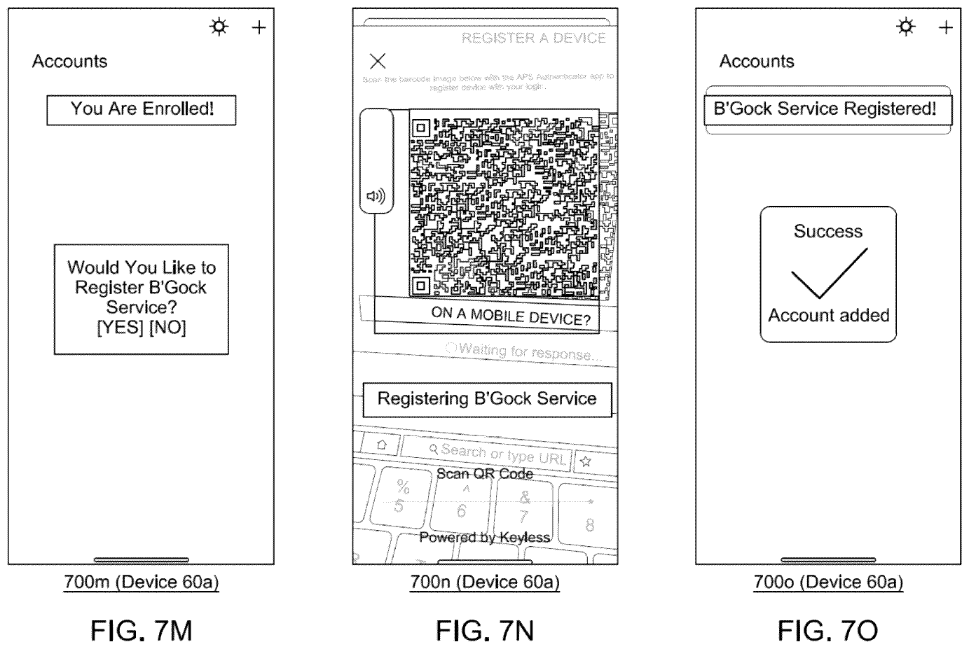

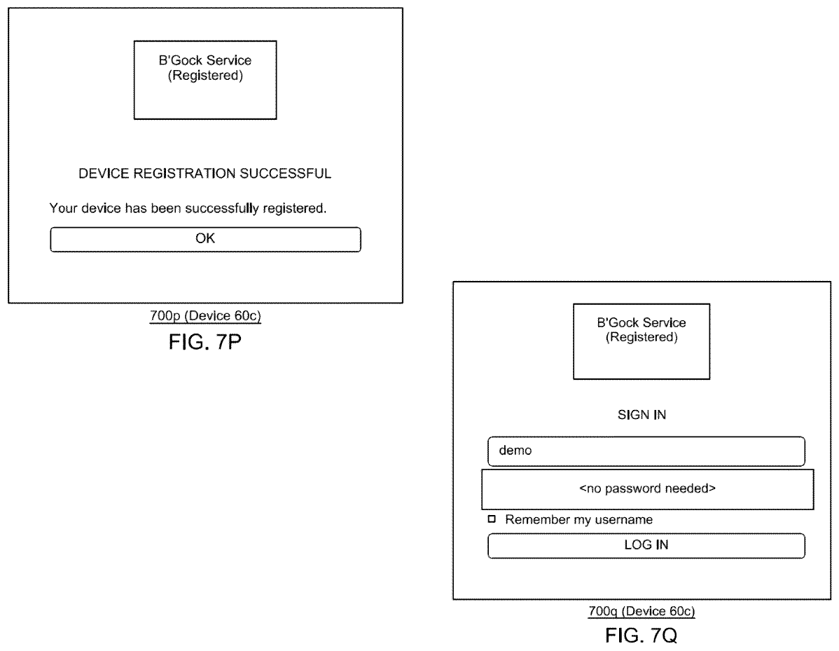

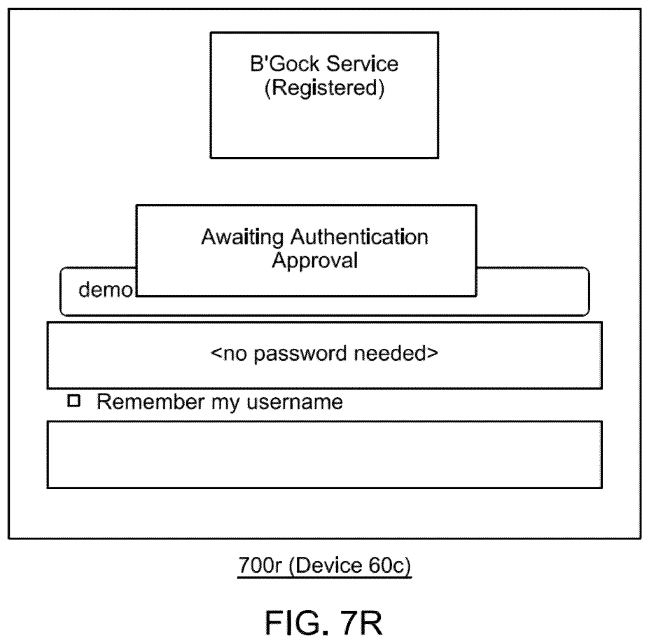

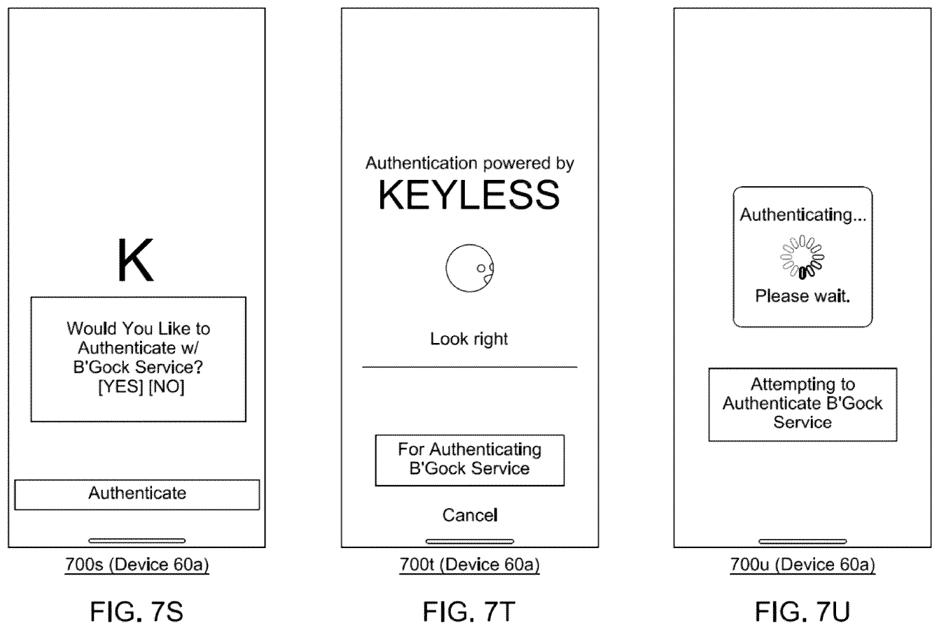

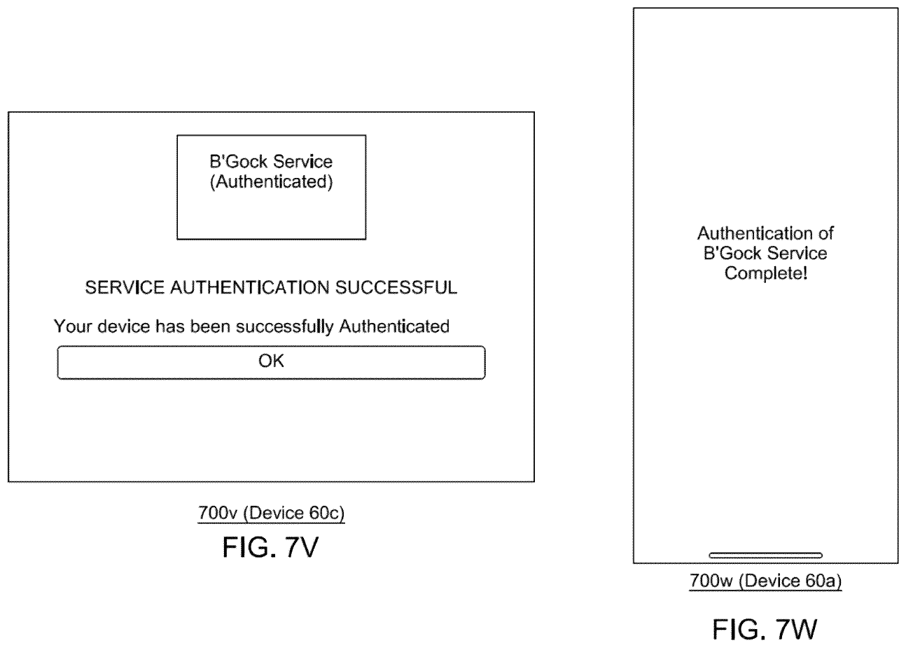

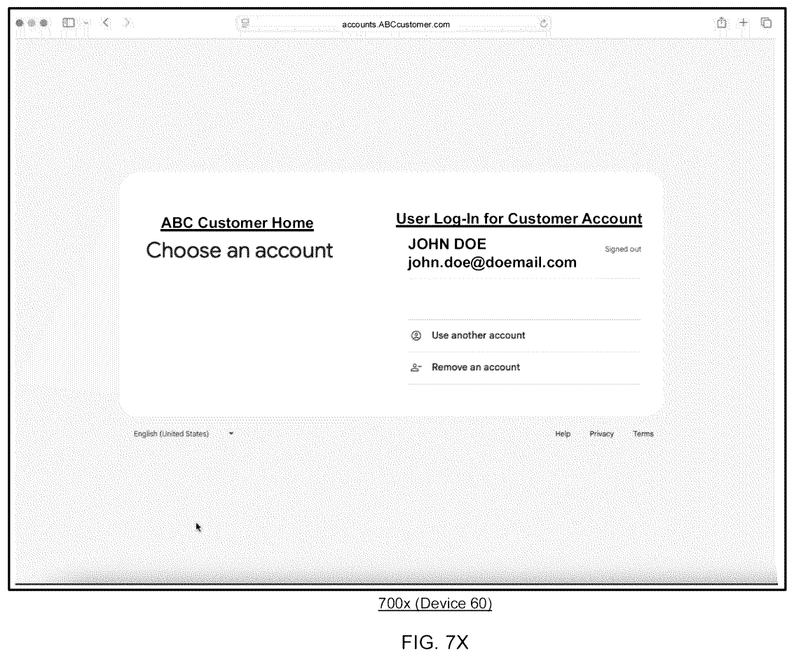

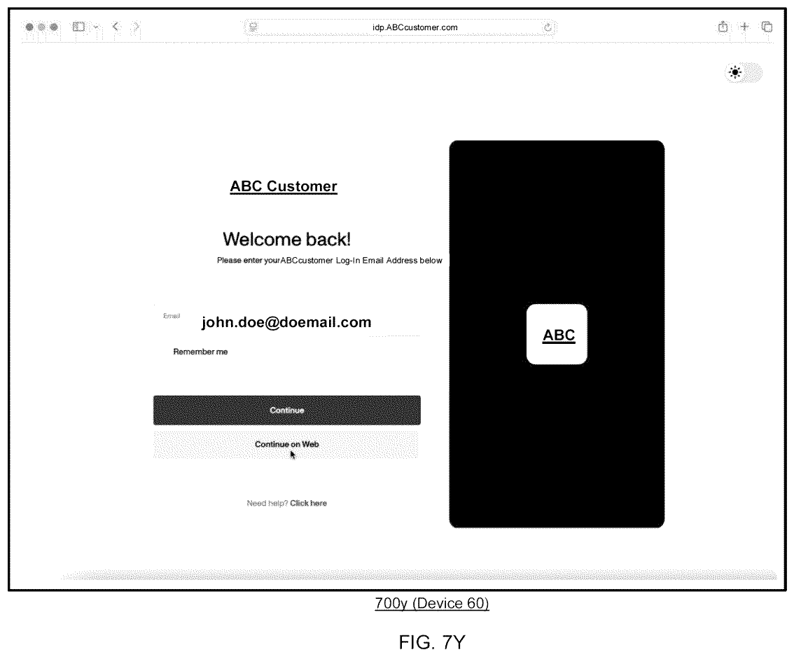

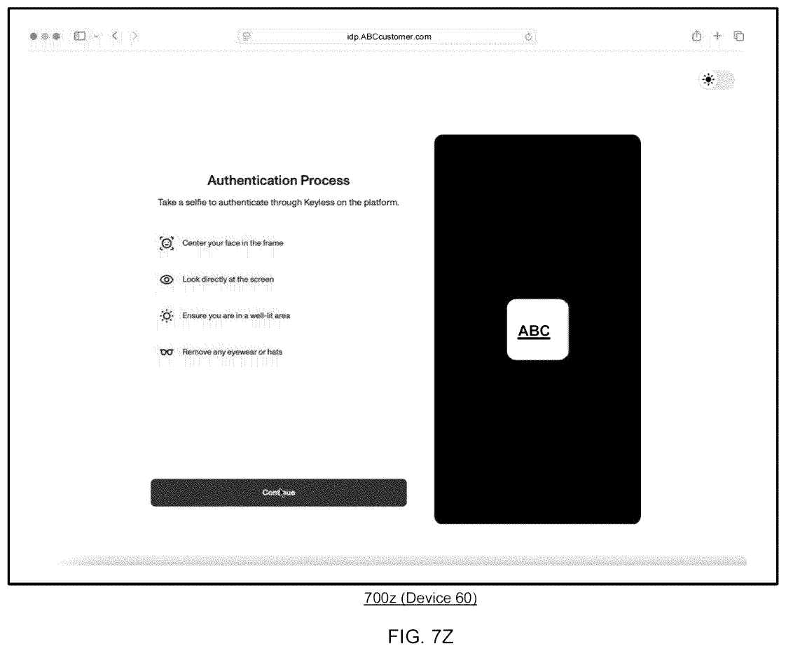

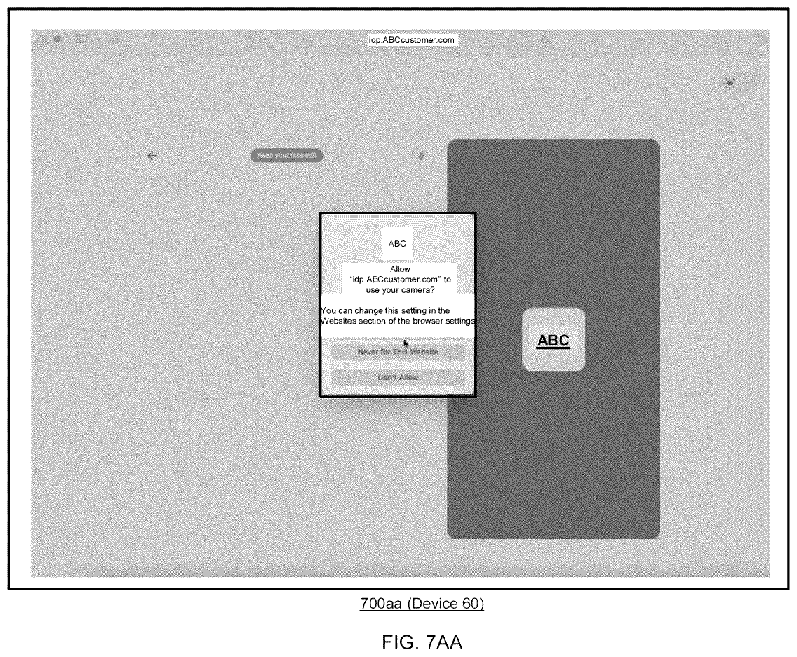

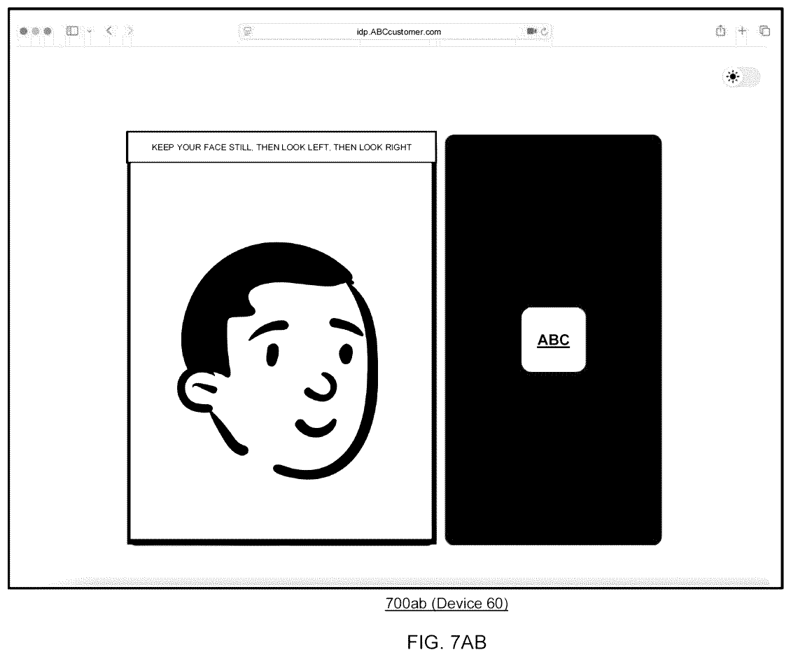

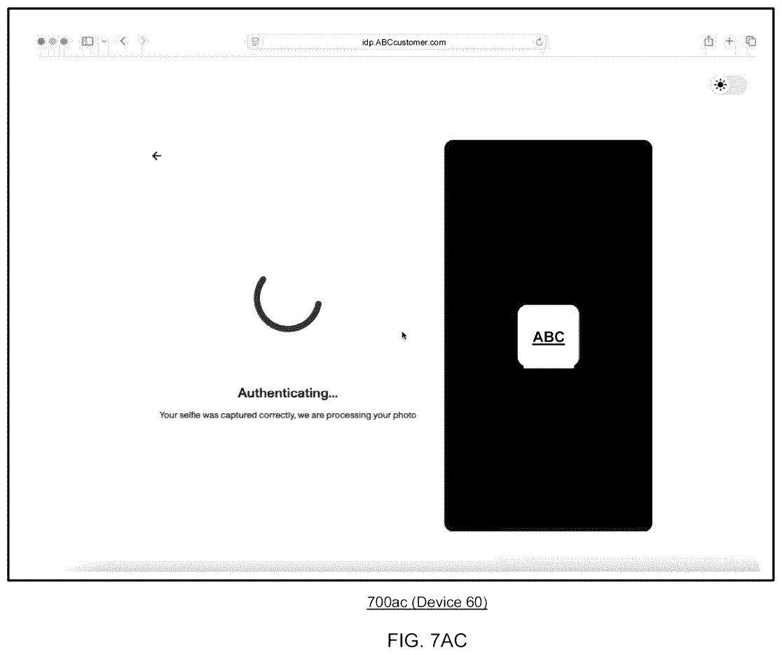

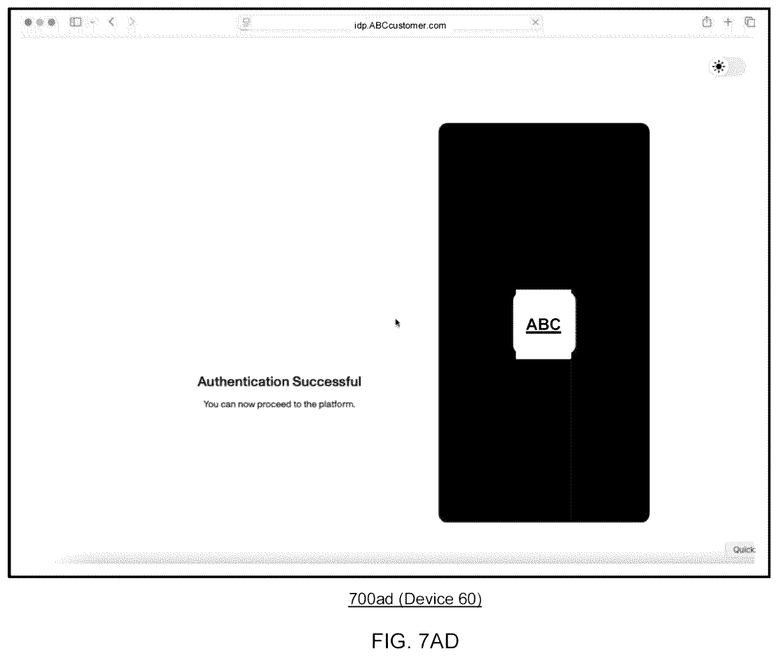

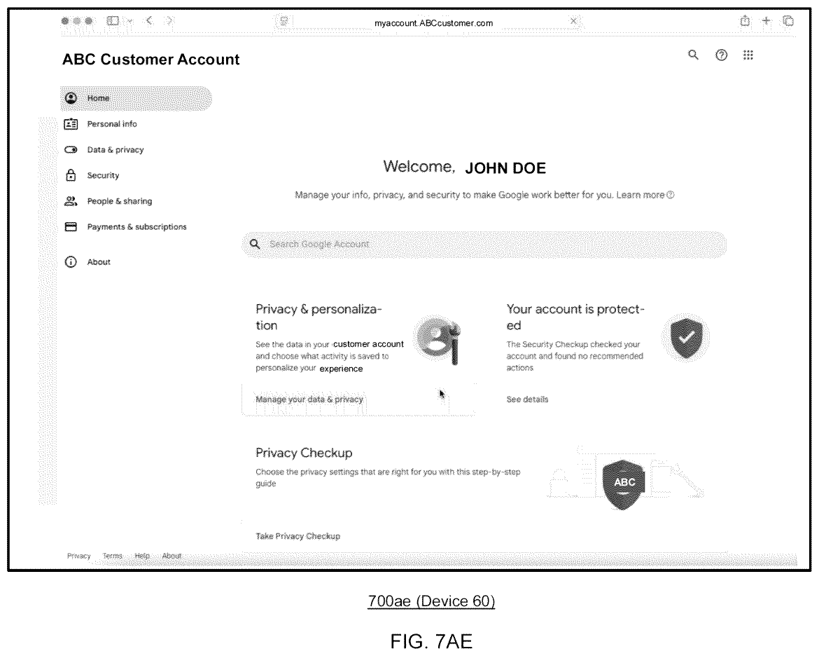

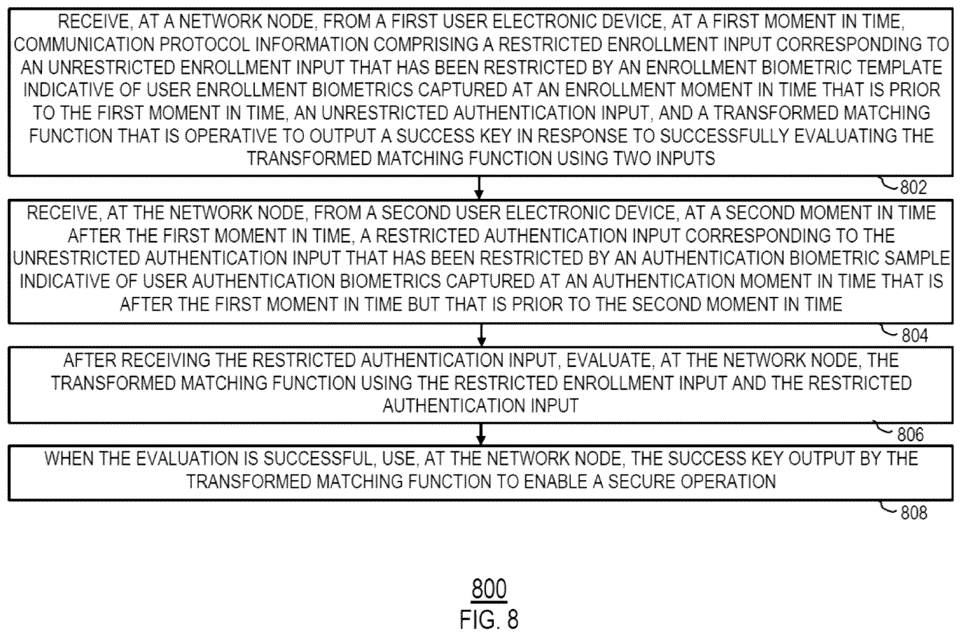

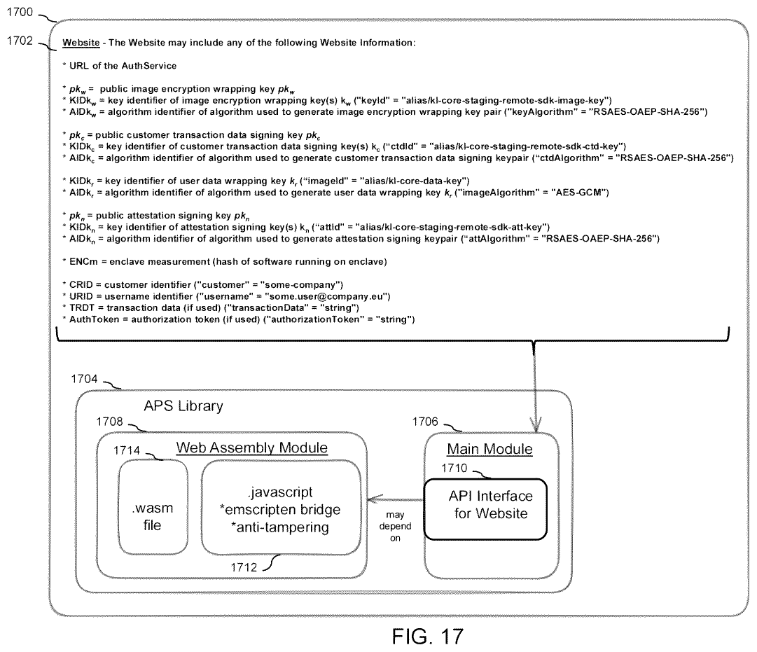

FIG. 1 shows a system 1 in which an authentication processing service (“APS”) may be facilitated amongst various user devices 60 (e.g., one or more APS user devices (e.g., APS user devices 60a and 60b (e.g., as may be operated by any suitable user U)) and/or one or more third party service (“TPS”) user devices (e.g., TPS user device 60c)), various network servers or network nodes 70, a repository 80, at least one third party subsystem 90 (e.g., as may be operated by any suitable customer organization (“O”)), and an APS subsystem 100 (e.g., as may be operated by any suitable administrator A), FIG. TA shows further details with respect to a particular embodiment of a user device 60 of system 1, FIG. 1B shows further details with respect to a particular embodiment of a network node 70 of system 1, FIG. 1C shows further details with respect to a particular embodiment of a repository 80 of system 1, FIG. 1D shows further details with respect to a particular embodiment of a third party subsystem 90 of system 1, FIG. 1E shows further details with respect to a particular embodiment of an APS subsystem 100 of system 1, FIG. 1F shows further details with respect to a particular embodiment of an AuthService subsystem 110 of system 1, FIG. 1G shows further details with respect to a particular embodiment of a key management service (“KMS”) subsystem 120 of system 1, FIG. 1H shows further details with respect to a particular embodiment of an enclave subsystem 130 of system 1, FIG. 1I shows further details with respect to a particular embodiment of a portion of system 1, FIGS. 2A and 2B illustrate a flowchart of an exemplary process for enrolling a user device 60 and a user thereof with an APS platform, FIG. 3 illustrates a flowchart of an exemplary process for generating one or more sets of authentication circuit information for a set of network nodes 70 using secure multi-party computation, FIGS. 4A-4C illustrate a flowchart of an exemplary process for authenticating an enrolled APS user of an enrolled APS user device 60 with the APS platform, FIG. 5 illustrates a flowchart of an exemplary process for registering a third party service of third party subsystem 90 with an enrolled APS user of an enrolled APS user device 60, FIG. 6 illustrates a flowchart of an exemplary process for authenticating an enrolled APS user of an enrolled APS user device 60 with a registered third party service of third party subsystem 90 using the APS platform, FIGS. 7A-7AE illustrate exemplary screens of graphical user interfaces (“UIs”) of one or more user devices 60 carrying out the processes of FIGS. 2A-6 and beyond, FIGS. 8-16 illustrate flowcharts of other exemplary processes for using an authentication processing service, and FIG. 17 illustrates a diagram of an exemplary website to be used by an authentication processing service, according to one or more embodiments of the disclosure.

### FIGS. 1 and 1A-1I

FIG. 1 is a schematic view of an illustrative biometric authentication system 1 in which enrollment and/or authentication processing may be facilitated utilizing one or more trusted environments or devices (e.g., an AuthService subsystem, an enclave subsystem, a user device) and one or more other subsystems. For example, as shown in FIG. 1, system 1 may include an authentication processing service (“APS”) subsystem 100, one or more user subsystems or devices 60 (e.g., one or more APS user subsystems or devices (e.g., APS user devices 60a and 60b) and/or one or more third party service (“TPS”) user subsystems or devices (e.g., TPS user device 60c)), one or more network nodes 70 (e.g., network nodes 70a-70c), at least one repository 80, at least one third party enabler subsystem 90, at least one AuthService subsystem 110, at least one KMS subsystem 120, and/or at least one enclave subsystem 130, and at least one communications network 50 through which APS subsystem 100 and at least one user device 60 and/or at least one network node 70 and/or at least one repository 80 and/or at least one third party enabler subsystem 90 and/or at least one AuthService subsystem 110 and/or at least one KMS subsystem 120 and/or at least one enclave subsystem 130 may communicate. Some or all portions of APS subsystem 100 may be operated, managed, or otherwise at least partially controlled by any suitable entity (e.g., an administrator A (e.g., Keyless™ or any other suitable entity)) that may be responsible for providing to one or more other entities (e.g., a user U of a user device 60 and/or a customer organization O (e.g., bank) of a third party subsystem 90 and/or a provider P of AuthService subsystem 110 and/or a manager M of KMS subsystem 120 and/or a supervisor S of enclave subsystem 130) of system 1 an authentication processing service or authentication processing service platform (“APSP”).

As shown in FIG. 1A, and as described in more detail below, a user device 60 (e.g., one, some, or each of devices 60a-60c of FIG. 1) may include any suitable components or modules, including, but not limited to, a processor component 62, a memory component 63, a communications component 64, a sensor 65, an input/output (“I/O”) component 66, a power supply component 67, a housing 61, and/or a bus 68 that may provide one or more wired or wireless communication links or paths for transferring data and/or power to, from, or between various other components of user device 60. In some embodiments, one or more components of user device 60 may be combined or omitted. Moreover, user device 60 may include other components not combined or included in FIG. 1A and/or several instances of the components shown in FIG. 1A. For the sake of simplicity, only one of each of the components of user device 60 is shown in FIG. 1A.

I/O component 66 may include at least one input component 66i (e.g., a button, mouse, keyboard, etc.) to receive information from a user or other device or power therefrom and/or at least one output component 66o (e.g., an audio output component or speaker, video output component or display, haptic output component (e.g., rumbler, vibrator, etc.), lighting output component, olfactory output component, movement actuator, etc.) to provide information or power or any other suitable support to a user or other device, such as a touch screen I/O component that may receive input information through a user's touch of a display screen and that may also provide visual information to a user via that same display screen, and/or the like. In some embodiments, an I/O component 66 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like.

Memory 63 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., user APSP data 69d (e.g., unique user identifier information, models, neural networks, algorithms, application data, etc.) and/or any suitable service system management model 69m (e.g., that may be used by or as any suitable application 69a))). Memory 63 may include suitable logic, circuitry, and/or code that may enable storage of various types of information, such as received data, generated data, code, and/or configuration information.

Communications component 64 may be provided to allow user device 60 to communicate with one or more other user devices 60 and/or network nodes 70 and/or repository 80 and/or third party subsystem 90 and/or APS subsystem 100 and/or AuthService subsystem 110 and/or KMS subsystem 120 and/or enclave subsystem 130 using any suitable communications protocol (e.g., via communications network 50). Communications component 64 can be operative to create or connect to a communication network or link of a network (e.g., network 50). Communications component 64 can provide wireless communications using any suitable short-range or long-range communications protocol, such as Wi-Fi (e.g., an 802.11 protocol), ZigBee™ (e.g., an 802.15.4 protocol), WiDi™, Ethernet, Bluetooth™ Low Energy (“BLE”), ultra-wideband, radio frequency systems (e.g., 1200 MHz, 2.4 GHz, and 5.6 GHz communication systems), high frequency systems (e.g., 900 MHz, 2.4 GHz, and 5.6 GHz communication systems), near field communication (“NFC”), infrared, protocols used by wireless and cellular telephones and personal e-mail devices, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, any other communications protocol, or any combination thereof. Communications component 64 can also be operative to connect to a wired communications link or directly to another data source wirelessly or via one or more wired connections or other suitable communication type(s). Communications component 64 may be a network interface that may include the mechanical, electrical, and/or signaling circuitry for communicating data over physical links that may be coupled to other devices of a network (e.g., network 50). Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access. Communications component 64 may also include or may be electrically coupled to any suitable transceiver circuitry that can enable device 60 to be communicatively coupled to another subsystem and communicate data with that other device wirelessly or via a wired connection (e.g., using a connector port). Communications component 64 (and/or sensor assembly 65) may be configured to determine a geographical position of device 60 and/or any suitable data that may be associated with that position. For example, communications component 6 may utilize a global positioning system (“GPS”) or a regional or site wide positioning system that may use cell tower positioning technology or Wi-Fi™ technology, or any suitable location based service or real time locating system, which may use a geo-fence for providing any suitable location based data to device 60 (e.g., to determine a current geo location of device 60 and/or any other suitable associated data. Communications component 64 may include or otherwise provide a network interface that may include mechanical, electrical, and/or signaling circuitry for communicating any suitable data over any suitable physical links that may be coupled to network 50.

Sensor 65 may be any suitable sensor that may be configured to sense any suitable data for user device 60 (e.g., location-based data via a GPS sensor system or any other suitable location determination protocol, motion data, environmental data, biometric data, etc.). Sensor 65 may be a sensor assembly that may include any suitable sensor or any suitable combination of sensors operative to detect movements of user device 60 and/or of any user thereof and/or any other characteristics of user device 60 and/or of its environment (e.g., physical activity or other characteristics of a user of user device 60, light content of the device environment, gas pollution content of the device environment, noise pollution content of the device environment, altitude of the device, etc.). Sensor 65 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 65 may include any suitable sensor components or subassemblies for detecting any suitable movement of user device 60 and/or of a user thereof. For example, sensor 65 may include one or more three-axis acceleration motion sensors (e.g., an accelerometer) that may be operative to detect linear acceleration in three directions (i.e., the x- or left/right direction, the y- or up/down direction, and the z- or forward/backward direction). As another example, sensor 65 may include one or more single-axis or two-axis acceleration motion sensors that may be operative to detect linear acceleration only along each of the x- or left/right direction and the y- or up/down direction, or along any other pair of directions. In some embodiments, sensor 65 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 65 may be operative to directly or indirectly detect rotation, rotational movement, angular displacement, tilt, position, orientation, motion along a non-linear (e.g., arcuate) path, or any other non-linear motions. Additionally or alternatively, sensor 65 may include one or more angular rate, inertial, and/or gyro-motion sensors or gyroscopes for detecting rotational movement (e.g., any suitable inertial measurement unit (“IMU”), such as a gyroscope and/or an accelerometer and/or a magnetometer sensor (e.g., a Gauss meter, a magnetic measurement unit (“MMU”), an inertial MMU (“IMMU”), etc.)). For example, sensor 65 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 65 for detecting motion on user device 60, such as any suitable pressure sensors, altimeters, or the like. Using sensor 65, user device 60 may be configured to determine a velocity, acceleration, orientation, and/or any other suitable motion attribute of user device 60. Sensor 65 may include any suitable sensor components or subassemblies for detecting any suitable biometric data and/or health data and/or sleep data and/or mindfulness data and/or the like of a user of user device 60. For example, sensor 65 may include any suitable biometric sensor that may include, but is not limited to, one or more facial recognition sensors, fingerprint scanners, iris scanners, retinal scanners, voice recognition sensors, gait sensors, hair sensors, hand geometry sensors, signature scanners, keystroke dynamics sensors, vein matching sensors, heart beat sensors, body temperature sensors, odor or scent sensors, behavioral biometric sensors (e.g., user behavioral modeling of movement, orientation, gesture, pausality, etc.), DNA sensors, sensors for any unclonable or extremely difficult to replicate personal function, and/or any other suitable sensors for detecting any suitable metrics related to any suitable characteristics of a user, which may also include health-related optical sensors, capacitive sensors, thermal sensors, electric field (“eField”) sensors, and/or ultrasound sensors, such as photoplethysmogram (“PPG”) sensors, electrocardiography (“ECG”) sensors, galvanic skin response (“GSR”) sensors, posture sensors, stress sensors, photoplethysmogram sensors, and/or the like. These sensors can generate data providing health-related information associated with the user. For example, PPG sensors can provide information regarding a user's respiratory rate, blood pressure, and/or oxygen saturation. ECG sensors can provide information regarding a user's heartbeats. GSR sensors can provide information regarding a user's skin moisture, which may be indicative of sweating and can prioritize a thermostat application to determine a user's body temperature. One or more biometric sensors may be multi-modal biometric sensors and/or operative to detect long-lived biometrics, modem liveness (e.g., active, passive, etc.) biometric detection, and/or the like. Sensor 65 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature-processing application that may be accessible to user device 60 for attempting to authenticate a user), line-in connector for data and/or power, and/or combinations thereof. In some examples, each sensor can be a separate device, while, in other examples, any combination of two or more of the sensors can be included within a single device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single device. Using one or more of these sensors, user device 60 can determine physiological characteristics of the user while performing a detected activity, such as a heart rate of a user associated with the detected activity, average body temperature of a user detected during the detected activity, any normal or abnormal physical conditions associated with the detected activity, or the like. In some examples, a GPS sensor or any other suitable location detection component(s) of user device 60 can be used to determine a user's location (e.g., geo-location and/or address and/or location type (e.g., library, school, office, zoo, etc.)) and movement, as well as a displacement of the user's motion. An accelerometer, directional sensor, and/or gyroscope can further generate activity data that can be used to determine whether a user of user device 60 is engaging in an activity, is inactive, or is performing a gesture. Any suitable activity of a user may be tracked by sensor 65, including, but not limited to, steps taken, flights of stairs climbed, calories burned, distance walked, distance run, minutes of exercise performed and exercise quality, time of sleep and sleep quality, nutritional intake (e.g., foods ingested and their nutritional value), mindfulness activities and quantity and quality thereof (e.g., reading efficiency, data retention efficiency), any suitable work accomplishments of any suitable type (e.g., as may be sensed or logged by user input information indicative of such accomplishments), and/or the like. User device 60 can further include a timer that can be used, for example, to add time dimensions to various attributes of any detected element(s) (e.g., the detected physical activity, such as a duration of a user's physical activity or inactivity, time(s) of a day when the activity is detected or not detected, and/or the like). Sensor 65 may include any suitable sensor components or subassemblies for detecting any suitable characteristics of any suitable condition of the lighting of the environment of user device 60. For example, sensor 65 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of user device 60 (e.g., in lux or lumens per square meter, etc.) and/or for determining the ambient color or white point chromaticity of ambient light in the environment of user device 60 (e.g., in hue and colorfulness or in x/y parameters with respect to an x-y chromaticity space, etc.) and/or for determining the UV index or UV radiation in the environment of user device 60 (e.g., in UV index units, etc.). A suitable light sensor may include, for example, a photodiode, a phototransistor, an integrated photodiode and amplifier, or any other suitable photo-sensitive device. In some embodiments, more than one light sensor may be integrated into user device 60. Sensor 65 may include any suitable sensor components or subassemblies for detecting any suitable characteristics of any suitable condition of the air quality of the environment of user device 60. For example, sensor 65 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of user device 60 (e.g., in O₂ % per liter, etc.) and/or for determining the air velocity of the ambient air in the environment of user device 60 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of user device 60 (e.g., in HG % per liter, etc.) and/or for determining the humidity of the ambient air in the environment of device 100 (e.g., in grams of water per cubic meter, etc. (e.g., using a hygrometer)) and/or for determining the temperature of the ambient air in the environment of user device 60 (e.g., in degrees Celsius, etc. (e.g., using a thermometer)). Sensor 65 may include any suitable sensor components or subassemblies for detecting any suitable characteristics of any suitable condition of the sound quality of the environment of user device 60. For example, sensor 65 may include any suitable sound quality sensor that may include, but is not limited to, one or more microphones or the like that may determine the level of sound pollution or noise in the environment of user device 60 (e.g., in decibels, etc.). Sensor 65 may also include any other suitable sensor for determining any other suitable characteristics about a user of user device 60 and/or the environment of user device 60 and/or any situation within which user device 60 may be existing. For example, any suitable clock and/or position sensor(s) may be provided to determine the current time and/or time zone within which user device 60 may be located. Sensor 65 may be embedded in a body (e.g., housing 61) of user device 60, such as along a bottom surface that may be operative to contact a user, or can be positioned at any other desirable location. In some examples, different sensors can be placed in different locations inside or on the surfaces of user device 60 (e.g., some located inside housing 61 and some attached to an attachment mechanism (e.g., a wrist band coupled to a housing of a wearable device), or the like). In other examples, one or more sensors can be worn by a user separately as different parts of a single user device 60 or as different devices. In such cases, the sensors can be configured to communicate with user device 60 using a wired and/or wireless technology (e.g., via communications component 64). In some examples, sensors can be configured to communicate with each other and/or share data collected from one or more sensors. In some examples, user device 60 can be waterproof such that the sensors can detect a user's activity in water.

Power supply 67 can include any suitable circuitry for receiving and/or generating power, and for providing such power to one or more of the other components of user device 60. For example, power supply assembly 67 can be coupled to a power grid (e.g., when device 60 is not acting as a portable device or when a battery of the device is being charged at an electrical outlet with power generated by an electrical power plant). As another example, power supply assembly 67 may be configured to generate power from a natural source (e.g., solar power using solar cells). As another example, power supply assembly 67 can include one or more batteries for providing power (e.g., when device 60 is acting as a portable device). User device 60 may also be provided with a housing 61 that may at least partially enclose one or more of the components of user device 60 for protection from debris and other degrading forces external to user device 60. Each component of user device 60 may be included in the same housing 61 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, user device 60 may include other components not combined or included in those shown or several instances of the components shown.

Processor 62 may be used to run one or more applications, such as an application 69 (e.g., a specific application 69a, any suitable web browser application 69w, etc.) that may be accessible from memory 63 (e.g., as a portion of user data 69d) and/or any other suitable source (e.g., from network 50 or any other subsystem). Application 69 may include, but is not limited to, one or more operating system applications, firmware applications, communication applications (e.g., for enabling communication of data between user devices 60 and APS subsystem 100 and/or nodes 70 and/or repository 80 and/or third party subsystem 90 and/or AuthService subsystem 110 and/or KMS subsystem 120 and/or enclave subsystem 130), third party service applications (e.g., wallet applications, banking applications, social media applications, etc.), internet browsing applications (e.g., for interacting with a website provided by a third party subsystem 90 and/or by APS subsystem 100 (e.g., via any suitable browser 69w of device 60) for enabling user device 60 to interact with an online service), application programming interfaces (“APIs”), software development kits (“SDKs”), APS applications (e.g., a web application or a native application that may be at least partially produced by APS subsystem 100 for enabling user device 60 to interact with an online service and/or one or more network nodes 70 and/or repository 80 and/or a third party subsystem 90 and/or AuthService subsystem 110 and/or KMS subsystem 120 and/or enclave subsystem 130), and/or any other suitable application(s), and/or the like. For example, processor 62 may load an application 69 as a user interface program to determine how instructions or data received via an input component 66i of I/O component 66 or other component of subsystem 60 (e.g., sensor 65 and/or communications component 64) may manipulate the way in which information may be stored (e.g., in memory 63) and/or provided to the user via an output component 66o of I/O component 66 and/or to another subsystem via communications component 64. As one example, application 69 may be a third party application that may be running on subsystem 60 that may be loaded on subsystem 60 (e.g., using communications component 64) via an application market, such as the Apple App Store or Google Play, or that may be accessed via an internet application or web browser (e.g., by Apple Safari or Google Chrome) that may be running on subsystem 60 and that may be pointed to a uniform resource locator (“URL”) whose target or web resource may be managed by or otherwise affiliated with any suitable entity. Any device (e.g., any user device or subsystem or server) may include any suitable special purpose hardware (e.g., hardware support of high-speed packet processing, hardware support of machine learning algorithms, etc.). Processor 62 may include suitable logic, circuitry, and/or code that may enable processing data and/or controlling operations of subsystem 60. In this regard, processor 62 may be enabled to provide control signals to various other components of subsystem 60. Processor 62 may also control transfers of data between various portions of subsystem 60. Processor 62 may further implement an operating system or may otherwise execute code to manage operations of subsystem 60. As one example, application 69 may provide a user with the ability to interact with an authentication processing service platform (“APSP”) of system 1, where application 69 may be a third party application that may be running on user device 60 (e.g., an application associated with APS subsystem 100 and/or third party subsystem 90) that may be loaded on user device 60 (e.g., using communications component 64) via an application market, such as the Apple App Store or Google Play, or that may be accessed via an internet application or web browser (e.g., by Apple Safari or Google Chrome) that may be running on user device 60 and that may be pointed to a uniform resource locator (“URL”) whose target or web resource may be managed by or otherwise affiliated with the APSP.

User device 60 may be any portable, mobile, wearable, implantable, or hand-held electronic device configured to operate with the APSP of system 1. Alternatively, user device 60 may not be portable during use, but may instead be generally stationary. User device 60 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), a tag, credit card-shaped device, transponder, transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device (e.g., watch, ring, glasses, etc.), boom box, internet of things (“IoT”) device, virtualized IoT device (e.g., cloud compute instance), modem, router, RFID card, printer, kiosk (e.g., a public kiosk that may be used to provide a personal virtual device by enrolling and/or authenticating various users through distinct enrollment and/or authentication processes), beacon (e.g., a Bluetooth low energy beacon transmitter device), server, and any combinations thereof. Subsystem 60 may be configured to have any physical structure (e.g., by one or more housings 61) that may include, but is not limited to, any suitable portable, mobile, wearable, implantable, rideable, controllable, or hand-held mobile electronic device (e.g., a portable and/or handheld media player), a headset, a helmet, glasses, a wearable, a tablet computer, a laptop computer, a controller, a VR and/or AR and/or MR device, a vehicle, server, sensor system, actuator system, and/or any other machine or device or housing or structure. Alternatively, subsystem 60 may not be portable during use, but may instead be generally stationary. In one or more implementations, one or more of processor 62, memory 63, sensor(s) 65, communications interface or communications component 64, 1/O component 66, and/or power supply 67, and/or one or more portions thereof, may be implemented in software (e.g., subroutines and code), may be implemented in hardware (e.g., an application specific integrated circuit (“ASIC”), a field programmable gate array (“FPGA”), a programmable logic device (“PLD”), a controller, a state machine, gated logic, discrete hardware components, or any other suitable devices), and/or a combination of both. Variations in the arrangement and type of the components may be made without departing from the spirit or scope of the claims as set forth herein Additional components, different components, or fewer components may be provided. A user device (e.g., a trusted user device) may be any suitable device that may be operative to store a trusted user device secret (e.g., a secret ((e.g., as may be described in U.S. Pat. No. 11,936,775, which is hereby incorporated by reference herein in its entirety)), and may, in some embodiments, have the ability to run cryptographic computation and/or to communicate with one or more servers (e.g., device 60a) and/or be provided as a low-power trusted device (e.g., a smart card, RFID tag, etc.) or even a passive device (e.g., a magnetic strip) (e.g., device 60b), for example, when there may be some semi-trusted infrastructure (e.g., TPS device 60c) that can perform part of the computation that may be required to authenticate the user. In some embodiments, a sensor and a user device can be the same entity. A sensor extracting user biometrics ub and/or processing a biometric template B (or ω) or biometric sample b (or ω′) and a device storing secret (e.g., secret 6) can be located on the same device (e.g., in the case of a smartphone equipped with a front-facing camera or a fingerprint scanner), or can exist on different devices, as in the case of a system that may use a smartcard or access card (e.g., trusted device) possessed by a user and a camera that may capture ub/ω at a gate or semi trusted device.

As shown in FIG. 1B, network node 70 (e.g., one, some, or each of nodes 70a-70c of FIG. 1) may include a processor component 72 that may be similar to processor 62, an application 79 (e.g., application 79a) that may be similar to application 69, a memory component 73 that may be similar to memory component 63 (e.g., for storing data (e.g., node APSP data 79d (e.g., unique user identifier information, models, neural networks, algorithms, application data, etc.) and/or any suitable node service system management model 79m (e.g., that may be used by or as any suitable application 79a))), a communications component 74 that may be similar to communications component 64, a sensor 75 that may be similar to sensor 65, an I/O component 76 that may be similar to I/O component 66 (e.g., with component(s) 66i and/or 66o), a power supply component 77 that may be similar to power supply component 67, a housing 71 that may be similar to housing 61, and/or a bus 78 that may be similar to bus 68. One, some, or each communications component 64 and/or one, some, or each communications component 74 may be a network interface that may include the mechanical, electrical, and signaling circuitry for communicating data over physical links coupled to network 50.

As shown in FIG. 1C, repository 80 may include a processor component 82 that may be similar to processor 62, an application 89 (e.g., application 89a) that may be similar to application 69, a memory component 83 that may be similar to memory component 63 (e.g., for storing data (e.g., repository APSP data 89d (e.g., unique user identifier information, models, neural networks, algorithms, application data, etc.) and/or any suitable repository service system management model 89m (e.g., that may be used by or as any suitable application 89a))), a communications component 84 that may be similar to communications component 64, a sensor 85 that may be similar to sensor 65, an I/O component 86 that may be similar to I/O component 66 (e.g., with component(s) 86i and/or 86o), a power supply component 87 that may be similar to power supply component 67, a housing 81 that may be similar to housing 61, and/or a bus 88 that may be similar to bus 68. One, some, or each communications component 64 and/or one, some, or each communications component 84 may be a network interface that may include the mechanical, electrical, and signaling circuitry for communicating data over physical links coupled to network 50.

As shown in FIG. 1D, third party subsystem 90 may include a processor component 92 that may be similar to processor 62, an application 99 (e.g., application 99a) that may be similar to application 69, a memory component 93 that may be similar to memory component 63 (e.g., for storing data (e.g., third party APSP data 99d (e.g., unique user identifier information, models, neural networks, algorithms, application data, etc.) and/or any suitable third party service system management model 99m (e.g., that may be used by or as any suitable application 99a))), a communications component 94 that may be similar to communications component 64, a sensor 95 that may be similar to sensor 65, an I/O component 96 that may be similar to I/O component 66 (e.g., with component(s) 96i and/or 96o), a power supply component 97 that may be similar to power supply component 67, a housing 81 that may be similar to housing 61, and/or a bus 98 that may be similar to bus 68. One, some, or each communications component 64 and/or one, some, or each communications component 94 may be a network interface that may include the mechanical, electrical, and signaling circuitry for communicating data over physical links coupled to network 50.

As shown in FIG. 1E, APS subsystem 100 may include a processor component 12 that may be similar to processor 62, an application 19 (e.g., application 19a) that may or may not be similar to application 69, a memory component 13 that may be similar to memory component 63 (e.g., for storing data (e.g., APS subsystem APSP data 19d (e.g., unique user identifier information, models, neural networks, algorithms, application data, etc.) and/or any suitable APS service system management model 19m (e.g., that may be used by or as any suitable application 19a))), a communications component 14 that may be similar to communications component 64, a sensor 15 that may be similar to sensor 65, an I/O component 16 that may be similar to I/O component 66 (e.g., with component(s) 16i and/or 16o), a power supply component 17 that may be similar to power supply component 67, a housing 11 that may be similar to housing 61, and/or a bus 18 that may be similar to bus 68. APS subsystem APSP data 19d may include one or more data sources or data structures that may include any suitable data and/or applications (e.g., application 69 for use by user device 60 and/or application 79 for use by a network node and/or an application 19 that may be run by processor 12 of APS subsystem 100 and/or the like) for facilitating an authentication processing service or APSP that may be provided by APS subsystem 100 and/or any other entities of system 1 to one or more users. Some or all portions of APS subsystem 100 may be operated, managed, or otherwise at least partially controlled by an entity responsible for providing to one or more users or entities of system 1 an authentication processing service or APSP, which may be referred to herein as a Keyless™ platform.

As shown in FIG. 1F, an authorization service subsystem or AuthService subsystem 110 may include a processor component 112 that may be similar to processor 62, an application 119 (e.g., application 119a) that may be similar to application 19, a memory component 113 that may be similar to memory component 63 (e.g., for storing data (e.g., AuthService data 119d (e.g., unique user identifier information, models, neural networks, algorithms, application data, etc.), such as data 119dw, and/or any suitable AuthService system management model 119m (e.g., that may be used by or as any suitable application 119a))), a communications component 114 that may be similar to communications component 64, a sensor 115 that may be similar to sensor 65, an I/O component 116 that may be similar to I/O component 66 (e.g., with component(s) 116i and/or 116o), a power supply component 117 that may be similar to power supply component 67, a housing 111 that may be similar to housing 61, and/or a bus 118 that may be similar to bus 68. One, some, or each communications component 64 and/or one, some, or each communications component 114 may be a network interface that may include the mechanical, electrical, and signaling circuitry for communicating data over physical links coupled to network 50.

As shown in FIG. 1G, KMS subsystem 120 may include a processor component 122 that may be similar to processor 62, an application 129 (e.g., application 129a) that may be similar to application 19, a memory component 123 that may be similar to memory component 63 (e.g., for storing data (e.g., KMS data 129d (e.g., unique user identifier information, models, neural networks, algorithms, application data, etc.), such as data 129dw, and/or any suitable KMS system management model 129m (e.g., that may be used by or as any suitable application 129a))), a communications component 124 that may be similar to communications component 64, a sensor 125 that may be similar to sensor 65, an I/O component 126 that may be similar to I/O component 66 (e.g., with component(s) 126i and/or 126o), a power supply component 127 that may be similar to power supply component 67, a housing 121 that may be similar to housing 61, and/or a bus 128 that may be similar to bus 68. One, some, or each communications component 64 and/or one, some, or each communications component 124 may be a network interface that may include the mechanical, electrical, and signaling circuitry for communicating data over physical links coupled to network 50.

As shown in FIG. 1H, enclave subsystem 130 may include a processor component 132 that may be similar to processor 62, an application 139 (e.g., application 139a) that may be similar to application 19, a memory component 133 that may be similar to memory component 63 (e.g., for storing data (e.g., enclave data 139d (e.g., unique user identifier information, models, neural networks, algorithms, application data, etc.), such as data 139dw, and/or any suitable enclave system management model 139m (e.g., that may be used by or as any suitable application 139a))), a communications component 134 that may be similar to communications component 64, a sensor 135 that may be similar to sensor 65, an I/O component 136 that may be similar to I/O component 66 (e.g., with component(s) 136i and/or 136o), a power supply component 137 that may be similar to power supply component 67, a housing 131 that may be similar to housing 61, and/or a bus 138 that may be similar to bus 68. One, some, or each communications component 64 and/or one, some, or each communications component 134 may be a network interface that may include the mechanical, electrical, and signaling circuitry for communicating data over physical links coupled to network 50.

APS subsystem 100 may communicate with one or more user devices 60 and/or network nodes 70 and/or repository 80 and/or third party enabler subsystems 90 and/or AuthService subsystems 110 and/or KMS subsystems 120 and/or enclave subsystems 130 via one or more communications networks 50, and/or any user device 60 may communicate with any other user device 60 and/or network node 70 and/or repository 80 and/or subsystem 90 and/or AuthService subsystem 110 and/or KMS subsystem 120 and/or enclave subsystem 130 via one or more communications networks 50, and/or any network node 70 may communicate with any other network node 70 and/or user device 60 and/or repository 80 and/or subsystem 90 and/or AuthService subsystem 110 and/or KMS subsystem 120 and/or enclave subsystem 130 via one or more communications networks 50, and/or any AuthService subsystem 110 may communicate with any other AuthService subsystem 110 and/or user device 60 and/or network node 70 and/or repository 80 and/or subsystem 90 and/or KMS subsystem 120 and/or enclave subsystem 130 via one or more communications networks 50, and/or any KMS subsystem 120 may communicate with any other KMS subsystem 120 and/or user device 60 and/or network node 70 and/or repository 80 and/or subsystem 90 and/or AuthService subsystem 110 and/or enclave subsystem 130 via one or more communications networks 50, and/or any enclave subsystem 130 may communicate with any other enclave subsystem 130 and/or user device 60 and/or network node 70 and/or repository 80 and/or subsystem 90 and/or AuthService subsystem 110 and/or KMS subsystem 120 via one or more communications networks 50. Network 50 may be the internet or any other network for coupling any two entities or devices or subsystems of system 1 that may be remote from one another, such that when interconnected, a user device 60 may access information (e.g., an API, SDK, protocol, application, etc. (e.g., from data structure 19d of APS subsystem 100, as may be provided as an authentication processing service via processor 12 of APS subsystem 100)) as if such information were stored locally at that user device (e.g., in memory component 63).

A user device 60 may be configured to enroll and then authenticate itself and a user with the APSP of system 1 by following any suitable APSP protocols, such as by using any suitable client application (e.g., any suitable APSP-enabled application) that may be running on the user device, while various nodes 70 may be used to store cryptographically protected shares of a user's biometric data and keys. For example, as shown in FIG. 1I, a client application 69a (e.g., an APSP app (e.g., as may be created and/or managed or otherwise at least partially under the auspices of APS subsystem 100)) may be run on a user device 60a that may include an APSP API and/or an APSP SDK, which may be at least partially defined by APS subsystem 100. An APSP API of a client application 69 may be configured to enable interaction with any suitable user device components (e.g., biometric sensors for capturing data (e.g., a camera for capturing images) indicative of the user's biometrics). An APSP SDK of a client application 69 may be configured to include or define a client-/user-side secure multi-party computation (“SMPC”) protocol engine and/or any suitable pseudorandom function family (“PRF”) (e.g., any suitable efficiently-computable function of the PRF and/or any suitable oblivious pseudorandom function (“OPRF”)) and/or a communication protocol for enabling interaction between the user device and various network nodes (e.g., for processing of a captured biometrics image and/or determining or otherwise obtaining a seed/secret value and/or for generating shares of the biometrics and/or shares of the seed and/or encrypting the shares with one or more keys and/or forwarding encrypted shares to various respective nodes and/or performing any other suitable tasks (e.g., passing the captured user biometrics through a neural network to extract embedding)). Moreover, as shown in FIG. 1I, each one of network nodes 70 (e.g., nodes 70a-70c) may be configured to run any suitable application(s) (e.g., respective applications 79a-79c) that may include any suitable SMPC/PRF engine(s) and/or any suitable APSP protocol(s), which may be at least partially defined by APS subsystem 100.

During APSP enrollment of a user U or a user device 60a of a user U, which may be referred to herein as an APS user device 60a that may be used to capture a user's biometrics (e.g., biometrics ub) or otherwise for obtaining any suitable low min-entropy signal B (or ω)/b (or ω′) (e.g., a biometric signal, some reproducible hardware noise, etc.) or otherwise obtain such a signal for user enrollment and/or user authentication with the APSP, as compared to a TPS user device (e.g., TPS user device 60c) that may or may not be running a dedicated client APS application 69a (e.g., beyond a web browser) and/or that may or may not be used to capture a user's biometrics or otherwise for user enrollment and/or user authentication with the APSP but may nevertheless be used by a user to interact with a third party subsystem 90 that may benefit from the enrollment/authentication of the APSP, the APS user device may be configured to generate or otherwise obtain any suitable seed (e.g., secret value (e.g., any value that may be confidential and/or lack predictability)) that may be used to provide or define any suitable keys, and/or while a third party subsystem 90 may be configured to provide any suitable service for the APSP (e.g., a third party app or website browser or server of a third party website (e.g., a social network site or banking site) or an identity and access management (“IAM”) server, in any suitable sector (e.g., e-wallets, fintech, banking, enterprise, A&D/travel, healthcare, government, etc.) (e.g., as may be described in U.S. Pat. No. 11,936,775)). Certain ones of such keys (e.g., public key(s)) may be communicated to and stored on repository 80 and/or one or more network nodes 70 by the APS user device 60 for enabling registration and enrollment of the APS user device and a user thereof with the APSP. Repository 80 may be any suitable subsystem that may be operative to store any suitable data (e.g., as at least a portion of repository APSP data 89d) for associating a user identifier and/or device identifier with any suitable keys (e.g., using blockchain, distributed identities (“DIDs”), etc.), such that the data may be accessible by various other entities of the system (e.g., via network 50) (e.g., for associating various device identifiers (e.g., various public device signing keys of various devices) with a particular user identifier (e.g., a public user key)). For example, repository 80 may be distinct from each network node, or may be a network node, or may be a part of APS subsystem 100. As shown in FIG. 1I, APS user device 60a may also be configured to capture any suitable biometric data, including user biometrics ub (e.g., user enrollment biometrics ueb or user authentication biometrics uab) of a device user U (e.g., using any suitable sensor(s) 65 and/or any other suitable features of that user device 60a). For example, during enrollment, the APS user device may be configured to capture any suitable user enrollment biometrics of the user, and those captured user enrollment biometrics may be used by the APS user device to generate an enrollment biometric template (“EBT”) (e.g., a user's face may be captured as an image by the user device (e.g., using a camera sensor), and a cropped and/or resized version of that image may be provided as input to a neural network to produce an embedding that may be used as the EBT (e.g., an EBT may be obtained as a feature vector from the captured user enrollment biometrics)). Alternatively, when the system is provided with an identity verification (“IDV”) bridge instance (e.g., as may be described by U.S. patent application Ser. No. 19/366,921, which is hereby incorporated by reference herein in its entirety), the IDV bridge instance may be configured to generate the EBT. The IDV bridge instance may be agnostic to the source of the user enrollment biometrics ueb. For example, the source may indeed be a camera on an end-user device. However, with an IDV bridge instance, the biometric sample (e.g., selfie picture or video) may be sent from the end-user device or some remote database to some other system (e.g., any suitable organization (e.g., bank)) as the biometric data source that may validate the biometrics and then send it to the IDV bridge instance for further processing. As another example, during authentication, the APS user device or any other suitable system entity may be configured to capture any suitable user authentication biometrics of the user, and those captured user authentication biometrics may be used by the APS user device to generate an authentication biometric sample (“ABS”) (e.g., a user's face may be captured as an image by the user device (e.g., using a camera sensor), and a cropped and/or resized version of that image may be provided as input to a neural network to produce an embedding that may be used as the ABS (e.g., an ABS may be obtained as a feature vector from the captured user enrollment biometrics)). Although described herein with respect to a user's biometrics, it is understood that any suitable original signal(s) (e.g., a low min-entropy signal (e.g., enrollment/authentication vectors)) may be generated based on any suitable biometrics, repeatable/reproducible hardware noise, physically or physical unclonable function (“PUF”), and/or the like as signals ub that may be indicative of any suitable metrics or characteristics of a user and/or a device controlled by the user.

Furthermore, during such enrollment, the APS user device or an IDV bridge instance or an AuthService subsystem or an enclave subsystem or the like may be configured to split each one of the seed and the EBT into any suitable number of shares, encrypt each seed share and each EBT share with one or more keys, store the encrypted seed share(s) on one or more network nodes 70, store the encrypted EBT share(s) on one or more network nodes 70, and delete the seed and the EBT and all their shares from the APS user device or IDV bridge instance (e.g., pursuant to the APSP protocol). The number of seed shares, the number of biometric template shares, and the number of nodes used during the enrollment may differ from one another, may be the same as one another other, or any two of the numbers may be the same as each other but different from the third number. In some embodiments, each seed share may be stored on a respective different node such that the number of seed shares may be equal to the number of nodes storing a seed share, and each biometric template share may be stored on a respective different node such that the number of biometric template shares may be equal to the number of nodes storing a biometric template share, where the number of seed shares may be equal to the number of biometric template shares such that the number of nodes storing seed shares may be equal to the number of nodes storing biometric template shares but such that the set of nodes storing the seed shares may or may not be the same as the set of nodes storing the biometric shares such that those sets may share all nodes, some nodes, or no nodes with each other. In some embodiments, the number of seed shares may not be equal to the number of biometric template shares. In some embodiments, two or more seed shares may be stored on one node (e.g., a more trusted or more favored node) while fewer seed shares may be stored on another node (e.g., a less trusted or less favored node). Similarly, in some embodiments, two or more biometric template shares may be stored on one node (e.g., a more trusted or more favored node) while fewer biometric template shares may be stored on another node (e.g., a less trusted or less favored node). In this way, a more trusted or favored node can replace two or more nodes in the protocol when reconstructing a seed and/or a biometric template. In some embodiments, all encrypted shares (e.g., of a seed and/or of a template) could be sent to a single node, or a single node could receive the entire encrypted seed without it first being split into numerous seed shares and/or a single node could receive the entire encrypted biometric template without it first being split into numerous biometric template shares. In some embodiments, a biometric template may not be shared with one or more nodes during enrollment (e.g., if the SMPC protocol does not need to re-generate any features (e.g., garbled circuits) through use of the biometric template). Each share may be doubly encrypted. For example, each share may be first encrypted with a random key that may be generated by the device. Then, for example, each share may be doubly encrypted with a success key that may be disclosed by the authentication protocol after successful authentication (e.g., a key disclosed by the success of an authentication protocol of the APSP (e.g., the success of an SMPC protocol (e.g., successful evaluation of a matching function (e.g., successful evaluation of the user's EBT with respect to an authentication biometric sample of the user)))). Such a success key may be unknown to any network node until an authentication attempt by an enrolled APS user device. During such an authentication attempt, the enrolled APS user device may be enabled by the APSP to generate an authentication biometric sample of the user that may then be shared with and successfully evaluated by a network node with respect to the user's EBT (e.g., using SMPC for protecting the accessibility of the EBT itself) for revealing the success key to the network node. Such a success key may be changed with each authentication attempt.

Therefore, during enrollment with the APSP of system 1, an APS user device 60 may be configured to register a user and the device itself with the APSP and store encrypted seed material and encrypted biometric data in a distributed form on various nodes using any suitable threshold secret sharing (e.g., using Shamir's secret sharing), such as a secret sharing scheme that may be chosen so that the seed material may be split into several pieces or shares, a number of which may be required to reconstruct the seed material, whereby each share may be encrypted and stored on a respective node (e.g., one share on one node), and whereby the seed may not be disclosed or accessible by an entity unless that entity has access to at least a required number of shares. Alternatively, an IDV bridge instance may be used by any suitable biometric data source (e.g., an organization (e.g., a bank)) rather than an APS user device during such enrollment. In some embodiments, a first secret sharing scheme may be used for the seed sharing and a second secret sharing scheme may be used for the biometric template sharing, where the first secret sharing scheme may be the same as the second secret sharing scheme or the first secret sharing scheme may differ from the second secret sharing scheme in any suitable way(s). At the end of such enrollment, the seed, the biometrics, and some other sensitive information may not be stored on or accessible to the APS user device or any central server (e.g., any IDV bridge instance, any APS subsystem, etc.) or individual entity, but, instead, only encrypted shares of the seed (or the encrypted seed) and only encrypted shares of the biometrics (or the encrypted biometric template) may be distributed amongst various network nodes (or on a single node). In addition to storing encrypted shares of the seed and encrypted shares of the EBT on various nodes, during enrollment with the APSP, the APS user device or an IDV bridge instance or AuthService or enclave may also be configured to generate and store on the network nodes any suitable mechanisms that may later (e.g., during authentication) enable any suitable protocol(s) (e.g., any suitable SMPC protocol(s), which may include any suitable secure two-party computation protocol(s)) to be carried out by the nodes for performing a matching function between the EBT of the enrollment and a later (e.g., during authentication) obtained authentication biometric sample (“ABS”) for potentially revealing the success key(s) to the node(s). Any suitable SMPC protocol(s) and/or any suitable SMPC protocol building tools (e.g., tool(s) with which an SMPC protocol may be built for use by the APSP) may be used by the APSP, including, but not limited to, Yao's garbled circuits, homomorphic (e.g., fully or somewhat homomorphic) encryption techniques, Goldreich-Micali-Wigderson protocol, zero-knowledge protocol, and/or the like.

After enrollment with the APSP, APS user device 60 may then be used to authenticate its user with the APSP. The APS user device may be configured to follow an APSP protocol for such authenticating. APS user device 60 may be configured to authenticate the device itself with the APSP (e.g., by properly signing, with a private key of the device, a challenge from each one of the various network nodes that may have access (e.g., locally and/or via repository 80) to a corresponding public key used during the device registration phase of the enrollment). Then, APS user device 60 may be configured to authenticate its user, first by capturing any suitable user authentication biometrics of its user that may then be used to generate an ABS (e.g., user authentication biometrics similar to the user enrollment biometrics used to generate the EBT of the enrollment (e.g., picture(s) of the user's face, scan(s) of the user's fingerprints, etc.)). This ABS may then be encrypted or otherwise protected such that it may be securely shared by the APS user device with the various network nodes (e.g., encrypted without any node having direct access to the ABS itself) and then such a protected ABS may be used by each network node to evaluate a matching function (e.g., a set intersection) between the ABS and the EBT according to the enrolled SMPC protocol (e.g., using a garbled circuit, such that neither the ABS nor the EBT may be directly accessed by any node). If the evaluation carried out by a particular network node is successful (e.g., if the evaluation indicates that the two biometric datapoints are from the same person with high probability), the particular network node may return its respective encrypted EBT share and/or its respective encrypted seed share to the APS user device (e.g., after partial decryption of the share(s) using a success key revealed to the network node based on the successful evaluation). Therefore, if a matching function performed by a node during APS authentication (e.g., authentication of an APS user/APS user device, as opposed to TPS authentication (e.g., authentication of a TPS or any suitable secure operation based on an APS authentication)) results in a successful evaluation of a user's EBT and ABS, then the success key can be revealed to the node (e.g., for enabling the node to partially decrypt the doubly encrypted seed share on the node and/or for enabling the node to partially decrypt the doubly encrypted EBT share on the node), all without the node ever having access to the EBT itself.

If an evaluation of a user's EBT and ABS is successful at a sufficient number (e.g., 1 or more (e.g., m-number for m out of n secret sharing)) of the network nodes (e.g., if user authentication with the APSP is successful at a sufficient number of the nodes), the APS user device may receive and further decrypt enough seed shares from the node(s) for recovering or reconstructing the seed (or receive and further decrypt the seed from a node). Such a recovered or reconstructed seed may then be used by the APS user device for any suitable purpose, such as for enabling any suitable secure operation (e.g., seamless authentication, unique identification, access control, key generation, e-signature, etc.), with any suitable service locally on the APS user device (e.g., using the reconstructed seed or a key derived therefrom for encrypting/decrypting a hard drive portion of the device's memory, for encrypting or signing a cryptocurrency transaction with a user's digital wallet on the device for publishing on the blockchain, etc.) and/or with any suitable service provided by any suitable third party subsystem 90 (e.g., using the reconstructed seed or a key derived therefrom for enabling secure user access via a third party app or website browser to a server of a third party website (e.g., a social network site or banking site) or an identity and access management (“IAM”) server), in any suitable sector (e.g., e-wallets, fintech, banking, enterprise, A&D/travel, healthcare, government, etc.). A secure operation may be any process that generates, persists, and/or uses secret keys (including private keys) using a recovered or reconstructed seed of the APSP and/or using one or more revealed success keys. For example, an APS user device may be configured to perform any suitable action with a recovered seed, including but not limited to, deriving a DID key and issuing a signed claim associated with a user's identity, deriving a crypto wallet secret key to perform a cryptocurrency transaction, deriving a list of crypto wallet public keys to check a user's balance, deriving a third party key and then using that third party key to sign or encrypt a challenge from a third party, and/or the like. Once a seed is recovered and used by the APS user device for any suitable purpose (e.g., a one-time use), the seed should once again be deleted from the APS user device (e.g., pursuant to the APSP protocol).

Therefore, between the end of APS enrollment (see, e.g., process 200) and APS successful APS authentication (see, e.g., process 400), as well as between authentications, the seed, the biometrics, and some other sensitive information may not be stored on or accessible to the APS user device or any central server or individual entity, but, instead, only encrypted shares of the seed (or the encrypted seed) and only encrypted shares of the biometrics (or the encrypted biometric template) may be distributed amongst various network nodes (or on a single node). Enrollment biometrics of a user may be captured and processed (e.g., by feature extraction through a neural network) as an EBT that, along with a secret seed, may then be split and one-way encrypted on the user device. These one-way encrypted biometric shares and one-way encrypted secret seed shares may be stored in many places (e.g., on various network nodes (e.g., different shares on different nodes) and/or various network domains and/or various control domains and/or the like) along with related SMPC features (e.g., enrolled garbled circuits), while the shares and underlying biometrics and secret seed are deleted from the user device. Later, the user device may then capture and process other user biometrics as an ABS, and the enrolled SMPC features of the nodes may be used to evaluate a comparison of the ABS to the EBT on each node to determine whether or not the encrypted seed share on the node may be returned from the node to the user device for potential recombination with other returned seed shares from other nodes for recovering the seed on the user device for use in a secure authentication-dependent operation. Benefits of such enrollment and authentication according to the APSP are numerous, including, but not limited to, avoiding the long term storage of sensitive information (e.g., the seed, a biometric template, or even shares thereof) on a user device or on any central server (e.g., between APS enrollment and APS authentication or between distinct authentications), consistent cross-platform user experience (e.g., for APS user devices of various types and/or running various operating systems, for TPS user devices of various types and/or running various operating systems, for different phases of the APSP (e.g., APS enrollment, APS authentication, TPS enrollment, TPS authentication, various secure operations, etc.)), fast and local user authentication on its own user device, maintaining a user's ability to be in control of its personal data, and/or the like. The security provided by this APSP may allow for a user and a decentralized and distributed system, rather than a central server (e.g., a company's central server), to be in control, as there may be no secret seed enabling authentication that is permanently stored on any one entity (e.g., no honeypot, no authentication secrets stored on a user device or on a single network node, etc.), and the APSP may provide a true password-less environment through SMPC. The APSP system may be robust such that if one or more portions (e.g., nodes) of the system are down (e.g., not functioning properly), the APSP may still function properly. Different nodes may be controlled (e.g., managed, maintained, operated, etc.) by different entities, which may allow control and costs to be split, which may increase the robustness of the system. The privacy provided by this APSP may be compliant with General Data Protection Regulation (“GDPR”). Zero-knowledge biometric authentication may be enabled, and a user may be enabled by the APSP to control what data is shared via selective data disclosure.

The APSP may solve a credential storage problem by providing a way to authenticate a user's biometrics for enabling a secure operation that may use distributed computation, threshold cryptography, and/or SMPC to recombine or otherwise recover a user's secret. With the APSP, users (e.g., their biometrics) may become their passwords and control their credentials through biometrics. The APSP may create a zero-knowledge system to achieve biometric authentication for enabling a secure operation without having to share the biometric template data or seed with those that may depend on the result of the authentication (e.g., a third party subsystem (e.g., a social media website's server or IAM server)). During an enrollment phase of the APSP, a user may register itself (e.g., register the user's biometrics) and its user device with the APSP network. This may include storing encrypted key material and encrypted biometric data (e.g., an encrypted EBT) in a distributed form on one or more nodes using threshold secret sharing. During an authentication phase of the APSP, the user may first authenticate its device (e.g., through appropriate handling of a network node challenge) and then provide authentication biometrics for generating an ABS for enabling user authentication. The ABS may be encrypted on the user's device, and may be matched against the encrypted EBT sent to the network node(s) during enrollment (e.g., using enrolled SMPC features (e.g., enrolled garbled circuits)). None of the nodes may be able to decrypt the encrypted EBT or the encrypted ABS. Matching may be performed using an SMPC protocol (e.g., based on Yao's garbled circuit technique). Therefore, the APSP protocol may remain secure even if some of the nodes and user devices are compromised. Specifically, secret user information (e.g., biometric data, seed, etc.) may not be disclosed if an adversary is able to control all nodes, or if an adversary is able to control the APS user device and a subset of the nodes below a user-defined threshold. Further, the privacy of the data stored on the nodes may not depend on the amount of entropy associated with the biometric signal, as every piece of information stored on the nodes may either be pseudorandom or encrypted (e.g., using advanced encryption standard (“AES”) with (random) 128-bit keys and/or using Rivest-Shamir-Adleman (“RSA”)-2048). Therefore, the strength of the keys (e.g., a user's secret key, the seed, etc.) may be independent of the amount of entropy associated with the biometric signal. This can make brute-force offline attacks on the data stored on the nodes impractical.

Each node 70 may be any suitable server or device or subsystem that may be independently operated or at least partially managed by a single entity (e.g., a manager of APS subsystem 100). In some embodiments, anode 70 may be provided by a user device 60 for use by another user (e.g., one user device 60 of system 1 may be configured to operate as a node 70 for another user device 60 of system 1). Nodes 70 of system 1 ought to be available and non-colluding. For example, an APSP network 40 (e.g., a decentralized and/or distributed network) of system 1 may include two or more nodes 70. In some embodiments, an APSP network 40 may include one or more user devices that may be at least partially configured as a node for one or more other user devices. Network 40 may be designed to scale to a geographically-distributed, large number of users. As a result, the APSP protocol may be configured to adhere to one or more suitable design requirements, including, but not limited to, the capacity of the network (e.g., the number of users that the network can handle) ought to increase linearly with the number of nodes, if a number of the nodes fail, the network ought to still be operational for the vast majority of the users, and/or the like. At any point in time a user device may be enrolled with or authenticating with a particular (e.g., fixed) subset of the nodes in the network. Adding new nodes may enable more users to leverage the network. Additionally or alternatively, through the use of threshold secret sharing, recovering a seed may require only a small number of nodes in the network to be operational at any point in time. To reduce latency, the nodes can be strategically placed close to their users. Given the availability of geographically distributed data centers from major cloud providers, this may be a simple and cost-effective way to improve user experience and provide quality of service. For segregated networks (e.g., enterprise, etc.), nodes can be deployed within the perimeter of the segregated network. For air-gapped networks (e.g., military, intelligence, and disaster recovery networks, etc.), nodes can be deployed inside the air-gapped network. The APSP may use secret sharing and encryption of sensitive data by enabling an APS user device to generate and forward encrypted shares of various private information (e.g., seed, biometric template, etc.) to appropriate network nodes. This may provide two layers of security if a particular node is compromised, as (1) an adversary must be able to recover a sufficient number of shares to reconstruct the user's secrets, which may substantially raise the bar for the adversary, who must be able to compromise a considerable number of nodes, and (2) the adversary must be able to decrypt the shares, each of which may be encrypted under an independent key (e.g., a success key). In an example in which Yao's garbled circuit technique may be used for an SMPC protocol of the APSP, a garbled circuit may be configured to output a valid success key only if the ABS is close to (e.g., within a threshold distance of) the EBT because of the security properties of the garbled circuit protocol. As a result, an attacker of a corrupted node will generally not be able to compute the circuit output key (e.g., the success key) unless it interacts with a trusted device, and the authentication is successful.

### FIGS. 2A-7W

Various arrangements of devices may be used for providing a useful system for implementing an APSP protocol of the disclosure. Various processes may be carried out in order for a user of a user device to be authenticated by the APSP for executing any suitable secure operation (e.g., for securely accessing a third party website or app), including, but not limited to, processes 200-600 of FIGS. 2A-6. FIGS. 2A and 2B illustrate a flowchart of an exemplary process 200 for enrolling an APS user device and a user thereof with the APSP. FIG. 3 illustrates a flowchart of an exemplary process 300 for generating one or more sets of authentication circuit information for a set of network nodes using secure multi-party computation, which may be used by process 200. FIGS. 4A-4C illustrate a flowchart of an exemplary process 400 for authenticating an enrolled APS user of an enrolled APS user device with the APSP. FIG. 5 illustrates a flowchart of an exemplary process 500 for registering a third party service with an enrolled APS user of an enrolled APS user device. FIG. 6 illustrates a flowchart of an exemplary process 600 for authenticating an enrolled APS user of an enrolled APS user device with a registered third party service using the APSP. FIGS. 7A-7W illustrate exemplary screens of graphical user interfaces (“UIs”) of one or more user devices carrying out the processes of FIGS. 2A-6 (e.g., each UI may be presented by any suitable I/O component 66 of any suitable user device 60 during processes 200-600). Each UI of FIGS. 7A-7W may be a graphical user interface (“GUI”) that may include various layers, windows, screens, templates, elements (e.g., buttons, sliders, labels, status bars, etc.), menus, and/or other components of a currently running application (e.g., application 69) that may be displayed by any suitable display of the device's I/O component. Additionally or alternatively, for a running application, various other types of non-visual information may be provided to a user as various other types of a UI via various other output components of the user device (e.g., audible, tactile, etc.). The operations of the processes described may be achieved with a wide variety of graphical elements and visual schemes. Therefore, the embodiments of FIGS. 7A-7W are not intended to be limited to the precise user interface conventions adopted herein. Rather, embodiments may include a wide variety of user interface styles, including non-graphical or otherwise non-visual interface styles.

### FIG. 2A, FIG. 2B, and FIGS. 7A-7I

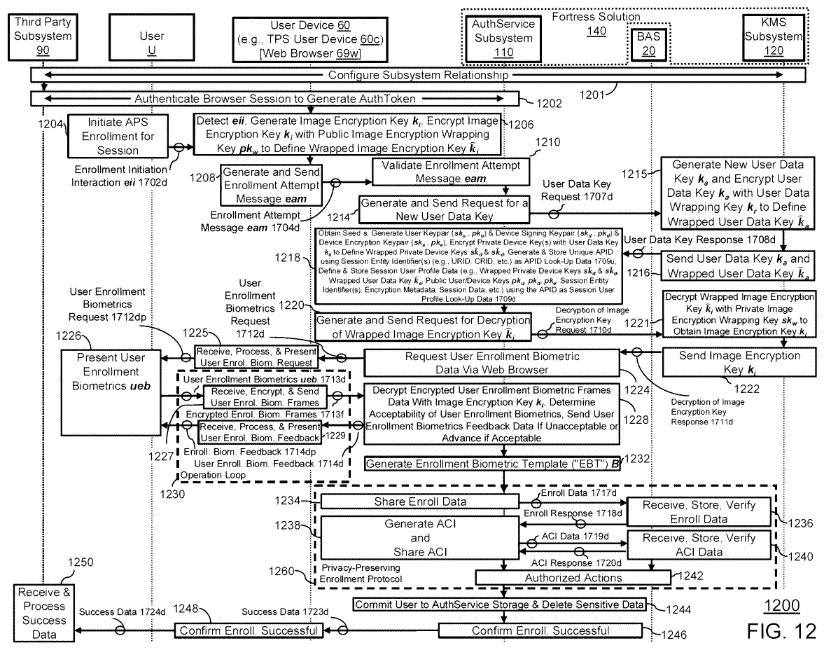

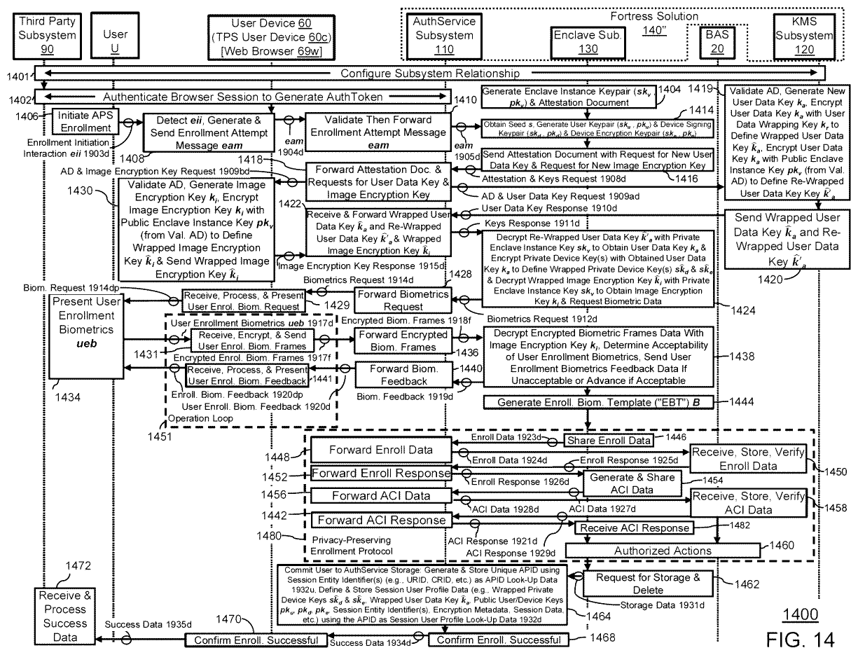

FIGS. 2A and 2B illustrate a flowchart of an exemplary process 200 for enrolling an APS user device and a user thereof with the APSP. Process 200 is shown being implemented by APS user device 60a, its user U, a selection of nodes 70 (e.g., a number n of selected nodes 70 (e.g., nodes 70a, 70b, 70c, . . . , 70n)), and repository 80. However, process 200 may be implemented using any other suitable components or subsystems or entities of system 1 of FIG. 1 or otherwise (e.g., node(s) 70 and repository 80 may be replaced by any suitable server(s) (e.g., APS subsystem 100). Process 200 may provide a seamless user experience for securely and efficiently enrolling user U and its user device 60a with the APSP. To facilitate the following discussion regarding the operation of system 1 for enrolling user U and its user device 60a with the APSP according to process 200 of FIGS. 2A and 2B, reference is made to various components of system 1 of the schematic diagrams of FIGS. 1 to 11, and to screens 700a-700i that may be representative of a graphical user interface of APS user device 60a during such a process (e.g., as shown in FIGS. 7A-7I). The operations described may be achieved with a wide variety of graphical elements and visual schemes. Therefore, the embodiments of FIGS. 7A-7I are not intended to be limited to the precise user interface conventions adopted herein. Rather, embodiments may include a wide variety of user interface styles. Other embodiments of enrollment may be described with respect to FIGS. 12 and 14.

Process 200 may begin at operation 202, where user U may initiate enrollment by carrying out any suitable enrollment initiation interaction eii 202d with an APS application 69 that may be running on the user's APS user device 60a. For example, as shown by screen 700a of FIG. 7A, the UI of APS device 60a may present an “ENROLL” option for user U to select with its enrollment initiation interaction eii in order to proceed with process 200 for enrolling with the APSP. In advance of operation 202, APS application 69 may be accessed by device 60a in any suitable manner (e.g., as an app downloaded from APS subsystem 100 or any suitable app store or otherwise) and user U may carry out any suitable account set-up operations with respect to the application, although any set-up operations not shown may or may not be required.

At operation 204, APS user device 60a may detect such an enrollment initiation interaction eii and, in response to such detection, user device 60a may obtain any suitable secret value or seed s in any suitable manner (e.g., according to application 69). For example, seed s may be a random cryptographic element generated by application 69 or securely imported from another application (e.g., a cryptographic wallet and/or as a result of a protocol (e.g., key negotiation)). For example, seed s may be generated as a random string of some length v (e.g., v=256 bits), uniformly selected from {0,1}v in any suitable manner. It can also be a pseudorandom string generated from some other secret, or it could be provided by an app that uses the APSP (e.g., it can be the root seed of a cryptographic wallet that may use a Bitcoin Improvement Proposal (“BIP”) 32 or 44 deterministic key generator. The seed may be generated on the APS user device (e.g., using the APS application that may be running on the APS user device), with or without any suitable piece(s) of randomness from one or more other sources, such as through asking one or more nodes or third party subsystem(s) for some randomness (e.g., when a user device may be limited in its ability to generate random data).

At operation 206, user device 60a may then derive or otherwise generate one or more keys and/or one or more keypairs (e.g., according to application 69). For example, user device may obtain any suitable constant string c (e.g., “user id”) and then use that constant string c and seed s to generate a private user key skᵤ, such as by defining private user key skᵤ=HMACₛ(c). For such a hash-based message authentication code (“HMAC”), the APSP may use HMAC-SHA256, but, in other embodiments, HMAC could be instantiated with other collision-resistant hash functions without impacting the security of the protocol. Further, HMAC can be replaced by any suitable pseudorandom function family (“PRF”) (e.g., any suitable efficiently-computable function of the PRF), where private user key skᵤ may be generated using any PRF computed over seed s and constant string c. Alternatively, the APSP may use HMACₛ(c) as a source of randomness for any suitable key generation algorithm (e.g., an elliptic curve digital signature algorithm (“ECDSA”)) that may be used to generate private user key skᵤ. A counterpart public user key pkᵤ to private user key skᵤ may also be generated at operation 206 in any suitable manner (e.g., for providing user keypair (skᵤ, pkᵤ) (e.g., a user biometric keypair)). For example, private user key skᵤ may be used as a private key for an ECDSA, and the corresponding public counterpart is public user key pkᵤ (e.g., pkᵤ=skᵤ×G, where G may be the elliptic curve base point). Therefore, user keypair (skᵤ, pkᵤ) may be deterministically generated from seeds. In some embodiments, constant string c may not be utilized. In some embodiments, private user key skᵤ may be defined as seed s. A public/private cryptosystem may come with a key generation process, and the key generation process may require some randomness. For example, a suitable public/private cryptosystem may be selected, and the corresponding key generation process of the selected cryptosystem may be used to obtain private user key skᵤ and public user key pkᵤ, where seed s or some transformation of seed s may be used as the source of randomness for that key generation process. A random device signing keypair (sk_{d}, pk_{d}) may also be generated at operation 206 (e.g., a keypair for an EdDSA signing key). For example, a private device signing key sk_{d} may be generated as a random integer of any suitable size (e.g., 256 bits) and then a counterpart public device signing key pk_{d} to private device signing key sk_{d} may also be generated in any suitable manner (e.g., for providing random device signing keypair (sk_{d}, pk_{d})), such as where private device signing key sk_{d} may be used as a private key for an Edwards-curve digital signature algorithm (“EdDSA”) or an ECDSA, and the corresponding public counterpart is public device signing key pk_{d} (e.g., pk_{d}=sk_{d}×G, where G may be the elliptic curve base point). As described herein, such a signing keypair may be used to authenticate a user device through a randomized challenge-response protocol based on a zero-knowledge proof of knowledge. A random encryption keypair (skₑ, pkₑ) may also be generated at operation 206. As described herein, such an encryption keypair may be used to encrypt a symmetric encryption key used to encrypt data (e.g., biometric shares and seed shares) that may be sent to various network nodes. A random TPS keypair (skₜ, pkₜ) may be generated (e.g., at operation 526 of process 500). Such a TPS keypair may be generated using EdDSA, while one, some, or each of user keypair (skᵤ, pkᵤ), device signing keypair (sk_{d}, pk_{d}), and encryption keypair (skₑ, pkₑ) may be generated using ECDSA. Although, any suitable keypair of the APSP may be generated using any suitable process.

At operation 208, APS device 60a may send public user key pkᵤ and public device signing key pk_{d} as data 208d to each node j of a selected set of nodes n (e.g., each node 70 of nodes 70a, . . . , 70n) of system 1 (e.g., according to application 69). The APS protocol may be configured to use a threshold secret sharing scheme to mitigate attacks that involve compromising a (possibly large) subset of the network nodes. In a (m, n) threshold secret sharing scheme, a seed s may be shared (e.g., as split shares) with a set of parties P in such a way that any subset Q of P such that |Q|≥m can reconstruct the secret value s, but no subset Q′ of P can recover seed s as long as |Q′|<m. A user device may select the set of nodes (e.g., any set of one or more nodes) based on any suitable characteristics, including, but not limited to, speed, availability, capacity, trust, and/or the like. A secret sharing technique may allow for a particular or any value m and/or a particular or any value n, where n may be any number greater than or equal to m (e.g., m=2, and n=3). The APSP may be configured to enable a user to choose m and n (e.g., using any suitable user interface on a user device) or to enable a third party to choose m and n (e.g., for a particular use case (e.g., for a particular secure operation)). APS application 69 may be configured to select the set of nodes n from network 40 randomly or based on any suitable enterprise policies. For example, certain policies can be pre-defined before the instantiation of the protocol. If needed, the policies can also be updated and correspondingly the user can interact with a new set of nodes in the network after the policy update. A node may be chosen based on its response time, but other selection policies are also appropriate. While the minimum number of nodes n may be 1, this number provides no redundancy and no ability to use secret sharing or distributing shares of a secret. A more typical minimum number of nodes n may be 3, where the number of nodes m to be n or n−1 or the like, or any other suitable number.

At operation 210, each node j of selected nodes n may receive data 208d from user device 60a and store (e.g., according to application 79 of that particular node 70) the public user key pkᵤ and public device signing key pk_{d} of data 208d (e.g., keys pkᵤ and pk_{d} may be stored together (e.g., in a linked fashion) as a portion of node APSP data 79d in memory 73 of the node).

At operation 212, each node j may generate a challenge rⱼ (e.g., a partially random data structure) for the public keys received at that node, and then the node may send that challenge rⱼ as at least a portion of data 212d back to user device 60a (e.g., according to application 79 of that particular node 70).

At operation 214, user device 60a may receive challenge rⱼ of data 212d from one or each of nodes n, generate a challenge response rⱼσₛₖᵤ for each received challenge rⱼ by signing that challenge rⱼ with the device's private user key skᵤ (e.g., challenge response rⱼαₛₖᵤ=Signₛₖᵤ(rⱼ)), and then send that challenge response rⱼσₛₖᵤ back to the appropriate node j as at least a portion of data 214d (e.g., according to application 69 of user device 60a).

At operation 216, one, some, or each node j of selected nodes n may receive data 214d from user device 60a, attempt to verify the public user key pkᵤ of earlier received data 208d using the challenge response rⱼσₛₖᵤ of recently received data 214d, generate a verification acknowledgment ackⱼ that may be indicative of whether or not the node was able to verify the public user key (e.g., confirm or deny verification), and then the node may send that verification acknowledgment ackⱼ as at least a portion of data 216d back to user device 60a (e.g., according to application 79 of that particular node 70). This may enable the node to verify whether or not public user key pkᵤ is indeed the public user key of user device 60a. If the node is unable to verify, then the node may delete the keys (e.g., as stored at operation 210).

At operation 218, user device 60a may receive and register verification acknowledgment ackⱼ of data 216d from one or each node j of nodes n (e.g., according to application 69 of user device 60a). If the received ackⱼ is indicative of a positive verification by node j, then user device 60a may determine that its public keys pkᵤ and pk_{d} have been received, stored, and verified by that particular node, whereby user device 60a may be enabled to proceed with the enrollment of process 200 (e.g., to operations 220/222). However, if the received ackⱼ is indicative of a negative verification by node j, then user device 60a may determine that its public keys pkᵤ and pk_{d} have not been received, stored, and verified by that particular node, whereby user device 60a may be configured to repeat operations 208 to 218 for at least each node that provided such a negative verification of its challenge.

Once a positive verification is registered by user device 60a for each node j of selected nodes n at operation 218, process 200 may advance to operation 220, where user U may present user enrollment biometrics ueb (e.g., as user enrollment biometric identifier information or user enrollment biometric information 220d) to user device 60a by carrying out any suitable user biometrics enrollment interaction with device 60a. APS user device 60a may be configured to capture such enrollment biometrics ueb for generating an enrollment biometric template (“EBT”) B at operation 222 (e.g., according to APS application 69 (e.g., different users may use different biometrics, different devices may use different sensors, different types of data may be captured in addition to biometrics (e.g., device environment data), and/or the set of characteristics and associated actions themselves may change from one enrollment to the next, etc.)). For example, as shown by screen 700b of FIG. 7B, the UI of APS device 60a may optionally present a user approval request for accessing any suitable sensor(s) or other device components (e.g., a camera of device 60a) for capturing user biometrics, a request which the user may accept or deny. If accepted or automatically allowed, the UI of APS device 60a may present instructions on how the user ought to present user enrollment biometrics ueb to user device 60a for capture. For example, as shown by one or more of screens 700c-700e of FIGS. 7C-7E, while the user's face (not shown) may be in the line of sight of a device camera sensor, device 60a may instruct the user to look left, then eventually look straight at the camera, and then eventually look right. This may enable device 60a to capture user enrollment biometrics ueb in the form of a video or photograph sequence of the user's face rotating. This may enable “liveness” detection of the user (e.g., as may instructing the user to carry out any other suitable action while biometrics are captured, such as winking with one eye then with the other eye, or smiling then frowning, or saying a word or phrase, etc.). This may help prevent spoofing and/or capturing biometrics of an unwilling user.

Any suitable biometrics of a user may be captured in any suitable manner by any suitable sensor(s) of user device 60a in response to a user presenting itself to the user device in any suitable manner(s) at operation 220. For example, any information that may be sensed about the user by any sensor 65 described herein or otherwise may be used to define the user enrollment biometrics ueb to be captured by the user device 60a, including, but not limited to, facial information, fingerprint information, iris information, retinal scan information, movement, orientation, gesture, gait, pausality, speech information, any suitable behavioral biometrics, sequenced DNA, the output of any physically unclonable function, and/or the like. Biometric traits may be physiological or behavioral characteristics that may uniquely identify a user. Because of the uniqueness of these traits, several authentication techniques based on biometric signals have been introduced, including with respect to biometrics modalities including fingerprints, face, iris, voice, speech, and keystroke dynamics. Biometrics may capture intrinsic characteristics of the user (e.g., something that the user is), thus removing the need for a user to memorize any secret (e.g., a password or PIN), or to possess a physical device (e.g., a hardware token or a smart card). The experience may typically be more user-friendly than other modalities. Further, biometric authentication may generally be more secure than passwords, whereas the security of biometric authentication systems is largely independent of the user's choices and behavior.

However, biometric signals may be somewhat noisy. For example, multiple measurements collected from the same user may tend to vary slightly due to several factors, including, but not limited to, sensor noise, changes in collection environment (e.g., environmental lighting when EBT is captured may be different than environmental lighting when ABS is captured), changes in collection sensors (e.g., device used to capture EBT may be different than device used to capture ABS), and natural variations in the physiological characteristic being sampled (e.g., user without beard to capture EBT different than user with beard to capture ABS). For instance, the image collected from a fingerprint may change between samples because of the amount of pressure of the finger on the sensor, the angle at which the finger touches the sensor, and skin dryness. Similarly, individual pixels of the images used for face authentication may be affected by lighting, the position of the user's face within the frame, presence of facial hair, and/or the like (e.g., the user may grow a beard between when its enrollment biometrics are captured for generating EBT B and when its authentication biometrics are captured for generating ABS b). Therefore, because of this noise, the APSP may be configured not to directly compare raw biometric signals (e.g., pixels in a fingerprint image of a user's enrollment biometrics and pixels in a fingerprint image of a user's authentication biometrics). Instead, the APSP may be configured to extract relevant features from the raw signals (e.g., the relative location and the orientation of minutiae points in fingerprint images) and match these features using any suitable pattern recognition systems. For example, at operation 222, user device 60a may not only be configured to capture user enrollment biometrics ueb (e.g., raw biometric signals), but may also be configured to generate an enrollment biometric template (“EBT”) B based on such captured user enrollment biometrics ueb using any suitable techniques (e.g., according to application 69). For example, if captured ueb is an image of the user's face, device 60a may be configured to perform a tight square crop containing the user's face, scale it to 160×160 pixels, and then feed the pre-processed image into a convolutional neural network (e.g., that may be run on device 60a) that may produce an embedding for constituting EBT B for the user's captured ueb (e.g., for an image x, the embedding may be represented as f(x)ϵ [symbol] , which may embed x into a d-dimensional Euclidean space, and the network nodes may be trained (e.g., by the SMPC protocol) such that the Euclidean distances (e.g., closenesses) in the embedding space when evaluating the user's EBT with respect to an ABS may correspond to the face similarity (e.g., such that faces of same person have smaller distances and faces of different persons have larger distances)). Therefore, in some embodiments, operation 222 may use one or more neural networks or otherwise to process captured ueb into one or more vectors for defining EBT B, such that the vector(s) of such an EBT B may later be compared to vector(s) of an ABS for computing a distance therebetween (e.g., with a matching function of an SMPC), such as one or more first models for isolating useful biometrics in the captured ueb (e.g., cropping, resizing, cleaning, etc. the biometrics for further processing) and one or more second models for extracting vectors from the isolated biometrics. However, any suitable enrollment biometrics ueb may be used in any suitable manner to define any suitable enrollment biometric template B (e.g., fingerprint biometrics ueb may be transferred into a set as EBT B). Generally, data may be collected from any or all sensors of the user device for any amount of time (e.g., while asking the user to cooperate or in the background without explicitly asking for the user's cooperation (e.g., when sensing the gait of a user that may be walking while carrying the device)), then a subset of the raw collected data may be selected based on any suitable data quality check(s), and then the raw data (e.g., subset or otherwise) may be processed using any suitable algorithms (e.g., legacy feature extraction, machine learning, etc.) and/or encoding of time-series information (e.g., for liveness checks (e.g., as may be distinct from snap-shot image data). For example, this may reveal a set and/or vector and/or matrix and/or the like that may be used to define EBT B, as any suitable representation (e.g., string of bits or digital representation) of the sensed data (e.g., user biometric data and/or device environmental data).

At operation 224, user device 60a may then generate one or more sets of authentication circuit information ACI on seed s and EBT B for the selected nodes n using secure multi-party computation (e.g., according to application 69). Operation 224 may be carried out in any suitable manner for enabling SMPC by the APSP to allow for each node j of nodes n to carry out a comparison on EBT B and a later generated authentication biometrics sample ABS without the node having access to the actual EBT or to the actual ABS. For example, operation 224 may generate/define a cryptographic process for biometric authentication (“CPBA”) that can be used at any later time to authenticate the user via evaluating a matching function on a fixed EBT and another input ABS provided at authentication-time, allow the user to perform cryptographic operations (e.g., optionally), and/or refresh or re-upload new instances of the cryptographic process to allow follow-up authentications (e.g., optionally). With the ACI, the CPBA may be prepared by the user device and uploaded to the node(s). In general, the CPBA may be created by the user device and node(s) cooperating together (e.g., the burden may be shared between the device and node(s) or more heavily handled by the device or more heavily handled by the node(s). Alternatively to garbled circuits, there are many other suitable protocol(s) and/or protocol tool(s) that may be used for CPBA. Generally, the ACI of operation 224 may be re-usable, but might be usable only once for security purposes in one or more embodiments. In general, the process may be based on any SMPC technique(s), as listed in previous comment. Biometrics (e.g., user biometrics and/or device environment biometrics) may be captured and used as inputs (e.g., EBT and ABS) to the CPBA, which may enable a secure operation as an output to the CPBA, where each one of the node(s) may be used by the CPBA to run a comparison on the inputs without any node having direct access to one or both of the inputs and then to use a successful result of the comparison (e.g., a revealed success key) to provide the output (e.g., to enable a secure operation). The generation of a particular set of authentication circuit information ACI by operation 224 may be carried out by a particular iteration of process 300 of FIG. 3.

### FIG. 3

FIG. 3 illustrates a flowchart of an exemplary process 300 for generating a set of authentication circuit information for a set of network nodes using secure multi-party computation, which may be used by process 200. Process 300 is shown being implemented by APS user device 60a (e.g., according to application 69). However, process 300 may be implemented using any other suitable components or subsystems or entities of system 1 of FIG. 1 or otherwise. For example, process 300 may be carried out one or more times by operation 224 of process 200 of FIGS. 2A and 2B and/or one or more times by operation 446 of process 400 of FIGS. 4A-4C.

Process 300 may begin at operation 302, where a new circuit identifier C_{id} may be obtained for the new set of authentication circuit information to be generated. Circuit identifier C_{id} may be defined or accessed or generated or otherwise obtained in any suitable manner (e.g., randomly generated or defined sequentially by device 60a) and may be of any suitable size and constitution (e.g., an 8 bit identifier) such that each new set of authentication circuit information to be generated by the remainder of process 300 may be associated with its own unique circuit identifier C_{id}, whereby different sets of authentication circuit information may be differentiated by their different unique circuit identifiers C_{ids}.

At operation 304, seed s may be split into n-number of seed shares [s]_{1, . . . , n}, such that the number of seed shares [s] generated may be equal to the number of selected nodes n being used by the enrollment process 200, whereby a particular one of the seed shares [s]_{1, . . . , n} may be associated with a particular one of the selected nodes n. Alternatively, more seed shares may be generated than selected nodes, with two or more seed shares being provided to a single node. Seed s may be split into n-number of seed shares [s]_{1, . . . , n} according to any suitable secret sharing scheme, such as Shamir's secret sharing. As an example, for a (m, n) scheme, at least m seed shares of the total n seed shares may be required to reconstruct the seed. Additionally or alternatively, any suitable verifiable secret sharing scheme may be used, such as Feldman's secret sharing scheme, which may provide assurances that could prevent one or more nodes from providing invalid shares.

At operation 306, EBT B may be split into n-number of EBT shares [B]_{1, . . . , n}, such that the number of EBT shares [B] generated may be equal to the number of selected nodes n being used by the enrollment process 200, whereby a particular one of the EBT shares [B]_{1, . . . , n} may be associated with a particular one of the selected nodes n. Alternatively, more EBT shares may be generated than selected nodes, with two or more EBT shares being provided to a single node. EBT B may be split into n-number of EBT shares [B]_{1, . . . , n} according to any suitable secret sharing scheme, such as Shamir's secret sharing. As an example, for a (m, n) scheme, at least m EBT shares of the total n EBT shares may be required to reconstruct the EBT. Additionally or alternatively, any suitable verifiable secret sharing scheme may be used, such as Feldman's secret sharing scheme, which may provide assurances that could prevent one or more nodes from providing invalid shares. The scheme(s) used to for the seed shares may be the same or different than the scheme(s) used for the EBT shares.

At operation 308, for new circuit identifier Cid of operation 302, new authentication circuit information ACI_{Cid_j} may be generated for a particular node j of selected nodes n using a respective particular seed share [s]ⱼ and a respective particular EBT share [B]ⱼ. Operation 308 may be carried out by process 300 n-times (e.g., serially or in parallel), once for each of the nodes n. As shown, each one of such n-iterations of operation 308 may include carrying out operations 310 to 328 of process 300.

At operation 310, for generating new authentication circuit information ACI_{Cid_j} for node j, a garbled circuit Cⱼ may be generated. The garbled circuit may be generated in accordance with any suitable SMPC protocol and may be designed to be agnostic to the underlying biometrics, and may support several modalities, including face recognition, fingerprints, speech recording, and iris scanning. For example, a circuit with an underlying function (e.g., a comparison function), may be described as a Boolean circuit with 2-input logic gates. Such a function may be generated or otherwise obtained by user device 60a, and then the function may be transformed or garbled (e.g., encrypted) into the garbled circuit by user device 60a (e.g., a collection of Boolean gates defining the function may be transformed into the garbled Boolean circuit). The garbled circuit C; may be generated with a circuit input table (“CIT”) Kⱼ and a CIT Tⱼ for a matching function mf: β_{y}×β_{z}->{FAIL, SUCCESS}. For example, the APSP may be configured to use a highly optimized SMPC construction, such as one based on a primitive called garbled circuits for evaluation of “closeness” between enrolled biometrics and authenticating biometrics of a user (e.g., between an EBT and an ABS of a user). Garbled circuits may enable private computation without the parties revealing their inputs. Here, the computation of closeness may be performed between user device 60a and the n-set of nodes 70. Therefore, with this garbled circuit technique, two parties can compute a shared matching function mf(β_{y}, βₜ) on their respective inputs β_{y} and β_{z}, disclosing only the output of the function. This may be achieved by representing function f(β_{y}, β_{z}) as a Boolean circuit and then by “garbling” the truth table of each Boolean gate so that the circuit can be evaluated provided appropriate decryption keys representing β_{y} and β_{z}. However, none of the intermediate gate outputs may be disclosed to the parties. The APSP may use garbled circuits to implement a distance function that may be applied to vectors representing an enrollment biometric template and vectors representing an authentication biometric sample, although the EBT and ABS may be defined in other forms besides vectors and the function may be defined to operate on such other form(s). The distance between the vectors may then be compared to a fixed threshold, and the garbled circuit may output the result of this comparison, thus hiding the actual distance. For example, a garbled circuit may be configured to compute a closeness or distance d between the two inputs β_{y} and β_{z} (e.g., two biometric samples (e.g., the EBT as β_{y} and the ABS as β_{z})) of its matching function mf(β_{y}, β_{z}) and then to compare the computed distance d with a threshold τ, where the circuit may be configured to output a SUCCESS output (e.g., a non-0 string set to be a success key ckⱼ) if d<τ and to output a FAIL output (e.g., a string of 0's) if d≥τ. Such a threshold τ may be defined in any suitable way and may vary based on the specific application (e.g., for a specific matching function and/or specific type of EBT and/or ABS). More generally, a matching function may be used to maximize the true accepts (e.g., correct successes) and minimize the false accepts (e.g., incorrect successes) of the whole system. The threshold may be selected in order to satisfy the trade-off (e.g., to allow as many correct biometric samples in as possible, while rejecting as many false samples as possible).

With garbled circuits, one party (e.g., the circuit generator (e.g., user device 60a)) may construct a Boolean circuit that may compute function f(⋅,⋅) and may “encrypt” or “garble” it. The other party (e.g., the circuit evaluator (e.g., node j)) may compute the output of the circuit and may share it with the circuit generator party. The circuit may include binary gates g connected by three types of wires p: (1) input wires that may assume the value of the parties' inputs, (2) output wires that may be set to the output of function f(⋅,⋅) at the end of the evaluation, and (3) intermediate wires that may carry intermediate values as they propagate throughout the circuit. The generator may associate a pair of keys or labels

$$( {l}_{p}^{0} , {l}_{p}^{1} )$$

to each wire p of the circuit. One of the labels may correspond to bit value 0, while the other one of the labels may correspond to bit value 1. For each gate g with input wires (y, z) with inputs b_{y}, b_{z}∈{0, 1} and output wire k, the generator may compute four ciphertexts (e.g., one for each gate input combination) using

$${l}_{y}^{0} , {l}_{y}^{1} , {l}_{z}^{0} , {l}_{z}^{1}$$

as encryption keys. Specifically, the generator may compute all four instances of

$${E}_{( {l}_{y}^{by} , {l}_{z}^{bz} )}^{k} ( {l}_{k}^{g ( by , bz )} ) ,$$

where g(b_{y}, b_{z}) may represent the output of gate g on inputs b_{y}, b_{z}. These ciphertexts may create a “garbled” gate and may be forwarded to the evaluator.

To decrypt the gates and evaluate the circuit, the evaluator may need two input labels corresponding to the pair

$$( {l}_{y}^{by} , {l}_{z}^{bz} )$$

associated with the computation being carried. While intermediate wire labels may be computed as the output of preceding gates, input labels may be sent from the generator to the evaluator. The generator labels may be sent as-is, for example, because their values may not disclose whether they represent a 0 or a 1 bit value. However, the generator may not know the evaluator's input, and therefore may not directly send only the correct labels to the evaluator. As an alternative, the generator may send all evaluator labels to the generator. However, the evaluator may selectively use values different from the evaluator's true input in order to learn information about the generator's input by observing multiple outputs of function f(⋅,⋅). To address this issue, the generator and the evaluator may run an oblivious transfer (“OT”) protocol instance for each of the evaluator's input bits. Specifically, the evaluator's input to each OT instance may be one of the evaluator's input bits, while the generator's input may be the two corresponding input labels. At the end of such a process, the evaluator may learn all the evaluator's input labels, while the generator may learn nothing.

The APSP may use a novel variant of the garbled circuit protocol, where the party acting as generator (e.g., user device 60a) may have two inputs (e.g., two biometric samples (e.g., the EBT as β_{y} and the ABS as β_{z})) of its matching function mf(β_{y}, β_{z}), albeit at different points in time (e.g., respectively, during enrollment and during authentication), and where the party acting as the evaluator (e.g., node j) may have effectively no input. This may allow the APSP to remove the OT phase, which may typically account for a substantial portion of the computation and communication costs of a typical garbled circuit protocol. To achieve this, the evaluator's input labels may be stored (e.g., encrypted) on the network node. During authentication, the node may return the labels to the user's device, which may decrypt the input labels and select the appropriate subset of the labels based on the second input (e.g., the ABS as β_{z}). As a result, at this point, the node may receive all the information needed to compute the output of the authentication (e.g., the garbled circuit, the evaluator's input, and the generator's input).

As mentioned, the garbled circuit may be configured to compute a closeness or distance d between the two inputs β_{y} and β_{z} of its matching function mf(β_{y}, β_{z}), such as the distance between biometric EBT as β_{y} and biometric ABS as β_{z}, and then to compare the computed distance d with a threshold τ. While the function may be configured to output a 1 when d<τ, the garbled circuit may be configured to output a SUCCESS output that may be an encrypted version of “1” that may be set as a valid success key ckⱼ when d<τ, and while the function may be configured to output a 0 when d≥τ, the garbled circuit may be configured to output a FAIL output that may be an encrypted version of “0” that may be set as null (e.g., a string of 0's) when d≥τ. Thus, as described herein, an SMPC protocol of the APSP may configure a garbled circuit to output a valid success key ckⱼ only if the ABS is close to (e.g., within a threshold distance of) the EBT because of the security properties of the garbled circuit protocol. As a result, a corrupted node may not be able to compute the valid success key ckⱼ unless it interacts with a trusted device, and the authentication is successful. The matching or distance function that may be used may depend on the specific biometric modality of the EBT and ABS. For instance, Hamming distance may be used for iris scan biometrics, while Euclidean distance may be used for facial scan biometrics. The APSP may be configured to implement each distance function by simply providing an appropriate Boolean representation for circuit garbling and evaluation. During authentication, a node and the user device may jointly reconstruct the inputs for the garbled circuit, where the node may use the encrypted template that was established during enrollment, while the user device may collect and encrypt a new biometric sample for authentication. Upon receiving the encrypted sample from the user, the node can evaluate their copy of the garbled circuit. If the authentication is successful, the node may recover a different share of the seed, and sends it to the user device. Once the user has received a sufficient number of seed shares, the user device may reconstruct the seed. While Hamming distance may be a specific realization of Manhattan and Euclidean distances over a binary field, there is no reason to limit a matching function to any specific distance or even metric. The APSP may operate effectively as long as the matching function is able to determine the “topological” notion of closeness. For example, the matching function may be operative to make an evaluation as to whether or not the EBT and ABS are close (e.g., likely from the same user and/or from the same environment), whereby there may not need to be an explicitly computable “distance” between the EBT and ABS, but only an evaluation output indicative of whether or not the EBT and ABS are close.

Therefore, at operation 310, for generating new authentication circuit information ACI_{Cid_j} for node j, a garbled circuit Cⱼ may be generated with a CIT Kⱼ and a CIT Tⱼ for a matching function mf: β_{y}×β_{z}->{FAIL, SUCCESS}, where each CIT may be a random string (e.g., an encrypted input table that may be instructions for the program to determine inputs).

At operation 312, the SUCCESS output (e.g., output label) of garbled circuit Cⱼ is determined and used to define a success key ckⱼ (e.g., success key ckⱼ may be set as equal to the SUCCESS output of garbled circuit Cⱼ (e.g., a string of bits of any suitable length)). For example, success key ckⱼ may be generated as a part of circuit generation operation 310 by the user device. The whole circuit Cⱼ may be generated by the device, and success key ckⱼ may be part of the circuit. Success key ckⱼ may be a random symmetric cryptographic key generated by circuit Cⱼ.

At operation 314, an inner key kⱼ may be generated. Inner key kⱼ may be generated independently of circuit Cⱼ (e.g., using any suitable randomness generation technique). Inner key kⱼ may be a random symmetric cryptographic key generated by user device 60a.

At operation 316, inner key kⱼ may be encrypted with public encryption key pkₑ to define encrypted key \hat{k}ⱼ (e.g., \hat{k}ⱼ=Epkₑ (kⱼ)). This may enable device 60a to securely communicate and store encrypted key kᵢ remotely (e.g., on node j rather than on device 60a) while also enabling device 60a to later retrieve that encrypted key kⱼ for re-accessing inner key kⱼ (e.g., using private encryption key skₑ).

At operation 318, a subset of CIT Tⱼ may be selected to define a restricted CIT T′ⱼ that may be representative of EBT B. This may enable restricted CIT T′ⱼ to be an instantiation of EBT B. While CIT Tⱼ may be a table operative to connect input keys to input values, operation 318 may define CIT T′ⱼ by restricting or adjusting CIT Tⱼ by removing half of each input label (e.g., a 0 bit or a 1 bit) from all of the input labels of CIT Tⱼ based on each bit of EBT B. The user device may choose and/or restrict the input for the circuit (e.g., partition the input). This may allow user device 60a to secure (e.g., encrypt or otherwise protect) EBT B for entry by node 70 as an input into the circuit Cⱼ without that node 70 being able to retrieve EBT B, or to replace EBT B by different input when evaluating circuit Cⱼ.

At operation 320, CIT Kⱼ may be encrypted with inner key kⱼ to define encrypted CIT \hat{K}ⱼ (e.g., \hat{K}ⱼ=Ekⱼ(Kⱼ)). While a subset of CIT Kⱼ may later be selected to define a restricted CIT K′ⱼ that may be representative of an ABS (e.g., at operation 432 of the authentication process 400 of FIGS. 4A-4C), such an operation is not yet ripe to occur during enrollment process 200, in which process 300 may be occurring, because such ABS has not yet been defined (e.g., user authentication biometrics have not yet been captured). Therefore, operation 320 may keep CIT Kⱼ as variable, but may encrypt CIT Kⱼ with inner key kⱼ to define encrypted CIT \hat{K}ⱼ, which may be shared with the evaluator node j during this enrollment process without enabling evaluator node j to access CIT Kⱼ.

At operation 322, seed share [s]ⱼ may be doubly encrypted to define a doubly encrypted seed share [ [symbol] ]ⱼ. For example, seed share [s]ⱼ may first be encrypted with inner key kⱼ to define a singly encrypted seed share [ŝ]ⱼ (e.g., [ŝ]ⱼ=Ekⱼ([s]ⱼ)) for enabling a first layer of seed share encryption, and then singly encrypted seed share [ŝ]ⱼ may be encrypted with success key ckⱼ to define doubly encrypted seed share [ [symbol] ]ⱼ (e.g., [ [symbol] ]ⱼ=Eckⱼ([ŝ]ⱼ)=Eckⱼ(Ekⱼ ([s]ⱼ))) for enabling a second layer of seed share encryption. Therefore, the seed share may first be encrypted with a key (e.g., inner key kⱼ) that may not be accessible to evaluator node j, and then that encrypted seed share may be encrypted with a key (e.g., success key ckⱼ) that may at some point (e.g., during the authentication phase) be made accessible to evaluator node j (e.g., if evaluator node j is able to have circuit Cⱼ return a SUCCESS output result (e.g., in response to a successful authentication)).

At operation 324, EBT share [B]ⱼ may be doubly encrypted to define a doubly encrypted EBT share [ [symbol] ]ⱼ. For example, EBT share [B]ⱼ may first be encrypted with inner key kⱼ to define a singly encrypted EBT share [\hat{B}]ⱼ (e.g., [\hat{B}]ⱼ=Ekⱼ([B]ⱼ)) for enabling a first layer of EBT share encryption, and then singly encrypted EBT share [\hat{B}]ⱼ may be encrypted with success key ckⱼ to define doubly encrypted EBT share [ [symbol] ]ⱼ (e.g., [ [symbol] ]ⱼ=Eckⱼ ([\hat{B}]ⱼ)=Eckⱼ (Ekⱼ ([B]ⱼ))) for enabling a second layer of EBT share encryption. Therefore, the EBT share may first be encrypted with a key (e.g., inner key kⱼ) that may not be accessible to evaluator node j, and then that encrypted EBT share may be encrypted with a key (e.g., success key ckⱼ) that may at some point (e.g., during the authentication phase) be made accessible to evaluator node j (e.g., if evaluator node j is able to have circuit Cⱼ return a SUCCESS output result (e.g., in response to a successful authentication)).

At operation 326, various elements generated during the generation of authentication circuit information ACI_{Cid_j} for each node j for new circuit identifier C_{id} of operation 308, such as each one of circuit Cⱼ of operation 310, encrypted key \hat{k}ⱼ of operation 316, restricted CIT T′ⱼ of operation 318, encrypted CIT Kⱼ of operation 320, doubly encrypted seed share [ [symbol] ]ⱼ of operation 322, and doubly encrypted EBT share [ [symbol] ]ⱼ of operation 324, may be signed with private device signing key sk_{d} to define signatures SVEⱼ.

At operation 328, various elements (sensitive circuit generation information SCGI) generated during the generation of authentication circuit information ACI_{Cid_j} for each node j for new circuit identifier C_{id} of operation 308 may be deleted from user device 60a. For example, such sensitive circuit generation information SCGI to be deleted from user device 60a at operation 328 may include seed share [s]ⱼ of operation 304, EBT share [B]ⱼ of operation 306, CIT Kⱼ of operation 310, CIT Tⱼ of operation 310, success key ckⱼ of operation 312, and inner key kⱼ of operation 314. Deletion of such SCGI from user device 60a during this enrollment process may prevent such information from being accessed by device 60a if device 60a were somehow compromised.

At operation 330, after each one of operations 310 to 328 of operation 308 has been completed for each node j of selected nodes n, a set of authentication circuit information ACI_{Cid_1, . . . , n} for circuit identifier C_{id} and nodes 1, . . . , n may be defined to include circuits C_{1, . . . , n} as generated by the n iterations of operation 310, encrypted keys \hat{k}_{1, . . . , n} as generated by the n iterations of operation 316, restricted CITs T′_{1, . . . , n} as generated by the n iterations of operation 318, encrypted CITs \hat{K}_{1, . . . , n} as generated by the n iterations of operation 320, doubly encrypted seed shares [ [symbol] ]_{1, . . . , n} as generated by the n iterations of operation 322, doubly encrypted EBT shares [ [symbol] ]_{1, . . . , n} as generated by the n iterations of operation 324, and signatures SVE_{1, . . . , n} as generated by the n iterations of operation 326. Such a set of authentication circuit information ACI_{Cid_1, . . . , n} for circuit identifier Cid may be eventually shared with and stored on respective nodes 70_{1, . . . , n} for furthering the enrollment of user device 60a and its user U with the network nodes of the APSP. Process 300 may end after operation 330.

The operations shown in process 300 of FIG. 3 are only illustrative and that existing operations may be modified or omitted, additional operations may be added, and the order of certain operations may be altered.

### FIG. 2A, FIG. 2B, and FIGS. 7A-7I (Continued)

After process 300, process 200 may resume at operation 224, where it may be determined if one or more additional sets of authentication circuit information ACI ought to be generated (e.g., by repeating process 300 one or more additional times for generating a new unique circuit identifier and associated authentication circuit information). However, once an appropriate number of sets of authentication circuit information ACI has been generated, process 200 may advance from operation 224 to operation 226. The APSP may be configured to have at least a threshold number of such sets of unique circuit identifier and associated circuit information available to a user device and its associated network nodes, because each authentication attempt may consume one such set, whereby a certain number of failed authentication attempts may render a user device unable to authenticate without re-enrolling.

At operation 226, each generated set of authentication circuit information ACI_{Cid_1, . . . , n} for each unique circuit identifier C_{id} may be sent as data 226d to respective nodes 70_{1, . . . , n} for furthering the enrollment of user device 60a and its user U with the network nodes of the APSP. For example, each node j may be sent authentication circuit information ACI_{Cid_j} for each unique circuit identifier C_{id} (e.g., circuit Cⱼ of each unique circuit identifier C_{id}, encrypted key kⱼ of each unique circuit identifier Cid, restricted CIT T′ⱼ of each unique circuit identifier C_{id}, encrypted CIT \hat{K}ⱼ of each unique circuit identifier C_{id}, doubly encrypted seed share [ [symbol] ]ⱼ of each unique circuit identifier C_{id}, doubly encrypted EBT share [ [symbol] ]ⱼ of each unique circuit identifier C_{id}, and signatures SVEⱼ of each unique circuit identifier C_{id}).

At operation 228, each node j of nodes 70_{1, . . . , n} may receive (e.g., as data 226d) its respective authentication circuit information ACI_{Cid_j} for each unique circuit identifier C_{id}, attempt to verify the signatures SVEⱼ of the received authentication circuit information ACI_{Cid_j} for each unique circuit identifier C_{id} using public device signing key pk_{d} of earlier received data 208d, generate a verification acknowledgment ack′_{CID_j} that may be indicative of whether or not the node was able to verify the signatures SVEⱼ of the received authentication circuit information ACI_{Cid_j} for each unique circuit identifier C_{id} (e.g., confirm or deny such verification), and then the node may send that verification acknowledgment ack′_{CID_j} as at least a portion of data 228d back to user device 60a (e.g., according to application 79 of that particular node 70). This may enable the node to verify the signatures SVEⱼ of the received authentication circuit information ACI_{Cid_j} for each unique circuit identifier Cid using public device signing key pk_{d} of user device 60a. If this verification is negative, the ACI would be rejected by the node and the node may even delete the stored keys pkᵤ and pk_{d}.

At operation 230, user device 60a may receive and register verification acknowledgment ack′_{CID_j} of data 228d from one or each node j of nodes n for each unique circuit identifier C_{id} (e.g., according to application 69 of user device 60a). If the received ack′_{CID_j} is indicative of a positive verification by node j for a particular unique circuit identifier C_{id}, then user device 60a may determine that its authentication circuit information ACI_{Cid_j} may be stored against its public keys pkᵤ and pk_{d} by node j, whereby user device 60a may be enabled to proceed with the enrollment of process 200 by advancing from operation 230 to operation 232. However, if the received ack′ⱼ is indicative of a negative verification by node j for a particular unique circuit identifier Cid, then user device 60a may determine that its authentication circuit information ACI_{Cid_j} may not be stored against its public keys pkᵤ and pk_{d} by node j, whereby user device 60a may be configured to repeat one or more of operations 224 and 226 for at least each node and each unique circuit identifier C_{id} that provided such a negative verification.

Once a positive verification is registered by user device 60a for a node j for its respective authentication circuit information ACI_{Cid_j} for a unique circuit identifier C_{id}, process 200 may advance to operation 232, where user device 60a may generate & send a store/publish instruction SPI_{CID_j} as at least a portion of data 232d to that particular node j for instructing that node to storing its received authentication circuit information ACI_{Cid_j} for a unique circuit identifier C_{id} with public keys pkᵤ and pk_{d}, and for instructing that node to publish those public keys pkᵤ and pk_{d}.

At operation 234, each node j of nodes 70_{1, . . . , n} may receive (e.g., as data 232d) its respective store/publish instruction SPI_{CID_j} for authentication circuit information ACI_{Cid_j} for a particular unique circuit identifier C_{id}, and, in response to such receipt, the node may store the received authentication circuit information ACI_{Cid_j} with the stored public keys pkᵤ and pk_{d} of user device 60a for enrolling user device 60a and its user U with the node, and the node may send the stored public keys pkᵤ and pk_{d} of user device 60a as at least a portion of data 234d to repository 80, and the node may generate an enrollment verification acknowledgment ack″_{CID_j} that may be indicative of that node fully enrolling the authentication circuit information ACI_{Cid_j} for a particular unique circuit identifier C_{id} with the stored public keys of user device 60a, and then the node may send that verification acknowledgment ack″_{CID_j} as at least a portion of data 235d back to user device 60a (e.g., according to application 79 of that particular node 70).

At operation 236, repository 380 may receive data 234d and store public keys pkᵤ and pk_{d} of user device 60a (e.g., as a portion of data 89d in repository memory 383).

At operation 238, user device 60a may receive and register verification acknowledgment ack″_{CID_j} of data 235d from one or each node j of nodes n for each unique circuit identifier C_{id} (e.g., according to application 69 of user device 60a). If the received ack″_{CID_j} is indicative of a positive verification by node j for a particular unique circuit identifier C_{id}, then user device 60a may determine that its authentication circuit information ACI_{Cid_j} has been stored against its public keys pkᵤ and pk_{d} by node j, and that its public keys pkᵤ and pk_{d} have been stored on repository 80 (if appropriate), whereby user device 60a may be enabled to end the enrollment process 200. Ending enrollment process 200 may include confirming that no sensitive enrollment information SEI remains on device 60a. This may include deleting any or each of the following items of information SEI of each applicable node j for each applicable circuit identifier C_{id} and/or for the entire enrollment process: user enrollment biometrics ueb of the enrollment process, seed s of the enrollment process, EBT B of the enrollment process, private user key skᵤ of the enrollment process, circuit Cⱼ of each one of the n-nodes of each unique circuit identifier C_{id}, encrypted CIT \hat{K}ⱼ of each one of the n-nodes of each unique circuit identifier C_{id}, restricted CIT T′ⱼ of each one of the n-nodes of each unique circuit identifier C_{id}, encrypted key \hat{k}ⱼ of each one of the n-nodes of each unique circuit identifier C_{id}, doubly encrypted seed share [ [symbol] ]ⱼ of each one of the n-nodes of each unique circuit identifier C_{id}, doubly encrypted EBT share [ [symbol] ]ⱼ of each one of the n-nodes of each unique circuit identifier C_{id}, and signatures SVEⱼ of each one of the n-nodes of each unique circuit identifier C_{id}. This deletion of sensitive enrollment information SEI (e.g., at operation 238) and of sensitive circuit generation information SCGI (e.g., at operation 328 or otherwise (e.g., at operation 238)) from user device 60a during this enrollment process may prevent such information from being accessed by device 60a if device 60a were somehow compromised after enrollment. Moreover, certain information, even before deletion, may never be provided to certain portions of memory 63 of user device 60a. For example, an APSP SDK of the client APS application 69a of user device 60a may retain at least seed s and EBT B and/or any other suitable data of the SEI and/or of the SCGI inside the APSP SDK and not allow such data to be provided to other portions of the APS application 69a and/or to other applications of device 60a. The APSP SDK may be configured never to save such data to a permanent storage of device memory 63 (e.g., a flash memory portion of memory 63), but only in device volatile memory or otherwise of device memory 63 (e.g., a RAM portion of memory 63), and may be configured to overwrite such data with zeroes or otherwise delete such data (e.g., overwrite with O's then overwrite with 1's then overwrite with random data) once the values are no longer necessary for the enrollment process (e.g., at operation 328 and/or operation 238). Ending enrollment process 200 may also include storing data indicative of each unique circuit identifier C_{id} and its associated nodes 1, . . . n on enrolled user device 60a (e.g., as a portion of data 69d (e.g., in permanent storage (e.g., a flash memory portion of memory 63))) for later retrieval (e.g., at operation 406 and/or at operation 424 of process 400). Some of the keys generated at operation 206 (e.g., public user key pkᵤ (but not private user key skᵤ of deleted sensitive enrollment information SEI), private device signing key sk_{d} (with or without public device signing key pk_{d}, which may be computed using private device signing key sk_{d}), and private encryption key skₑ (with or without public encryption key pkₑ, which may be computed using private encryption key skₑ)), may also be stored on enrolled user device 60a (e.g., as a portion of data 69d (e.g., in permanent storage (e.g., a flash memory portion of memory 63))) before ending enrollment process 200. As shown, screens 700f-700h of FIGS. 7F-7H may be provided by application 69 of user device 60a during such enrollment, but screen 700i of FIG. 7I may be presented when such enrollment is complete and confirmed (e.g., after operation 238), at which time a user may be presented with any suitable enrolled options (e.g., whether or not to enable push notifications from the APSP on the enrolled device). However, if the received ack″ⱼ is indicative of a negative verification by node j for a particular unique circuit identifier C_{id}, then user device 60a may determine that its authentication circuit information ACI_{Cid_j} may not have been stored against its public keys pkᵤ and pk_{d} by node j, and/or that its public keys pkᵤ and pk_{d} have not been stored on repository 80 (if appropriate), whereby user device 60a may be configured to repeat one or more of operations 222 to 232 for at least each node and each unique circuit identifier C_{id} that provided such a negative verification. In some embodiments of a repository 80 (e.g., as a public blockchain), a user device may be able to independently verify if the public keys have been published to the repository.

The operations shown in process 200 of FIGS. 2A and 2B are only illustrative and that existing operations may be modified or omitted, additional operations may be added, and the order of certain operations may be altered. Much of enrollment process 200 may be carried out transparently to user U for providing a more seamless and efficient user experience. For example, operations 204 to 222 may be transparent to user U (e.g., between being presented with screen 700a of FIG. 7A and being presented with screen 700b of FIG. 7B). As another example, operations 222 to 238, including the entirety of one or more iterations of process 300, may be transparent to user U (e.g., between being presented with screen 700f of FIG. 7F and being presented with screen 700i of FIG. 7I).

### FIGS. 4A-4C, FIGS. 7S7U, and FIG. 7W

FIGS. 4A-4C illustrate a flowchart of an exemplary process 400 for authenticating an enrolled APS user of an enrolled APS user device with the APSP. Process 400 is shown being implemented by APS user device 60a, its user U, a selection of nodes 70 (e.g., a number n of selected nodes 70 (e.g., nodes 70a, 70b, 70c, . . . , 70n)), and repository 80. However, process 400 may be implemented using any other suitable components or subsystems or entities of system 1 of FIG. 1 or otherwise. Process 400 may provide a seamless user experience for securely and efficiently authenticating an enrolled APS user U and its enrolled APS user device 60a with the APSP. To facilitate the following discussion regarding the operation of system 1 for authenticating user U and its user device 60a with the APSP according to process 400 of FIGS. 4A-4C, reference is made to various components of system 1 of the schematic diagrams of FIGS. 1 to 11, and to screens 700s-700u and 700w that may be representative of a graphical user interface of APS user device 60a during such a process (e.g., as shown in FIGS. 7S-7U and 7W). The operations described may be achieved with a wide variety of graphical elements and visual schemes. Therefore, the embodiments of FIGS. 7S-7U and 7W are not intended to be limited to the precise user interface conventions adopted herein. Rather, embodiments may include a wide variety of user interface styles.

Process 400 may begin at operation 402, where user U may initiate enrollment by carrying out any suitable authentication initiation interaction aii 402d with an APS application 69 that may be running on the user's enrolled APS user device 60a (e.g., a device that has been enrolled with the APSP (e.g., via process 200)). For example, as shown by screen 700s of FIG. 7S, the UI of APS device 60a may present selectable options “[YES]” and “[NO]” associated with a request to authenticate (e.g., authenticate for enabling a particular secure operation (e.g., accessing a particular service (e.g., a “B'Gock” service as particularly described with respect to FIGS. 5 and 6))), and the user may be enabled to select one of the options with its authentication initiation interaction aii in order to proceed with process 400 for authentication with the APSP. Such an authentication option presentation may be provided as a push notification (e.g., as may have been accepted by the user at screen 700i of an enrollment process) in response to the user device receiving any suitable request or challenge for enabling a particular secure operation that may be facilitated through authentication with the APSP. In advance of operation 402, APS application 69 may be accessed by device 60a in any suitable manner (e.g., as an app downloaded from APS subsystem 100 or any suitable app store or otherwise) and user U may first enroll itself and the device with the APSP (e.g., via process 200 of FIGS. 2A and 2B).

At operation 404, APS user device 60a may detect an affirmative authentication initiation interaction aii (e.g., an interaction indicative of an interest in initiating authentication) and, in response to such detection, user device 60a may access certain keys associated with the earlier device enrollment, including public user key pk_{d} (e.g., as may be stored in memory 63 of device 60a) and public device signing key pk_{d} (e.g., as may be stored in memory 63 of device 60a or as may be computed using private device signing key sk_{d} as may be stored in memory 63 of device 60a). These keys may then be used (e.g., during operations 406 to 418) to authenticate device 60a with the nodes of the APSP (e.g., similarly to operations 208 to 218 of enrollment process 200, but perhaps through signing using different private device keys).

At operation 406, APS device 60a may send public user key pkᵤ and public device signing key pk_{d} as data 406d to each node j of a selected set of nodes n (e.g., each node 70 of nodes 70a, . . . , 70n) of system 1 (e.g., according to application 69), where information indicative of that set of nodes n may have been stored on the device during enrollment (e.g., at operation 238). For example, a particular available stored circuit identifier may be identified at operation 406 and the set of nodes n stored for that identifier (e.g., at operation 238) may be used. A single user and/or a single APS user device may be enrolled with multiple different sets of nodes, and the user might have to choose a particular one of the multiple sets for a particular authentication process (e.g., using a particular circuit identifier).

At operation 408, each node j of selected nodes n may receive data 406d from user device 60a and may then make a determination (e.g., according to application 79 of that particular node 70) whether the public user key pkᵤ and public device signing key pk_{d} of data 208d have already been verified (e.g., at operation 216 of enrollment process 200) by making an internal determination through review of any suitable node data 79d of that particular node j at operation 408, and/or whether the public user key pkᵤ and public device signing key pk_{d} of data 208d have already been and remain stored together at repository 80 (e.g., at operation 236 of enrollment process 200) by sending the keys and a repository request as data 408d to repository 80 and then receiving by data 408d′ from repository 80 a verification that those same public keys have already been and remain stored together at repository 80 (e.g., based on any suitable receive and verify operation 410 by repository 80). If either one or both of such an internal verification at the node and such a repository verification by the repository is an affirmative verification of an existing link between keys pkᵤ and pk_{d} as provided by data 406d, then the node may enable the advancement of process 400 from operation 408 to operation 412, otherwise process 400 may fail or be reverted back to a re-enrollment process of the device with the node.

At operation 412, each node j may generate a challenge lⱼ (e.g., a partially random data structure) for the public keys received and verified at operation 408, and then the node may send that challenge lⱼ as at least a portion of data 412d back to user device 60a (e.g., according to application 79 of that particular node 70).

At operation 414, user device 60a may receive challenge lⱼ of data 412d from one or each of nodes n, generate a challenge response lⱼσ_{skd} for each received challenge lⱼ by signing that challenge lⱼ with the device's private device signing key sk_{d} (e.g., challenge response lⱼσₛₖₐ=Sign_{skd} (lⱼ)), and then send that challenge response lⱼσ_{skd} back to the appropriate node j as at least a portion of data 414d (e.g., according to application 69 of user device 60a).

At operation 416, one, some, or each node j of selected nodes n may receive data 414d from user device 60a, attempt to verify the public device signing key pk_{d} of earlier received data 406d using the challenge response lⱼσ_{skd} of recently received data 414d, generate a verification acknowledgment verⱼ that may be indicative of whether or not the node was able to verify the public device signing key pk_{d} (e.g., confirm or deny verification), and then the node may send that verification acknowledgment verⱼ as at least a portion of data 416d back to user device 60a (e.g., according to application 79 of that particular node 70). This may enable the node to verify whether or not public device signing key pk_{d} is indeed the public device signing key of user device 60a and/or whether a processing error may have occurred on the node and/or on the user device and/or whether an attempt to authenticate as the user is being attempted by an attacker.

At operation 418, user device 60a may receive and register verification acknowledgment verⱼ of data 416d from one or each node j of nodes n (e.g., according to application 69 of user device 60a). If the received verification acknowledgment verⱼ is indicative of a positive verification by node j, then user device 60a may determine that its public keys pkᵤ and pk_{d} have been received, stored, and verified by that particular node, which may be indicative of the device being authenticated, whereby user device 60a may be enabled to proceed further with the authentication of process 400 (e.g., to operations 420/422 (e.g., for authenticating the user of the device)). While operations 208 to 218 of the enrollment process may enable each node to verify that device 60a is in possession of private user key skᵤ (e.g., a counterpart to public user key pkᵤ) for allowing enrollment, operations 406 to 418 of the authentication process may enable each node to verify that device 60a is in possession of private device signing key sk_{d} (e.g., a counterpart to public device signing key pk_{d}) for satisfying a first of at least two forms of authentication (e.g., a device authentication of at least two forms of authentication that may also include a user authentication). For example, the APSP may be configured to require that an enrolled user authenticate its enrolled user device with the APSP (e.g., at operations 406 to 418 (e.g., a first factor authentication)) and that an enrolled user provide its biometric template to authenticate the user itself with the APSP (e.g., at operations 422 to 438 (e.g., a second factor authentication)), which may be a form of two factor authentication, before enabling the user device to reconstruct its seed s and/or its EBT B. However, if the received verification acknowledgment verⱼ is indicative of a negative verification by node j, then user device 60a may determine that its public keys pkᵤ and pk_{d} have not been received, stored, and verified by that particular node, which may be indicative of the device not being authenticated, whereby user device 60a may be configured to repeat operations 404 to 418 for at least each node that provided such a negative verification of its challenge or to re-enroll the device (e.g., at process 200).

Once a positive verification is registered by user device 60a for a sufficient number (e.g., number m) of nodes j of selected nodes n at operation 418, process 400 may advance to operation 420, where user U may present user authentication biometrics uab (e.g., as user authentication biometric identifier information or user authentication biometric information 420d) to user device 60a by carrying out any suitable user biometrics authentication interaction with device 60a, which may be configured to capture such authentication biometrics uab for generating an authentication biometric sample (“ABS”) b at operation 422 (e.g., according to APS application 69). For example, as shown by screen 700t of FIG. 7T, the UI of APS device 60a may present instructions on how the user ought to present user authentication biometrics uab to user device 60a for capture. For example, similarly to as shown by one or more of screens 700c-700e of FIGS. 7C-7E, while the user's face (not shown) may be in the line of sight of a device camera sensor, device 60a may instruct the user to look left, then eventually look straight at the camera, and then eventually look right (e.g., as shown in FIG. 7T). This may enable device 60a to capture user authentication biometrics uab in the form of a video or photograph sequence of the user's face rotating. This may enable “liveness” detection of the user (e.g., as may instructing the user to carry out any other suitable action while biometrics are captured, such as winking with one eye then with the other eye, or smiling then frowning, or saying a word or phrase, etc.). This may help prevent spoofing and/or capturing biometrics of an unwilling user. Just as any suitable enrollment biometrics ueb of a user may be captured in any suitable manner(s) by any suitable sensor(s) of user device 60a at operation 222 in response to a user presenting itself to the user device in any suitable manner(s) at operation 220 of enrollment process 200, any suitable authentication biometrics uab of a user may be captured in any suitable manner(s) by any suitable sensor(s) of user device 60a at operation 422 in response to a user presenting itself to the user device in any suitable manner(s) at operation 420 of authentication process 400 (e.g., according to an APS application of the APS user device). Moreover, just as any suitable EBT B may be generated in any suitable manner(s) using any suitable enrollment biometrics ueb at operation 222 of enrollment process 200, any suitable ABS b may be generated in any suitable manner(s) using any suitable authentication biometrics uab at operation 422 of authentication process 400 (e.g., according to an APS application of the APS user device). As mentioned, operation 222 may use any suitable neural network(s) to process captured ueb for defining EBT B. Similarly, operation 422 may use any suitable neural network(s) to process captured uab for defining ABS b, where such neural network(s) used at operation 422 may be the same as or different than the neural network(s) used at operation 222. However, the manner in which enrollment biometrics are captured may differ in any suitable way(s) from the manner in which the authentication biometrics are captured (e.g., the amount of information captured (e.g., the quality or resolution of the capture) may be less for the ABS than for the EBT). For example, this may help ensure high quality of an enrollment template and, as such, less false rejects and false accepts during authentications, while the differences can include, but are not limited to, amount of data captured, possible additional/different collaboration from the user, possible quality checks and repeated capture of data, other processing techniques, and/or the like.

At operation 424 (if not previously at operation 406), user device 60a may then identify (e.g., according to APS application 69) a stored unique circuit identifier C_{id} and its associated set of nodes n (e.g., as may be stored in a list on device 60a (e.g., in local permanent storage) at operation 238 of enrollment process 200 and/or at operation 452 of an earlier iteration of authentication process 400). This may be done at random from all available circuit identifiers. The identified unique circuit identifier Cid may then be sent as at least a portion of data 424d to each node j of the nodes n associated with that unique circuit identifier Cid and then that identified and shared unique circuit identifier C_{id} may be removed from device 60a (e.g., that identified and shared unique circuit identifier C_{id} may be removed from the stored list such that the same circuit identifier C_{id} may not be selected again for use in another authentication attempt at another iteration of operation 424 of authentication process 400).

At operation 426, each node j of nodes 70_{1, . . . , n} may receive (e.g., as data 424d) the identified and shared unique circuit identifier C_{id}, identify the respective authentication circuit information ACI_{Cid_j} of that unique circuit identifier C_{id} as previously received and stored on that node j (e.g., as previously received and stored in memory 73 of the node at operations 228/234 of enrollment process 200 and/or at operation 450 of an earlier iteration of authentication process 400), and then return certain elements of that identified authentication circuit information ACI_{Cid_j} as at least a portion of data 426d to user device 60a, where such elements may include encrypted CIT \hat{K}ⱼ and encrypted key \hat{k}ⱼ (e.g., according to node application 79).

At operation 428, user device 60a may receive data 426d including encrypted CIT Kⱼ and encrypted key \hat{k}ⱼ from one or each node j of nodes n and then obtain inner key kⱼ by decrypting encrypted key \hat{k}ⱼ as received from each node j using the device's private encryption key skₑ (e.g., according to APS application 69).

At operation 430, user device 60a may obtain CIT Kⱼ by decrypting encrypted CIT \hat{K}ⱼ as received from each node j using the obtained inner key kⱼ (e.g., according to APS application 69).

At operation 432, a subset of obtained CIT Kⱼ may be selected to define a restricted CIT K′ⱼ that may be representative of ABS b (e.g., according to APS application 69). This may enable restricted CIT K′ⱼ to be an instantiation of ABS b. While CIT Kⱼ may be a table operative to connect input keys to input values, operation 432 may define CIT K′ⱼ by restricting or adjusting CIT Kⱼ by removing half of each input label (e.g., a 0 bit or a 1 bit) from all of the input labels of CIT Kⱼ based on each bit of ABS b. The user device may choose and/or restrict the input for the circuit (e.g., partition the input). This may allow user device 60a to secure (e.g., encrypt or otherwise protect) ABS b for entry by node 70 as an input into the circuit Cⱼ without that node 70 being able to retrieve ABS b, or to replace ABS b by different input when evaluating circuit Cⱼ. Operation 432 may also include user device 60a sending each restricted CIT K′ⱼ to its respective node j as at least a portion of data 432d.

At operation 434, each node j of nodes 70_{1, . . . , n} may receive (e.g., as data 432d) restricted CIT K′ⱼ and then use that restricted CIT K′ⱼ with restricted CIT T′ⱼ of the particular authentication circuit information ACI_{Cid_j} as previously received and stored on that node j (e.g., as previously received and stored in memory 73 of the node at operations 228/234 of enrollment process 200 and/or at operation 450 of an earlier iteration of authentication process 400) to evaluate circuit C; of the particular authentication circuit information ACI_{Cid_j} (e.g., as previously received and stored in memory 73 of the node at operations 228/234 of enrollment process 200 and/or at operation 450 of an earlier iteration of authentication process 400). As mentioned, the circuit Cⱼ may be configured to compute a closeness or distance d between the two inputs β_{y} and β_{z} of its matching function mf(β_{y}, β_{z}), such as the distance between EBT B as β_{y} and ABS b as β_{z} and then to compare the computed distance d with a threshold τ, but while using restricted CIT K′ⱼ and restricted CIT K′ⱼ as the respective inputs to the circuit Cⱼ for following the SMPC protocol. While the function may be configured to output a 1 when d<τ, the garbled circuit may be configured to output a SUCCESS output that may be an encrypted version of “1” that may be set as a valid success key ckⱼ when d<τ, and while the function may be configured to output a 0 when d≥τ, the garbled circuit may be configured to output a FAIL output that may be an encrypted version of “0” that may be set as null (e.g., a string of 0's) when d≥τ. Thus, as described herein, an SMPC protocol of the APSP may configure a garbled circuit to output a valid success key ckⱼ only if ABS b is close to (e.g., within a threshold distance of) EBT B because of the security properties of the garbled circuit protocol.

At operation 436, each node j of nodes 70_{1, . . . , n} may determine if its evaluation of operation 434 resulted in a SUCCESS output or a FAIL output. If a FAIL output is determined, then the node may return an authentication failure response (not shown) to user device 60a that may be used by user device 60a to repeat one, some, or each one of operations 420 to 432 with another stored circuit identifier C_{id} or to carry out any other suitable operations. However, if a SUCCESS output is determined, then valid success key ckⱼ may be revealed to the node and the node may use that valid success key ckⱼ at operation 436 to decrypt doubly encrypted seed share [ [symbol] ]ⱼ of the particular authentication circuit information ACI_{Cid_j} as previously received and stored on that node j (e.g., as previously received and stored in memory 73 of the node at operations 228/234 of enrollment process 200 and/or at operation 450 of an earlier iteration of authentication process 400) for revealing singly encrypted seed share [ŝ]ⱼ. Moreover, if a SUCCESS output is determined, then valid success key ckⱼ may be revealed to the node and the node may use that valid success key ckⱼ at operation 436 to decrypt doubly encrypted EBT share [ [symbol] ]ⱼ of the particular authentication circuit information ACI_{Cid_j} as previously received and stored on that node j (e.g., as previously received and stored in memory 73 of the node at operations 228/234 of enrollment process 200 and/or at operation 450 of an earlier iteration of authentication process 400) for revealing singly encrypted EBT share [\hat{B}]ⱼ. Then, the node may send the revealed singly encrypted seed share [ŝ]ⱼ and the revealed singly encrypted EBT share [\hat{B}]ⱼ as at least a portion of data 436d to user device 60a. Therefore, obtaining a SUCCESS evaluation result from a garbled circuit for revealing a valid success key may enable one layer of seed share decryption and/or one layer of EBT share decryption on the node (e.g., a layer that would not be enabled on the user device). At operation 436, the node may then delete its particular authentication circuit information ACI_{Cid_j} for the particular circuit identifier C_{id} just used, in order to avoid jeopardizing certain security considerations, unless doing so would delete the only remaining authentication circuit information ACI_{Cid_j} on the node, otherwise re-enrollment may then be required.

At operation 438, user device 60a may receive singly encrypted seed share [ŝ]ⱼ and singly encrypted EBT share [\hat{B}]ⱼ from received data 436d from each node j, obtain each seed share [s]ⱼ by decrypting each singly encrypted seed share [ŝ]ⱼ from each node j of nodes n with obtained inner key kⱼ, and obtain each EBT share [B]ⱼ by decrypting each singly encrypted EBT share [\hat{B}]ⱼ from each node j of nodes n with obtained inner key kⱼ. Therefore, by only enabling inner key kⱼ to be accessible by user device 60a, another layer of seed share decryption and/or another layer of EBT share decryption may be enabled on device 60a (e.g., a layer that would not be enabled on the node).

At operation 440, user device 60a may reconstruct seed s by combining at least m seed shares [s]ⱼ obtained at operation 438 (e.g., when the APSP is using a (m, n) threshold secret sharing scheme), reconstruct EBT B by combining at least m EBT shares [B]ⱼ obtained at operation 438 (e.g., when the APSP is using a (m, n) threshold secret sharing scheme), which may be carried out using any suitable secret sharing technique(s)/protocol(s), including, but not limited to Shamir's secret sharing, blind signature protocol, threshold combining, and/or the like, and then using the reconstructed seed s for carrying out any suitable secure operation SO, such as using the reconstructed seed s to derive a secret key of a third party service that may be registered with the APSP (e.g., as described with respect to FIGS. 5 and 6). If less than m seed shares [s]ⱼ are obtained at operation 438 (e.g., if less than m evaluations result in SUCCESS at operation 434), then the number of obtained seed shares may not be adequate for enabling the user device to reconstruct its seed. Similarly, if less than m EBT shares [B]ⱼ are obtained at operation 438 (e.g., if less than m evaluations result in SUCCESS at operation 434), then the number of obtained EBT shares may not be adequate for enabling the user device to reconstruct its EBT and, for example, process 400 may restart from operation 420. As shown, screen 700u of FIG. 7U may be provided by application 69 of user device 60a during such authentication (e.g., after operation 422), but screen 700w of FIG. 7W may be presented when such authentication is complete and confirmed (e.g., after operation 440), at which time process 400 may advance to operations 442/444. While reconstructed EBT B may not be used for carrying out the secure operation SO, reconstructed EBT B may be used for generating one or more new sets of authentication circuit information ACI (e.g., at least to replace the authentic circuit information for the unique circuit identifier C_{id} used at operations 424 to 440 (e.g., as described with respect to operations 446 to 452)). Moreover, when EBT B is reconstructed or recovered at operation 440, that EBT B has been determined by the APSP to match successfully with ABS b generated at operation 422, such that APS user device 60a may be configured to use that EBT B and that ABS b to improve (e.g., train or otherwise adjust) any suitable model(s) on APS user device 60a (e.g., without having to share such sensitive biometric data with any remote entities (e.g., APS subsystem 100, etc.), including, but not limited to, any suitable model(s) of any suitable neural network(s) that may be used at operation 222 for processing captured ueb, any suitable model(s) of any suitable neural network(s) that may be used at operation 422 for processing captured uab, and/or the like.

At operation 442, a user U may initiate a biometrics update by carrying out any suitable biometrics update interaction bui 442d with an APS application 69 that may be running on the user's and authenticated APS user device 60a (e.g., a device that has been authenticated with the APSP (e.g., via operations 402 to 440 of process 400)). Although not shown, the UI of APS device 60a may present selectable options “[YES]” and “[NO]” associated with a request to update EBT B of the authenticated user (e.g., as reconstructed at operation 440), and the user may be enabled to select one of the options with its biometrics update interaction bui in order to proceed with process 400. If the user chooses to update EBT B, then operation 444 may include the device enabling the user to choose to capture new user enrollment biometrics for defining a new EBT B (e.g., similar to operations 220 and 222) and after defining that new EBT B, operation 444 may delete all remaining unique circuit identifiers C_{ids} from device 60a as they may now be unassociated with the new EBT B, and then operation 444 may advance to operation 446 with that new EBT B. As another example, if the user chooses to update EBT B, then operation 444 may include the device enabling the user to choose to replace or modify existing EBT B using existing ABS b (e.g., as captured at operation 422) and after defining that new EBT B using the ABS b, operation 444 may delete all remaining unique circuit identifiers C_{ids} from device 60a as they may now be unassociated with the new EBT B and then operation 444 may advance to operation 446 with that new EBT B. As another example, if the user chooses not to update EBT B, then operation 444 may advance to operation 446 with that same EBT B. Such a potential template update may allow the APSP to keep tight thresholds, because the template may be representative of user variations over time such as aging, growing a beard, different haircuts, and/or the like.

At operation 446, user device 60a may then generate one or more new sets of authentication circuit information ACI on seed s (e.g., as reconstructed at operation 440) and EBT B (e.g., whatever EBT B may be passed from operation 444, whether it may be unchanged, modified by ABS b, replaced by ABS b, or a completely newly defined EBT B, etc.) for the selected nodes n using secure multi-party computation (e.g., according to application 69). Operation 446 may be carried out similarly to operation 224 of process 200 but with a potentially different EBT B.

At operation 448, each generated new set of authentication circuit information ACI_{Cid_1, . . . , n} for each new unique circuit identifier C_{id} may be sent as a portion data 448d to respective nodes 70_{1, . . . , n} for storing each new set of authentication circuit information ACI_{Cid_1, . . . , n} with publication keys pkᵤ and pk_{d} for enabling additional authentication attempts by the enrolled user and device in the future. For example, each node j may be sent new authentication circuit information ACI_{Cid_j} for each new unique circuit identifier C_{id} (e.g., circuit Cⱼ of each new unique circuit identifier C_{id}, encrypted key kⱼ of each new unique circuit identifier C_{id}, restricted CIT T′ⱼ of each new unique circuit identifier C_{id}, encrypted CIT \hat{K}ⱼ of each new unique circuit identifier C_{id}, doubly encrypted seed share [ [symbol] ]ⱼ of each new unique circuit identifier C_{id}, doubly encrypted EBT share [ [symbol] ]ⱼ of each new unique circuit identifier C_{id}, and signatures SVEⱼ of each new unique circuit identifier C_{id}).

At operation 450, each node j of nodes 70_{1, . . . , n} may receive (e.g., as data 448d) its respective new authentication circuit information ACI_{Cid_j} for each new unique circuit identifier C_{id} and may store the received new authentication circuit information ACI_{Cid_j} with the stored public keys pkᵤ and pk_{d} of user device 60a with the node, and the node may generate a storage confirmation acknowledgment cnf_{CID_j} that may be indicative of that node fully enrolling the authentication circuit information ACI_{Cid_j} for each new particular unique circuit identifier C_{id} with the stored public keys of user device 60a, and then the node may send that storage confirmation acknowledgment cnf_{CID_j} as at least a portion of data 450d back to user device 60a (e.g., according to application 79 of that particular node 70).

At operation 452, user device 60a may receive and register storage confirmation acknowledgment cnf_{CID_j} of data 450d from one or each node j of nodes n for each new unique circuit identifier C_{id} (e.g., according to application 69 of user device 60a). If the received storage confirmation acknowledgment cnf_{CID_j} is indicative of a positive storage by node j for a particular new unique circuit identifier C_{id}, then user device 60a may determine that its new authentication circuit information ACI_{Cid_j} has been stored against its public keys pkᵤ and pk_{d} by node j, whereby user device 60a may be enabled to end process 400. Ending process 400 may include confirming that no sensitive authentication information SAI remains on device 60a. This may include deleting any or each of the following items of information SAI of each applicable node j for each applicable new circuit identifier C_{id} and/or for the entire authentication process: user authentication biometrics uab of the authentication process, reconstructed seed s of the authentication process, reconstructed or new EBT B of the authentication process, ABS b of the authentication process, private user key skᵤ (although private user key skᵤ is usually not reconstructed during the authentication process), circuit Cⱼ of each one of the n-nodes of each new unique circuit identifier C_{id}, encrypted CIT Kⱼ of each one of the n-nodes of each new unique circuit identifier C_{id}, restricted CIT T′ⱼ of each one of the n-nodes of each new unique circuit identifier C_{id}, encrypted key kⱼ of each one of the n-nodes of each new unique circuit identifier C_{id}, doubly encrypted seed share [ [symbol] ]ⱼ of each one of the n-nodes of each new unique circuit identifier C_{id}, doubly encrypted EBT share [ [symbol] ]ⱼ of each one of the n-nodes of each new unique circuit identifier C_{id}, and signatures SVEⱼ of each one of the n-nodes of each new unique circuit identifier C_{id}. This deletion of sensitive authentication information SAI (e.g., at operation 452) and of sensitive new circuit generation information SCGI (e.g., at operation 328 of operation 446 or otherwise (e.g., at operation 452)) from user device 60a during this authentication process may prevent such information from being accessed by device 60a if device 60a were somehow compromised after this authentication process. Moreover, certain information, even before deletion, may never be provided to certain portions of memory 63 of user device 60a. For example, an APSP SDK of the client APS application 69a of user device 60a may retain at least reconstructed seed s and reconstructed EBT B and/or any other suitable data of the SAI and/or of the SCGI inside the APSP SDK and not allow such data to be provided to other portions of the APS application 69a and/or to other applications of device 60a. The APSP SDK may be configured never to save such data to a permanent storage of device memory 63 (e.g., a flash memory portion of memory 63), but only in device volatile memory or otherwise of device memory 63 (e.g., a RAM portion of memory 63), and may be configured to overwrite such data with zeroes or otherwise delete such data once the values are no longer necessary for the authentication process (e.g., at operation 328 of operation 446 and/or operation 452). Ending authentication process 400 may also include storing data indicative of each new unique circuit identifier C_{id} and its associated nodes 1, . . . n on authenticated user device 60a (e.g., as a portion of data 69d (e.g., in permanent storage (e.g., a flash memory portion of memory 63))) for later retrieval (e.g., at operation 406 and/or at operation 424 of a later iteration of authentication process 400). Some of the keys that may be used by process 400 (e.g., public user key pkᵤ (but not private user key skᵤ potentially of deleted sensitive enrollment information SAI), private device signing key sk_{d} (with or without public device signing key pk_{d}, which may be computed using private device signing key ska), and private encryption key skₑ (with or without public encryption key pkₑ, which may be computed using private encryption key skₑ)), may also be stored on user device 60a (e.g., as a portion of data 69d (e.g., in permanent storage (e.g., a flash memory portion of memory 63))) before ending authentication process 400. However, if the received storage confirmation acknowledgment cnf_{CID_j} j is indicative of a negative (e.g., failed) storage by node j for a particular new unique circuit identifier C_{id}, then user device 60a may determine that its new authentication circuit information ACI_{Cid_j}; may not have been stored against its public keys pkᵤ and pk_{d} by node j, whereby user device 60a may be configured to repeat one or more of operations 444 to 452 for at least each node and each unique circuit identifier C_{id} that provided such a negative confirmation acknowledgment.

Therefore, the APSP may use a novel variant of the garbled circuit protocol, where the party acting as generator (e.g., user device 60a) may have two inputs (e.g., two biometric samples (e.g., EBT B as β_{y} and ABS b as β_{z})) of its matching function mf(β_{y}, β_{z}), albeit at different points in time (e.g., respectively, during APS enrollment (e.g., at operations 222 to 226 of process 200) and during APS authentication (e.g., at operations 422 to 432 of process 400)), and where the party acting as the evaluator (e.g., node j) may have effectively no input. This may allow the APSP to remove one, some, or each one of the OT phase(s), which may typically account for a substantial portion of the computation and communication costs of a typical garbled circuit protocol. To achieve this, the evaluator's input labels may be stored (e.g., encrypted) on the network node. During APS authentication, the node may return the labels to the user's device, which may decrypt the input labels and select (e.g., at operation 432) the appropriate subset of the labels based on the second input (e.g., ABS b as β_{z}). As a result, at this point, the node may receive all the information needed to compute the output of the authentication (e.g., the garbled circuit, the evaluator's input, and the generator's input). Therefore, such APS enrollment and APS authentication of the APSP of processes 200-400 may be much faster than common SMPC techniques. For example, compared to standard garbled circuits, the APSP may remove OT, which may be very computationally demanding. In some common garbled circuit evaluation, oblivious transfer may be used to restrict a CIT. However, the APSP may instead restrict each CIT on an APS user device (e.g., CIT Tⱼ to CIT T′ⱼ for EBT B at operation 318 of operation 224 on APS user device 60a (e.g., during an APS enrollment process 200) and CIT Kⱼ to CIT K′ⱼ for ABS b at operation 432 on APS user device 60a (e.g., during a later APS authentication process 400)). This modification may be made possible due to the fact that EBT B may be known to APS user device 60a while constructing circuit Cⱼ, while such an input is not known in advance in some common garbled circuit evaluation protocols, and/or due to the fact that ABS b may be known to APS user device 60a while attempting to authenticate APS user device 60a and its user U. Therefore, the APSP may enable increased speed by removing OT through reduction of each one of input tables T and K on an APS user device directly (e.g., albeit at different phases of the protocol) without running the OT protocol.

For any particular circuit identifier C_{id}, the matching function, the EBT, and the ABS used in an iteration of operations 422 to 440 may be the same for all nodes, while the representation of the matching function in the form of circuit Cⱼ on each node, the representation of EBT B as T′ⱼ on each node, and the representation of ABS b as Kⱼ or K′ⱼ on each node used in an iteration of operations 422 to 440 may be different and unrelated for each node. Despite each node having a different circuit and different inputs, the result of each node's matching function (e.g., SUCCESS or FAIL) will be the same for a given EBT, ABS, and circuit identifier C_{id}, yet the success key that may be revealed by such a successful result may differ between nodes.

APS authentication process 400 may allow for various features of the CPBA (e.g., authentication circuit information ACI (e.g., garbled circuit(s) and associated success key(s))) to be refreshed, rotated, rolled, or otherwise updated after a successful authentication. Whether or not EBT B may be updated at operation 444, at least the recovered and/or reconstructed seed s from operation 440 as a result of a successful authentication may be used to enable the generation of one or more new sets of authentication circuit information ACI at operation 446, which may then be used to replace (e.g., at operation 450) the old set of authentication circuit information ACI that was just used to enable the successful authentication. Therefore, the CPBA may be updated while securely maintaining the same seed s, if not also maintaining the same EBT B. Therefore, after deleting seed s and EBT B from APS user device 60a at the end of an APS enrollment phase (e.g., at operation 238) or at the end of an APS authentication phase (e.g., at operation 452), a new APS authentication phase may enable recovery or reconstruction of that deleted seed s and EBT B through successful evaluation of garbled circuit(s) of a first set of authentication circuit information ACI, and that recovered or reconstructed seed s and EBT B may then be used to generate a second set of authentication circuit information ACI that may then be used for a future APS authentication phase (e.g., authentication circuit information ACI may be rolled or otherwise updated on one or more nodes in response to authentication circuit information ACI enabling recovery or reconstruction of a secure seed s). This may essentially enable the APSP to send a message to itself in the future.

The operations shown in process 400 of FIGS. 4A-4C are only illustrative and that existing operations may be modified or omitted, additional operations may be added, and the order of certain operations may be altered. Much of authentication process 400 may be carried out transparently to user U for providing a more seamless and efficient user experience. For example, operations 404 to 422 may be transparent to user U (e.g., between being presented with screen 700s of FIG. 7S and being presented with screen 700t of FIG. 7T). As another example, operations 422 to 440 may be transparent to user U (e.g., between being presented with screen 700u of FIG. 7U and being presented with screen 700w of FIG. 7W). In some embodiments, the success of an authentication may not be disclosed to the user. In some embodiments, the success of an authentication may not be shared by the node with the user device.

As mentioned, one or more nodes 70 and/or repository 80 may be operative to store any suitable data for associating an APS user identifier with an APS device identifier (e.g., for enrolling a public user key pkᵤ with a public device signing key pk_{d}, (e.g., at operation 210 and/or at operation 236 of an APS enrollment process for a user of a first APS user device 60a)). However, two or more different APS user devices (e.g., first APS user device 60a and second APS user device 60b) may be enrolled with the APSP for a single user (e.g., a single user persona (e.g., a single EBT B)). For example, after the enrollment of user U and first APS user device 60a of process 200, during which public user key pkᵤ of user U and public device signing keys pk_{d} of first APS user device 60a may be enrolled with the APSP by storing those public keys together (e.g., on one or more nodes 70 at operation 210 and/or on a repository 80 at operation 236) and verifying that first APS user device 60a has access to private user key skᵤ as the counterpart to public user key pkᵤ (e.g., at operation 216) and generating and storing one or more sets of authentication circuit information ACI for an EBT B of user U on one or more nodes 70 (e.g., at operations 222 to 238), user U and second APS user device 60b may be enrolled with the APSP. Therefore, second APS user device 60b may then be enabled to authenticate second APS user device 60b with the APSP using the same EBT B from the enrollment of first user device 60a and an ABS b that may be captured during the authentication using second APS user device 60b (e.g., at operations 402 to 418 when carried out by second APS user device 60b rather than by first APS user device 60a).

In some embodiments, different encrypted EBT shares need not be stored on different nodes but may instead be stored on one particular node (e.g., a more favored or more trusted node). For example, a first doubly encrypted EBT share of an EBT B may be used along with a first circuit to partially define first ACI for a particular circuit identifier C_{id} and that first ACI may be shared with a first node, while a second doubly encrypted EBT share of the same EBT B may be used along with a second circuit to partially define second ACI for the same particular circuit identifier C_{id} and that second ACI may be shared with the same first node, such that, during an APS authentication phase, the APS user device may identify that particular circuit identifier C_{id} (e.g., at operation 424) and make two different restricted CITs K′, one for each of the first and second ACIs, and send both of those first and second restricted CITs K′ to the same first node (e.g., at operation 432). Then, the first circuit of the first ACI may be successfully evaluated using the first restricted CIT K′ for revealing a first success key that may be used to decrypt the first doubly encrypted EBT share, while the second circuit of the second ACI may be successfully evaluated using the second restricted CIT K′ for revealing a second success key that may be used to decrypt the second doubly encrypted EBT share, such that both the first and second singly encrypted EBT shares may then be sent back from the same node to the APS user device. Therefore, operation 308 may be carried out two or more times for a single node. As another example, a single success key may be used to encrypt and decrypt multiple EBT shares provided to a single node, where each one of a first doubly encrypted EBT share of an EBT B and a second doubly encrypted EBT share of the same EBT B may be used along with a circuit to partially define ACI for a particular circuit identifier C_{id} and that ACI may be shared with a node, such that, during an APS authentication phase, the APS user device may identify that particular circuit identifier C_{id} (e.g., at operation 424) and make a single restricted CIT K′ for the ACI, and send that restricted CIT K′ to the same node (e.g., at operation 432). Then, the circuit of the ACI may be successfully evaluated using the restricted CIT K′ for revealing a success key that may be used to decrypt each one of the first doubly encrypted EBT share and the second doubly encrypted EBT share, such that both the first and second singly encrypted EBT shares may then be sent back from the same node to the APS user device. Therefore, operation 324 of operation 308 may be carried out two or more times for a single node, while operation 436 may be carried out two or more times for a single operation 434. Alternatively, in some embodiments, EBT B need not be split into two or more EBT shares (e.g., at operation 304) before being encrypted and stored on one or more nodes. Instead, the entire EBT B may be doubly encrypted with an inner key and a success key (e.g., at operation 322) and the doubly encrypted EBT may be stored as a portion of authentication circuit information ACI on one or more nodes, such that a successful evaluation by such a node may decrypt the doubly encrypted EBT with a revealed success key and send the singly encrypted EBT as encrypted by the inner key back to the APS user device. This may obviate the need for any reconstruction of EBT shares, but may enable the APS user device to recover the EBT simply through decrypting an encrypted EBT provided by a node. Alternatively, in some embodiments, besides using an EBT B to select a subset of a CIT T to make a restricted CIT T′ (e.g., at operation 318) that may define a portion of authentication circuit information ACI to be stored and used by one or more nodes 70, such an EBT B need not be stored in any form on any nodes. For example, neither a doubly encrypted EBT nor any doubly encrypted EBT shares need be stored on any nodes, such that no node needs to singly encrypt any such doubly encrypted EBT or doubly encrypted EBT share with a revealed success key, such that no APS user device needs to recover or reconstruct an EBT during an APS authentication phase. Although this may prevent the APS user device from accessing (e.g., at operation 440) an enrolled EBT during an APS authentication phase (e.g., the enrolled EBT with which an ABS may be evaluated during the APS authentication phase), which may prevent the APS user device from using such an enrolled EBT for generating one or more new sets of authentication circuit information ACI, process 400 may still allow for the APS user device to replace the enrolled EBT with a new EBT (e.g., at operation 444) before using such a new EBT for generating one or more new sets of authentication circuit information ACI (e.g., at operation 446).

In some embodiments, different encrypted seed shares need not be stored on different nodes but may instead be stored on one particular node (e.g., a more favored or more trusted node). For example, a first doubly encrypted seed share of a seed s may be used along with a first circuit to partially define first ACI for a particular circuit identifier C_{id} and that first ACI may be shared with a first node, while a second doubly encrypted seed share of the same seed s may be used along with a second circuit to partially define second ACI for the same particular circuit identifier C_{id} and that second ACI may be shared with the same first node, such that, during an APS authentication phase, the APS user device may identify that particular circuit identifier C_{id} (e.g., at operation 424) and make two different restricted CITs K′, one for each of the first and second ACIs, and send both of those first and second restricted CITs K′ to the same first node (e.g., at operation 432). Then, the first circuit of the first ACI may be successfully evaluated using the first restricted CIT K′ for revealing a first success key that may be used to decrypt the first doubly encrypted seed share, while the second circuit of the second ACI may be successfully evaluated using the second restricted CIT K′ for revealing a second success key that may be used to decrypt the second doubly encrypted seed share, such that both the first and second singly encrypted seed shares may then be sent back from the same node to the APS user device. Therefore, operation 308 may be carried out two or more times for a single node. As another example, a single success key may be used to encrypt and decrypt multiple seed shares provided to a single node, where each one of a first doubly encrypted seed share of a seed s and a second doubly encrypted seed share of the same seed s may be used along with a circuit to partially define ACI for a particular circuit identifier C_{id} and that ACI may be shared with a node, such that, during an APS authentication phase, the APS user device may identify that particular circuit identifier C_{id} (e.g., at operation 424) and make a single restricted CIT K′ for the ACI, and send that restricted CIT K′ to the same node (e.g., at operation 432). Then, the circuit of the ACI may be successfully evaluated using the restricted CIT K′ for revealing a success key that may be used to decrypt each one of the first doubly encrypted seed share and the second doubly encrypted seed share, such that both the first and second singly encrypted seed shares may then be sent back from the same node to the APS user device. Therefore, operation 322 of operation 308 may be carried out two or more times for a single node, while operation 436 may be carried out two or more times for a single operation 434. Alternatively, in some embodiments, seed s need not be split into two or more seed shares (e.g., at operation 304) before being encrypted and stored on one or more nodes. Instead, the entire seed s may be doubly encrypted with an inner key and a success key (e.g., at operation 322) and the doubly encrypted seed may be stored as a portion of authentication circuit information ACI on one or more nodes, such that a successful evaluation by such a node may decrypt the doubly encrypted seed with a revealed success key and send the singly encrypted seed as encrypted by the inner key back to the APS user device. This may obviate the need for any reconstruction of seed shares, but may enable the APS user device to recover the seed simply through decrypting an encrypted seed provided by a node. Alternatively, in some embodiments, seed s need not be stored in any form on any nodes or recovered or reconstructed on the APS user device based on any data received at the APS user device from one or more nodes. Instead, any success key(s) that may be revealed through any successful evaluation(s) on one or more nodes (e.g., at operation 434) may then be used by the one or more nodes for carrying out a secure operation SO. As just one example, the success key (or success keys) that may be revealed by one or more nodes (e.g., at operation 434 for an APS authentication phase) may be used as different small pieces of a secret, which may be used to perform a secure operation directly by the node(s) or by any other suitable entity.

### FIG. 5 and FIGS. 7J-7P

FIG. 5 illustrates a flowchart of an exemplary process 500 for registering a third party service with an enrolled APS user of an enrolled APS user device. Process 500 is shown being implemented by user U, its APS user device 60a, a TPS user device 60c, TP subsystem 90, a selection of nodes 70 (e.g., a number n of selected nodes 70 (e.g., nodes 70a, 70b, 70c, . . . , 70n)), and repository 80. However, process 500 may be implemented using any other suitable components or subsystems or entities of system 1 of FIG. 1 or otherwise. Process 500 may provide a seamless user experience for securely and efficiently registering a third party service of TP subsystem 90 with enrolled APS user device 60a and its enrolled APS user U via TPS user device 60c. To facilitate the following discussion regarding the operation of system 1 for registering the third party service of TP subsystem 90 with enrolled APS user device 60a and its enrolled APS user U via TPS user device 60c according to process 500 of FIG. 5, reference is made to various components of system 1 of the schematic diagrams of FIGS. 1 to 11, and to screens 700j-700p that may be representative of a graphical user interface of enrolled APS user device 60a or TPS user device 60c during such a process (e.g., as shown in FIGS. 7J-7P). The operations described may be achieved with a wide variety of graphical elements and visual schemes. Therefore, the embodiments of FIGS. 7J-7P are not intended to be limited to the precise user interface conventions adopted herein. Rather, embodiments may include a wide variety of user interface styles.

Process 500 may begin at operation 502, where user U may initiate a third party (“TP”) service action enrollment by carrying out any suitable TP service action tpsa 502d with a third party service (“TPS”) application that may be running on a user's TPS user device 60c, which may be the same as enrolled APS user device 60a or may be a different device that may not be enrolled with (or even may not be able to enroll with) the APSP but may nevertheless be used by user U to interact with a third party subsystem 90 that may benefit from the enrollment/authentication of the APSP. For example, as shown by screen 700j of FIG. 7J, the UI of TPS device 60c may present a “LOG-IN” option for user U to log-into a TPS (e.g., a TPS website that may be managed or under the control of a third party subsystem 90a (e.g., a “B'Gock Service” subsystem)) with its TP service action tpsa in order to proceed with process 500 for registering the TPS with an enrolled APS user of an enrolled APS user device 60a. In advance of operation 502, a TPS application 69 may be accessed by TPS device 60c in any suitable manner (e.g., as an app downloaded from any suitable app store or as a website via any suitable web browser or otherwise) and user U may carry out any suitable account set-up operations with respect to the TPS and the TPS application for enabling the user to log-in at operation 502 (e.g., using a <user name> and <password> as shown in FIG. 7J).

At operation 504, the TPS application that may be running on TPS user device 60c may be operative to receive and send TP service action tpsa data 502d on to TP subsystem 90 (e.g., a server of the “B'Gock Service”) as at least a portion of TP service action tpsa data 504d. At operation 506, TP subsystem 90 may be operative to receive and process TP service action tpsa data 504d in order to determine any APSP availability for the TPS at operation 508. For example, TP subsystem 90 may be operative to determine that it may enable user U to register the TPS with the APSP (e.g., using any suitable code provided to TP subsystem 90 by APS subsystem 100 or otherwise). In response to such a determination, TP subsystem 90 may be operative to send associated APSP availability (“apspa”) data 508d back to TPS user device 60c at operation 508. In response to receiving such apspa data 508d, TPS user device 60c (e.g., in accordance with its TPS application) may be operative to present any suitable apspa information for the TPS to user U. For example, as shown by screen 700k of FIG. 7K, the TPS application may present any suitable options that may be available to the user with respect to potentially registering the TPS with the APSP, such as “REGISTER SERVICE USING ENABLED DEVICE” (e.g., register the TPS using another device that is APS enabled) or “GET THE APP” (e.g., obtain an APSP app on this device for enabling this device for APS and registering the TPS with the APSP on this device) or “SKIP THIS STEP” (e.g., do not register the TPS with the APSP). Although operations 504 to 510 may include communicating data to and from TP subsystem 90 that may handle some of the processing, the functionality of these operations may alternatively be carried out entirely on TPS user device 60c running a TPS application in an offline mode (e.g., without relying on any processing of a TPS server).

At operation 512 user U may initiate any suitable APSP registration for the TPS while interfacing with the TPS application that may be running on TPS user device 60c by carrying out any suitable APSP registration with action apspr 512d. For example, as mentioned and as shown by screen 700k of FIG. 7K, the UI of TPS device 60c may present at operation 510 any suitable options that may be available to the user with respect to potentially registering the TPS with the APSP, and the user may choose one of the options with data 512d at operation 512, such as “REGISTER SERVICE USING ENABLED DEVICE” (e.g., register the TPS using another device that is APS enabled).

At operation 514, the TPS application that may be running on TPS user device 60c may be operative to receive and send APSP action apspr 512d on to TP subsystem 90 (e.g., a server of the “B'Gock Service”) as at least a portion of APSP action apspr data 514d. At operation 516, TP subsystem 90 may be operative to receive and process APSP action apspr data 514d in order to determine any appropriate APS device registration (“apsdr”) information as aspdr data 518d for the TPS at operation 518. For example, TP subsystem 90 may be operative to determine that it may enable user U to register the TPS with the APSP on an enrolled APS device that is not TPS user device 60c by generating information that may be transferable from TPS user device 60c to an enrolled APS user device 60a in any suitable manner for enabling such registration. For example, a QR code or any other suitable information may be presented on device 60c as apspr data 520d at operation 520, in response to receiving associated apsdr data 518d sent from TP subsystem 90 at operation 518, and then captured by APS user device 60a at operation 524 (e.g., with the help of user U at operation 522 (e.g., screen 700l of FIG. 7L may be presented by TPS device 60c at operation 520 with such a QR code, screen 700m of FIG. 7M may be presented by an enrolled APS device 60a at operation 524 (e.g., in response to user U selecting a “register new service” option provided by the APSP application that may be running on enrolled user device 60a (e.g., after operation 238)) that may allow the user to affirmatively choose to register a new service on the APSP using enrolled APS device 60a, then screen 700n of FIG. 7N may be presented by APS device 60a instructing the user how to aid in the registration at operation 524 by capturing the QR code being presented by TPS device 60c)). In other embodiments the information of apspr data 520d provided by the QR code may be sent directly from TPS device 60c to APS device 60a or from TP subsystem 90 to APS device 60a without requiring the user to help with the communication. Such apspr data 520d may include any suitable data indicative of the TPS and/or of the user's account with the TPS (e.g., the account logged into by user U at operations 502 to 506).

At operation 524, in response to receiving such apspr data 520d, enrolled APS user device 60a may process such data and determine how to enable the requested registration. For example, in response operation 524, APS user device 60a may be operative to generate a TPS keypair (skₜ, pkₜ) at operation 526. For example, a private TPS key skₜ may be generated as a random integer of any suitable size (e.g., 256 bits) and then a counterpart public TPS key pkₜ to private TPS key skₜ may also be generated in any suitable manner (e.g., for providing random TPS keypair (skₜ, pkₜ)), such as where private TPS key skₜ may be used as a private key for a signature scheme, such as EdDSA or ECDSA, and the corresponding public counterpart is public TPS key pkₜ (e.g., pkₜ=skₜ×G, where G may be the elliptic curve base point in the case of ECDSA). Moreover, at operation 526, APS user device 60a may encrypt private TPS key skₜ with public user key pkᵤ to derive encrypted private TPS key [symbol] (e.g., [symbol] =Epkᵤ (skₜ)) and then, at operation 526, APS user device 60a may delete private TPS key skₜ, such that the only way in which APS user device may regain access to private TPS key skₜ may be to regain access to private user key skᵤ (e.g., the counterpart of public user key pkᵤ) for decrypting encrypted private TPS key [symbol] by reconstructing seed s through authentication with the APSP. At operation 528, APS user device 60a may store encrypted private TPS key [symbol] with at least a portion of apspr data 520d for associating the stored encrypted private TPS key [symbol] with the TPS and user U's account therewith. In some embodiments, encrypted private TPS key [symbol] may be stored with at least a portion of apspr data 520d directly on APS user device 60a (e.g., at operation 528). Additionally or alternatively encrypted private TPS key [symbol] may be stored with at least a portion of apspr data 520d on one or more nodes 70 of the APSP (e.g., at operation 530 via data 530d from user device 60a). Additionally or alternatively encrypted private TPS key [symbol] may be stored with at least a portion of apspr data 520d on repository 80 (e.g., at operation 532 via data 532d from user device 60a). Then, at operation 534, APS user device 60a may send public TPS key pkₜ with at least a portion of apspr data 520d as apsrc data 534d to TP subsystem 90, where such data may also be indicative of enrolled APS user device 60a. Finally, at operation 534, APS user device 60a may provide confirmation of the registration of the TPS with the APSP (e.g., by presenting screen 700o of FIG. 7O).

At operation 536, TP subsystem 90 may receive apsrc data 534d and then store on TP subsystem 90 public TPS key pkₜ of apsrc data 534d in association with at least a portion of apspr data 520d of apsrc data 534d or some other data associated therewith. Therefore, any suitable data indicative of the TPS and/or of the user's account with the TPS (e.g., the account logged into by user U at operations 502 to 506) may be stored on TP subsystem 90 along with public TPS key pkₜ, while such data indicative of the TPS and/or of the user's account with the TPS may also be stored on enrolled APS user device 60a and/or node(s) 70 and/or repository 80 of the APSP. At operation 538, TP subsystem 90 may determine and send a confirmation of the APSP registration of the TPS achieved at operation 538 as apscr data 538d to TPS user device 60c, which may then receive and process such data for presenting to the user a confirmation of such APSP registration of the TPS (e.g., by presenting screen 700p of FIG. 7P). Process 500 may end after the APSP registration of the TPS has been confirmed to the user via one or both of devices 60a and 60c. Although operations 514 to 520 may include communicating data to and from TP subsystem 90 that may handle some of the processing, the functionality of these operations may alternatively be carried out entirely on TPS user device 60c running a TPS application in an offline mode (e.g., without relying on any processing of a TPS server). Although operations 536 to 540 may include communicating data to and from TP subsystem 90 that may handle some of the processing, the functionality of these operations may alternatively be carried out entirely on TPS user device 60c running a TPS application in an offline mode (e.g., without relying on any processing of a TPS server).

The operations shown in process 500 of FIG. 5 are only illustrative and that existing operations may be modified or omitted, additional operations may be added, and the order of certain operations may be altered. Much of registration process 500 may be carried out transparently to user U for providing a more seamless and efficient user experience. For example, operations 504 to 510 may be transparent to user U (e.g., between being presented with screen 700j of FIG. 7J and being presented with screen 700k of FIG. 7K). As another example, operations 514 to 534 may be transparent to user U (e.g., between being presented with screen 700k of FIG. 7K and being presented with screen 700o of FIG. 7O). As another example, operations 514 to 540 may be transparent to user U (e.g., between being presented with screen 700k of FIG. 7K and being presented with screen 700p of FIG. 7P (e.g., except for potentially operation 522 and FIGS. 7L-7N in some embodiments)). Process 500 may be repeated for registering various third party services (e.g., of a single or various third party subsystems) with a single user persona of the APSP (e.g., a single enrolled EBT B of a particular user). For example, a single user U may open multiple distinct user accounts with the B'Gock service, each of which may be registered with a single APSP persona of that user. Additionally or alternatively, a single user U can enroll multiple user personas on the APSP (e.g., by repeating process 200 with different keypairs and a different EBT B).

### FIG. 6 and FIGS. 7Q-7W

FIG. 6 illustrates a flowchart of an exemplary process 600 for authenticating an enrolled APS user of an enrolled APS user device with a registered third party service using the APSP. Process 600 is shown being implemented by user U, its APS user device 60a, a TPS user device 60c, TP subsystem 90, a selection of nodes 70 (e.g., a number n of selected nodes 70 (e.g., nodes 70a, 70b, 70c, . . . , 70n)), and repository 80. However, process 600 may be implemented using any other suitable components or subsystems or entities of system 1 of FIG. 1 or otherwise. Process 600 may provide a seamless user experience for securely and efficiently authenticating enrolled APS user U of enrolled APS user device 60a with a registered third party service of TP subsystem 90 using the APSP via TPS user device 60c. To facilitate the following discussion regarding the operation of system 1 for authenticating enrolled APS user U of enrolled APS user device 60a with a registered third party service of TP subsystem 90 using the APSP via TPS user device 60c according to process 600 of FIG. 6, reference is made to various components of system 1 of the schematic diagrams of FIGS. 1 to 11, and to screens 700q-700w that may be representative of a graphical user interface of enrolled APS user device 60a or TPS user device 60c during such a process (e.g., as shown in FIGS. 7Q-7W). The operations described may be achieved with a wide variety of graphical elements and visual schemes. Therefore, the embodiments of FIGS. 7Q-7W are not intended to be limited to the precise user interface conventions adopted herein. Rather, embodiments may include a wide variety of user interface styles.

Process 600 may begin at operation 602, where user U may initiate a registered TPS authentication (“rtpsa”) by carrying out any suitable rtps action rtpsa 602d with a third party service (“TPS”) application that may be running on a user's TPS user device 60c, which may be the same as enrolled APS user device 60a or may be a different device that may not be enrolled with (or even may not be able to enroll with) the APSP but may nevertheless be used by user U to interact with a third party subsystem 90 that may benefit from the enrollment/authentication of the APSP. For example, as shown by screen 700q of FIG. 7Q, the UI of TPS device 60c may present a “LOG-IN” option for user U to log-into a registered TPS (e.g., a TPS website that may be managed or under the control of a third party subsystem 90a (e.g., a “B'Gock Service” subsystem) as may have been registered during process 500) with its RTPS action rtpsa in order to proceed with process 600 for authenticating an enrolled APS user of an enrolled APS user device with the registered TPS using the APSP. Unlike screen 700j of FIG. 7J that may be presented by an unregistered TPS, screen 700q of FIG. 7Q of the registered TPS may only require the user to enter a <user name> but not also a password.

At operation 604, the TPS application that may be running on TPS user device 60c may be operative to receive and send RTPS action rtpsa data 602d on to TP subsystem 90 (e.g., a server of the registered “B'Gock Service”) as at least a portion of RTPS action rtpsa data 604d. At operation 606, TP subsystem 90 may be operative to receive and process RTPS action rtpsa data 604d in order to determine any APSP data that may be available for the registered TPS (e.g., to identify public TPS key pkₜ as stored in association with at least a portion of apspr data 520d that may be indicative of the currently logged in account of the registered service and an enrolled APS user device of that user). In response to such processing, TP subsystem 90 may determine that it ought to generate and send a challenge to an enrolled APS user device associated with that APSP data (e.g., enrolled APS user device 60a). Then, at operation 608, TP subsystem 90 may generate a challenge tⱼ and any suitable APS device authentication information (“apsdi”) and then send that challenge tⱼ and the apsdi to the enrolled APS user device 60a as data 608d, where such apsdi may include any suitable information, such as information indicative of the registered and currently logged-in TPS by user U. Additionally, after operation 608, TP subsystem 90 may determine and send a status update of the TPS authentication at operation 610 to TPS user device 60c using apsas data 610d. At operation 612, TPS user device 60c may receive and process apsas data 610d and then present an update of the TPS authentication to the user (e.g., screen 70r of FIG. 7R may be presented by TPS user device 60c at operation 612 to indicate to the user that TPS user device 60c and the TPS itself are awaiting authentication approval from the APSP (e.g., for enrolled APS user device 60a)).

At operation 614, enrolled APS user device 60a may receive and process challenge tⱼ and the apsdi of data 608d, which may include user device 60a (e.g., according to an APS application 69a running thereon) that it must regain access to private TPS key skₜ in order to properly respond to challenge tⱼ from the registered service and that, in order to do so, it must reconstruct seed s. Therefore, at operation 616, enrolled APS user device 60a may attempt to obtain seed s for handling challenge tⱼ. Such an operation 616 may include enrolled APS user device 60a carrying out at least a portion of authentication process 400 (e.g., operations 402 to 440, which may involve nodes 70 and repository 80) that enables enrolled APS user device 60a to reconstruct seed s. (e.g., as shown by screens 700s-700u of FIGS. 7S-7U, enrolled APS user device 60a may present information for enabling the user to attempt to reconstruct seed s). Then, once seed s has been reconstructed by enrolled APS user device 60a, device 60a may access encrypted private TPS key [symbol] (e.g., from memory local to device 60a or from one or more nodes 70 or from repository 80) and then derive private TPS key skₜ from accessed encrypted private TPS key [symbol] using reconstructed seed s. Particularly, in some embodiments, this may involve device 60a regaining access to private user key skᵤ (e.g., the counterpart of public user key pkᵤ) for decrypting encrypted private TPS key [symbol] with private user key skᵤ, which may involve device 60a regenerating private user key skᵤ using reconstructed seed s and constant c (e.g., private user key skᵤ=HMACₛ(c)). Then, once user device 60a has derived private TPS key skₜ from accessed encrypted private TPS key [symbol] using reconstructed seed s at operation 618, device 60a may generate a challenge response σₛₖₜ(tⱼ) by signing the received challenge tⱼ with the derived private TPS key skₜ, and then sending that challenge response σₛₖₜ to TP subsystem 90 as at least a portion of data 620d at operation 620. Although not shown, operation 620 may then also include deleting any suitable sensitive data from user device 60a, including, but not limited to, reconstructed seed s, private user key skᵤ, any biometrics, any seed shares, any biometric shares, any suitable circuit information, and/or the like for providing additional security to the system.

At operation 622, TP subsystem 90 may receive and attempt to verify challenge response σₛₖₜ of data 620d using stored public TPS key pkₜ (e.g., as stored at operation 536 of registration process 500) in order to authenticate the TPS for user U (e.g., according to an APS application 99 that may be running on TP subsystem 90). If verification of challenge response σₛₖₜ is successful, TP subsystem 90 may authenticate TPS for user U (e.g., grant access to the TPS (e.g., grant access to the B'Gock service provided by TPS user device 60c)) and send a confirmation of such TPS authentication to TPS user device 60c as apsac data 622d, which may be received and processed by TPS user device 60c in order to present confirmation of the TPS authentication to the user at operation 624 (e.g., screen 700v of FIG. 7V may be presented by TPS user device 60c for indicating that the user has been authenticated with the TPS (e.g., the secure operation of granting a user access to the third party service has been achieved using a reconstructed seed s via the APSP)). Moreover, TP subsystem 90 may send a confirmation of such TPS authentication to APS user device 60a as apsac data 623d, which may be received and processed by APS user device 60a in order to present confirmation of the TPS authentication to the user at operation 626 (e.g., screen 700w of FIG. 7W may be presented by APS user device 60a for indicating that the user has been authenticated with the TPS (e.g., the secure operation of granting a user access to the third party service has been achieved using a reconstructed seed s via the APSP)). Although operations 604 to 612 may include communicating data to and from TP subsystem 90 that may handle some of the processing, the functionality of these operations may alternatively be carried out entirely on TPS user device 60c running a TPS application in an offline mode (e.g., without relying on any processing of a TPS server). Although operations 622 and 624 may include communicating data to and from TP subsystem 90 that may handle some of the processing, the functionality of these operations may alternatively be carried out entirely on TPS user device 60c running a TPS application in an offline mode (e.g., without relying on any processing of a TPS server). This is but just one example of how a reconstructed seeds may be used by an enrolled APS user device to enable a secure operation SO of any suitable service (e.g., a third party service or any other suitable service), such as to encrypt or decrypt a hard drive of the enrolled APS user device (e.g., using a new symmetric key or a keypair that may be derived from (e.g., anchored under) seed s), which may not involve a TPS user device or TP subsystem 90, or to carry out a secure operation with a blockchain and/or user wallet (e.g., signing a Bitcoin transaction), and/or the like.

As another particular example, TP subsystem 90 may be operative to manage a user's booking of a hotel room and enabling secure entry into that hotel room using the APSP. For example, during process 500, TPS user device 60c may be any suitable device that user U may interface with for booking a hotel room for a particular date (e.g., any device operative to run an app or website of a travel agency or hotel management entity, which may be APS user device 60a or a distinct different device) and/or registering that user's hotel booking or that user's hotel booking service account with that user's enrollment with the APSP. Then, during process 600, TPS user device 60c may be any suitable device that user U may interface with for gaining access to the booked hotel room on the particular date (e.g., a smart doorknob or lock that may be operative to automatically unlock and grant access to a hotel room if the user may be authenticated by the APSP). For example, at operations 602 and 604, user U may utilize APS user device 60a to communicate data 602d with such a TPS user device 60c (e.g., using NFC or Bluetooth or any other suitable communication path), which may indicate that the user is present outside the hotel room and would like to authenticate with the hotel booking service, and then APS user device 60a may be provided with a challenge by TP subsystem 90, and APS user device 60a may be operative to carry out a secure operation in response to such a challenge through authenticating with the APSP, where the secure operation may include providing a challenge response that may be utilized by TP subsystem 90 for unlocking the door to the hotel room using TPS user device 60c (e.g., the smart doorknob).

As another particular example, TP subsystem 90 may be operative to track a user's location (e.g., for confirming that a user is doing its designated tasks (e.g., that a security guard is checking various locations throughout a shift)) using the APSP. For example, during process 500, TPS user device 60c may be any suitable device that user U may interface with for registering with a tracking service and/or registering that tracking service with that user's enrollment with the APSP. Then, during process 600, TPS user device 60c may be any suitable device that user U may interface with for proving that the user U was located near that TPS user device 60c (e.g., a beacon (e.g., a Bluetooth low energy beacon transmitter device) that may be operative to communicate data indicative of the beacon and/or its location as well a time at which that data was communicated)). For example, at operations 602 and 604, user U may utilize APS user device 60a to communicate data 602d with such a TPS user device 60c (e.g., using NFC or Bluetooth or any other suitable communication path), which may request beacon data from the TPS user device and/or beacon data may be automatically (e.g., periodically) communicated by TPS user device 60c and received by APS user device 60a (e.g., as data 608d). In response to receiving such a challenge (e.g., timestamped beacon data), APS user device 60a may be operative (e.g., at operations 614 to 620) to sign such a challenge with a private TPS key skₜ, and then store that signed challenge as unmodifiable information (e.g., on repository 80 (e.g., on a public blockchain)). This may be used for facilitating a secure operation, as the TP subsystem may then utilize that stored signed challenge (e.g., by confirming the signature with its public TPS key pkₜ) for securely determining that the user authenticated with the APSP to prove that APS user device 60a and user U received the challenge and thus was proximate beacon TPS user device 60c at the time of the timestamp.

The operations shown in process 600 of FIG. 6 are only illustrative and that existing operations may be modified or omitted, additional operations may be added, and the order of certain operations may be altered. For example, operations 604 to 612 may be transparent to user U (e.g., between being presented with screen 700q of FIG. 7Q and being presented with screen 700r of FIG. 7R). As another example, operations 604 to 616 may be transparent to user U (e.g., between being presented with screen 700q of FIG. 7Q and being presented with screen 700s of FIG. 7S). As another example, operations 618 to 624 may be transparent to user U (e.g., between being presented with screen 700t of FIG. 7T and being presented with screen 700v of FIG. 7V). As another example, operations 618 to 626 may be transparent to user U (e.g., between being presented with screen 700t of FIG. 7T and being presented with screen 700w of FIG. 7W).

In some embodiments, a TPS keypair (skₜ, pkₜ) may be generated (e.g., at operation 526 of process 500) using seed s. For example, operation 526 of process 500 may include APS user device 60a first attempting to obtain seed s (e.g., similarly to operation 616 (e.g., through at least a portion of APS authentication process 400)), and then generating the TPS keypair using that obtained seed s. Then, operation 618 of process 600 may use the seed obtained at operation 616 to regenerate at least a portion of that TPS keypair for enabling any suitable operation 620 that may be operative to enable any suitable secure operation.

In some embodiments, rather than generating an EBT B based on captured user enrollment biometrics ueb (e.g., as user enrollment biometric identifier information or user enrollment biometric information, which may be indicative of a user's physiological and/or behavioral characteristics, as captured by one or more suitable sensors of the APS user device (e.g., at operation 222), the EBT B may additionally or alternatively be generated during an APS enrollment process based on any suitable enrollment device environmental data that may be captured by any suitable sensors of the APS user device as indicative of any suitable characteristic(s) of the device environment and/or that may be provided to the APS user device from any suitable third party source. Moreover, rather than generating an ABS b based on captured user authentication biometrics uab (e.g., as user authentication biometric identifier information or user authentication biometric information, which may be indicative of a user's physiological and/or behavioral characteristics, as captured by one or more suitable sensors of the APS user device (e.g., at operation 422), the ABS b may additionally or alternatively be generated during an APS authentication process based on any suitable authentication device environmental data that may be captured by any suitable sensors of the APS user device (e.g., concurrently with any captured user authentication biometrics uab) as indicative of any suitable characteristic(s) of the device environment. Therefore, the success or failure of any evaluation of EBT B and ABS b (e.g., at operation 434) may be based on a determined closeness between the enrollment device environmental data of the EBT B and the authentication device environmental data of the ABS b (if not also on a determined closeness between the user enrollment biometrics ueb of the EBT B and the user authentication biometrics uab of the ABS b). Such environmental data may be any suitable data indicative of any suitable characteristic(s) of the environment of the APS user device, including, but not limited to, location, temperature, air quality, light quality, sound quality, altitude, data captured by wireless sensor(s), and/or the like.

### FIG. 8

FIG. 8 is a flowchart of an illustrative process 800 for authenticating a user of at least a first user electronic device and a second user electronic device using a network node. At operation 802, the network node may receive, at the network node, from the first user electronic device, at a first moment in time, communication protocol information that may include a restricted enrollment input corresponding to an unrestricted enrollment input that has been restricted by an enrollment biometric template indicative of user enrollment biometrics captured at an enrollment moment in time that is prior to the first moment in time, an unrestricted authentication input, and a transformed matching function that is operative to output a success key in response to successfully evaluating the transformed matching function using two inputs (e.g., a node j may receive ACIⱼ at operation 228 of process 200). At operation 804, the network node may receive, at the network node, from the second user electronic device, at a second moment in time after the first moment in time, a restricted authentication input corresponding to the unrestricted authentication input that has been restricted by an authentication biometric sample indicative of user authentication biometrics captured at an authentication moment in time that is after the first moment in time but that is prior to the second moment in time (e.g., a node j may receive a restricted CIT K′ⱼ at operation 434 of process 400). At operation 806, after the network node has received the restricted authentication input at operation 804, the network node may evaluate, at the network node, the transformed matching function using the restricted enrollment input and the restricted authentication input (e.g., node j may use restricted CIT K′ⱼ and restricted CIT T′ⱼ to evaluate circuit Cⱼ at operation 434 of process 400). When the evaluation of operation 806 is successful, the network node, at operation 808, may use, at the network node, the success key output by the transformed matching function to enable a secure operation (e.g., node j may use success key ckⱼ at operation 436 of process 400).

The operations shown in process 800 of FIG. 8 are only illustrative and that existing operations may be modified or omitted, additional operations may be added, and the order of certain operations may be altered.

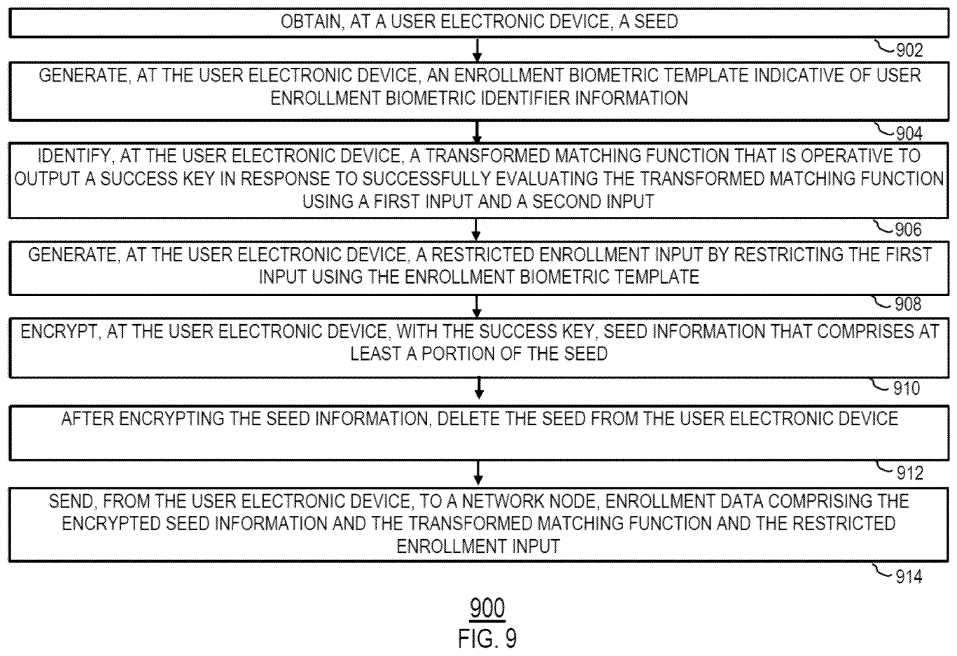

### FIG. 9

FIG. 9 is a flowchart of an illustrative process 900 for authenticating a user of a user electronic device using a network node. At operation 902, the user electronic device may obtain, at the user electronic device, a seed (e.g., device 60a may obtain seed s at operation 204 of process 200). At operation 904, the user electronic device may generate, at the user electronic device, an enrollment biometric template indicative of user enrollment biometric identifier information (e.g., device 60a may generate an EBT B at operation 222 of process 200). At operation 906, the user electronic device may identify, at the user electronic device, a transformed matching function that is operative to output a success key in response to successfully evaluating the transformed matching function using a first input and a second input (e.g., device 60a may identify a garbled circuit at operation 310 of operation 224 of process 200). At operation 908, the user electronic device may generate, at the user electronic device, a restricted enrollment input by restricting the first input using the enrollment biometric template (e.g., device 60a may make restricted CIT T′ⱼ representative of EBT B at operation 318 of operation 224 of process 200). At operation 910, the user electronic device may encrypt, at the user electronic device, with the success key, seed information that includes at least a portion of the seed (e.g., device 60a may encrypt at least a seed share with success key ckⱼ at operation 322 of operation 224 of process 200). After the encryption of operation 910, at operation 912, the user electronic device may delete the seed from the user electronic device (e.g., device 60a may delete seed s at operation 238 of process 200). At operation 914, the user electronic device may send, from the user electronic device, to the network node, enrollment data including the encrypted seed information and the transformed matching function and the restricted enrollment input (e.g., device 60a may send authentication circuit information ACIⱼ to node j at operation 226 of process 200).

The operations shown in process 900 of FIG. 9 are only illustrative and that existing operations may be modified or omitted, additional operations may be added, and the order of certain operations may be altered.

### FIG. 12

FIG. 12 is a flowchart of an illustrative process 1200 for enrolling an APS user U with the APSP using any suitable web browser of any suitable user device (e.g., any suitable web browser application 69w of any suitable user device 60 (e.g., Google Chrome, Safari, Edge, Firefox, etc.)), rather than, for example, using a dedicated APS application (e.g., of process 200). Process 1200 is shown being implemented by any such APS user device 60 with any such web browser 69w (e.g., any suitable TPS user device 60c, any suitable APS user device 60a not utilizing a dedicated APS application, etc.), its user U, any suitable biometric authentication subsystem (“BAS”) 20 (e.g., any suitable node(s) 70, repository 80, APS subsystem 100, and/or the like), any suitable third party subsystem 90 (e.g., any suitable web server that may be configured to provide web page files for a website being accessed by web browser 69w (e.g., an APSP customer server (e.g., for a bank or any other suitable user service provider)), where such an operation 1202 may use any suitable tool(s) or framework(s), including, but not limited to, OpenID Connect (“OIDC”), OAuth 2.0, Security Assertion Markup Language (“SAML”) 2.0, and/or the like (e.g., to keep federated identity safe), and any suitable fortress solution 140 (e.g., any suitable AuthService subsystem 110 (e.g., any suitable server that may be configured to verify an authorization token of the process) and any suitable KMS subsystem 120 (e.g., any suitable server that may provide any suitable key management service (e.g., a cloud service, which may not be publicly accessible))). However, process 1200 may be implemented using any other suitable components or subsystems or entities of any suitable system 1 of FIG. 1 or otherwise (e.g., node(s) 70 and repository 80 may be replaced by any suitable server(s) (e.g., APS subsystem 100)). Process 1200 may provide a seamless user experience for securely and efficiently enrolling user U with the APSP using any suitable web browser 69w of any suitable user device 60. To facilitate the following discussion regarding the operation of system 1 for enrolling user U with the APSP according to process 1200 of FIG. 12, reference is made to various components of system 1 of the schematic diagrams of FIGS. 1 to 11, and to screens 700a-700i that may be representative of a graphical user interface of user device 60 during such a process (e.g., as shown in FIGS. 7A-7I, but in an APS app rather than in a web browser (e.g., as may be shown in FIGS. 7X-7AE)). The operations described may be achieved with a wide variety of graphical elements and visual schemes. Therefore, the embodiments of FIGS. 7A-7I are not intended to be limited to the precise user interface conventions adopted herein. Rather, embodiments may include a wide variety of user interface styles. Other embodiments of enrollment, such as with an enclave subsystem (e.g., any suitable enclave subsystem 130), may be described with respect to FIG. 14.

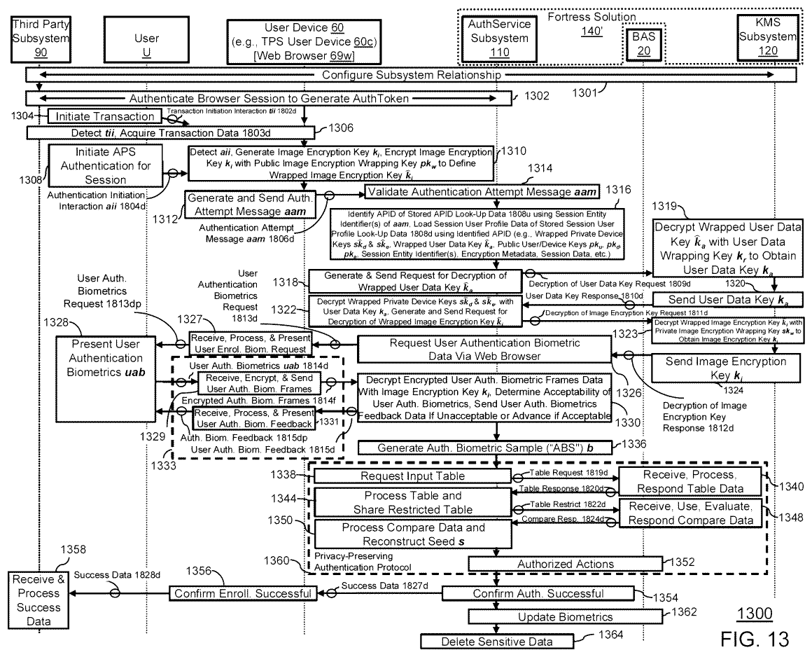

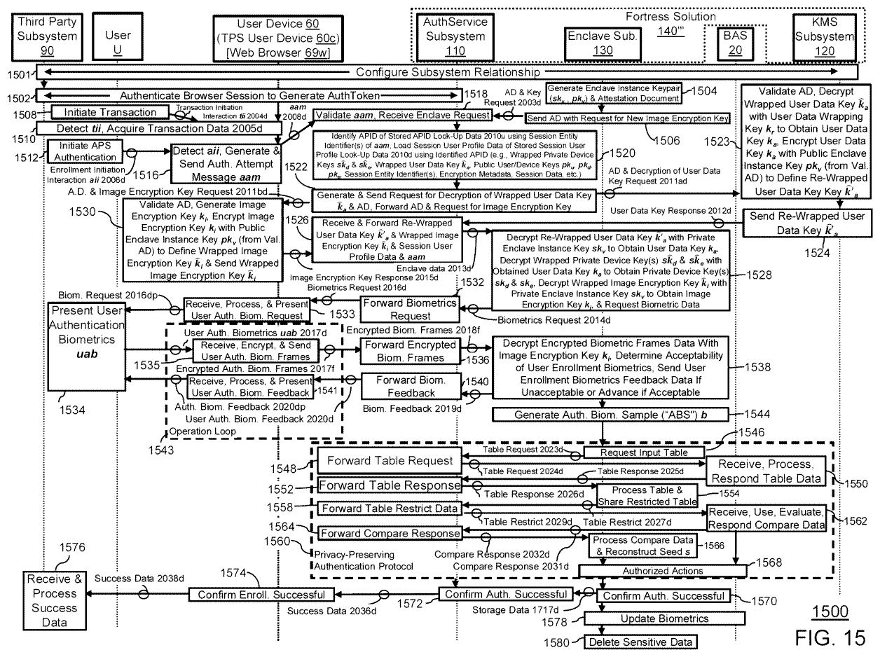

As browser limitations may prevent a full APS mobile or client SDK implementation from running directly in a web context, an APS WebSDK implementation may be configured to split the client functionality into multiple components of the WebSDK architecture, such as (1) a JavaScript SDK or WebSDK component (e.g., a lightweight component that may be configured to run directly in browser 69w as part of the customer's website (e.g., the website of an operator of third party subsystem 90), where the component may be configured to handle user interaction, camera access, initial image processing, and/or the like) and the core APS mobile or client SDK functionality component (e.g., a component that may be configured to run on a compatible AuthService subsystem 110 (see, e.g., FIGS. 12 and 13) or on some other trusted execution environment (“TEE”) (see, e.g., FIGS. 14 and 15 (e.g., where the core APS mobile or client SDK functionality may operate within any suitable enclave subsystem 130 (e.g., an AWS Nitro Enclave), which may provide hardware-level isolation and security guarantees for biometric processing))). Such an architectural split may maintain the zero-knowledge principles of an APS protocol with any suitable biometric authentication subsystem 20 while enabling browser-based enrollment and/or authentication flows using web browser 69w of any suitable device 60. Web browser 69w may be any suitable web browser that may be configured to run on any suitable device 60 to implement such an APS WebSDK, including, but not limited to, a dedicated web browser application (e.g., Chrome by Google, Chromium by Google, Safari by Apple, Edge by Microsoft, Firefox by Mozilla, etc.), any suitable web browser that may be embedded with any other suitable application (e.g., any suitable WebView), and/or the like. The APS WebSDK may lightweight and flexible enough to be configured to work with any such web browser that may be provided on any suitable device 60 (e.g., any suitable portable media device, laptop, desktop, tablet, smart phone, and/or the like that may be originally sold with a default web browser or that may be updated to load any suitable browser of a user's choosing). In some embodiments, as shown in FIGS. 12 and 13, any suitable AuthService subsystem 110 may be configured to run a more robust core APS mobile or client SDK functionality component (e.g., as any suitable application 119a (e.g., via any suitable data 119d) and/or any suitable hardware) that may work with the APS WebSDK component of browser 69w of device 60 to enable any suitable privacy-preserving protocol with any suitable BAS subsystem 20 for enrolling and/or authenticating a user of the web browser with the APSP. In some embodiments, AuthService subsystem 110 and BAS 20 may each be operated by the same entity, while, in other embodiments, BAS subsystem 120 may be operated by a first entity (e.g., a provider of the APSP (e.g., Keyless Technologies Limited of London)) that may be different than a second entity that may operate AuthService subsystem 110 (e.g., a customer of the APSP provider or (e.g., a bank or social media company) or other suitable partner or unrelated entity that may run the AuthService as a piece of software running in the cloud). In other embodiments, as shown in FIGS. 14 and 15, any suitable enclave subsystem 130 may be configured to run a more robust core APS mobile or client SDK functionality component (e.g., as any suitable application 139a (e.g., via any suitable data 139d) and/or any suitable hardware) that may work with the APS WebSDK component of browser 69w of device 60 to enable any suitable privacy-preserving protocol with any suitable BAS subsystem 20 for enrolling and/or authenticating a user of the web browser with the APSP. In some embodiments, enclave subsystem 130 and BAS 20 may each be operated by the same entity, while, in other embodiments, BAS subsystem 120 may be operated by a first entity (e.g., a provider of the APSP (e.g., Keyless Technologies Limited of London)) that may be different than a second entity that may operate enclave subsystem 130 (e.g., an APSP provider's partner or unrelated entity that may run the enclave as a piece of software running in the cloud (e.g., Amazon, AMD, Microsoft, etc.). As described with respect to FIGS. 14 and 15, enclave subsystem 130 may be trusted by web browser 69w and/or KMS subsystem 120 through any suitable attestation (e.g., any suitable remote attestation), where enclave subsystem 130 may work with any suitable web browser 69w such that system 1 may enable APS authentication to be platform-agnostic and adaptable to different trust environments, such as AWS Nitro Enclaves, Intel SGX, and other trusted execution environment technologies, which may allow for widespread adoption across various industries without vendor lock-in. Enclave subsystem 130 may be configured to provide any suitable secure enclave, whose memory cannot be accessed by the operator (e.g., the enclave may be configured to isolate all private keys, biometrics, seeds, or any other data thereon from being accessed by an operator). In such embodiments, any suitable AuthService subsystem 110 may be used to provide any suitable network communication between the web browser device 60 and enclave subsystem 130 if the enclave is not configured for such network communication on its own (e.g., AuthService subsystem 110 (e.g., as used in FIGS. 14 and 15) may be configured as a side-car for the secure enclave that may use a virtual socket to enable communications with the AuthService subsystem on a shared computer). As shown in FIGS. 12-15, any suitable KMS subsystem 120 may be configured (e.g., specifically) to protect private keys (e.g., private keys of assymetric keypairs and/or symmetric keys (e.g., key(s) kᵣ, sk_{w}, etc.)), where it may be configured such that no functionality of such keys may be exported off of KMS subsystem 120. In some embodiments, KMS subsystem 120 may be configured as any suitable hardware security module (“HSM”) that may be built and managed by any suitable entity or built by one entity and leased to or operated by another entity (e.g., as a service in the cloud), where the manufacturer and/or operator of KMS subsystem 120 may be independent of the APSP provider or may be the same entity in some embodiments.

Process 1200 may begin at operation 1201, where a subsystem relationship (e.g., between KMS subsystem 120 and AuthService subsystem 110 and/or third party subsystem 90) may be configured by the system. This subsystem relationship may be configured prior to any enrollment and/or any authentication with the APSP via a web browser. This subsystem relationship may or may not be unique to any particular third party subsystem, although such a unique relationship (e.g., for one or more portions of the configuration data) may be configured for a particular third party subsystem if desired. This subsystem relationship may be configured once for a particular AuthService subsystem 110, which may be used for all embodiments or, in some embodiments, there may be a different AuthService subsystem used for each respective continent or any other suitable arrangement. The configuring of operation 1201 may include any suitable communication(s) between KMS subsystem 120 and any of AuthService subsystem 110, third party subsystem 90, user device 60, and/or the like in order to enable the system to carry out any suitable APSP enrollment and/or authentication with any suitable web browser using any suitable website(s). A website of third party subsystem 90 may be defined by any suitable website data (e.g., any suitable website data 99dw of data 99 of subsystem 90) for presenting any suitable web page(s) to a user (e.g., via web browser 69w). As shown by diagram 1700 of FIG. 17, such a website may be configured to include any suitable website information 1702, including, but not limited to, an identifier or URL of any suitable AuthService (e.g., AuthService subsystem 110), any suitable public image encryption wrapping key pk_{w} of any suitable image encryption wrapping keypair (sk_{w}, pk_{w}), any suitable image encryption wrapping key key identifier KIDk_{w} of such image encryption wrapping key(s) k_{c} (e.g., “keyId”=“alias/kl-core-staging-remote-sdk-image-key-XYZ”), any suitable image encryption wrapping key algorithm identifier AIDk_{w} of any suitable algorithm used to generate such an image encryption wrapping keypair (e.g., “keyAlgorithm”=“RSAES-OAEP-SHA-256”), any suitable public customer transaction data signing key pk_{c} of any suitable customer transaction data signing keypair (sk_{c}, pk_{c}), any suitable customer transaction data signing key key identifier KIDk_{c} of such customer transaction data signing key(s) k_{c} (e.g., “ctdId”=“alias/kl-core-staging-remote-sdk-ctd-key-XYZ”), any suitable customer transaction data signing key algorithm identifier AIDk_{c} of any suitable algorithm used to generate such a customer transaction data signing keypair (e.g., “ctdAlgorithm”=“RSAES-OAEP-SHA-256”), any suitable user data wrapping key key identifier KIDkᵣ of any suitable user data wrapping key kᵣ, any suitable user data wrapping key algorithm identifier AIDkᵣ of any suitable algorithm used to generate user data wrapping key kᵣ (e.g., “imageAlgorithm”=“AES-GCM”), any suitable customer identifier CRID that may identify any suitable entity (e.g., bank, social media platform, etc.) of the system that may be managing the website (e.g., “customer”=“some-company”), any suitable username identifier URID that may identify any suitable user (e.g., user U) that may interface with the website (e.g., “username”=“some.user@company.eu”), any suitable transaction data TRDT that may be used (e.g., signed) after a successful APSP authentication for any suitable end use (e.g., “transactionData”=“string”), any suitable authorization token (“AuthToken”) that may be used during any suitable enrollment/authentication (e.g., “authorizationToken”=“string”), and/or the like. As shown, the website may be configured to provide any such website information 1702 to any suitable APS library 1704 when using APS library 1704 to authenticate and/or enroll a user to the APSP. APS library 1704 may include any suitable main module 1706 and any suitable web assembly module 1708. Main module 1706 may include any suitable API interface 1710 for the website, which may be configured to depend on web assembly module 1708, which may include any suitable .javascript 1712 (e.g., emscripten bridge, anti-tampering, etc.) and/or any suitable .wasm file 1714. The website may be configured to use any suitable function(s) from interface 1710 to enroll and/or authenticate users, including, but not limited to, a “load webassembly( )” function, a “create APSP auth( )” function, a “create APSP enroll( )” function, and/or the like. For example in some embodiments, APS library 1704 may be any suitable software with any suitable API 1710 such that the APSP may use such website function(s) to instruct user U via web browser 69w to enroll and/or authenticate.

At operation 1201 of process 1200, in order to configure a suitable subsystem relationship, KMS subsystem 120 may be configured to generate any suitable keys for enabling a secure APSP, including, but not limited to, any suitable image encryption wrapping keypair (sk_{w}, pk_{w}), any suitable customer transaction data signing keypair (sk_{c}, pk_{c}), any suitable user data wrapping key kᵣ, and/or the like. Image encryption wrapping keypair (sk_{w}, pk_{w}) may include private image encryption wrapping key sk_{w} and public image encryption wrapping key pk_{w}, which may be identified by any suitable image encryption wrapping key identifier KIDk_{w}, which may be defined by KMS subsystem 120. Image encryption wrapping keypair (sk_{w}, pk_{w}) may be generated by KMS subsystem 120 using any suitable algorithm(s) (e.g., a method for encrypting data using the Rivest-Shamir-Adleman (“RSA”) algorithm with Optimal Asymmetric Encryption Padding (“OAEP”) and the secure hash algorithm (“SHA”)-256 hash function), which may be identified by any suitable image encryption wrapping key algorithm identifier AIDk_{w} (e.g., any suitable “keyAlgorithm” that may be defined as any suitable string, such as “RSAES-OAEP-SHA-256”), which may be defined by KMS subsystem 120. Public image encryption wrapping key pk_{w} may be an assymetric public RSA key that may be shared outside of KMS subsystem 120 (e.g., to user device 60 (e.g., web browser 69w) (e.g., via third party subsystem 90)). Customer transaction data signing keypair (sk_{c}, pk_{c}) may include private customer transaction data signing key sk_{c} and public customer transaction data signing key pk_{c}, which may be identified by any suitable customer transaction data signing key identifier KIDk_{c}, which may be defined by KMS subsystem 120. Customer transaction data signing keypair (sk_{c}, pk_{c}) may be generated by KMS subsystem 120 using any suitable algorithm(s) (e.g., a method for encrypting data using the RSA algorithm with OAEP and the SHA-256 hash function), which may be identified by any suitable customer transaction data signing algorithm identifier AIDk_{c}, which may be defined by KMS subsystem 120. Public customer transaction data signing key pk_{c} may be an assymetric public RSA key that may be shared outside of KMS subsystem 120 (e.g., to user device 60 (e.g., web browser 69w) (e.g., via third party subsystem 90)). User data wrapping key kᵣ may be identified by any suitable user data wrapping key identifier KIDkᵣ, which may be defined by KMS subsystem 120. User data wrapping key kᵣ may be generated by KMS subsystem 120 using any suitable algorithm(s) (e.g., a symmetric encryption mode that may provide both data confidentiality (e.g., encryption) and data authenticity (e.g., ensuring data hasn't been tampered with), such as an Advanced Encryption Standard in Galois/Counter Mode (“AES-GCM”)), which may be identified by any suitable user data wrapping key algorithm identifier AIDkᵣ, which may be defined by KMS subsystem 120. Moreover, at operation 1201 of process 1200, KMS subsystem 120 may store any suitable data (e.g., as data 129dw), including, but not limited to, private image encryption wrapping key sk_{w}, public image encryption wrapping key pkᵥ, image encryption wrapping key identifier KIDk_{w}, image encryption wrapping key algorithm identifier AIDk_{w}, private customer transaction data signing key sk_{c}, public customer transaction data signing key pk_{c}, customer transaction data signing identifier KIDk_{c}, customer transaction data signing key algorithm identifier AIDk_{c}, user data wrapping key kᵣ, user data wrapping key identifier KIDkᵣ (e.g., as may be stored against or in association with user data wrapping key kᵣ), user data wrapping key algorithm identifier AIDkᵣ (e.g., as may be stored against or in association with user data wrapping key kᵣ), and/or the like. Moreover, at operation 1201 of process 1200, KMS subsystem 120 may make any suitable information accessible to third party subsystem 90 (e.g., directly or via AuthService subsystem 110 and/or BAS 20 (e.g., for storage as data 99dw)), including, but not limited to, public image encryption wrapping key pk_{w}, image encryption wrapping key identifier KIDk_{w}, image encryption wrapping key algorithm identifier AIDk_{w}, public customer transaction data signing key pk_{c}, customer transaction data signing identifier KIDk_{c}, customer transaction data signing algorithm identifier AIDk_{c}, user data wrapping key identifier KIDkᵣ, user data wrapping key algorithm identifier AIDkᵣ, and/or the like. For example, any of such information may be made accessible to third party subsystem 90 for defining a portion of website data 99dw that may be made available to browser 69w of device 60 during any suitable enrollment and/or authentication processes (e.g., public image encryption wrapping key pk_{w} may be used to define a portion of website information 1702 (e.g., public image encryption wrapping key pk_{w} may be hardcoded into an integration of APS library 1704 (e.g., when the webpage/library needs to enroll and/or authenticate, it may be configured to call the library and access code that integrates public image encryption wrapping key pk_{w}))). In some embodiments, operation 1201 may include KMS subsystem 120 receiving any suitable request for the generation of such configuration data, generating such data, sharing a portion of such data (e.g., the non-private KMS data (e.g., not key kᵣ, key sk_{w}, etc.)) with one or more suitable remote subsystems (e.g., AuthService subsystem 110, third party subsystem 90, etc.), and storing some or all of such configuration data (e.g., including the private KMS data (e.g., key kᵣ, key sk_{w}, etc.)) at KMS subsystem 120 (e.g., as data 129dw) for later use during any suitable enrollment and/or authentication process of the APSP. For example, such a generation request may be received from APS subsystem 100 or any other suitable BAS 20 or AuthService subsystem 110 that may be operated by a manager of the APSP in response to a request from any suitable customer for enabling the APSP for their users. In such embodiments, the shareable configuration data (e.g., the non-private KMS data (e.g., key kᵣ, key sk_{w}, etc.)) may be obtained by that APS-provider subsystem (e.g., from KMS subsystem 120 and/or any other suitable source(s)) and then shared with the appropriate third party subsystem(s) 90 of that customer. For example, AuthService subsystem 110 may receive and store all such shareable configuration data in association with the CRID of that data for future look-up by the AuthService (e.g., pk_{w}, KIDk_{w}, AIDk_{w}, pk_{c}, KIDk_{c}, AIDk_{c}, KIDkᵣ, AIDkᵣ, pkₙ, KIDkₙ, AIDkₙ, ENCm, CRID, URID, and/or the like) while also sharing such data with the customer. For example, some or all such configuration data that may be shared with third party subsystem 90 may also be stored against or in association with the CRID at AuthService subsystem 110 in order to identify any such configuration data in response to receiving an enrollment attempt message eam or authentication attempt message aam from that third party subsystem 90 for an enrollment/authentication session (e.g., via a device 60 running a web browser 69w running a website of that third party subsystem 90) that may include the CRID, such that any suitable configuration data may be recalled by AuthService subsystem 110 using that CRID for future use in the session (e.g., to identify a proper KIDk_{w} and/or AIDk_{w} (e.g., at operation 1220 for defining a portion of data 1710d)). Alternatively, some or all of such configuration data may be communicated to the customer (e.g., to third party subsystem 90) without storing any of such data at the AuthService at operation 1201, whereby any data that may be needed by AuthService subsystem 110 during an enrollment/authentication session may be provided to it in an enrollment attempt message eam or authentication attempt message aam from third party subsystem 90 (e.g., via a device 60 running a web browser 69w running a website of that third party subsystem 90). In some embodiments, some of such configuration data of operation 1201 may be the same for all third party subsystems, or some or all of such configuration data of operation 1201 may be unique for a particular customer (e.g., beyond the CRID, such as pk_{w}, KIDk_{w}, and AIDk_{w}). However, beyond such subsystem configuration data, there may be any suitable AuthToken configuration data generated and appropriately shared between AuthService subsystem 110 and third party subsystem 90 at operation 1201 that may be unique to a particular third party subsystem 90 (e.g., using CRID or otherwise as a look-up) and to AuthService subsystem 110 for enabling third party subsystem 90 to generate any suitable AuthToken (e.g., at operation 1202) that may be validated by AuthService subsystem 110 (e.g., at operation 1210) for any suitable browser session. Such an AuthToken may be generated such that the AuthService may trust the browser of the session in order to proceed with APS enrollment or APS authentication for the trusted browser session. In such embodiments, AuthService subsystem 110 may be configured to function as a passive participant by providing some configuration into how the AuthToken ought to be defined and such an AuthToken service may be enabled using any suitable tool(s) or framework(s), including, but not limited to, OpenID Connect (“OIDC”), OAuth 2.0, Security Assertion Markup Language (“SAML”) 2.0, and/or the like (e.g., to keep federated identity safe), where third party subsystem 90 may have any suitable connection to AuthService subsystem 110 (e.g., third party subsystem 90 may have some hard coded URL from AuthService subsystem 110 (e.g., as a portion of any suitable website information 1702 of a website of the third party (e.g., as may be defined at operation 1201)))).

After operation 1201, process 1200 may include an operation 1202 where the system may be configured to attempt to authenticate any suitable browser scenario or session (e.g., any suitable browser scenario or browser session between a user U of any suitable user device 60 using any suitable web browser 69w to access any suitable website of any suitable third party subsystem 90 of the system) and generate any suitable AuthToken (e.g., an OAuth 2.0 token) if the authentication is successful. In some embodiments, operation 1202 may occur at any suitable time prior to operation 1210 (e.g., after operation 1204 and/or operation 1206), such that any suitable attempt message (e.g., eam of data 1704d) may include the AuthToken of operation 1202. In some embodiments, such a scenario or session may be authenticated at operation 1202 by identifying any suitable authentication cookie that may be stored in the web browser of the session, where such an authentication cookie may be generated and stored once the session has been authenticated through some other technique. Such another technique for authenticating the browser session at operation 1202 may include authenticating the user of the session through any suitable methods (e.g., non-APSP biometric methods), such as authenticating the user through conducting a successful user log-in to an existing user account of the third party subsystem (e.g., third party subsystem 90 collecting log-in credentials (e.g., user name and password) from user U via device 60 and processing such log-in credentials to verify whether or not the log-in credentials are for an existing account (e.g., using a screen that may be similar to screen 700j of FIG. 7J)) or any other suitable know-your-customer (“KYC”) check, credit card on device check, and/or the like. Once the browser session is authenticated by the browser and third party subsystem, operation 1202 may continue by generating any suitable AuthToken for the session. Such an AuthToken for an authenticated browser session may be generated by third party subsystem 90 and provided to web browser 69w (e.g., as a portion of any suitable website information 1702 of a website of the third party). For example, AuthService subsystem 110 may be configured to define the type of AuthToken to be generated (e.g., the syntax, format, composition, etc.), while third party subsystem 90 and web browser 69w of device 60 may work with user U to generate the AuthToken for the authenticated session. The AuthToken of the session generated at operation 1202 may later be used during any suitable enrollment and/or authentication of the APSP using the browser session to prove to AuthService subsystem 110 that the user and/or user device of the browser session has been authenticated in some way by third party subsystem 90 before AuthService subsystem 110 may be enabled to continue with such an enrollment and/or authentication of the APSP using the browser session. Therefore, during operation 1202, AuthService subsystem 110 may be configured to function as a passive participant by providing some configuration into how the AuthToken ought to be defined (e.g., depending on method used, may allow the user to authenticate a browser session against one party (e.g., third party subsystem (e.g., not authenticated using biometric APS factor(s))) but prove authentication of such a browser session to another party (e.g., Auth Service subsystem)), where such an operation 1202 may use any suitable tool(s) or framework(s), including, but not limited to, OpenID Connect (“OIDC”), OAuth 2.0, Security Assertion Markup Language (“SAML”) 2.0, and/or the like (e.g., to keep federated identity safe), where third party subsystem 90 may have any suitable connection to AuthService subsystem 110 (e.g., third party subsystem 90 may have some hard coded URL from AuthService subsystem 110 (e.g., as a portion of any suitable website information 1702 of a website of the third party (e.g., as may be defined at operation 1201)))). The AuthToken may include any suitable information, including, but not limited to, a user name (e.g., username identifier URID) for the user of the authenticated browser session, a customer name (e.g., customer identifier CRID may be included in and/or associated with the AuthToken)) for the customer (e.g., third party) of the authenticated browser session, an expiration time for the AuthToken (if any), an audience (e.g., audience identifier that may indicate that the AuthToken was issued for AuthService subsystem 110 and not for a different purpose), and/or the like (e.g., pursuant to any suitable JSON Web Token (“JWT”) standard (see, e.g., RFC 7519)). APS library 1704 might not be updated with such an AuthToken as the AuthToken might change every session, but APS library 1704 may be configured to receive an AuthToken when needed. Once an AuthToken has been generated for a successfully authenticated browser session at operation 1202 (e.g., once the AuthToken has been generated by third party subsystem 90 and provided to device 60 (e.g., to web browser 69w)), process 1200 may be enabled to attempt to carry out the remainder of an enrollment process (e.g., operation 1204 through operation 1250) for that browser session (e.g., by presenting an “ENROLL” option for user U via web browser 69w of the session (e.g., using a screen similar to screen 700a of FIG. 7A)).

After a browser session has been authenticated and an AuthToken generated at operation 1202, process 1200 may include operations 1204 and 1206, where the system may be configured to enable a user of the session to initiate APSP enrollment. For example, at operation 1204, user U may initiate APSP enrollment for the browser session by carrying out any suitable enrollment initiation interaction eii 1702d with web browser 69w that may be presenting any suitable APS website on user device 60. For example, similarly to as shown by screen 700a of FIG. 7A, the UI of user device 60 may present an “ENROLL” option for user U to select with its enrollment initiation interaction eii in order to proceed with process 1200 for enrolling with the APSP. In advance of operation 1202, the third party website may be accessed by web browser 69w on user device 60 or otherwise (e.g., using any other suitable device) in any suitable manner and user U may carry out any suitable account set-up operations with respect to the website (e.g., creating an account, logging-in, etc.), although any set-up operations not shown may or may not be required.

At operation 1206, user device 60 may detect such an enrollment initiation interaction eii and, in response to such detection, user device 60 may generate any suitable (e.g., random) image encryption key ki (e.g., any suitable random data that may be generated by browser 69w, where the length of the random key may depend on the length of public image encryption wrapping key pk_{w} (e.g., 16 bytes or otherwise)) and then encrypt or wrap or that image encryption key ki with public image encryption wrapping key pk_{w} (e.g., as made available at operation 1201) to define wrapped image encryption key \hat{k}ᵢ (e.g., \hat{k}ᵢ=Epk_{w} (kᵢ)). This may enable device 60 to securely communicate wrapped image encryption key \hat{k}ᵢ remotely to AuthService subsystem 110 while also enabling AuthService subsystem 110 to later use that encrypted image encryption key \hat{k}ᵢ for accessing clean image encryption key kᵢ through communication with KMS subsystem 120 (e.g., through KMS subsystem 120 using private image encryption wrapping key sk_{w} (e.g., as generated at operation 1201)), such that AuthService subsystem 120 may use that image encryption key kᵢ to securely receive and process (e.g., at operation 1228) biometric data from user device 60 that may be encrypted with that image encryption key kᵢ by device 60 (e.g., at operation 1227). APS library 1704 may be used as part of the third party (e.g., APS customer) website being presented to user U via web browser 69w, which may include an “ENROLL” button (e.g., using a screen that may be similar to screen 700a of FIG. 7A). When that button may be selected (e.g., at operation 1204), the website may be configured to use a “create APSP enroll( )” function from interface 1710 to enroll user U using public image encryption wrapping key pk_{w} (e.g., the website may ask the APS library to enroll the user, such that it may provide the public image encryption wrapping key pk_{w} to the APS library (e.g., the customer website may provide public image encryption wrapping key pk_{w} along with any suitable instruction(s) to the library to enroll the user)). Public image encryption wrapping key pk_{w} may be configured (e.g., during operation 1201) to differ per any suitable environment (e.g., continent) or could be customer specific (e.g., third party subsystem specific), but, in some embodiments, the APS library may be configured to be consistent worldwide all the time so it may or may not include public image encryption wrapping key pk_{w}. Web browser 69w of user device 60 may include the APS library inside as the website hosts the library.

At operation 1208, user device 60 (e.g., web browser 69w) may be configured to generate and send any suitable enrollment attempt message eam (e.g., as data 1704d) to AuthService subsystem 110 (e.g., using any suitable communication channel(s) and/or any suitable communication protocol(s)), such as by using the URL of the AuthService that may be included in website information 1702 (e.g., as may be defined at operation 1201 or otherwise). Enrollment attempt message eam may be configured to include any suitable data, including, but not limited to, any suitable enrollment initiation information, any suitable image encryption and wrapping information, any suitable information that may be used for “authorized actions” after successful enrollment, and/or the like. For example, enrollment attempt message eam may include any suitable enrollment initiation information, including, but not limited to, an “event” field that may be defined by some attempt identifier (e.g., “Attempt”), a “sessionType” field that may be defined by some enrollment identifier (e.g., “ENROLLMENT”), a “customer” field that may be defined by some identifier (e.g., CRID) of the customer of the session (e.g., “some-company” (e.g., “CITIBANK” or “FACEBOOK” or “B'GOCK” or “ABC_CUSTOMER” or the like)), a “username” field that may be defined by some identifier (e.g., URID) of the end user (e.g., some.user@company.eu (e.g., “john.doe@doemail.com” or the like)), an “authorizationToken” field that may be defined by some string (e.g., the AuthToken generated at operation 1202), and/or the like. Additionally or alternatively, enrollment attempt message eam may include any suitable subsystem configuration data (e.g., from operation 1201), such as any suitable image encryption and wrapping information, including, but not limited to, key pk_{w}, a “keyId” field that may be defined by some key identifier (e.g., KIDk_{w}) for image encryption wrapping key(s) k_{w} of operation 1201 (e.g., “alias/kl-core-staging-remote-sdk-image-key”), a “keyAlgorithm” field that may be defined by some algorithm identifier (e.g., AIDk_{w}) for the algorithm used (e.g., at operation 1201) to generate the image encryption wrapping keypair (sk_{w}, pk_{w}) (e.g., “RSAES-OAEP-SHA-256”), key pk_{c}, a “ctdId” field that may be defined by some key identifier (e.g., KIDk_{c}) for customer transaction data signing key(s) k_{c} of operation 1201, a “ctdAlgorithm” field that may be defined by some algorithm identifier (e.g., AIDk_{c}) for the algorithm used (e.g., at operation 1201) to generate the customer transaction data signing keypair (sk_{c}, pk_{c}), an “imageKey” field that may be defined by (e.g., the string for) wrapped image encryption key \hat{k}ᵢ (e.g., as defined at operation 1206), an “imageAlgorithm” field that may be defined by some algorithm identifier (e.g., AIDkᵣ) for the algorithm used (e.g., at operation 1201) to generate user data wrapping key kᵣ (e.g., “AES-GCM”), an “imageId” field that may be defined by some key identifier (e.g., KIDkᵣ) for user data wrapping key kᵣ of operation 1201 (e.g., “alias/kl-core-data-key”), and/or the like. In other embodiments, some or all of such subsystem configuration data of operation 1201 may be already accessible to AuthService subsystem 110 (e.g., in any suitable data 119d that may have been stored at operation 1201 and may be recalled by the AuthService using any suitable CRID of eam data 1704d). Additionally or alternatively, enrollment attempt message eam may include any suitable information that may be used for “authorized actions” after successful enrollment, including, but not limited to, a “transactionData” field that may be defined by some string (e.g., TRDT) or other suitable data (e.g., a “string” that may be provided by third party subsystem 90 (e.g., at operation 1202 or otherwise of process 1200 (e.g., via web browser 69w)) and that may be signed after successful enrollment, where, in some embodiments, such transaction data TRDT may be defined by third party subsystem 90 (e.g., at operation 1201 or afterwards (e.g., similarly to operation 1306 of process 1200)), a “seedEntropy” field that may be defined as either true or false (e.g., if true, the APS can request to receive a user-related cryptographic key generated from a seed after successful enrollment and/or authentication), and/or the like. In some embodiments, at operation 1208, user device 60 may be configured to store or at least keep available during the enrollment session of process 1200 any suitable data and/or delete any suitable data. For example, user device 60 may store image encryption key kᵢ at operation 1208 (e.g., as any suitable data 69dw) such that image encryption key kᵢ may be utilized by device 60 at future operation(s) (e.g., at operation 1227 (e.g., such that device 60 may collect user biometrics and encrypt those biometrics for transmission to AuthService subsystem 110 without the biometrics being accessible by an entity that is unable to access private image encryption wrapping key sk_{w}, which AuthService subsystem 110 may be enabled to do by establishing trust with KMS subsystem 120)). In some embodiments, operation 1202 may be carried out after operation 1204 (e.g., after eii 1702d may be received by device 60) but prior to the completion of operation 1208, which may rely on the AuthToken of operation 1202.

At operation 1210, AuthService subsystem 110 may be configured to receive and attempt to validate any suitable portion(s) of enrollment attempt message eam in any suitable manner, such as directly from user electronic device 60 or via third party subsystem 90 (e.g., if/when AuthService subsystem 110 may be configured to act as an IDV bridge). If sent from subsystem 90 and not any user device 60, any suitable portion of the message may be used to identify an appropriate device 60 or any suitable QR code or NFC chip or the like may be used to identify the user device to the process. In some embodiments, operation 1210 may include attempting to validate any suitable enrollment initiation information of the received enrollment attempt message eam, including, but not limited to, an “authorizationToken” (AuthToken), “username” (URID), “customer” (CRID), and/or the like. AuthService subsystem 110 may be configured to attempt to validate the AuthToken using any suitable AuthToken configuration data of operation 1201 and/or otherwise for validating the AuthToken according to any appropriate tool(s) or framework(s), including, but not limited to, OIDC, OAuth 2.0, SAML 2.0, and/or the like. If validation fails, process 1200 may end or the AuthService may instruct the web browser to try again due to failure of the AuthToken.

At operation 1214, if the received enrollment attempt message eam has been appropriately validated at operation 1210, AuthService subsystem 110 may be configured to generate and send any suitable request for a new user data key (e.g., as user data key request data 1707d) to KMS subsystem 120 (e.g., using any suitable communication channel(s) and/or any suitable communication protocol(s)) (e.g., configuration data of operation 1201 may include data available to AuthService subsystem 110 indicating the address of KMS subsystem 120). Such a new user data key request may include any suitable information that may be available to AuthService subsystem 110 and useful to KMS subsystem 120 for fulfilling the request. For example, this new user data key request may include any suitable request data that may be used by KMS subsystem 120 to understand the type of data being requested (e.g., a new user data key) and any other suitable data that may be useful to KMS subsystem 120 (e.g., to instill some trust in the request), such as a key identifier (e.g., KIDkᵣ) of user data wrapping key kᵣ (e.g., as may be known to KMS subsystem 120 from operation 1201 and as may be known to AuthService subsystem 110 from received enrollment attempt message eam and/or otherwise (e.g., operation 1201)) and/or an algorithm identifier (e.g., AIDkᵣ) of the algorithm used to generate user data wrapping key kᵣ (e.g., as may be known to KMS subsystem 120 from operation 1201 and as may be known to AuthService subsystem 110 from received enrollment attempt message eam and/or otherwise (e.g., operation 1201)).

At operation 1215, KMS subsystem 120 may be configured to receive and attempt to execute the request for a new user data key (e.g., the request of data 1707d from AuthService subsystem 110). This may include KMS subsystem 120 receiving and processing data 1707d to identify the type of request being made and at least key identifier (e.g., KIDkᵣ) of user data wrapping key kᵣ, which may be known to KMS subsystem 120 from operation 1201 and stored at KMS subsystem 120 against or in association with user data wrapping key kᵣ, such that KMS subsystem 120 may access user data wrapping key kᵣ (e.g., from data 129dw as stored at operation 1201) using the key identifier (e.g., KIDkᵣ) of request data 1707d and may similarly access the algorithm identifier (e.g., AIDkᵣ) from such storage and/or from request data 1707d. Next, KMS subsystem 120 may generate any suitable new user data key kₐ (e.g., a core database key, which may be unique the current browser session) using any suitable algorithm(s) (e.g., a symmetric encryption mode that may provide both data confidentiality (e.g., encryption) and data authenticity (e.g., ensuring data hasn't been tampered with), such as an Advanced Encryption Standard in Galois/Counter Mode (“AES-GCM”)). Next, KMS subsystem 120 may encrypt this user data key kₐ with the accessed user data wrapping key kᵣ (e.g., as identified by key identifier KIDkᵣ, such as by using the algorithm identified by algorithm identifier AIDkᵣ) to define wrapped user data key \hat{k}ₐ (e.g., \hat{k}ₐ=Ekᵣ (kₐ)).

Then, at operation 1216, KMS subsystem 120 may be configured to send both unwrapped user data key kₐ and wrapped user data key \hat{k}ₐ (e.g., as generated at operation 1215) as user data key response data 1708d back to AuthService subsystem 110 (e.g., using any suitable communication channel(s) and/or any suitable communication protocol(s)). Any other suitable operations may be carried out by KMS subsystem 120 at operation 1216.

At operation 1218, AuthService subsystem 110 may generate and/or store any suitable data, which may include carrying out any suitable actions for generating any suitable data for enabling enrollment and/or later authentication, where at least some of this data may be stored (e.g., as any suitable session user profile data 1709d) for later retrieval during an authentication session. For example, at operation 1218, AuthService subsystem 110 may generate or obtain any suitable secret value or seed s in any suitable manner (e.g., as described at operation 204), such as by using any suitable AuthService application(s). Additionally, at operation 1218, AuthService subsystem 110 may then derive or otherwise generate or obtain, such as by using any suitable AuthService application(s), one or more suitable keys and/or one or more suitable keypairs in any suitable manner (e.g., as described at operation 206) including, but not limited to, a user (e.g., user signing) keypair (private user key skᵤ, public user key pkᵤ) (e.g., a user biometric keypair (e.g., which may be unique per user U), which may be generated or otherwise derived using seed s), a random device signing keypair (private device signing key sk_{d}, public device signing key pk_{d}) (e.g., which may be unique per device 60), a random device encryption keypair (private device encryption key skₑ, public device encryption key pkₑ) (e.g., which may be unique per user U), and/or the like. Additionally, at operation 1218, AuthService subsystem 110 may then encrypt one or more of the generated private device keys (e.g., private device signing key sk_{d}, private device encryption key skₑ, etc.) with unwrapped user data key kₐ as provided from KMS subsystem 120 by received data 1708d. For example, this may result in defining wrapped private device signing key s\hat{k}_{d} (e.g., s\hat{k}_{d}=Ekₐ (sk_{d})), wrapped private device encryption key s\hat{k}ₑ (e.g., s\vec{k}ₑ=Ekₐ (skₑ)), and/or the like. Additionally, at operation 1218, AuthService subsystem 110 may then generate any suitable unique authentication process identifier APID (e.g., any suitable number or string of any suitable format (e.g., a random string or any sequentially generated ID, etc.) or the APID may be the URID (e.g., if no CRID and the user is attempting to authenticate themself with an APSP that may only have a single customer or no customer and thus no need for a CRID)) for the current enrollment session and store that APID against or in association with or otherwise using any suitable session entity identifier(s) of the current enrollment session (e.g., CRID, URID, etc.) that may be made accessible to AuthService subsystem 110 via enrollment attempt message eam as received and validated at operation 1210 (e.g., AuthService subsystem 110 may store such an APID against such entity identifier(s) as a portion of any suitable data 119dw that may be stored locally on AuthService subsystem 110 or that may be stored remotely from but accessible to AuthService subsystem 110 (e.g., as any suitable portion of any suitable APID look-up data (e.g., APID look-up data 1709u))). In other embodiments, the APID may be the URID and the URID may be used as the APID. Therefore, such session entity identifier(s) (e.g., the combination of a URID and CRID, or the URID itself) of APID look-up data 1709u may be used as a look-up tool or other suitable link for accessing the APID of the APID look-up data 1709u of a particular enrollment session (e.g., the enrollment session of enrollment process 1200) at some later time (e.g., during a future authentication session (e.g., at operation 1316 of an authentication process 1300)). Additionally, at operation 1218, AuthService subsystem 110 may generate any suitable session user profile data for the current enrollment session (e.g., any data of the current enrollment session that may be useful for a future authentication session) and store that session user profile data against the APID (e.g., AuthService subsystem 110 may store such session user profile data against the APID of the session (e.g., the APID generated at operation 1218) as a portion of any suitable data 119dw that may be stored locally on AuthService subsystem 110 or that may be stored remotely from but accessible to AuthService subsystem 110 (e.g., as any suitable portion of any suitable session user profile data look-up data (e.g., session user profile data look-up data 1709d))). Therefore, the APID of session user profile data look-up data 1709d may be used as a look-up tool or other suitable link for accessing the session user profile data of the session user profile data look-up data 1709d of a particular enrollment session (e.g., the enrollment session of enrollment process 1200) at some later time (e.g., during a future authentication session (e.g., at operation 1316 of an authentication process 1300)). Such session user profile data of the session user profile data look-up data 1709d may include any suitable data, including, but not limited to, one, some, or each wrapped private device keys (e.g., key s\hat{k}_{d}, key s\hat{k}ₑ, and/or the like) as may be generated at operation 12019, wrapped user data key \hat{k}ₐ as may be received from data 1708d, Public User/Device Keys (e.g., pkᵤ, pk_{d}, pkₑ, etc.) as may be defined at operation 1201, any suitable session entity identifier(s) (e.g., URID, CRID, etc.) as may be provided via enrollment attempt message eam at operation 1210, any suitable encryption metadata (e.g., any suitable subsystem relationship data (e.g., pk_{w}, pk_{c}, AIDk_{w}, KIDk_{w}, AIDk_{c}, KIDk_{c}, KIDkᵣ, AIDkᵣ, etc.)) that may be defined at operation 1201 and that may be made accessible to AuthService subsystem 110 at operation 1201 and/or via enrollment attempt message eam at operation 1210 (e.g., AIDkᵣ, and/or KIDkᵣ may be included in such session user profile data in order to be used during a later authentication session (e.g., of process 1300) to recall key kᵣ for decrypting wrapped user data key \hat{k}ₐ), any other suitable session data (e.g., a “current_pipeline_id” field that may be defined by any suitable identifier of a biometric pipeline to be used in the session), and/or the like. Such a biometric pipeline identifier of the session user profile data of operation 1218 may include any suitable data indicative of any suitable model(s) of any suitable neural network(s) that will be used to generate an enrollment biometric template (“EBT”) B during this session (e.g., at operation 1232 of enrollment process 1200), such that the identifier may be later recalled (e.g., during an appropriate authentication session) in order to use the same model(s) for generating an authentication biometric sample (“ABS”) b (e.g., at operation 1336 of authentication process 1300). Therefore, even when a system may be adjusted to support additional models, such a biometric pipeline identifier of the session user profile data may be used to ensure that the same model(s) are used for both generating an EBT B during enrollment of a customer's user and an ABS b during authentication of the customer's user. Therefore, after operation 1218 of an enrollment process (e.g., during a later authentication process 1300 (e.g., at operation 1316)), such a unique user identifier APID may be identified when using any suitable session entity identifier(s) (e.g., URID, CRID, and/or the like) of appropriate APID look-up data 1709u of operation 1218 and then that identified APID may be used as a look-up tool or other suitable link for accessing all other such session user profile data of session user profile look-up data 1709d of operation 1218. It is to be understood that, in some embodiments, a URID may be the identifier the user may use to log-in to an account with the customer (e.g., e-mail address, user name, social security number, etc.), while in other embodiments the URID may be a unique identifier that may be provided by the customer that uniquely identifies the user to the customer but that on its own may not provide any user identifying information to AuthService subsystem 110 or otherwise. Two or more services may share the same user base may enable enrollment of a user during use of a first service be useful for later authenticating the user for not only the first service but also one or more other services, whereby the two or more services may maintain their own internal documentation of URIDs and CRIDs, such that the URID/CRID combination that may be provided to AuthService subsystem 110 in an enrollment attempt message may cover any combination of a particular user with those various services (e.g., for when a particular user “John Doe” with a URID “JohnDoe@doemail.com” interfacing with a first branch of a national bank or a second branch of a national bank, where the national bank may configure each branch to issue the same CRID when enrolling users, so enrollment of the particular user when interfacing with a first third party subsystem 90 for the first branch may provide the same URID/CRID combination as would enrollment of the same particular user when interfacing with a second third party subsystem 90 for the second branch, such that either enrollment may enable look-up of the same data 1709u/1709d).

At operation 1220 (e.g., once the session user profile data has been stored with a unique user identifier APID for the current session at operation 1218), AuthService subsystem 110 may be configured to generate and send any suitable request for the decryption of wrapped image encryption key \hat{k}ᵢ (e.g., as decryption of image encryption key request data 1710d) to KMS subsystem 120 (e.g., using any suitable communication channel(s) and/or any suitable communication protocol(s)). Such a decryption of image encryption key request may include any suitable information that may be available to AuthService subsystem 110 and useful to KMS subsystem 120 for fulfilling the request. For example, this decryption of image encryption key request may include any suitable request data that may be used by KMS subsystem 120 to understand the type of data being requested (e.g., the decryption of wrapped image encryption key \hat{k}ᵢ) and any other suitable data that may be useful to KMS subsystem 120 (e.g., to gain some trust in the request and/or to enable the request), such as wrapped image encryption key \hat{k}ᵢ (e.g., as may be known to AuthService subsystem 110 from enrollment attempt message eam of operation 1210 and/or the session user profile data of operation 1218), a key identifier (e.g., KIDk_{w}) of image encryption wrapping key(s) k_{w} (e.g., as may be known to KMS subsystem 120 from operation 1201 and as may be known to AuthService subsystem 110 from received enrollment attempt message eam and/or otherwise (e.g., operation 1201)), and/or an algorithm identifier (e.g., AIDk_{w}) of the algorithm used to generate the image encryption wrapping keypair (sk_{w}, pk_{w}) (e.g., as may be known to KMS subsystem 120 from operation 1201 and as may be known to AuthService subsystem 110 from received enrollment attempt message eam and/or otherwise (e.g., operation 1201)).

At operation 1221, KMS subsystem 120 may be configured to receive and attempt to execute the request for decryption of image encryption key (e.g., the request of data 1710d from AuthService subsystem 110). This may include KMS subsystem 120 receiving and processing data 1710d to identify the type of request being made, to identify wrapped image encryption key \hat{k}ᵢ, and to identify at least key identifier (e.g., KIDk_{w}) of image encryption wrapping key(s) k_{w}, which may be known to KMS subsystem 120 from operation 1201 and stored at KMS subsystem 120 against or in association with image encryption wrapping key(s) k_{w} (e.g., private image encryption wrapping key sk_{w}), such that KMS subsystem 120 may access private image encryption wrapping key sk_{w} (e.g., from data 129dw as stored at operation 1201) using the key identifier (e.g., KIDk_{w}) of request data 1710d and may similarly access the algorithm identifier (e.g., AIDk_{w}) from such storage and/or from request data 1710d. Next, KMS subsystem 120 may decrypt this wrapped image encryption key kᵢ with the accessed private image encryption wrapping key sk_{w} (e.g., as identified by key identifier KIDk_{w}, such as by using the algorithm identified by algorithm identifier AIDk_{w}) to obtain unwrapped image encryption key kᵢ.

Then, at operation 1222, KMS subsystem 120 may be configured to send such an unwrapped image encryption key kᵢ (e.g., as obtained at operation 1221) as decryption of image encryption key response data 1711d to be returned to AuthService subsystem 110 (e.g., using any suitable communication channel(s) and/or any suitable communication protocol(s)). Any other suitable operations may be carried out by KMS subsystem 120 at operation 1222.

Then, at operation 1224, once AuthService subsystem 110 may have received unwrapped image encryption key kᵢ from KMS subsystem 120 (e.g., as at least a portion of data 1711d) or otherwise, AuthService subsystem 110 may be configured to request user enrollment biometric data from user U via web browser 69w of device 60 by generating and sending any suitable user enrollment biometrics request data 1712d to device 60 (e.g., using any suitable communication channel(s) and/or any suitable communication protocol(s)).

Then, at operation 1225, user device 60 may be configured to receive and process such user enrollment biometrics request data 1712d to generate any suitable user enrollment biometrics request data 1712dp that may be presented to user U via any suitable device user interface using web browser 69w or otherwise, whereby device 60 may be enabled to capture at operation 1227 any suitable user enrollment biometrics ueb that may be presented by user U at operation 1226 as user enrollment biometrics ueb data 1713d. However, rather than user device 60 capturing such user enrollment biometrics ueb data and then processing such data for generating an EBT B on device 60, device 60 may capture (e.g., using any suitable sensor(s) 65) one or more frames of image data (e.g., during user presentation of user enrollment biometrics ueb) and any associated sensor data or fast data (e.g., any suitable environment data and/or motion data) that may be acquired by device 60 in between two or more image data frames, and then encrypt such data with image encryption key kᵢ (e.g., as generated by device 60 at operation 1206), and then send such encrypted enrollment biometric frame data 1713f to AuthService subsystem 110 at operation 1227 (e.g., using any suitable communication channel(s) and/or any suitable communication protocol(s)) for generating an EBT B. Device 60 may be configured define a particular instance of data 1713f for a particular moment in time to include not only image data for an image that may capture ueb at that particular moment in time but also any suitable other sensor data (e.g., environment data, motion data, etc.) that may have been collected by device 60 from after the moment in time of the previous instance of data 1713f to the moment in time of this particular instance of data 1713f (e.g., such that device 60 may share a combination of particular image data and associated movement data (e.g., as encrypted by image encryption key kᵢ) with AuthService subsystem 110 for further processing. Any suitable data packaging module for combining any suitable image data and associated movement data (e.g., environment data and/or motion data) into any suitable user enrollment biometric data package(s) (e.g., as may be described in co-pending, commonly-assigned U.S. patent application Ser. No. 19/217,833, which is hereby incorporated by reference herein in its entirety) may be provided by AuthService subsystem 110 for generating any suitable user enrollment biometric data package(s) based on data 1713f (e.g., as decrypted by image encryption key kᵢ) prior to processing such package(s) with any suitable attack detector (e.g., as may be described in co-pending, commonly-assigned U.S. patent application Ser. No. 19/217,833, which is hereby incorporated by reference herein in its entirety).

Then, at operation 1228, AuthService subsystem 110 may receive any suitable encrypted enrollment biometric frame data 1713f from device 60, decrypt such data using image encryption key kᵢ (e.g., as obtained from data 1711d), and then process such decrypted enrollment biometric frame data to determine if the user enrollment biometrics are acceptable (e.g., determined to be genuine) or not acceptable (e.g., determined to be a spoof or indeterminable or the like) using any suitable attack detector (e.g., as may be described in co-pending, commonly-assigned U.S. patent application Ser. No. 19/217,833, which is hereby incorporated by reference herein in its entirety). If determined not to be acceptable, AuthService subsystem 110 may request new user enrollment biometric data from user U via web browser 69w of device 60 by generating and sending any suitable user enrollment biometrics feedback data 1714d to device 60 (e.g., using any suitable communication channel(s) and/or any suitable communication protocol(s)). Then, at operation 1229, user device 60 may be configured to receive and process such user enrollment biometrics feedback data 1714d to generate any suitable user enrollment biometrics feedback data 1714dp that may be presented to user U via any suitable device user interface using web browser 69w or otherwise, whereby device 60 may be enabled to capture at another iteration of operation 1227 any suitable additional user enrollment biometrics ueb that may be presented by user U at operation 1226 as additional user enrollment biometrics ueb data 1713d, where such operations 1226, 1227, 1228, and 1229 may together form any suitable operation loop 1230. Operation loop 1230 may be repeated any suitable number of times until AuthService subsystem 110 determines at an instance of operation 1228 that the user enrollment biometrics of the most recently processed decrypted enrollment biometric frame data are acceptable (e.g., determined to be genuine), at which point process 1200 may advance from operation 1228 out of operation loop 1230 to operation 1232, where AuthService subsystem 110 may generate an enrollment biometric template (“EBT”) B based on such acceptable user enrollment biometrics.

User device 60 may be configured to capture such enrollment biometrics ueb as at least a portion of data 1713d for generating data 1713f that may be appropriately processed by AuthService subsystem 110 for determining whether acceptable for use in generating an EBT B (e.g., according to web browser 69w and/or any other suitable application(s) that may be running on device 60 (e.g., different users may use different biometrics, different devices may use different sensors, different types of data may be captured in addition to biometrics (e.g., device environment data, device motion data, etc.), and/or the set of characteristics and associated actions themselves may change from one enrollment to the next, etc.)). For example, similarly to as shown by screen 700b of FIG. 7B, the UI of device 60 may optionally present a user approval request for accessing any suitable sensor(s) or other device components (e.g., a camera of device 60) for capturing user biometrics, a request which the user may accept or deny. If accepted or automatically allowed, the UI of APS device 60 may present instructions on how the user ought to present user enrollment biometrics ueb to user device 60 for capture. For example, similarly to as shown by one or more of screens 700c-700e of FIGS. 7C-7E, while the user's face (not shown) may be in the line of sight of a device camera sensor, device 60 may instruct the user to look left, then eventually look straight at the camera, and then eventually look right. This may enable device 60 to capture user enrollment biometrics ueb in the form of a video or photograph sequence of the user's face rotating. This may enable “liveness” detection of the user (e.g., as may instructing the user to carry out any other suitable action while biometrics are captured (e.g., winking with one eye then with the other eye, or smiling then frowning, or saying a word or phrase, etc.) and/or adjusting one or more functionalities of the device (e.g., increasing an ambient light source of the device, etc.)). This presentation and/or feedback may help prevent spoofing and/or capturing biometrics of an unwilling user.

In some embodiments, operation loop 1230 may achieve improved efficiency if user device 60 (e.g., web browser 69w) is configured to conduct any suitable biometric acceptability determinations by processing data 1713d on board device 60 and immediately provide certain feedback to user U (e.g., as data 1714dp) without requiring such biometric acceptability determinations to be handled by AuthService subsystem 110 (e.g., at one or more instances of operation 1228). For example, device 60 may be configured to make certain acceptability determinations and provide certain appropriate feedback on its own (e.g., face not in image, face too close to camera, etc.), thereby saving data bandwidth between device 60 and AuthService subsystem 110 for communicating only user biometrics in data 1713f to AuthService subsystem 110 that meet a first threshold of acceptability determined by device 60 (e.g., only “good images” of a user's face may be included in data 1713f communicated to AuthService subsystem 110). For example, such device-based acceptability determinations may be enabled through part of browser code (e.g., as part of APS library 1704 for enabling browser biometric analysis (e.g., in web assembly module 1708)). Therefore, some of the acceptability determination work of operation 1228 may be offloaded from AuthService subsystem 110 to user device 60 at operation 1227 and operation 1229 so an initial filter at a browser of user device 60 may enable initial quality check(s) and then only pass acceptable frames to AuthService subsystem 110 for further analysis at operation 1228.

Then, at operation 1232, once AuthService subsystem 110 has determined at an instance of operation 1228 that the user enrollment biometrics of the most recently processed decrypted enrollment biometric frame data 1713f are acceptable (e.g., determined to be genuine), AuthService subsystem 110 may generate an enrollment biometric template (“EBT”) B based on such acceptable user enrollment biometrics in any suitable manner (e.g., similarly as described with respect to operation 222 of process 200).

Then, once AuthService subsystem 110 has generated EBT B at operation 1232, AuthService subsystem 110 may be enabled to run any suitable portion of any suitable privacy-preserving biometric matching technique for enabling enrollment of user U with the biometrics of EBT B, such as by running any suitable privacy-preserving enrollment protocol of operation 1260 with BAS subsystem 20 (e.g., using any suitable SMPC and/or OPRF and/or the like (e.g., as may be described by operations 208 to 218 and 224 to 238 of process 200 herein, as may be described by process 400 and/or process 600 of U.S. Pat. No. 11,936,775, and/or the like)). By running any suitable privacy-preserving enrollment protocol of operation 1260 with BAS subsystem 20 and AuthService subsystem 110 (e.g., using any suitable application 119 (e.g., an APS application 119a)) rather than with BAS subsystem 20 and an APS user device (e.g., as described with respect to process 200), process 1200 may avoid any limitations that web browser 69w might present in enabling such enrollment securely and efficiently. For example, this may avoid user device 60 having to generate any of its own device signing keys, device encryption keys, user keys, and/or the like. Additionally or alternatively, this may avoid user device 60 running any suitable biometric processing models (e.g., any suitable acceptability or liveness or attack detector models (e.g., for analyzing any suitable enrollment biometrics and/or any suitable authentication biometrics) and/or any suitable biometric authentication models), but instead such model(s) may be run on any suitable AuthService subsystem 110 and/or on any suitable enclave subsystem 130 rather than on any web browser 69w and/or any APS application 69a or otherwise that may have limited resources or capabilities (e.g., a web browser may be 10% of the size of an APS SDK (e.g., an APS application 69a) and/or may not have advanced encryption capabilities, while certain subsystems 110 and/or 130 may not have such limitations).

In some embodiments, operation 1260 or otherwise of process 1200 may include operation 1234, where any suitable portion(s) of session user profile data 1709d may be sent as any suitable enroll data 1717d to any suitable BAS 20 (e.g., using any suitable communication channel(s) and/or any suitable communication protocol(s)). For example, such enroll data 1717d may include any suitable data from session user profile data 1709d of this enrollment session or otherwise, including, but not limited to, public user key pkᵤ and/or public device signing key pk_{d}(e.g., similarly to operation 208 of process 200 (e.g., AuthService subsystem 110 may send such key(s) to each node j of a selected set of nodes n (e.g., each node 70 of nodes 70a, . . . , 70n) of system 1 (e.g., according to any suitable application 119))), public device encryption key pkₑ, session unique user identifier APID as may be used as a look-up tool or other suitable link for accessing all other such session user profile data (e.g., data 1709d) of operation 1218 for a particular session, any suitable identifier of a biometric pipeline used in the session (e.g., identifier of any suitable model(s) used at operation 1232 (e.g., “current_pipeline_id” field of user profile data of this session)), and/or the like.

In some embodiments, operation 1260 or otherwise of process 1200 may include operation 1236, where any suitable portion(s) of such enroll data 1717d may be received, stored, and/or verified by any suitable BAS 20. For example, some or all of data 1717d received by BAS 20 may be stored at any suitable portion(s) of BAS 20 for use during later portion(s) of the enrollment process and/or for a future authentication process involving the current session (e.g., similarly to operation(s) 210 and/or 236 of process 200 (e.g., each node j of selected nodes n may receive data 1717d from AuthService subsystem 110 and store (e.g., according to application 79 of that particular node 70) the public user key pkᵤ and public device signing key pk_{d} of data 1717d and/or the like together (e.g., in a linked fashion (e.g., with session unique user identifier APID, biometric pipeline identifier(s), etc.)) as a portion of node APSP data 79d in memory 73 of the node)). In some embodiments, BAS 20 may also be configured to verify any such enroll data 1717d at operation 1236 by generating and sending any suitable enroll response data 1718d in response to AuthService subsystem 110 (e.g., using any suitable communication channel(s) and/or any suitable communication protocol(s)). Such verification may be configured to achieve any suitable functionality for any suitable result(s) (e.g., similarly to any of operation(s) 210, 212, 214, 216, and/or 218 of process 200). Alternatively, in some other embodiments, rather than BAS 20 sending a challenge to AuthService subsystem 110 that may be solved by any suitable private key(s) that may be available to AuthService subsystem 110 and then returned to BAS 20 for verifying a signature of the challenge response, any suitable messages that may be sent from AuthService subsystem 110 to BAS 20 (e.g., data 1717d) may be signed using any suitable private key(s) that may be available to AuthService subsystem 110.

In some embodiments, operation 1260 or otherwise of process 1200 may include operation 1238, where AuthService subsystem 110 may generate any suitable authentication circuit information (“ACI”) and share some or all of such ACI as any suitable ACI data 1719d with any suitable BAS 20 (e.g., using any suitable communication channel(s) and/or any suitable communication protocol(s)). For example, such ACI may be generated in any suitable manner (e.g., similarly to operation 224 of process 200 (e.g., AuthService subsystem 110 may generate one or more sets of authentication circuit information ACI on seed s (e.g., of operation 1218) and EBT B (e.g., of operation 1232) for any selected nodes n using secure multi-party computation (e.g., according to any suitable application 119), where such generating of operation 1238 may be carried out in any suitable manner for enabling SMPC by the APSP to allow for each node j of nodes n to carry out a comparison on EBT B and a later generated authentication biometrics sample ABS without the node having access to the actual EBT or to the actual ABS) and then at least a portion of such ACI may be shared as ACI data 1719d with any suitable BAS 20 (e.g., similarly to data 226d of process 200).

In some embodiments, operation 1260 or otherwise of process 1200 may include operation 1240, where any suitable portion(s) of such ACI data 1719d may be received, stored, and/or verified by any suitable BAS 20. For example, some or all of data 1719d received by BAS 20 may be stored at any suitable portion(s) of BAS 20 for use during later portion(s) of the enrollment process and/or for a future authentication process involving the current session (e.g., similarly to any of operation(s) 228 and/or 234 of process 200). In some embodiments, BAS 20 may also be configured to verify any such ACI data 1719d at operation 1240 by generating and sending any suitable ACI response data 1720d to AuthService subsystem 110 (e.g., using any suitable communication channel(s) and/or any suitable communication protocol(s)). Such verification may be configured to achieve any suitable functionality for any suitable result(s) (e.g., similarly to any of operation(s) 228, 230, 232, 234, 236, and/or 238 of process 200). Alternatively, in some other embodiments, rather than a circuit identifier list being stored on AuthService subsystem 110 during enrollment (e.g., similarly to process 200) and then AuthService subsystem 110 picking one circuit identifier and asking BAS 20 to use that specific circuit to perform authentication (e.g., similarly to operation 424 of processes 200/400), a circuit identifier list may not be stored on AuthService subsystem 110 but, instead, may upload circuits to BAS 20 (e.g., at operation 1240) and when AuthService subsystem 110 may want to authenticate, it may call BAS 20 asking for one or more random circuits to be selected from a pool of circuits that may be available for the user of the session being authenticated (see, e.g., operations 1338 and 1340 of process 1300 of FIG. 13), which may, for example, enable shared circuits rather than dedicated circuits. In such embodiments, it may be easier to have more devices available to an enrolled user. Although AuthService subsystem 110 may be configured to store one or more circuit identifiers (e.g., similarly to operation 238 (e.g., at operation 1260)), they may need to be updated after every authentication.

In some embodiments, operation 1260 or otherwise of process 1200 may include any suitable operation(s) 1242, where any suitable authorized actions may occur with AuthService subsystem 110 and/or BAS 20 and/or otherwise, such as for generating any suitable third party transaction challenge response for enrollment process 1200 (e.g., similarly to how may be done by operation 1352 for generating any suitable third party transaction challenge response for authentication process 1300).

In some embodiments, such as after operation 1260 or otherwise after enrollment has been enabled, process 1200 may include an operation 1244, where the enrolled user of the session may be committed to storage by AuthService subsystem 110 (e.g., AuthService subsystem 110 may store any suitable data associated with the enrolled user of the session as a portion of any suitable data 119dw that may be stored locally on AuthService subsystem 110 or that may be stored remotely from but accessible to AuthService subsystem 110 (e.g., as any suitable portion of any suitable session user profile data (e.g., data 1709d) or otherwise)). Such storage may be configured to achieve any suitable functionality for any suitable result(s) (e.g., similarly to operation 238 of process 200). For example, although the session user profile data of session user profile look-up data 1709d may be defined at operation 1218, such data may not be stored until or may only be committed to storage at operation 1244 (e.g., once enrollment has been successful (e.g., after operation 1260)). Additionally or alternatively, at operation 1244, AuthService subsystem 110 may execute any final functions before deleting any sensitive data. For example, if the “seedEntropy” field of enrollment attempt message eam of the current session (e.g., as received at operation 1210) is true, then AuthService subsystem 110 may generate any suitable random seedEntropy string that may be unique to the user by deriving the string deterministically from seed s (e.g., as obtained at operation 1218). Additionally or alternatively, at operation 1244, AuthService subsystem 110 may delete from AuthService subsystem 110 and/or not store to long-term memory of AuthService subsystem 110 any suitable data (e.g., of the current enrollment session), including, but not limited to, user data key kₐ (e.g., as obtained by data 1708d at operation 1218), any suitable private user/device keys (e.g., private user key skᵤ, private device signing key sk_{d}, private device encryption key skₑ, and/or the like (e.g., as generated at operation 1218)), image encryption key kᵢ (e.g., as obtained by data 1711d at operation 1224), user enrollment biometrics ueb (e.g., as obtained at operation 1228), EBT B (e.g., as obtained at operation 1232), seed s (e.g., as obtained at operation 1218), any other suitable data from enrollment (e.g., any suitable data deleted at operation 238 of process 200), and/or the like, such that none of this information will be retained by the AuthService (e.g., not stored as part of the session user profile data (e.g., data 1709d) at operation 1218 for later recall during an appropriate authorization session).

In some embodiments, such as after operation 1244, process 1200 may include an operation 1246 where the successful enrollment of the user of the session may be confirmed in any suitable way by AuthService subsystem 110 to device 60 (e.g., to web browser 69w), such as by communicating any suitable success data 1723d to device 60, which may enable presenting any suitable information to user U to indicate that the enrollment was successful. For example, similarly to as shown by screens 700f-700h of FIGS. 7F-7H, web browser 69w may enable device 60 to present any suitable information to user U during such enrollment (e.g., during operations 1228, 1232, 1234, 1236, 1238, 1240, 1242, 1244, and 1246), but similarly to screen 700i of FIG. 7I, web browser 69w may enable device 60 to present any suitable information to user U when such enrollment is complete and confirmed (e.g., at operation 1248), at which time a user may be presented with any suitable enrolled options. Much of enrollment process 1200 may be carried out transparently to user U for providing a more seamless and efficient user experience. For example, operations 1206 to 1224 may be transparent to user U (e.g., between being presented with a screen similar screen 700a of FIG. 7A and being presented with a screen similar to screen 700b of FIG. 7B). As another example, operations 1232 to 1246 may be transparent to user U (e.g., between being presented with a screen similar to screen 700f of FIG. 7F and being presented with a screen similar to screen 700i of FIG. 7I). In some embodiments, data 1723d may include the seedEntropy string (e.g., as generated at operation 1244), which may be used for any suitable purpose by device 60 (e.g., this string may provide any suitable randomness to the device/browser of the session, that the customer can use as it may please).

In some embodiments, such as after operation 1244 and/or after operation 1246, process 1200 may include an operation 1248 where the successful enrollment of the user of the session may be confirmed in any suitable way by AuthService subsystem 110 to third party subsystem 90 (e.g., directly and/or via device 60) using any suitable success data 1724d.

In some embodiments, such as after operation 1248, process 1200 may include an operation 1250 where third party subsystem 90 may receive and process such success data 1724d in any suitable way for verifying the success of the enrollment of enrollment process 1200 (e.g., similarly to how may be done by operation 1358 for verifying the success of authentication process 1300).

The operations shown in process 1200 of FIG. 12 are only illustrative and existing operations may be modified or omitted, additional operations may be added, and the order of certain operations may be altered.

### FIG. 13

FIG. 13 is a flowchart of an illustrative process 1300 for authenticating user U with the APSP using any suitable web browser of any suitable user device (e.g., any suitable web browser application 69w of any suitable user device 60 (e.g., Google Chrome, Safari, Edge, Firefox, etc.)), rather than, for example, using a dedicated APS application (e.g., of process 400). Process 1300 is shown being implemented by any such APS user device 60 with any such web browser 69w, its user U, any suitable BAS 20, any suitable third party subsystem 90, and any suitable fortress solution 140′ (e.g., any suitable AuthService subsystem 110, and any suitable KMS subsystem 120 (e.g., the same or a similar implementation as that of process 1200)). However, process 1300 may be implemented using any other suitable components or subsystems or entities of any suitable system 1 of FIG. 1 or otherwise. Process 1300 may provide a seamless user experience for securely and efficiently authenticating user U with the APSP using any suitable web browser 69w of any suitable user device 60. To facilitate the following discussion regarding the operation of system 1 for authenticating user U with the APSP according to process 1300 of FIG. 13, reference is made to various components of system 1 of the schematic diagrams of FIGS. 1 to 11, and to screens 700x-700ae that may be representative of a graphical user interface of user device 60 during such a process (e.g., as shown in FIGS. 7X-7AE). The operations described may be achieved with a wide variety of graphical elements and visual schemes. Therefore, the embodiments of FIGS. 7X-7AE are not intended to be limited to the precise user interface conventions adopted herein. Rather, embodiments may include a wide variety of user interface styles. Other embodiments of authentication, such as with an enclave subsystem (e.g., any suitable enclave subsystem 130), may be described with respect to FIG. 15.

Process 1300 may begin at operation 1301, where a subsystem relationship (e.g., between KMS subsystem 120 and AuthService subsystem 110 and/or third party subsystem 90) may be configured by the system. This subsystem relationship may be configured prior to any enrollment and/or any authentication with the APSP via a web browser. Operation 1301 may be the same or substantially similar to operation 1201. In some embodiments, operation 1301 may be unnecessary if third party subsystem 90 and AuthService subsystem 110 and BAS 20 and KMS 120 are the same in process 1300 as they were in process 1200, no matter whether or not user U and/or user device 60 and browser 69w are the same in process 1300 as they were in process 1200, such that the processes may be generic to any suitable browsers and any suitable devices and any suitable users (e.g., whereby the website loaded by any browser may be defined by third party subsystem 90 to be similar or the same with respect to subsystem configuration data).

After an appropriate subsystem relationship has been configured, process 1300 may include an operation 1302 where the system may be configured to attempt to authenticate any suitable browser session (e.g., any suitable session between a user U of any suitable user device 60 using any suitable web browser 69w to access any suitable website of any suitable third party subsystem 90 of the system) and generate any suitable AuthToken if the authentication is successful. In some embodiments, a session may be authenticated at operation 1302 by identifying any suitable authentication cookie that may be stored in the web browser of the session, where such an authentication cookie may be generated and stored once the session has been authenticated through some other technique (e.g., such a cookie may be an AuthToken generated during a previous session that may be re-used (e.g., if still viable)). Such another technique for authenticating the session at operation 1302 may include authenticating the user of the session through any suitable methods (e.g., non-APSP biometric methods), such as authenticating the user through conducting a successful user log-in to an existing user account of the third party subsystem (e.g., third party subsystem 90 collecting log-in credentials (e.g., user name and password) from user U via device 60 and processing such log-in credentials to verify whether or not the log-in credentials are for an existing account (e.g., using a screen that may be similar to screen 700j of FIG. 7J)) or any other suitable KYC check, credit card on device check, and/or the like. In some embodiments, operation 1302 may generate an AuthToken after validating device 60 of the session (e.g., as opposed to validating user U of the session (e.g., if device 60 is determined to be trusted by third party subsystem 90 in any suitable manner)). Once the session is authenticated, operation 1302 may continue by generating any suitable AuthToken for the session. Such an AuthToken for an authenticated browser session may be generated by third party subsystem 90 and provided to web browser 69w (e.g., as a portion of any suitable website information 1702 of a website of the third party). For example, AuthService subsystem 110 may be configured to define the type of AuthToken to be generated (e.g., the syntax, format, composition, etc.), while third party subsystem 90 and web browser 69w of device 60 may work with user U to generate the AuthToken for the authenticated session. The AuthToken of the session generated at operation 1302 may later be used during any suitable authentication of the APSP using the session to prove to AuthService subsystem 110 that the user and/or user device of the session has been authenticated in some way by third party subsystem 90 before AuthService subsystem 110 may be enabled to continue with such an authentication of the APSP using the session. The AuthToken of operation 1302 may include any suitable information, including, but not limited to, some or all of the same information described above with respect to the AuthToken of operation 1202, although, in some embodiments, the AuthToken of operation 1302 may not include a user name (e.g., username identifier URID) as that information may be made available to device 60 through another source of process 1300 other than the AuthToken (e.g., by operation 1306). Once an AuthToken has been generated for a successfully authenticated browser session at operation 1302 (e.g., once the AuthToken has been generated by third party subsystem 90 and provided to device 60 (e.g., to web browser 69w)), process 1300 may be enabled to carry out the remainder of an authentication process (e.g., operation 1304 through operation 1364) using that session (e.g., by presenting a customer's log-in option for user U via web browser 69w of the session (e.g., using screen 700x of FIG. 7X)). It is to be understood that the same user U and the same third party subsystem 90 may generate similar AuthTokens for different devices 60 and/or different web browsers 69w (e.g., any suitable browser on any suitable device).

For example, after a browser session has been authenticated and an AuthToken generated at operation 1302, process 1300 may include operations 1304 and 1306, where the system may be configured to enable a user of the session to initiate a transaction with the customer of third party subsystem 90. For example, at operation 1304, user U may initiate a transaction by carrying out any suitable transaction initiation interaction tii 1802d with web browser 69w that may be presenting any suitable third party website on user device 60 (e.g., accounts.customer.com). For example, as shown by screen 700x of FIG. 7X, the UI of user device 60 may present a “User Log-In for Customer Account” option for user U to enter or otherwise select the user's username identifier for their account with the third party (e.g., user John Doe's e-mail address of john.doe@doemail.com), or any other suitable user transaction initiation option in order to proceed with process 1300 for authenticating with the APSP. In advance of operation 1202 and/or operation 1302, the third party website may be accessed by web browser 69w on user device 60 or otherwise (e.g., using any other suitable device) in any suitable manner and user U may carry out any suitable account set-up operations with respect to the website (e.g., creating an account, logging-in, etc.), although any set-up operations not shown may or may not be required.

At operation 1306, user device 60 may detect such a transaction initiation interaction tii (e.g., entry of a user's particular username identifier) and, in response to such detection, user device 60 may communicate in any suitable manner with third party subsystem 90 in order to acquire any suitable transaction data 1803d. Such transaction data 1803d may include any suitable information that may enable device 60 to initiate user authentication with the APSP, including, but not limited to, the user's particular username identifier (e.g., URID, which may or may not have been made available by the AuthToken of operation 1302), the customer's particular customer identifier (e.g., CRID, which may or may not have been made available by the AuthToken of operation 1302), any suitable transaction data (e.g., TRDT, which may be any suitable “transactionData” string (e.g., as may be generated by third party subsystem 90 (e.g., at operation 1306)) that may be signed and returned to third party subsystem 90 after successful authentication), any suitable seed entropy field data (e.g., either a true or false identifier for a “seedEntropy” field that may selectively configured the APSP to request to receive a user-related cryptographic key that may be generated from a seed after successful authentication), and/or the like.

After such a transaction has been initiated, process 1300 may include operations 1308 and 1310, where the system may be configured to enable a user of the session to initiate APSP authentication. For example, at operation 1308, user U may initiate APSP authentication for the session by carrying out any suitable authentication initiation interaction aii 1804d with web browser 69w that may be presenting any suitable website on user device 60. For example, as shown by screen 700y of FIG. 7Y, the UI of user device 60 may present via web browser 69w any suitable website (e.g., idp.ABCcustomer.com) with any suitable options, such as a “Continue on Web” option, for user U to select with its authentication initiation interaction aii in order to proceed with process 1300 for authenticating with the APSP (e.g., using any suitable federation chain, in some embodiments). In advance of operation 1202 and/or operation 1302, the third party website may be accessed by web browser 69w on user device 60 or otherwise (e.g., using any other suitable device) in any suitable manner and user U may carry out any suitable account set-up operations with respect to the website (e.g., creating an account, logging-in, etc.), although any set-up operations not shown may or may not be required.

At operation 1310, user device 60 may detect such an authentication initiation interaction aii and, in response to such detection, user device 60 may generate any suitable (e.g., random) image encryption key kᵢ (e.g., any suitable random data that may be generated by browser 69w, where the length of the random key may depend on the length of public image encryption wrapping key pk_{w} (e.g., 16 bytes or otherwise)) and then encrypt or wrap or that image encryption key kᵢ with public image encryption wrapping key pk_{w} (e.g., as made available at operation 1201 and/or operation 1301) to define wrapped image encryption key kᵢ (e.g., \hat{k}ᵢ=Epk_{w} (kᵢ)). This image encryption key kᵢ of operation 1310 of authentication process 1300 may be similar to image encryption key kᵢ of operation 1206 of enrollment process 1200 in format and functionality, but these two keys may be unique from one another in value as each may be generated as an independent random string during an independent session. This may enable device 60 to securely communicate and store wrapped image encryption key \hat{k}ᵢ remotely on AuthService subsystem 110 while also enabling AuthService subsystem 110 to later retrieve that encrypted image encryption key \hat{k}ᵢ for accessing image encryption key kᵢ through communication with KMS subsystem 120 (e.g., using private image encryption wrapping key sk_{w} (e.g., as generated at operation 1201 and/or operation 1301)), such that AuthService subsystem 120 may use that image encryption key kᵢ to securely receive and process biometric data from user device 60 that may be encrypted with that image encryption key kᵢ (e.g., at operation 1330). APS library 1704 may be used as part of the third party (e.g., APS customer) website being presented to user U via web browser 69w, which may include a “Continue on Web” button (e.g., using screen 700y of FIG. 7Y). When that button may be selected (e.g., at operation 1308), the website may be configured to use a “create APSP auth( )” function from interface 1710 to authenticate user U using public image encryption wrapping key pk_{w} (e.g., the website may ask the APS library to authenticate the user, such that it may provide the public image encryption wrapping key pk_{w} to the APS library (e.g., the customer website may provide public image encryption wrapping key pk_{w} along with any suitable instruction(s) to the library to enroll the user)). Public image encryption wrapping key pk_{w} may be configured (e.g., during operation 1201 and/or operation 1301) to differ per any suitable environment (e.g., continent) or could be customer specific (e.g., third party subsystem specific), but, in some embodiments, the APS library may be configured to be consistent worldwide all the time so it may or may not include public image encryption wrapping key pk_{w}. Web browser 69w of user device 60 may include the APS library inside as the website hosts the library.

At operation 1312, user device 60 (e.g., web browser 69w) may be configured to generate and send any suitable authentication attempt message aam (e.g., as data 1806d) to AuthService subsystem 110 (e.g., using any suitable communication channel(s) and/or any suitable communication protocol(s)). Authentication attempt message aam may be configured to include any suitable data, including, but not limited to, any suitable authentication initiation information, any suitable image encryption and wrapping information, any suitable information that may be used for “authorized actions” after successful enrollment, and/or the like. For example, authentication attempt message aam may include any suitable enrollment initiation information, including, but not limited to, an “event” field that may be defined by some attempt identifier (e.g., “Attempt”), a “sessionType” field that may be defined by some authentication identifier (e.g., “AUTHENTICATION”) (e.g., rather than by some enrollment identifier as in operation 1208), a “customer” field that may be defined by some identifier (e.g., CRID) of the customer of the session (e.g., “some-company” (e.g., “CITIBANK” or “FACEBOOK” or “B'GOCK” or “ABC_CUSTOMER” or the like)), a “username” field that may be defined by some identifier (e.g., URID) of the end user (e.g., some.user@company.eu (e.g., “john.doe@doemail.com” or the like)), an “authorizationToken” field that may be defined by some string (e.g., the AuthToken generated at operation 1302), and/or the like. Additionally or alternatively, authentication attempt message aam may include any suitable image encryption and wrapping information, including, but not limited to, KIDk_{w} for image encryption wrapping key(s) k_{w} of operation 1201 and/or operation 1301, AIDk_{w} for the algorithm used (e.g., at operation 1201 and/or operation 1301) to generate the image encryption wrapping keypair (sk_{w}, pk_{w}), key pk_{w} (e.g., of operation 1201 and/or operation 1301), KIDk_{c} for customer transaction data signing key(s) k_{c} of operation 1201 and/or operation 1301, AIDk_{c} for the algorithm used (e.g., at operation 1201 and/or operation 1301) to generate the customer transaction data signing keypair (sk_{c}, pk_{c}), key pk_{c} (e.g., of operation 1201 and/or operation 1301), an “imageKey” field that may be defined by (e.g., the string for) wrapped image encryption key kᵢ (e.g., as defined at operation 1310), AIDkᵣ for the algorithm used (e.g., at operation 1201 and/or operation 1301) to generate user data wrapping key kᵣ, KIDkᵣ for user data wrapping key kᵣ of operation 1201 and/or operation 1301, and/or the like. Additionally or alternatively, authentication attempt message aam may include any suitable information that may be used for “authorized actions” after successful enrollment, including, but not limited to, a “transactionData” field that may be defined by some string (e.g., TRDT) or other suitable data (e.g., a “string” that may be provided by third party subsystem 90 (e.g., at operation 1302 or otherwise of process 1300 (e.g., via web browser 69w)) and that is to be signed after successful APSP authentication), a “seedEntropy” field that may be defined as either true or false (e.g., the APS can request to receive a user-related cryptographic key generated from a seed after successful authentication), and/or the like. In some embodiments, at operation 1312, user device 60 may be configured to store any suitable data and/or delete any suitable data. For example, user device 60 may store image encryption key kᵢ at operation 1312 (e.g., as any suitable data 69dw) such that image encryption key kᵢ may be utilized by device 60 at future operation(s) of the session (e.g., at operation 1329 (e.g., such that device 60 may collect user biometrics and encrypt those biometrics for transmission to AuthService subsystem 110 without the biometrics being accessible by an entity that is unable to access private image encryption wrapping key sk_{w}, which AuthService subsystem 110 may be enabled to do by establishing trust with KMS subsystem 120)). In some embodiments, operation 1302 may be carried out after operation 1308 (e.g., after aii 1804d may be received by device 60) but prior to operation 1312, which may rely on the AuthToken of operation 1302.

At operation 1314, AuthService subsystem 110 may be configured to receive and attempt to validate any suitable portion(s) of authentication attempt message aam in any suitable manner. This may include attempting to validate any suitable authentication initiation information of the received authentication attempt message aam, including, but not limited to, an “authorizationToken”, “username”, “customer”, and/or the like, which may be done similarly to validation of enrollment attempt message eam of process 1200. For example, AuthService subsystem 110 may be configured to attempt to validate the AuthToken using any suitable AuthToken configuration data of operation 1201 and/or operation 1301 and/or otherwise for validating the AuthToken according to any appropriate tool(s) or framework(s), including, but not limited to, OIDC, OAuth 2.0, SAML 2.0, and/or the like. If validation fails, process 1300 may end or the AuthService may instruct the web browser to try again due to failure of the AuthToken.

At operation 1316, if the received authentication attempt message aam has been appropriately validated at operation 1314, AuthService subsystem 110 may identify a unique APID of any suitable APID look-up data 1808u that may be stored on or accessible to AuthService subsystem 110 (e.g., from any suitable data 119dw) using any suitable session entity identifier(s) (e.g., CRID, URID, etc.) of the aam (e.g., as validated at operation 1314). Then, for example, also at operation 1316, AuthService subsystem 110 may use that identified APID to identify particular session user profile look-up data 1808d that may be stored on or accessible to AuthService subsystem 110 (e.g., from any suitable data 119dw) using that identified APID and then load any suitable session user profile data (e.g., wrapped private device keys s\hat{k}_{d} & s\hat{k}_{d}, wrapped user data key \hat{k}ₐ, public user/device keys pkᵤ, pk_{d}, pkₑ, session entity identifier(s), encryption metadata, session data, etc.) of that identified session user profile look-up data 1808d for further use during process 1300. Therefore, for example, when the CRID and URID of the aam of operation 1314 of the APSP authentication process for a particular browser session of process 1300 match the CRID and URID of the eam of any earlier operation 1210 of any earlier APSP enrollment for any browser session of process 1200, then the APID identified at operation 1316 of process 1300 may be the same as the APID used by operation 1218 of that process 1200, such that the session user profile data that may be loaded at operation 1316 (e.g., as a portion of session user profile look-up data 1808d) may be the same as the session user profile data that may have been previously stored (e.g., as a portion of session user profile look-up data 1709d) at that operation 1218 of that process 1200. However, if the session entity identifier(s) of the aam are unable to be used by process 1300 to surface any unique APID for use in surfacing any session user profile data that may have been stored during an earlier APS enrollment session, then operation 1316 may stop and terminate the APS authentication session of process 1300.

At operation 1318, once appropriate session user profile data 1808d has been identified and loaded at operation 1316, AuthService subsystem 110 may be configured to generate and send any suitable request for the decryption of wrapped user data key \hat{k}ₐ (e.g., as decryption of user data key request data 1809d) to KMS subsystem 120 (e.g., using any suitable communication channel(s) and/or any suitable communication protocol(s)). Such a decryption of user data key request may include any suitable information that may be available to AuthService subsystem 110 and useful to KMS subsystem 120 for fulfilling the request. For example, this decryption of user data key request may include any suitable request data that may be used by KMS subsystem 120 to understand the type of data being requested (e.g., the decryption of wrapped user data key \hat{k}ₐ) and any other suitable data that may be useful to KMS subsystem 120 (e.g., to gain some trust in the request and/or to enable the request), such as wrapped user data key \hat{k}ₐ (e.g., as may be known to AuthService subsystem 110 from loaded user profile data 1808d of operation 1316), a key identifier (e.g., KIDkᵣ) of user data wrapping key kᵣ (e.g., as may be known to KMS subsystem 120 from operation 1201 and/or operation 1301 and as may be known to AuthService subsystem 110 from received authentication attempt message aam and/or otherwise (e.g., at operation 1201 and/or operation 1301)), and/or an algorithm identifier (e.g., AIDkᵣ) of the algorithm used to generate the user data wrapping key kᵣ (e.g., as may be known to KMS subsystem 120 from operation 1201 and/or operation 1301 and as may be known to AuthService subsystem 110 from received authentication attempt message aam and/or otherwise (e.g., at operation 1201 and/or operation 1301)).

At operation 1319, KMS subsystem 120 may be configured to receive and attempt to execute the request for decryption of user data key (e.g., the request of data 1809d from AuthService subsystem 110). This may include KMS subsystem 120 receiving and processing data 1809d to identify the type of request being made, to identify wrapped user data key \hat{k}ₐ, and to identify at least key identifier (e.g., KIDkᵣ) of user data wrapping key kᵣ, which may be known to KMS subsystem 120 from operation 1201 and/or operation 1301 and stored at KMS subsystem 120 against or in association with user data wrapping key(s) kᵣ, such that KMS subsystem 120 may access user data wrapping key(s) kᵣ (e.g., from data 129dw as stored at operation 1201 and/or operation 1301) using the key identifier (e.g., KIDkᵣ) of request data 1809d and may similarly access the algorithm identifier (e.g., AIDkᵣ) from such storage and/or from request data 1809d. Next, KMS subsystem 120 may decrypt this wrapped user data key \hat{k}ₐ with the accessed user data wrapping key(s) kᵣ (e.g., as identified by key identifier KIDkᵣ, such as by using the algorithm identified by algorithm identifier AIDkᵣ) to obtain unwrapped user data key kₐ.

Then, at operation 1320, KMS subsystem 120 may be configured to send such an unwrapped user data key kₐ (e.g., as obtained at operation 1319) as at least a portion of user data key response data 1810d to AuthService subsystem 110 (e.g., using any suitable communication channel(s) and/or any suitable communication protocol(s)).

Once unwrapped user data key kₐ has been received as data 1810d by AuthService subsystem 110, AuthService subsystem 110, at operation 1322, may use unwrapped user data key kₐ to decrypt the wrapped private device keys s\hat{k}_{d} and s\hat{k}_{d} of loaded session user profile data 1808d (e.g., to obtain unwrapped private device signing key sk_{d} and unwrapped private device encryption key skₑ (e.g., as encrypted with user data key kₐ by AuthService subsystem 110 at operation 1218 during enrollment process 1200)), such that private device signing key sk_{d} and private device encryption key skₑ may be used by AuthService subsystem 110 during this APSP authentication session (e.g., when running any suitable privacy-preserving authentication protocol or privacy-preserving biometric matching of operation 1360), while these private device keys along with unwrapped user data key kₐ received by data 1810d may later be deleted from AuthService subsystem 110 (e.g., at operation 1364) and/or not stored in long-term memory of AuthService subsystem 110 at the end of this authentication session. Moreover, at operation 1322, once appropriate user profile data 1808d has been loaded, AuthService subsystem 110 may be configured to generate and send any suitable request for the decryption of wrapped image encryption key kᵢ (e.g., as decryption of image encryption key request data 1811d) to KMS subsystem 120 (e.g., using any suitable communication channel(s) and/or any suitable communication protocol(s)). Such a decryption of image encryption key request may include any suitable information that may be available to AuthService subsystem 110 and useful to KMS subsystem 120 for fulfilling the request. For example, this decryption of image encryption key request may include any suitable request data that may be used by KMS subsystem 120 to understand the type of data being requested (e.g., the decryption of wrapped image encryption key \hat{k}ᵢ) and any other suitable data that may be useful to KMS subsystem 120 (e.g., to gain some trust in the request and/or to enable the request), such as wrapped image encryption key kᵢ (e.g., as received by AuthService subsystem 110 via the aam at operation 1314), a key identifier (e.g., KIDk_{w}) of image encryption wrapping key(s) k_{w} (e.g., as may be known to KMS subsystem 120 from operation 1201 and/or operation 1301 and as may be known to AuthService subsystem 110 from received authentication attempt message aam and/or otherwise (e.g., at operation 1201 and/or operation 1301)), and/or an algorithm identifier (e.g., AIDk_{w}) of the algorithm used to generate the image encryption wrapping keypair (sk_{w}, pk_{w}) (e.g., as may be known to KMS subsystem 120 from operation 1201 and/or operation 1301 and as may be known to AuthService subsystem 110 from received authentication attempt message aam and/or otherwise (e.g., at operation 1201 and/or operation 1301)).

At operation 1323, KMS subsystem 120 may be configured to receive and attempt to execute the request for decryption of image encryption key (e.g., the request of data 1811d from AuthService subsystem 110). This may include KMS subsystem 120 receiving and processing data 1811d to identify the type of request being made, to identify wrapped image encryption key \hat{k}ᵢ, and to identify at least key identifier (e.g., KIDk_{w}) of image encryption wrapping key(s) k_{w}, which may be known to KMS subsystem 120 from operation 1201 and/or operation 1301 and stored at KMS subsystem 120 against or in association with image encryption wrapping key(s) k_{w} (e.g., private image encryption wrapping key sk_{w}), such that KMS subsystem 120 may access private image encryption wrapping key sk_{w} (e.g., from data 129dw as stored at operation 1201 and/or operation 1301) using the key identifier (e.g., KIDk_{w}) of request data 1811d and may similarly access the algorithm identifier (e.g., AIDk_{w}) from such storage and/or from request data 1811d. Next, KMS subsystem 120 may decrypt this wrapped image encryption key \hat{k}ᵢ with the accessed private image encryption wrapping key sk_{w} (e.g., as identified by key identifier KIDk_{w}, such as by using the algorithm identified by algorithm identifier AIDk_{w}) to obtain unwrapped image encryption key kᵢ.

Then, at operation 1324, KMS subsystem 120 may be configured to send such an unwrapped image encryption key kᵢ (e.g., as obtained at operation 1323) as decryption of image encryption key response data 1812d to AuthService subsystem 110 (e.g., using any suitable communication channel(s) and/or any suitable communication protocol(s)). Any other suitable operations may be carried out by KMS subsystem 120 at operation 1324.

Then, at operation 1326, once AuthService subsystem 110 may have received unwrapped user data key kₐ from KMS subsystem 120 (e.g., as at least a portion of data 1810d) and unwrapped image encryption key kᵢ from KMS subsystem 120 (e.g., as at least a portion of data 1812d), AuthService subsystem 110 may be configured to request user authentication biometric data from user U via web browser 69w of device 60 by generating and sending any suitable user authentication biometrics request data 1813d to device 60 (e.g., using any suitable communication channel(s) and/or any suitable communication protocol(s)).

Then, at operation 1327, user device 60 may be configured to receive and process such user authentication biometrics request data 1813d to generate any suitable user authentication biometrics request data 1813dp that may be presented to user U via any suitable device user interface using web browser 69w or otherwise, whereby device 60 may be enabled to capture at operation 1329 any suitable user authentication biometrics uab that may be presented by user U at operation 1328 as user authentication biometrics uab data 1814d. However, rather than user device 60 capturing such user authentication biometrics uab data and then processing such data for generating an ABS b on device 60, device 60 may capture (e.g., using any suitable sensor(s) 65) one or more frames of image data (e.g., during user presentation of user authentication biometrics uab) and any associated sensor data or fast data (e.g., any suitable environment data and/or motion data) that may be acquired by device 60 in between two or more image data frames, and then encrypt such data with image encryption key kᵢ (e.g., as generated by device 60 at operation 1310), and then send such encrypted authentication biometric frame data 1814f to AuthService subsystem 110 at operation 1329 (e.g., using any suitable communication channel(s) and/or any suitable communication protocol(s)) for generating an ABS b. Device 60 may be configured define a particular instance of data 1814f for a particular moment in time to include not only image data for an image that may capture uab at that particular moment in time but also any suitable other sensor data (e.g., environment data, motion data, etc.) that may have been collected by device 60 from after the moment in time of the previous instance of data 1814f to the moment in time of this particular instance of data 1814f (e.g., such that device 60 may share a combination of particular image data and associated movement data (e.g., as encrypted by image encryption key kᵢ) with AuthService subsystem 110 for further processing. Any suitable data packaging module for combining any suitable image data and associated movement data (e.g., environment data and/or motion data) into any suitable user authentication biometric data package(s) (e.g., as may be described in co-pending, commonly-assigned U.S. patent application Ser. No. 19/217,833, which is hereby incorporated by reference herein in its entirety) may be provided by AuthService subsystem 110 for generating any suitable user authentication biometric data package(s) based on data 1814f (e.g., as decrypted by image encryption key kᵢ) prior to processing such package(s) with any suitable attack detector (e.g., as may be described in co-pending, commonly-assigned U.S. patent application Ser. No. 19/217,833, which is hereby incorporated by reference herein in its entirety).

Then, at operation 1330, AuthService subsystem 110 may receive any suitable encrypted authentication biometric frame data 1814f from device 60, decrypt such data using image encryption key kᵢ (e.g., as obtained from data 1812d), and then process such decrypted authentication biometric frame data to determine if the user authentication biometrics are acceptable (e.g., determined to be genuine) or not acceptable (e.g., determined to be a spoof or indeterminable or the like) using any suitable attack detector (e.g., similarly to operation 1228 with respect to user enrollment biometrics). If determined not to be acceptable, AuthService subsystem 110 may request new user authentication biometric data from user U via web browser 69w of device 60 by generating and sending any suitable user authentication biometrics feedback data 1815d to device 60 (e.g., using any suitable communication channel(s) and/or any suitable communication protocol(s)). Then, at operation 1331, user device 60 may be configured to receive and process such user authentication biometrics feedback data 1815d to generate any suitable user authentication biometrics feedback data 1815dp that may be presented to user U via any suitable device user interface using web browser 69w or otherwise, whereby device 60 may be enabled to capture at another iteration of operation 1329 any suitable additional user authentication biometrics ueb that may be presented at operation 1328 by user U as additional user authentication biometrics uab data 1814d, where such operations 1326, 1329, 1330, and 1331 may together form any suitable operation loop 1333. Operation loop 1333 may be repeated any suitable number of times until AuthService subsystem 110 determines at an instance of operation 1330 that the user authentication biometrics of the most recently processed decrypted authentication biometric frame data are acceptable (e.g., determined to be genuine), at which point process 1300 may advance from operation 1330 out of operation loop 1333 to operation 1336, where AuthService subsystem 110 may generate an authentication biometric sample (“ABS”) b based on such acceptable user authentication biometrics.

User device 60 may be configured to capture such authentication biometrics uab as at least a portion of data 1814d for generating data 1814f that may be appropriately processed by AuthService subsystem 110 for determining whether acceptable for use in generating an ABS b (e.g., according to web browser 69w and/or any other suitable application(s) that may be running on device 60 (e.g., different users may use different biometrics, different devices may use different sensors, different types of data may be captured in addition to biometrics (e.g., device environment data, device motion data, etc.), and/or the set of characteristics and associated actions themselves may change from one authentication to the next, etc.)). For example, similarly to as shown by screen 700z of FIG. 7Z and screen 700aa of FIGS. 7AA, the UI of device 60 may optionally present a user approval request for accessing any suitable sensor(s) or other device components (e.g., a camera of device 60) for capturing user biometrics, a request which the user may accept or deny. If accepted or automatically allowed, the UI of APS device 60 may present instructions on how the user ought to present user authentication biometrics uab to user device 60 for capture. For example, as shown by screen 700ab of FIG. 7AB, while the user's face may be in the line of sight of a device camera sensor, device 60 may instruct the user to keep their face still, then look left, then look right, or carry out any other suitable instructions and then initiate further authentication processing, as shown by screen 700ac of FIG. 7AC (e.g., at operation 1336, once acceptable biometrics have been successfully captured). This may enable device 60 to capture user authentication biometrics uab in the form of a video or photograph sequence of the user's face rotating. This may enable “liveness” detection of the user (e.g., as may instructing the user to carry out any other suitable action while biometrics are captured (e.g., winking with one eye then with the other eye, or smiling then frowning, or saying a word or phrase, etc.) and/or adjusting one or more functionalities of the device (e.g., increasing an ambient light source of the device, etc.)). This presentation and/or feedback may help prevent spoofing and/or capturing biometrics of an unwilling user.

In some embodiments, operation loop 1333 may achieve improved efficiency if user device 60 (e.g., web browser 69w) is configured to conduct any suitable biometric acceptability determinations by processing data 1814d on board device 60 and immediately provide certain feedback to user U (e.g., as data 1815dp) without requiring such biometric acceptability determinations to be handled by AuthService subsystem 110 (e.g., at one or more iterations of operation 1330). For example, device 60 may be configured to make certain acceptability determinations and provide certain appropriate feedback on its own (e.g., face not in image, face too close to camera, etc.), thereby saving data bandwidth between device 60 and AuthService subsystem 110 for communicating only user biometrics in data 1814f to AuthService subsystem 110 that meet a first threshold of acceptability determined by device 60 (e.g., only “good images” of a user's face may be included in data 1814f communicated to AuthService subsystem 110). For example, such device-based acceptability determinations may be enabled through part of browser code (e.g., as part of APS library 1704 for enabling browser biometric analysis (e.g., in web assembly module 1708)). Therefore, some of the acceptability determination work of operation 1330 may be offloaded from AuthService subsystem 110 to user device 60 at operation 1329 and operation 1331 so an initial filter at a browser of user device 60 may enable initial quality check(s) and then only pass acceptable frames to AuthService subsystem 110 for further analysis at operation 1330. The quality control and/or filtering requirements and/or acceptability determinations of loop 1230 during enrollment (e.g., at device 60 and/or at AuthService subsystem 110) may be the same as or more or less stringent than that of loop 1333 during authentication depending on any suitable requirements or goals of the system.

Then, at operation 1336, once AuthService subsystem 110 has determined at an instance of operation 1330 that the user authentication biometrics of the most recently processed decrypted authentication biometric frame data 1814f are acceptable (e.g., determined to be genuine), AuthService subsystem 110 may generate an authentication biometric sample (“ABS”) b based on such acceptable user authentication biometrics in any suitable manner (e.g., similarly as described with respect to operation 422 of process 400). AuthService subsystem 110 may be configured to use any suitable model(s) of any suitable neural network(s) that may be identified by any suitable session data (e.g., data of a “current_pipeline_id” field) of the session user profile data loaded at operation 1316 in order to generate ABS b at operation 1336. Therefore, even if the system has been adjusted after process 1200 but before process 1300 to support additional models, such a biometric pipeline identifier of the session user profile data may be used to ensure that the same model(s) may be used for both generating an EBT B during enrollment of a customer's user and an ABS b during authentication of the customer's user.

Then, once AuthService subsystem 110 has generated ABS b at operation 1336, AuthService subsystem 110 may be enabled to run any suitable portion of any suitable privacy-preserving biometric matching technique for enabling authentication of user U with the biometrics of ABS b, such as by running any suitable privacy-preserving authentication protocol or privacy-preserving biometric matching of operation 1360 with BAS subsystem 20 (e.g., using any suitable SMPC and/or OPRF and/or the like (e.g., as may be described by operations 424 to 440 of process 400 herein, as may be described by process 500 and/or process 700 of U.S. Pat. No. 11,936,775, and/or the like)). For example, the privacy-preserving biometric matching of operation 1360 may carry out any suitable biometric authentication in any suitable manner that may enable the comparison of the user's biometrics ueb and/or EBT B of operation 1232 with the user's biometrics uab and/or ABS b of operation 1336 using AuthService subsystem 110 and BAS 20 without sharing either biometrics or EBT B or ABS b with BAS 20. For example, such a comparison may be made between any suitable embeddings (e.g., any suitable set(s) and/or vector(s) and/or matrix(ces)) that may be extracted from biometrics ueb and any suitable embeddings that may be extracted from biometrics uab, without BAS 20 having access to any such embeddings of either of the two biometrics (e.g., without BAS 20 obtaining any information about the embeddings (e.g., vectors (e.g., no numbers or properties related to such vectors)), thereby maintaining the security of the biometrics while still enabling effective biometric authentication. By running any suitable privacy-preserving authentication protocol or privacy-preserving biometric matching of operation 1360 with BAS subsystem 20 and AuthService subsystem 110 (e.g., using any suitable application 119 (e.g., an APS application 119a)) rather than with BAS subsystem 20 and an APS user device (e.g., as described with respect to process 200), process 1300 may avoid any limitations that web browser 69w might present in enabling such authentication securely and efficiently. For example, this may avoid user device 60 having to generate any of its own device signing keys, device encryption keys, user keys, and/or the like. Additionally or alternatively, this may avoid user device 60 running any suitable biometric processing models (e.g., any suitable acceptability or liveness or attack detector models (e.g., for analyzing any suitable enrollment biometrics and/or any suitable authentication biometrics) and/or any suitable biometric authentication models), but instead such model(s) may be run on any suitable AuthService subsystem 110 and/or on any suitable enclave subsystem 130 rather than on any web browser 69w and/or any APS application 69a or otherwise that may have limited resources or capabilities (e.g., a web browser may be 10% of the size of an APS SDK (e.g., an APS application 69a) and/or may not have advanced encryption capabilities, while certain subsystems 110 and/or 130 may not have such limitations).

In some embodiments, operation 1360 or otherwise of process 1300 may include operation 1338, where AuthService subsystem 110 may generate and send any suitable request for an input table as any suitable table request data 1819d to any suitable BAS 20 (e.g., using any suitable communication channel(s) and/or any suitable communication protocol(s)). For example, such table request data 1819d may be a request for any suitable random circuit(s) to be selected from any suitable pool that may be available for user U and BAS 20 may receive and process such a request and provide any suitable table response data 1820d back to AuthService subsystem 110 at operation 1340, whereby this may allow AuthService subsystem 110 not to store a list of circuits (e.g., across devices (e.g., as a generic web browser 69w may be used during process 1200 and process 1300 for various devices (e.g., for enabling shared circuits))). Alternatively, AuthService subsystem 110 may select a circuit identifier and ask BAS 20 to use that specific circuit at operations 1338 and 1340 (e.g., similarly to operations 424 and 426 of process 400).

Next, operation 1360 or otherwise of process 1300 may include operation 1344, where AuthService subsystem 110 may process the appropriate circuit or table data and share any suitable restricted table data as table restrict data 1822d to any suitable BAS 20 (see, e.g., operations 428 to 432 and data 432d of process 400), and BAS 20 may receive, use, and evaluate such data in any suitable way and then respond to AuthService subsystem 110 at operation 1348 with any suitable compare data as compare response data 1824d (see, e.g., operations 434 and 436 and data 436d of process 400).

Next, operation 1360 or otherwise of process 1300 may include operation 1350, where AuthService subsystem 110 may process such compare response data 1824d in any suitable manner to reconstruct seed s (see, e.g., operations 438 and 440 of process 400), where reconstructed seed s of operation 1350 of authentication process 1300 may be the same seed s of operation 1218 of enrollment process 1200.

In some embodiments, once seed s has been reconstructed, operation 1360 or otherwise of process 1300 may include any suitable operation(s) 1352, where any suitable authorized actions may occur with AuthService subsystem 110 and/or BAS 20 and/or otherwise, such as retrieving any suitable secret(s) using reconstructed seed s (e.g., private user key skᵤ) and generating any suitable challenge response for web browser 69w and/or third party subsystem 90 of the session using such secret(s). For example, at operation 1352 of authorization process 1300, AuthService subsystem 110 may be configured to deterministically derive private user key skᵤ from reconstructed seed s, just as private user key skᵤ may have previously been deterministically derived from original seed s by AuthService subsystem 110 at operation 1218 of enrollment process 1200 (also, see, e.g., operation 440 of process 400, operation 526 of process 500, operation 618 of process 600, and/or the like). Then, also at operation 1352 of authorization process 1300, AuthService subsystem 110 may be configured to identify any suitable transaction data (e.g., TRDT) that may have been generated by third party subsystem 90 for the user transaction of the current session (e.g., as may be defined by third party subsystem 90 as a part of transaction data 1803d of operation 1306 and then shared with AuthService subsystem 110 at operation 1312 (e.g., as a portion of authentication attempt message aam)) and then such transaction data may be processed in some way to enable verification of the authentication process by device 60 and/or third party subsystem 90. For example, in some embodiments, AuthService subsystem 110 may be configured to encrypt or sign or otherwise manipulate or process such transaction data with private user key skᵤ as recently derived. Then, at operation 1354, AuthService subsystem 110 may be configured to confirm such successful authentication by sharing any suitable success data with browser 69w of device 60 (e.g., as success data 1827d) and/or with third party subsystem 90 (e.g., as success data 1828d (e.g., directly from AuthService subsystem 110 or via device 60 (e.g., at operation 1356))), where such success data may include the transaction data as encrypted or signed or otherwise manipulated or processed by private user key skᵤ from operation 1352 (e.g., as a transaction data challenge response (also see, e.g., operation 620 of process 600)). In some embodiments, operation 1354 may include AuthService subsystem 110 using the reconstructed seed to rederive a seedEntropy string and include such a string in data 1827d. Then, at operation 1358, third party subsystem 90 may be configured to receive and process such success data to attempt to verify the transaction data challenge response (e.g., using public user key pkᵤ of the same keypair as private user key skᵤ, where such public user key pkᵤ may have been shared by AuthService subsystem 110 at an earlier stage (e.g., during an associated successful enrollment process 1200 (e.g., through data 1723d and/or data 1724d)), such that the requested transaction of operation 1304 may be fully executed by third party subsystem 90 (also see, e.g., operation 534 of process 500 and operation 622 of process 600). Therefore, if authentication is successful by AuthService subsystem 110 and the ensuing verification of the transaction data challenge response is successful by third party subsystem 90, subsystem 90 may authenticate user U for the requested transaction (e.g., grant access to the third party customer's requested service) at operation 1358 (see, e.g., UI screen 700ad of FIG. 7AD and UI screen 700ae of FIG. 7AE that may be presented by third party subsystem 90 to user U (e.g., via web browser 69w of the session)). In such embodiments, this use of such a user keypair (skᵤ, pkᵤ) may be unique to a particular user U, in which case third party subsystem 90 may have to keep track of distinct public user keys pkᵤ for all its users in order to be enabled to verify transactions for all its users in this manner. A similar verification process may be enabled for a successful enrollment process 1200 (e.g., at operations 1242 to 1250).

In some embodiments, AuthService subsystem 110 and/or BAS 20 may be configured to act as any suitable Certificate Authority (“CA”) (e.g., under the X.509 public key certificate standard). In such embodiments, third party subsystem 90 may be enabled to know the root public key of the certificate authority. During enrollment, the AuthService CA and/or BAS CA may be configured to issue an end-user certificate that may include the user URID and/or the customer CRID of the session as well as the user's public user key pkᵤ, and may be signed under the CA private key. The certificate may be stored alongside other keys as a part of the user profile data on the AuthService. Then, when the AuthService may send the transaction data challenge response to the third party subsystem (e.g., at operation 1354), the associated user's end-user certificate may be sent along with the transaction data challenge response, such that the third party subsystem may access the appropriate public user key pkᵤ at that time (e.g., by processing the certificate using the public key of the certificate authority). A similar verification process may be enabled for a successful enrollment process 1200 (e.g., at operations 1242 to 1250).

In some embodiments, core backend keys may be utilized, where, for each customer (e.g., each third party subsystem 90), KMS subsystem 120 may be configured to generate a “customer transaction data signing keypair” (sk_{c}, pk_{c}) (e.g., using any suitable asymmetric algorithm RSA or ECDSA or the like), such as at operation 1201 and/or operation 1301. The private key of this customer transaction data signing keypair may be stored at KMS subsystem 120 (e.g., at operation 1201 and/or operation 1301), while the public key of this customer transaction data signing keypair may be provided to its associated third party subsystem 90 (e.g., at operation 1201 and/or operation 1301) for subsequent validation. Then, at operation 1352, AuthService subsystem 110 may be configured to send the transaction data (e.g., the transaction data challenge) to KMS 120 as any suitable data (not shown (e.g., via BAS 20)) for signing with the private key sk_{c} of the relevant customer transaction data signing keypair, and KMS 120 may return back this signature under the customer transaction data signing keypair to third party subsystem 90 (e.g., directly (not shown) or via BAS 20 and/or AuthService subsystem 110 and/or device 60) to enable appropriate verification processing (e.g., at operation 1358) using the public key pk_{c} of this customer transaction data signing keypair. A similar verification process may be enabled for a successful enrollment process 1200 (e.g., at operations 1242 to 1250).

In some embodiments, process 1300 may include an operation 1362 at which any suitable biometrics may be updated using AuthService 110 and BAS 20 (similarly see, e.g., operation 444 to 452 of process 400).

In some embodiments, process 1300 may include an operation 1364 at which any suitable data may be deleted by AuthService 110 (e.g., for security purposes), such as user data key ka and/or image encryption key kᵢ and/or any other suitable sensitive data that has not yet been deleted (e.g., at operation 1362 (see, e.g., operation 452)), including, but not limited to, reconstructed seed s, re-derived private user key skᵤ, ABS b, EBT B, uab, unwrapped private device signing key sk_{d} and unwrapped private device encryption key sk_{c}, and/or any suitable elements of the privacy-preserving authentication protocol 1360.

The operations shown in process 1300 of FIG. 13 are only illustrative and existing operations may be modified or omitted, additional operations may be added, and the order of certain operations may be altered.

### FIG. 14

FIG. 14 is a flowchart of an illustrative process 1400 for enrolling an APS user U with the APSP using any suitable web browser of any suitable user device (e.g., any suitable web browser application 69w of any suitable user device 60 (e.g., Google Chrome, Safari, Edge, Firefox, etc.)), rather than, for example, using a dedicated APS application (e.g., of process 200). Like process 1200, process 1400 is shown being implemented by any suitable user device 60 with any such web browser 69w, its user U, any suitable biometric authentication subsystem (“BAS”) 20, any suitable third party subsystem 90, and any suitable fortress solution 140″ (e.g., any suitable AuthService subsystem 110 and any suitable KMS subsystem 120 along with any suitable enclave subsystem 130). However, unlike process 1200, process 1400 may be implemented by also using any suitable enclave subsystem 130 as a portion of the fortress solution. Process 1400 may be implemented using any other suitable components or subsystems or entities of any suitable system 1 of FIG. 1 or otherwise (e.g., node(s) 70 and repository 80 may be replaced by any suitable server(s) (e.g., APS subsystem 100)). Process 1400 may provide a seamless user experience for securely and efficiently enrolling user U with the APSP using any suitable web browser 69w of any suitable user device 60. Process 1400 may involve any of the same devices 60 and/or browsers 69w and/or third party subsystems 90 (e.g., customer) and/or users U and/or BAS 20 and/or KMS 120 and/or AuthService subsystems 110 as process 1200 and/or process 1300, and the user experience to an end user U may be the same. To facilitate the following discussion regarding the operation of system 1 for enrolling user U with the APSP according to process 1400 of FIG. 14, reference is made to various components of system 1 of the schematic diagrams of FIGS. 1 to 11, and to screens 700a-700i that may be representative of a graphical user interface of user device 60 during such a process (e.g., as shown in FIGS. 7A-7I, but in an APS app rather than in a web browser (e.g., as may be shown in FIGS. 7X-7AE)). The operations described may be achieved with a wide variety of graphical elements and visual schemes. Therefore, the embodiments of FIGS. 7A-7I are not intended to be limited to the precise user interface conventions adopted herein. Rather, embodiments may include a wide variety of user interface styles.

As shown in FIGS. 14 and 15, any suitable enclave subsystem 130 may be configured to run a more robust core APS mobile or client SDK functionality component (e.g., as any suitable application 139a (e.g., via any suitable data 139d) and/or any suitable hardware) that may work with the APS WebSDK component of browser 69w of device 60 to enable any suitable privacy-preserving protocol with any suitable BAS subsystem 20 for enrolling and/or authenticating a user of the web browser with the APSP. In some embodiments, any suitable AuthService subsystem 110 may be used to provide any suitable network communication between the web browser device 60 and enclave subsystem 130 if the enclave is not configured for such network communication on its own. Enclave subsystem 130 may be configured to provide any suitable secure enclave, whose memory cannot be accessed by the operator (e.g., the enclave may be configured to isolate all private keys, biometrics, seeds, or any other data thereon from being accessed by an operator). Enclave subsystem 130 may be trusted by web browser 69w and/or KMS subsystem 120 through any suitable attestation (e.g., any suitable remote attestation), where enclave subsystem 130 may work with any suitable web browser 69w such that system 1 may enable APS authentication to be platform-agnostic and adaptable to different trust environments, such as AWS Nitro Enclaves, Intel SGX, and other trusted execution environment technologies, which may allow for widespread adoption across various industries without vendor lock-in.

Process 1400 may begin at operation 1401, where a subsystem relationship (e.g., between KMS subsystem 120 and AuthService subsystem 110 and/or third party subsystem 90 and/or enclave subsystem 130) may be configured by the system. This subsystem relationship may be configured prior to any enrollment and/or any authentication with the APSP via a web browser. This subsystem relationship may or may not be unique to any particular third party subsystem, although such a unique relationship (e.g., for one or more portions of the configuration data) may be configured for a particular third party subsystem if desired. This subsystem relationship may be configured once for a particular AuthService subsystem 110, which may be used for all embodiments or, in some embodiments, there may be a different AuthService subsystem used for each respective continent or any other suitable arrangement. The configuring of operation 1201 may include any suitable communication(s) between KMS subsystem 120 and any of AuthService subsystem 110, third party subsystem 90, user device 60, enclave subsystem 130, and/or the like in order to enable the system to carry out any suitable APSP enrollment and/or authentication with any suitable web browser using any suitable website(s). Some of the configuration data of operation 1401 of process 1400 may be the same as that of operation 1201 of process 1200, including, but not limited to, pk_{c}, KIDk_{c}, AIDk_{c}, KIDkᵣ, AIDkᵣ, CRID, and/or the like. However, operation 1401 might not include generating and appropriately storing image encryption wrapping keypair (sk_{w}, pk_{w}) and associated KIDk_{w}/AIDk_{w}. Instead, any suitable attestation may be developed at process 1400 (e.g., between enclave subsystem 130 and KMS subsystem 120 and/or between enclave subsystem 130 and web browser 69w of device 60). For example, operation 1401 may include generating any suitable attestation keypair (private attestation key skₙ, public attestation key pkₙ), which may be any suitable (e.g., assymetric) keypair that may be generated by any suitable source (e.g., not shown) that may enable public attestation key pkₙ to be made available to KMS subsystem 120 and third party subsystem 90 and/or device 60 (e.g., at website information 1702) alone or with any suitable associated KIDKₙ and/or AIDKₙ. Additionally or alternatively, operation 1401 may include providing any suitable enclave measurement ENCm, which may be a hash of any suitable software that may be running on the enclave of enclave subsystem 130 (e.g., a hash of any suitable application or other software 139a or otherwise) to KMS subsystem 120 and to third party subsystem 90 and/or device 60 (e.g., at website information 1702). Additionally or alternatively, process 1400 may include another suitable keypair, such as an enclave instance keypair (private enclave instance key skᵥ, public enclave instance key pkᵥ), being generated (e.g., at enclave subsystem 130) at any suitable operation (e.g., at operation 1404) along with any suitable attestation document (“AD”) that may be generated by any suitable attestation service of enclave subsystem 130. The AD may include any suitable data, including, but not limited to, enclave measurement ENCm, public enclave instance key pk_{c}, and/or any other suitable data, which is then (e.g., at operation 1404 or otherwise prior to operation 1416) signed by private attestation key skₙ (e.g., by any suitable service (e.g., not shown (e.g., any suitable enclave operator))) to define the AD, and the AD may then be made available by enclave subsystem 130 to device 60 (e.g., via AuthService subsystem 110 (e.g., at operations 1416 and 1418)). Such subsystem relationship configuration of operation 1401 in combination with any suitable attestation configuration of operation 1404 and the like may enable web browser 69w to trust and use enclave subsystem 130 for APSP enrollment and/or authentication.

At operation 1401 of process 1400, in order to configure a suitable subsystem relationship, KMS subsystem 120 may be configured to generate any suitable keys for enabling a secure APSP, including, but not limited to, any suitable customer transaction data signing keypair (sk_{c}, pk_{c}), any suitable user data wrapping key kᵣ, any associated KIDs and/or AIDs, and/or the like. Additionally, at operation 1401, any suitable service may be configured to generate any suitable keys and/or the like for further enabling a secure APSP, including, but not limited to, any suitable attestation signing keypair (skₙ,pkₙ), any associated KIDs and/or AIDs, any suitable enclave measurement ENCm, and/or the like. Additionally (e.g., at operation 1404), any suitable service may be configured to generate any suitable keys and/or the like for further enabling a secure APSP, including, but not limited to, any suitable enclave instance keypair (skᵥ, pkᵥ), any associated KIDs and/or AIDs, any suitable attestation document AD, and/or the like. For example, this may enable third party subsystem 90 and/or any associated website 1700 running on any suitable browser 69w of any suitable device 60 to have access to any suitable configuration data, such as pk_{c}, KIDk_{c}, AIDk_{c}, KIDkᵣ, AIDkᵣ, pk_{w}, KIDkₙ, AIDkₙ, ENCm, and a CRID, while KMS subsystem 120 may have access to any suitable configuration data, such as kᵣ and sk_{c}, as well as pk_{w}, KIDkₙ, AIDkₙ, and ENCm, while enclave subsystem 130 may have access to any suitable configuration data, such as enclave instance keypair (skᵥ, pkᵥ) and attestation document AD. Additionally, at operation 1401, any suitable AuthToken validation configuration may be enabled between third party subsystem 90 and AuthService subsystem 110 (e.g., similarly to as described with respect to operation 1201).

After operation 1401, process 1400 may include an operation 1402 where the system may be configured to attempt to authenticate any suitable browser scenario or session (e.g., any suitable browser scenario or browser session between a user U of any suitable user device 60 using any suitable web browser 69w to access any suitable website of any suitable third party subsystem 90 of the system) and generate any suitable AuthToken (e.g., an OAuth 2.0 token) if the authentication is successful. In some embodiments, this may be similar to operation 1201 of process 1200. In some embodiments, operation 1402 may occur at any suitable time prior to operation 1410 (e.g., after operation 1406 and/or operation 1408), such that any suitable attempt message (e.g., eam of data 1904d) may include the AuthToken of operation 1402. In some embodiments, such a scenario or session may be authenticated at operation 1402 by identifying any suitable authentication cookie that may be stored in the web browser of the session, where such an authentication cookie may be generated and stored once the session has been authenticated through some other technique. Such another technique for authenticating the browser session at operation 1402 may include authenticating the user of the session through any suitable methods (e.g., non-APSP biometric methods), such as authenticating the user through conducting a successful user log-in to an existing user account of the third party subsystem (e.g., third party subsystem 90 collecting log-in credentials (e.g., user name and password) from user U via device 60 and processing such log-in credentials to verify whether or not the log-in credentials are for an existing account (e.g., using a screen that may be similar to screen 700j of FIG. 7J)) or any other suitable KYC check, credit card on device check, and/or the like. Once the browser session is authenticated by the browser and third party subsystem, operation 1402 may continue by generating any suitable AuthToken for the session. Such an AuthToken for an authenticated browser session may be generated by third party subsystem 90 and provided to web browser 69w (e.g., as a portion of any suitable website information 1702 of a website of the third party). Once an AuthToken has been generated for a successfully authenticated browser session at operation 1402 (e.g., once the AuthToken has been generated by third party subsystem 90 and provided to device 60 (e.g., to web browser 69w)), process 1400 may be enabled to attempt to carry out the remainder of an enrollment process (e.g., operation 1408 through operation 1472) for that browser session (e.g., by presenting an “ENROLL” option for user U via web browser 69w of the session (e.g., using a screen similar to screen 700a of FIG. 7A)).

After a browser session has been authenticated and an AuthToken generated at operation 1402, process 1400 may include operations 1406 and 1408, where the system may be configured to enable a user of the session to initiate APSP enrollment. For example, at operation 1406, user U may initiate APSP enrollment for the browser session by carrying out any suitable enrollment initiation interaction eii 1903d with web browser 69w that may be presenting any suitable APS website on user device 60. For example, similarly to as shown by screen 700a of FIG. 7A, the UI of user device 60 may present an “ENROLL” option for user U to select with its enrollment initiation interaction eii in order to proceed with process 1400 for enrolling with the APSP. In advance of operation 1402, the third party website may be accessed by web browser 69w on user device 60 or otherwise (e.g., using any other suitable device) in any suitable manner and user U may carry out any suitable account set-up operations with respect to the website (e.g., creating an account, logging-in, etc.), although any set-up operations not shown may or may not be required.

At operation 1408, user device 60 may detect such an enrollment initiation interaction eii and, in response to such detection, user device 60 may generate and send any suitable enrollment attempt message eam (e.g., as data 1904d) to AuthService subsystem 110 (e.g., using any suitable communication channel(s) and/or any suitable communication protocol(s)), such as by using the URL of the AuthService that may be included in website information 1702 (e.g., as may be defined at operation 1401 or otherwise). Enrollment attempt message eam may be configured to include any suitable data, including, but not limited to, any suitable enrollment initiation information, any suitable image encryption and wrapping information, any suitable information that may be used for “authorized actions” after successful enrollment, and/or the like. For example, enrollment attempt message eam may include any suitable enrollment initiation information, including, but not limited to, an “event” field that may be defined by some attempt identifier (e.g., “Attempt”), a “sessionType” field that may be defined by some enrollment identifier (e.g., “ENROLLMENT”), a “customer” field that may be defined by some identifier (e.g., CRID) of the customer of the session (e.g., “some-company” (e.g., “CITIBANK” or “FACEBOOK” or “B'GOCK” or “ABC_CUSTOMER” or the like)), a “username” field that may be defined by some identifier (e.g., URID) of the end user (e.g., some.user@company.eu (e.g., “john.doe@doemail.com” or the like)), an “authorizationToken” field that may be defined by some string (e.g., the AuthToken generated at operation 1402), and/or the like. Additionally or alternatively, enrollment attempt message eam may include any suitable subsystem configuration data (e.g., from operation 1401), such as any suitable image encryption and wrapping information and/or any suitable configuration data from operation 1401. Additionally or alternatively, enrollment attempt message eam may include any suitable information that may be used for “authorized actions” after successful enrollment, including, but not limited to, a “transactionData” field that may be defined by some string (e.g., TRDT) or other suitable data (e.g., as may be generated by third party subsystem 90 (e.g., at operation 1401 or afterwards (e.g., similarly to operation 1510 of process 1500)), a “seedEntropy” field that may be defined as either true or false, and/or the like. Any other suitable information may be included in enrollment attempt message eam of operation 1408, which may be similar to eam of operation 1208. In some embodiments, operation 1402 may be carried out after operation 1406 (e.g., after eii 1902d may be received by device 60) but prior to the completion of operation 1408, which may rely on the AuthToken of operation 1402.

At operation 1410, AuthService subsystem 110 may be configured to receive and attempt to validate any suitable portion(s) of enrollment attempt message eam in any suitable manner. This may include attempting to validate any suitable enrollment initiation information of the received enrollment attempt message eam, including, but not limited to, an “authorizationToken” (AuthToken), “username” (URID), “customer” (CRID), and/or the like. AuthService subsystem 110 may be configured to attempt to validate the AuthToken using any suitable AuthToken configuration data of operation 1401 and/or otherwise for validating the AuthToken according to any appropriate tool(s) or framework(s), including, but not limited to, OIDC, OAuth 2.0, SAML 2.0, and/or the like. If validation fails, process 1400 may end or the AuthService may instruct the web browser to try again due to failure of the AuthToken. If validation succeeds, AuthService subsystem 110 may proceed to forward at least a portion or all of enrollment attempt message eam to enclave subsystem 130 (e.g., using any suitable communication channel(s) and/or any suitable communication protocol(s)) at operation 1410 as eam data 1905d.

At operation 1414, in addition to accessing enclave instance keypair (skᵥ, pkᵥ) and the attestation document AD from operation 1404 and receiving eam data 1905d from AuthService subsystem 110, enclave subsystem 130 may generate any suitable data, which may include carrying out any suitable actions for generating any suitable data for enabling enrollment and/or later authentication, including, but not limited to, any suitable secret value or seed s in any suitable manner (e.g., as described at operation 204), such as by using any suitable enclave application(s). Additionally, at operation 1414, enclave subsystem 130 may then derive or otherwise generate or obtain, such as by using any suitable enclave application(s), one or more suitable keys and/or one or more suitable keypairs in any suitable manner (e.g., as described at operation 206) including, but not limited to, a user (e.g., user signing) keypair (private user key skᵤ, public user key pkᵤ) (e.g., a user biometric keypair (e.g., which may be unique per user U or current browser session), which may be generated or otherwise derived using seed s), a random device signing keypair (private device signing key sk_{d}, public device signing key pk_{d}) (e.g., which may be unique per device 60), a random device encryption keypair (private device encryption key skₑ, public device encryption key pkₑ) (e.g., which may be unique per user U), and/or the like.

At operation 1416, enclave subsystem 130 may send any suitable attestation and keys request data 1908d to AuthService subsystem 110 (e.g., using any suitable communication channel(s) and/or any suitable communication protocol(s)), where such data 1908d may include the attestation document AD (e.g., of operation 1404) and any suitable request for a new user data key and a request for a new image encryption key. Such a new user data key request portion of data 1908d may include any suitable information that may be available to enclave subsystem 130 and useful to AuthService subsystem 110 for forwarding the request to KMS subsystem 120 and useful to KMS subsystem 120 for fulfilling the request (e.g., beyond the attestation document of data 1908d). For example, this new user data key request may include any suitable request data that may be used by KMS subsystem 120 to understand the type of data being requested (e.g., a new user data key) and any other suitable data that may be useful to KMS subsystem 120 (e.g., to instill some trust in the request), such as a key identifier (e.g., KIDkᵣ) of user data wrapping key kᵣ (e.g., as may be known to KMS subsystem 120 from operation 1201 and as may be known to AuthService subsystem 110 and/or enclave subsystem 130 from received enrollment attempt message eam and/or otherwise (e.g., operation 1401)) and/or an algorithm identifier (e.g., AIDkᵣ) of the algorithm used to generate user data wrapping key kᵣ (e.g., as may be known to KMS subsystem 120 from operation 1401 and as may be known to AuthService subsystem 110 and/or enclave subsystem 130 from received enrollment attempt message eam and/or otherwise (e.g., operation 1401)). Such anew image encryption key request portion of data 1908d may include any suitable information that may be available to enclave subsystem 130 and useful to AuthService subsystem 110 for forwarding the request to KMS subsystem 120 and useful to KMS subsystem 120 for fulfilling the request (e.g., beyond the attestation document of data 1908d). For example, this new image encryption key request may include any suitable request data that may be used by device 60 to understand the type of data being requested (e.g., a new image encryption key) and any other suitable data that may be useful to device 60 (e.g., to instill some trust in the request), such as any data from the eam (e.g., if useful). However, in some embodiments, device 60 may already have the eam (e.g., from operation 1408).

At operation 1418, AuthService subsystem 110 may receive data 1908d from enclave subsystem 130 and process such data in order to forward the attestation document and any other new user data key request portion of data 1908d to KMS subsystem 120 (e.g., using any suitable communication channel(s) and/or any suitable communication protocol(s)) as AD and user data key request data 1909ad (e.g., any suitable request data that may be used by KMS subsystem 120 to understand the type of data being requested (e.g., a new user data key) and any other suitable data that may be useful to KMS subsystem 120 (e.g., to instill some trust in the request), such as a key identifier (e.g., KIDkᵣ) of user data wrapping key kᵣ (e.g., as may be known to KMS subsystem 120 from operation 1201 and as may be known to AuthService subsystem 110 and/or enclave subsystem 130 from received enrollment attempt message eam and/or otherwise (e.g., operation 1401)) and/or an algorithm identifier (e.g., AIDkᵣ) of the algorithm used to generate user data wrapping key kᵣ (e.g., as may be known to KMS subsystem 120 from operation 1401 and as may be known to AuthService subsystem 110 and/or enclave subsystem 130 from received enrollment attempt message eam and/or otherwise (e.g., operation 1401)). Additionally, at operation 1418, AuthService subsystem 110 may receive data 1908d from enclave subsystem 130 and process such data in order to forward the attestation document and any other new image encryption key request portion of data 1908d to device 60 (e.g., using any suitable communication channel(s) and/or any suitable communication protocol(s)) as AD and image encryption key request data 1909bd (e.g., any suitable request data that may be used by device 60 to understand the type of data being requested (e.g., a new image encryption key) and any other suitable data that may be useful to device 60 (e.g., to instill some trust in the request), such as any data from the eam (e.g., if useful). However, in some embodiments, device 60 may already have the eam (e.g., from operation 1408).

At operation 1419, KMS subsystem 120 may be configured to receive and attempt to execute the request for a new user data key (e.g., the request of data 1909ad from AuthService subsystem 110). This may include KMS subsystem 120 receiving and attempting to validate the attestation document of data 1909ad (e.g., by using public attestation signing key pkₙ (e.g., as made available to KMS subsystem 120 at operation 1401 or via AuthService subsystem 110 using eam to define data 19109ad)) to decrypt or unsign the contents of the received attestation document, and then comparing the now accessible enclave measurement ENCm of that attestation document with the enclave measurement ENCm previously made available to KMS subsystem 120 (e.g., at operation 1401), and then validating the attestation document if the comparison is successful (e.g., the two ENCm's are the same)). Then, if/when the attestation document has been validated, KMS subsystem 120 may be configured to generate any suitable new user data key ka (e.g., a core database key, which may be unique for device 60 of the current session) using any suitable algorithm(s) (e.g., a symmetric encryption mode that may provide both data confidentiality (e.g., encryption) and data authenticity (e.g., ensuring data hasn't been tampered with), such as an Advanced Encryption Standard in Galois/Counter Mode (“AES-GCM”)). Next, KMS subsystem 120 may encrypt this user data key kₐ with an accessed user data wrapping key kᵣ (e.g., as may be identified by key identifier KIDkᵣ using the algorithm identified by algorithm identifier AIDkᵣ) to define wrapped user data key \hat{k}ₐ (e.g., \hat{k}ₐ=Ekᵣ (kₐ)) and may also encrypt this user data key kₐ with public enclave instance key pkᵥ (e.g., as may be identified by the content of the validated attestation document of operation 1419) to define re-wrapped user data key [symbol] (e.g., [symbol] =pkₙ(kₐ)).

Then, at operation 1420, KMS subsystem 120 may be configured to send both wrapped user data key \hat{k}ₐ and re-wrapped user data key \hat{k}′ₐ (e.g., as generated at operation 1419) as user data key response data 1910d back to AuthService subsystem 110 (e.g., using any suitable communication channel(s) and/or any suitable communication protocol(s)).

At operation 1430, device 60 may be configured to receive and attempt to execute the request for a new image encryption key (e.g., the request of data 1909bd from AuthService subsystem 110). This may include device 60 (e.g., web browser 69w or otherwise) receiving and attempting to validate the attestation document of data 1909bd (e.g., by using public attestation signing key pkₙ (e.g., as made available to device 60 at operation 1401) to decrypt or unsign the contents of the received attestation document, and then comparing the now accessible enclave measurement ENCm of that attestation document with the enclave measurement ENCm previously made available to device 60 (e.g., at operation 1401), and then validating the attestation document if the comparison is successful (e.g., the two ENCm's are the same)). Then, if/when the attestation document has been validated, device 60 may be configured to generate any suitable new image encryption key kᵢ (e.g., any suitable random data that may be generated by browser 69w, where the length of the random key may depend on the length of public enclave instance key pkᵥ (e.g., 16 bytes or otherwise)). Next, device 60 may encrypt this image encryption key kᵢ with public enclave instance key pkᵥ (e.g., as may be identified by the content of the validated attestation document of operation 1430) to define wrapped image encryption key kᵢ (e.g., \hat{k}ᵢ=Epkᵥ(kᵢ)). Then, device 60 may be configured to send this wrapped image encryption key \hat{k}ᵢ as image encryption key response data 1915d back to AuthService subsystem 110 (e.g., using any suitable communication channel(s) and/or any suitable communication protocol(s)).

At operation 1422, AuthService subsystem 110 may be configured to receive both wrapped user data key \hat{k}ₐ and re-wrapped user data key \hat{k}′ₐ of user data key response data 1910d from KMS subsystem 120 and to receive wrapped image encryption key kᵢ of image encryption key response data 1915d from device 60 and then to forward each one of those keys \hat{k}ₐ, \hat{k}′ₐ, and key \hat{k}ᵢ to enclave subsystem 130 as at least a part of any suitable keys response data 1911d (e.g., using any suitable communication channel(s) and/or any suitable communication protocol(s)).

At operation 1424, enclave subsystem 130 may receive such data 1911d, decrypt re-wrapped user data key \hat{k}′ₐ of data 1911d with private enclave instance key skᵥ (e.g., as made available at operation 1404) to obtain user data key kₐ, encrypt one or more of the generated private device keys (e.g., private device signing key sk_{d}, private device encryption key skₑ, etc. (e.g., of operation 1414)) with that obtained user data key kₐ to define wrapped private device keys (e.g., wrapped private device signing key s\hat{k}_{d} (e.g., skₐ=Ekₐ (sk_{d})), wrapped private device encryption key s\hat{k}ₑ (e.g., s\hat{k}ₑ=Ekₐ (skₑ)), and/or the like), decrypt wrapped image encryption key \hat{k}ᵢ of data 1911d with private enclave instance key skᵥ (e.g., as made available at operation 1404) to obtain image encryption key kᵢ, and to generate and send any suitable request for user enrollment biometric data from user U via web browser 69w of device 60 by generating and sending any suitable user enrollment biometrics request data 1912d to AuthService subsystem 110 (e.g., using any suitable communication channel(s) and/or any suitable communication protocol(s)).

At operation 1428, AuthService subsystem 110 may be configured to receive such user enrollment biometrics request data 1912d from enclave subsystem 130 and forward such data as user enrollment biometrics request data 1914d to device 60 (e.g., using any suitable communication channel(s) and/or any suitable communication protocol(s)).

Then, at operation 1429, user device 60 may be configured to receive and process such user enrollment biometrics request data 1914d to generate any suitable user enrollment biometrics request data 1914dp that may be presented to user U via any suitable device user interface using web browser 69w or otherwise, whereby device 60 may be enabled to capture at operation 1431 any suitable user enrollment biometrics ueb that may be presented by user U at operation 1434 as user enrollment biometrics ueb data 1917d. However, rather than user device 60 capturing such user enrollment biometrics ueb data and then processing such data for generating an EBT B on device 60, device 60 may capture (e.g., using any suitable sensor(s) 65) one or more frames of image data (e.g., during user presentation of user enrollment biometrics ueb) and any associated sensor data or fast data (e.g., any suitable environment data and/or motion data) that may be acquired by device 60 in between two or more image data frames, and then encrypt such data with image encryption key kᵢ (e.g., as generated by device 60 at operation 1430), and then send such encrypted enrollment biometric frame data 1917f to AuthService subsystem 110 at operation 1431 (e.g., using any suitable communication channel(s) and/or any suitable communication protocol(s)), which may be forwarded as data 1918f to enclave subsystem 130 for generating an EBT B. Device 60 may be configured define a particular instance of data 1917f for a particular moment in time to include not only image data for an image that may capture ueb at that particular moment in time but also any suitable other sensor data (e.g., environment data, motion data, etc.) that may have been collected by device 60 from after the moment in time of the previous instance of data 1917f to the moment in time of this particular instance of data 1917f (e.g., such that device 60 may share a combination of particular image data and associated movement data (e.g., as encrypted by image encryption key kᵢ) with enclave subsystem 130 (e.g., via AuthService subsystem 110) for further processing. Any suitable data packaging module for combining any suitable image data and associated movement data (e.g., environment data and/or motion data) into any suitable user enrollment biometric data package(s) (e.g., as may be described in co-pending, commonly-assigned U.S. patent application Ser. No. 19/217,833, which is hereby incorporated by reference herein in its entirety) may be provided by enclave subsystem 130 for generating any suitable user enrollment biometric data package(s) based on data 1917f (e.g., as decrypted by image encryption key kᵢ) prior to processing such package(s) with any suitable attack detector (e.g., as may be described in co-pending, commonly-assigned U.S. patent application Ser. No. 19/217,833, which is hereby incorporated by reference herein in its entirety).

Then, at operation 1436, AuthService subsystem 110 may be configured to receive such encrypted enrollment biometric frame data 1917f from user device 60 and forward such data as encrypted enrollment biometric frame data 1918f to enclave subsystem 130 (e.g., using any suitable communication channel(s) and/or any suitable communication protocol(s)).

At operation 1438, enclave subsystem 130 may receive any suitable encrypted enrollment biometric frame data 1918f from AuthService subsystem 110, decrypt such data using image encryption key kᵢ (e.g., as obtained at operation 1424), and then process such decrypted enrollment biometric frame data to determine if the user enrollment biometrics are acceptable (e.g., determined to be genuine) or not acceptable (e.g., determined to be a spoof or indeterminable or the like) using any suitable attack detector (e.g., as may be described in co-pending, commonly-assigned U.S. patent application Ser. No. 19/217,833, which is hereby incorporated by reference herein in its entirety). If determined not to be acceptable, enclave subsystem 130 may request new user enrollment biometric data from user U via web browser 69w of device 60 by generating and sending any suitable user enrollment biometrics feedback data 1919d to AuthService subsystem 110 (e.g., using any suitable communication channel(s) and/or any suitable communication protocol(s)), which may then be forwarded by AuthService subsystem 110 to device 60 at operation 1440 as user enrollment biometrics feedback data 1920d (e.g., using any suitable communication channel(s) and/or any suitable communication protocol(s)). Then, at operation 1441, user device 60 may be configured to receive and process such user enrollment biometrics feedback data 1920d to generate any suitable user enrollment biometrics feedback data 1920dp that may be presented to user U via any suitable device user interface using web browser 69w or otherwise, whereby device 60 may be enabled to capture at another iteration of operation 1431 any suitable additional user enrollment biometrics ueb that may be presented by user U at operation 1434 as additional user enrollment biometrics ueb data 1917d, where such operations 1434, 1431, 1436, 1438, 1440, and 1441 may together form any suitable operation loop 1451. Operation loop 1451 may be repeated any suitable number of times until enclave subsystem 130 determines at an instance of operation 1438 that the user enrollment biometrics of the most recently processed decrypted enrollment biometric frame data are acceptable (e.g., determined to be genuine), at which point process 1400 may advance from operation 1438 out of operation loop 1451 to operation 1444, where enclave subsystem 130 may generate an enrollment biometric template (“EBT”) B based on such acceptable user enrollment biometrics.

User device 60 may be configured to capture such enrollment biometrics ueb as at least a portion of data 1917d for generating data 1917f that may be forwarded by AuthService subsystem 110 as data 1918f that may be appropriately processed by enclave subsystem 130 for determining whether acceptable for use in generating an EBT B (e.g., according to web browser 69w and/or any other suitable application(s) that may be running on device 60 (e.g., different users may use different biometrics, different devices may use different sensors, different types of data may be captured in addition to biometrics (e.g., device environment data, device motion data, etc.), and/or the set of characteristics and associated actions themselves may change from one enrollment to the next, etc.)). For example, similarly to as shown by screen 700b of FIG. 7B, the UI of device 60 may optionally present a user approval request for accessing any suitable sensor(s) or other device components (e.g., a camera of device 60) for capturing user biometrics, a request which the user may accept or deny. If accepted or automatically allowed, the UI of APS device 60 may present instructions on how the user ought to present user enrollment biometrics ueb to user device 60 for capture. For example, similarly to as shown by one or more of screens 700c-700e of FIGS. 7C-7E, while the user's face (not shown) may be in the line of sight of a device camera sensor, device 60 may instruct the user to look left, then eventually look straight at the camera, and then eventually look right. This may enable device 60 to capture user enrollment biometrics ueb in the form of a video or photograph sequence of the user's face rotating. This may enable “liveness” detection of the user (e.g., as may instructing the user to carry out any other suitable action while biometrics are captured (e.g., winking with one eye then with the other eye, or smiling then frowning, or saying a word or phrase, etc.) and/or adjusting one or more functionalities of the device (e.g., increasing an ambient light source of the device, etc.)). This presentation and/or feedback may help prevent spoofing and/or capturing biometrics of an unwilling user.

In some embodiments, operation loop 1451 may achieve improved efficiency if user device 60 (e.g., web browser 69w) is configured to conduct any suitable biometric acceptability determinations by processing data 1917d on board device 60 and immediately provide certain feedback to user U (e.g., as data 1920dp) without requiring such biometric acceptability determinations to be handled by enclave subsystem 130 (e.g., at one or more instances of operation 1438). For example, device 60 may be configured to make certain acceptability determinations and provide certain appropriate feedback on its own (e.g., face not in image, face too close to camera, etc.), thereby saving data bandwidth between device 60 and AuthService subsystem 110 and enclave subsystem 130 for communicating only user biometrics in data 1917f to AuthService subsystem 110 and in data 1918f to enclave subsystem 130 that meet a first threshold of acceptability determined by device 60 (e.g., only “good images” of a user's face may be included in data 1917f communicated to AuthService subsystem 110 and then as data 1918f to enclave subsystem 130). For example, such device-based acceptability determinations may be enabled through part of browser code (e.g., as part of APS library 1704 for enabling browser biometric analysis (e.g., in web assembly module 1708)). Therefore, some of the acceptability determination work of operation 1438 may be offloaded from enclave subsystem 130 to user device 60 at operation 1431 and operation 1441 so an initial filter at a browser of user device 60 may enable initial quality check(s) and then only pass acceptable frames to enclave subsystem 130 (e.g., AuthService subsystem 110) for further analysis at operation 1438.

Then, at operation 1444, once enclave subsystem 130 has determined at an instance of operation 1438 that the user enrollment biometrics of the most recently processed decrypted enrollment biometric frame data 1918f are acceptable (e.g., determined to be genuine), enclave subsystem 130 may generate an enrollment biometric template (“EBT”) B based on such acceptable user enrollment biometrics in any suitable manner (e.g., similarly as described with respect to operation 222 of process 200).

Then, once enclave subsystem 130 has generated EBT B at operation 1444, enclave subsystem 130 may be enabled to run any suitable portion of any suitable privacy-preserving biometric matching technique for enabling enrollment of user U with the biometrics of EBT B, such as by running any suitable privacy-preserving enrollment protocol of operation 1480 with BAS subsystem 20 (e.g., using any suitable SMPC and/or OPRF and/or the like (e.g., as may be described by operations 208 to 218 and 224 to 238 of process 200 herein, as may be described by process 400 and/or process 600 of U.S. Pat. No. 11,936,775, and/or the like)). By running any suitable privacy-preserving enrollment protocol of operation 1480 with BAS subsystem 20 and enclave subsystem 130 (e.g., using any suitable application 139 (e.g., an APS application 139a)) rather than with BAS subsystem 20 and an APS user device (e.g., as described with respect to process 200), process 1400 may avoid any limitations that web browser 69w might present in enabling such enrollment securely and efficiently. For example, this may avoid user device 60 having to generate any of its own device signing keys, device encryption keys, user keys, and/or the like. Additionally or alternatively, this may avoid user device 60 running any suitable biometric processing models (e.g., any suitable acceptability or liveness or attack detector models (e.g., for analyzing any suitable enrollment biometrics and/or any suitable authentication biometrics) and/or any suitable biometric authentication models), but instead such model(s) may be run on any suitable AuthService subsystem 110 and/or on any suitable enclave subsystem 130 rather than on any web browser 69w and/or any APS application 69a or otherwise that may have limited resources or capabilities (e.g., a web browser may be 10% of the size of an APS SDK (e.g., an APS application 69a) and/or may not have advanced encryption capabilities, while certain subsystems 110 and/or 130 may not have such limitations).

In some embodiments, operation 1480 or otherwise of process 1400 may include operation 1446, where any suitable portion(s) of data that may be available to enclave subsystem 130 during this active session may be sent as any suitable enroll data 1923d to AuthService subsystem 110, which may then be forwarded by AuthService subsystem 110 to BAS 20 as any suitable enroll data 1924d at operation 1448 (e.g., using any suitable communication channel(s) and/or any suitable communication protocol(s)). For example, such enroll data 1923d/1924d may include any suitable data of this enrollment session available to enclave subsystem 130, including, but not limited to, public user key pkᵤ and/or public device signing key pk_{d} (e.g., similarly to operation 208 of process 200 (e.g., AuthService subsystem 110 may send such key(s) to each node j of a selected set of nodes n (e.g., each node 70 of nodes 70a, . . . , 70n) of system 1 (e.g., according to any suitable application 139))), public device encryption key pkₑ, any suitable session unique user identifier APID for the particular session, any suitable identifier of a biometric pipeline used in the session (e.g., identifier of any suitable model(s) used at operation 1444 (e.g., “current_pipeline_id” field of user profile data of this session)), and/or the like.

In some embodiments, operation 1480 or otherwise of process 1400 may include operation 1450, where any suitable portion(s) of such enroll data 1924d may be received, stored, and/or verified by any suitable BAS 20. For example, some or all of data 1924d received by BAS 20 may be stored at any suitable portion(s) of BAS 20 for use during later portion(s) of the enrollment process and/or for a future authentication process involving the current session (e.g., similarly to operation(s) 210 and/or 236 of process 200 (e.g., each node j of selected nodes n may receive data 1924d from AuthService subsystem 110 and store (e.g., according to application 79 of that particular node 70) the public user key pkᵤ and public device signing key pk_{d} of data 1924d and/or the like, such as together (e.g., in a linked fashion (e.g., with session unique user identifier APID, biometric pipeline identifier(s), etc.)), as a portion of node APSP data 79d in memory 73 of the node)). In some embodiments, BAS 20 may also be configured to verify any such enroll data 1924d at operation 1450 by generating and sending any suitable enroll response data 1925d in response to AuthService subsystem 110 (e.g., using any suitable communication channel(s) and/or any suitable communication protocol(s)), where such enroll response data 1925d may be forwarded as any suitable response data 1926d from AuthService subsystem 110 to enclave subsystem 130. Such verification may be configured to achieve any suitable functionality for any suitable result(s) (e.g., similarly to any of operation(s) 210, 212, 214, 216, and/or 218 of process 200). Alternatively, in some other embodiments, rather than BAS 20 sending a challenge to enclave subsystem 130 (e.g., via AuthService subsystem 110) that may be solved by any suitable private key(s) that may be available to enclave subsystem 130 and then returned to BAS 20 for verifying a signature of the challenge response, any suitable messages that may be sent from enclave subsystem 130 (e.g., via AuthService subsystem 110) to BAS 20 (e.g., data 1924d) may be signed using any suitable private key(s) that may be available to enclave subsystem 130.

In some embodiments, operation 1480 or otherwise of process 1400 may include operation 1454, where enclave subsystem 130 may generate any suitable authentication circuit information (“ACI”) and share some or all of such ACI as any suitable ACI data 1927d with AuthService subsystem 110, which may then be forwarded as any suitable ACI data 1928d at operation 1456 from AuthService subsystem 110 to any suitable BAS 20 (e.g., using any suitable communication channel(s) and/or any suitable communication protocol(s)). For example, such ACI may be generated in any suitable manner (e.g., similarly to operation 224 of process 200 (e.g., enclave subsystem 130 may generate one or more sets of authentication circuit information ACI on seed s (e.g., of operation 1414) and EBT B (e.g., of operation 1444) for any selected nodes n using secure multi-party computation (e.g., according to any suitable application 139), where such generating of operation 1454 may be carried out in any suitable manner for enabling SMPC by the APSP to allow for each node j of nodes n to carry out a comparison on EBT B and a later generated authentication biometrics sample ABS without the node having access to the actual EBT or to the actual ABS) and then at least a portion of such ACI may be shared as ACI data 1927d with any suitable BAS 20 (e.g., via AuthService subsystem 110 as ACI data 1928d (e.g., similarly to data 226d of process 200).

In some embodiments, operation 1480 or otherwise of process 1400 may include operation 1458, where any suitable portion(s) of such ACI data 1928d may be received, stored, and/or verified by any suitable BAS 20. For example, some or all of data 1928d received by BAS 20 may be stored at any suitable portion(s) of BAS 20 for use during later portion(s) of the enrollment process and/or for a future authentication process involving the current session (e.g., similarly to any of operation(s) 228 and/or 234 of process 200). In some embodiments, BAS 20 may also be configured to verify any such ACI data 1928d at operation 1458 by generating and sending any suitable ACI response data 1929d to AuthService subsystem 110 (e.g., using any suitable communication channel(s) and/or any suitable communication protocol(s)) that may then be forwarded at operation 1442 as any suitable ACI response data 1921d from AuthService subsystem 110 to enclave subsystem 130. Such verification may be configured to achieve any suitable functionality for any suitable result(s) (e.g., similarly to any of operation(s) 228, 230, 232, 234, 236, and/or 238 of process 200). Alternatively, in some other embodiments, rather than a circuit identifier list being available to enclave subsystem 130 and/or stored on AuthService subsystem 110 during enrollment (e.g., similarly to process 200) and then enclave subsystem 130 and/or AuthService subsystem 110 picking one circuit identifier and asking BAS 20 to use that specific circuit to perform authentication (e.g., similarly to operation 424 of processes 200/400), a circuit identifier list may not be stored on enclave subsystem 130 and/or on AuthService subsystem 110 but, instead, may upload circuits to BAS 20 (e.g., at operation 1458) and when AuthService subsystem 110 and/or enclave subsystem 130 may want to authenticate, it may call BAS 20 asking for one or more random circuits to be selected from a pool of circuits that may be available for the user of the session being authenticated (see, e.g., operations 1546 and 1550 of process 1500 of FIG. 15), which may, for example, enable shared circuits rather than dedicated circuits. In such embodiments, it may be easier to have more devices available to an enrolled user. Although enclave subsystem 130 and/or AuthService subsystem 110 may be configured to store one or more circuit identifiers (e.g., similarly to operation 238 (e.g., at operation 1480 or otherwise)), they may need to be updated after every authentication.

In some embodiments, operation 1480 or otherwise of process 1400 may include any suitable operation 1482, where enclave subsystem 130 may receive ACI response data 1921d and then any suitable operation(s) 1460, where any suitable authorized actions may occur with enclave subsystem 130 and/or BAS 20 (e.g., via AuthService subsystem 110 (not shown)) and/or otherwise, such as for generating any suitable third party transaction challenge response for enrollment process 1400 (e.g., similarly to how may be done by operation 1568 for generating any suitable third party transaction challenge response for authentication process 1500).

In some embodiments, such as after operation 1480 or otherwise after enrollment has been enabled, process 1400 may include an operation 1462, where enclave subsystem 130 may generate any suitable request for storage by sending any suitable storage data 1931d currently available to enclave subsystem 130 for the current session to AuthService subsystem 110, such that this data may be stored by AuthService subsystem 110 prior to the end of this enrollment session in order for such data to be re-loaded by AuthService subsystem 110 during a later associated authentication session (e.g., during process 1500). In some embodiments (e.g., if the seedEntropy field of enrollment attempt message eam is true), enclave subsystem 130 may generate any suitable seedEntropy string using seed s at operation 1462 and include it in data 1931d. At operation 1462, enclave subsystem 130 may delete or otherwise not store in any long-term memory any suitable data that may be available to enclave subsystem 130, including, but not limited to, the content of data 1931d, seed s, keys sk_{d}, skₑ, skᵤ, kᵢ, kₐ, ueb, B, and/or any other suitable data that may be available to enclave subsystem 130 that may be related to the session. In some embodiments all data generated by or received by enclave subsystem 130 (e.g., from operation 1414 to operation 1462) may be deleted from enclave subsystem 130 before ending process 1400. In some embodiments, the data of operation 1404 may be carried over between instances of process 1400 and/or processes 1500, while, in other embodiments, the data of operation 1404 may be deleted at operation 1462 and a new iteration of operation 1404 may occur for each iteration of process 1400.

At operation 1464, AuthService subsystem 110 may receive such storage data 1931d and carry out any suitable actions for generating and/or storing any suitable data for enabling enrollment and/or later authentication, where at least some of this data may be stored (e.g., as any suitable session user profile data 1932d) for later retrieval during an authentication session. For example, at operation 1464, AuthService subsystem 110 may generate any suitable unique authentication process identifier APID (e.g., any suitable number or string of any suitable format (e.g., a random string or any sequentially generated ID, etc.) or the APID may be the URID (e.g., if no CRID and the user is attempting to authenticate themself with an APSP that may only have a single customer or no customer and thus no need for a CRID)) for the current enrollment session (or receive such an APID (e.g., as a portion of data 1931d) as may be generated by enclave subsystem 130) and store that APID against or in association with or otherwise using any suitable session entity identifier(s) of the current enrollment session (e.g., CRID, URID, etc.) that may be made accessible to AuthService subsystem 110 via enrollment attempt message eam as received and validated at operation 1410 (e.g., AuthService subsystem 110 may store such an APID against such entity identifier(s) as a portion of any suitable data 119dw that may be stored locally on AuthService subsystem 110 or that may be stored remotely from but accessible to AuthService subsystem 110 (e.g., as any suitable portion of any suitable APID look-up data (e.g., APID look-up data 1932u))). In other embodiments, the APID may be the URID and the URID may be used as the APID. Therefore, such session entity identifier(s) (e.g., the combination of a URID and CRID) of APID look-up data 1932u may be used as a look-up tool or other suitable link for accessing the APID of the APID look-up data 1932u of a particular enrollment session (e.g., the enrollment session of enrollment process 1500) at some later time (e.g., during a future authentication session (e.g., at operation 1520 of an authentication process 1500)). Additionally, at operation 1464, AuthService subsystem 110 may generate any suitable session user profile data for the current enrollment session (e.g., any data of the current enrollment session that may be useful for a future authentication session) and store that session user profile data against the APID (e.g., AuthService subsystem 110 may store such session user profile data against the APID of the session (e.g., the APID generated at operation 1464) as a portion of any suitable data 119dw that may be stored locally on AuthService subsystem 110 or that may be stored remotely from but accessible to AuthService subsystem 110 (e.g., as any suitable portion of any suitable session user profile data look-up data (e.g., session user profile data look-up data 1932d))). Therefore, the APID of session user profile data look-up data 1932d may be used as a look-up tool or other suitable link for accessing the session user profile data of the session user profile data look-up data 1932d of a particular enrollment session (e.g., the enrollment session of enrollment process 1400) at some later time (e.g., during a future authentication session (e.g., at operation 1520 of an authentication process 1500)). Such session user profile data of the session user profile data look-up data 1932d may include any suitable data, including, but not limited to, one, some, or each wrapped private device keys (e.g., key s\hat{k}_{d}, key s\hat{k}ₑ, and/or the like) as may be generated at operation 1424 and provided to subsystem 110 as data 1931d, wrapped user data key \hat{k}ₐ as may be received from data 1910d and/or data 1931d (e.g., wrapped user data key \hat{k}ₐ may be used to enable repossession of user data key kₐ across different sessions, such as between an iteration of enrollment process 1400 and an iteration of a related authentication process 1500 due to user data wrapping key kᵣ being consistent throughout all enrollment and authentication processes for a customer or at least for a customer's user in most embodiments), Public User/Device Keys (e.g., pkᵤ, pk_{d}, pkₑ, etc.) as may be defined at operation 1414 and provided as data 1931d, any suitable session entity identifier(s) (e.g., URID, CRID, etc.) as may be provided via enrollment attempt message eam at operation 1410 or otherwise, any suitable encryption metadata (e.g., any suitable subsystem relationship data (e.g., pk_{c}, pkᵤ, AIDkₙ, KIDkₙ, AIDk_{c}, KIDk_{c}, KIDkᵣ, AIDkᵣ, etc.)) that may be defined at operation 1401 and that may be made accessible to AuthService subsystem 110 at operation 1401 and/or via enrollment attempt message eam at operation 1410 and/or via data 1931d (e.g., AIDkᵣ, and/or KIDkᵣ may be included in such session user profile data in order to be used during a later authentication session (e.g., of process 1500) to recall key kᵣ for decrypting wrapped user data key \hat{k}ₐ), any other suitable session data (e.g., a “current_pipeline_id” field that may be defined by any suitable identifier of the last biometric pipeline used (e.g., identifier(s) of any suitable model(s) of any suitable neural network(s) used to generate an enrollment biometric template (“EBT”) B during this session (e.g., at operation 1444))), and/or the like. In some embodiments, key identifier KIDkᵣ may be stored as a part of the session user profile data (e.g., as a part of the encryption metadata (e.g., with or with AIDkᵣ)) so that key kᵣ of the particular user/customer (e.g., of the appropriate APID) may be easily identified during an associated authentication process (see, e.g., process 1500). Alternatively or additionally, key identifier KIDkᵣ may be stored against an appropriate CRID during subsystem configuration (e.g., at operation 1201, operation 1301, operation 1401, operation 1501, etc.), such as with any other suitable public keys, key identifiers, algorithm identifiers, enclave measurement(s), and/or the like. Therefore, after operation 1464 of an enrollment process (e.g., during a later authentication process 1500 (e.g., at operation 1520)), such a unique user identifier APID may be identified when using any suitable session entity identifier(s) (e.g., URID, CRID, and/or the like) of appropriate APID look-up data 1932u of operation 1464 and then that identified APID may be used as a look-up tool or other suitable link for accessing all other such session user profile data of session user profile look-up data 1932d of operation 1464. The session user profile data of session user profile look-up data 1932d may be defined at operation 1464 and committed to any suitable storage of AuthService subsystem 110 at operation 1464 (e.g., because the enrollment of the session has been deemed successful (e.g., at operation 1480)).

In some embodiments, such as after operation 1464, process 1400 may include an operation 1468 where the successful enrollment of the user of the session may be confirmed in any suitable way by AuthService subsystem 110 to device 60 (e.g., to web browser 69w), which may enable presenting any suitable information to user U to indicate that the enrollment was successful. For example, similarly to as shown by screens 700f-700h of FIGS. 7F-7H, web browser 69w may enable device 60 to present any suitable information to user U during such enrollment (e.g., during operations 1438, 1444, 1446, 1448, 1450, 1452, 1454, 1456, 1458, 1442, 1482, 1460, 1462, 1464, and 1468), but similarly to screen 700i of FIG. 7I, web browser 69w may enable device 60 to present any suitable information to user U when such enrollment is complete and confirmed (e.g., at operation 1470), at which time a user may be presented with any suitable enrolled options. Much of enrollment process 1400 may be carried out transparently to user U for providing a more seamless and efficient user experience. For example, operations 1408 to 1424 may be transparent to user U (e.g., between being presented with a screen similar screen 700a of FIG. 7A and being presented with a screen similar to screen 700b of FIG. 7B). As another example, operations 1444 to 1468 may be transparent to user U (e.g., between being presented with a screen similar to screen 700f of FIG. 7F and being presented with a screen similar to screen 700i of FIG. 7I). At operation 1468, AuthService subsystem 110 may generate and send any suitable success data 1934d to device 60 (e.g., which may include a seedEntropy string (e.g., as may be generated by enclave subsystem 130 at operation 1462).

In some embodiments, such as after operation 1468, process 1400 may include an operation 1470 where the successful enrollment of the user of the session may be confirmed in any suitable way by AuthService subsystem 110 to third party subsystem 90 (e.g., directly and/or via device 60) using any suitable success data 1935d.

In some embodiments, such as after operation 1470, process 1400 may include an operation 1472 where third party subsystem 90 may receive and process such success data 1935d in any suitable way for verifying the success of the enrollment of enrollment process 1400 (e.g., similarly to how may be done by operation 1358 for verifying the success of authentication process 1300 and/or operation 1576 for verifying the success of authentication process 1500).

In some embodiments, enclave subsystem 130 may be configured to communicate with one or more other subsystems directly and/or not via AuthService subsystem 110, such as when enclave subsystem 130 may be provided by an AMD secure encrypted virtualization (“SEV”) enclave or any other suitable enclave. Therefore, it is to be understood that, in some embodiments, enclave subsystem 130 may be configured to communicate directly with device 60, in which case AuthService subsystem 110 may not be utilized for forwarding such communications (e.g., at one, some, or all of operations 1418, 1422, 1428, 1436, 1440, and/or the like). Additionally or alternatively, it is to be understood that, in some embodiments, enclave subsystem 130 may be configured to communicate directly with KMS subsystem 120, in which case AuthService subsystem 110 may not be utilized for forwarding such communications (e.g., at one, some, or all of operations 1418, 1422, and/or the like). Additionally or alternatively, it is to be understood that, in some embodiments, enclave subsystem 130 may be configured to communicate directly with BAS subsystem 20, in which case AuthService subsystem 110 may not be utilized for forwarding such communications (e.g., at one, some, or all of operations 1448, 1452, 1456, 1442, 1460, and/or the like).

The operations shown in process 1400 of FIG. 14 are only illustrative and existing operations may be modified or omitted, additional operations may be added, and the order of certain operations may be altered.

### FIG. 15

FIG. 15 is a flowchart of an illustrative process 1500 for authenticating user U with the APSP using any suitable web browser of any suitable user device (e.g., any suitable web browser application 69w of any suitable user device 60 (e.g., Google Chrome, Safari, Edge, Firefox, etc.)), rather than, for example, using a dedicated APS application (e.g., of process 400). Like process 1300, process 1500 is shown being implemented by any suitable user device 60 with any such web browser 69w, its user U, any suitable BAS 20, any suitable third party subsystem 90, and any suitable fortress solution 140′″ (e.g., any suitable AuthService subsystem 110 and any suitable KMS subsystem 120 and any suitable enclave subsystem 130). However, unlike process 1300, process 1500 may be implemented by also using any suitable enclave subsystem 130 as part of the fortress solution (e.g., the same or a similar implementation as that of process 1400). Process 1500 may provide a seamless user experience for securely and efficiently authenticating user U with the APSP using any suitable web browser 69w of any suitable user device 60. To facilitate the following discussion regarding the operation of system 1 for authenticating user U with the APSP according to process 1500 of FIG. 15, reference is made to various components of system 1 of the schematic diagrams of FIGS. 1 to 11, and to screens 700x-700ae that may be representative of a graphical user interface of user device 60 during such a process (e.g., as shown in FIGS. 7X-7AE). The operations described may be achieved with a wide variety of graphical elements and visual schemes. Therefore, the embodiments of FIGS. 7X-7AE are not intended to be limited to the precise user interface conventions adopted herein. Rather, embodiments may include a wide variety of user interface styles.

Process 1500 may begin at operation 1501, where a subsystem relationship (e.g., between KMS subsystem 120 and AuthService subsystem 110 and/or third party subsystem 90 and/or enclave subsystem 130) may be configured by the system. This subsystem relationship may be configured prior to any enrollment and/or any authentication with the APSP via a web browser. Operation 1501 may be the same or substantially similar to operation 1401. In some embodiments, operation 1501 may be unnecessary if third party subsystem 90 and AuthService subsystem 110 and BAS 20 and KMS 120 and enclave subsystem 130 are the same in process 1500 as they were in process 1400, no matter whether or not user U and/or user device 60 and browser 69w are the same in process 1500 as they were in process 1400, such that the processes may be generic to any suitable browsers and any suitable devices and any suitable users (e.g., whereby the website loaded by any browser may be defined by third party subsystem 90 to be similar or the same with respect to subsystem configuration data). Process 1500 may also initiate with an operation 1504, where an enclave instance keypair and an attestation document may be generated. Operation 1504 may be the same or substantially similar to operation 1404.

After an appropriate subsystem relationship has been configured (e.g., at operation 1401 and operation 1404 and/or at operation 1501 and operation 1504, etc.), process 1500 may include an operation 1502, where the system may be configured to attempt to authenticate any suitable browser session (e.g., any suitable session between a user U of any suitable user device 60 using any suitable web browser 69w to access any suitable website of any suitable third party subsystem 90 of the system) and generate any suitable AuthToken if the authentication is successful. In some embodiments, a session may be authenticated at operation 1502 by identifying any suitable authentication cookie that may be stored in the web browser of the session, where such an authentication cookie may be generated and stored once the session has been authenticated through some other technique (e.g., such a cookie may be an AuthToken generated during a previous session that may be re-used (e.g., if still viable)). Such another technique for authenticating the session at operation 1502 may include authenticating the user of the session through any suitable methods (e.g., non-APSP biometric methods), such as authenticating the user through conducting a successful user log-in to an existing user account of the third party subsystem (e.g., third party subsystem 90 collecting log-in credentials (e.g., user name and password) from user U via device 60 and processing such log-in credentials to verify whether or not the log-in credentials are for an existing account (e.g., using a screen that may be similar to screen 700j of FIG. 7J)) or any other suitable KYC check, credit card on device check, and/or the like. In some embodiments, operation 1502 may generate an AuthToken after validating device 60 of the session (e.g., as opposed to validating user U of the session (e.g., if device 60 is determined to be trusted by third party subsystem 90 in any suitable manner)). Once the session is authenticated, operation 1502 may continue by generating any suitable AuthToken for the session. Such an AuthToken for an authenticated browser session may be generated by third party subsystem 90 and provided to web browser 69w (e.g., as a portion of any suitable website information 1702 of a website of the third party). For example, AuthService subsystem 110 may be configured to define the type of AuthToken to be generated (e.g., the syntax, format, composition, etc.), while third party subsystem 90 and web browser 69w of device 60 may work with user U to generate the AuthToken for the authenticated session. The AuthToken of the session generated at operation 1502 may later be used during any suitable authentication of the APSP using the session to prove to AuthService subsystem 110 that the user and/or user device of the session has been authenticated in some way by third party subsystem 90 before AuthService subsystem 110 may be enabled to continue with such an authentication of the APSP using the session. The AuthToken of operation 1502 may include any suitable information, including, but not limited to, some or all of the same information described above with respect to the AuthToken of operation 1202, operation 1302, and/or operation 1402, although, in some embodiments, the AuthToken of operation 1502 may not include a user name (e.g., username identifier URID) as that information may be made available to device 60 through another source of process 1500 other than the AuthToken (e.g., by operation 1510). Once an AuthToken has been generated for a successfully authenticated browser session at operation 1502 (e.g., once the AuthToken has been generated by third party subsystem 90 and provided to device 60 (e.g., to web browser 69w)), process 1500 may be enabled to carry out the remainder of an authentication process (e.g., operation 1508 through operation 1580) using that session (e.g., by presenting a customer's log-in option for user U via web browser 69w of the session (e.g., using screen 700x of FIG. 7X)). It is to be understood that the same user U and the same third party subsystem 90 may generate similar AuthTokens for different devices 60 and/or different web browsers 69w (e.g., any suitable browser on any suitable device).

For example, after a browser session has been authenticated and an AuthToken generated at operation 1502, process 1500 may include operations 1508 and 1510, where the system may be configured to enable a user of the session to initiate a transaction with the customer of third party subsystem 90. For example, at operation 1508, user U may initiate a transaction by carrying out any suitable transaction initiation interaction tii 2004d with web browser 69w that may be presenting any suitable third party website on user device 60 (e.g., accounts.customer.com). For example, as shown by screen 700x of FIG. 7X, the UI of user device 60 may present a “User Log-In for Customer Account” option for user U to enter or otherwise select the user's username identifier for their account with the third party (e.g., user John Doe's e-mail address of john.doe@doemail.com), or any other suitable user transaction initiation option in order to proceed with process 1500 for authenticating with the APSP. In advance of operation 1402 and/or operation 1502, the third party website may be accessed by web browser 69w on user device 60 or otherwise (e.g., using any other suitable device) in any suitable manner and user U may carry out any suitable account set-up operations with respect to the website (e.g., creating an account, logging-in, etc.), although any set-up operations not shown may or may not be required.

At operation 1510, user device 60 may detect such a transaction initiation interaction tii (e.g., entry of a user's particular username identifier) and, in response to such detection, user device 60 may communicate in any suitable manner with third party subsystem 90 in order to acquire any suitable transaction data 2005d. Such transaction data 2005d may include any suitable information that may enable device 60 to initiate user authentication with the APSP, including, but not limited to, the user's particular username identifier (e.g., URID, which may or may not have been made available by the AuthToken of operation 1502), the customer's particular customer identifier (e.g., CRID, which may or may not have been made available by the AuthToken of operation 1502), any suitable transaction data (e.g., TRDT, which may be any suitable “transactionData” string (e.g., as may be generated by third party subsystem 90 (e.g., at operation 1510)) that may be signed and returned to third party subsystem 90 after successful authentication), any suitable seed entropy field data (e.g., either a true or false identifier for a “seedEntropy” field that may selectively configured the APSP to request to receive a user-related cryptographic key that may be generated from a seed after successful authentication), and/or the like.

After such a transaction has been initiated, process 1500 may include operations 1512 and 1516, where the system may be configured to enable a user of the session to initiate APSP authentication. For example, at operation 1512, user U may initiate APSP authentication for the session by carrying out any suitable authentication initiation interaction aii 2006d with web browser 69w that may be presenting any suitable website on user device 60. For example, as shown by screen 700y of FIG. 7Y, the UI of user device 60 may present via web browser 69w any suitable website (e.g., idp.ABCcustomer.com) with any suitable options, such as a “Continue on Web” option, for user U to select with its authentication initiation interaction aii in order to proceed with process 1500 for authenticating with the APSP (e.g., using any suitable federation chain, in some embodiments). In advance of operation 1402 and/or operation 1502, the third party website may be accessed by web browser 69w on user device 60 or otherwise (e.g., using any other suitable device) or otherwise in any suitable manner and user U may carry out any suitable account set-up operations with respect to the website (e.g., creating an account, logging-in, etc.), although any set-up operations not shown may or may not be required.

At operation 1516, user device 60 may detect such an authentication initiation interaction aii and, in response to such detection, user device 60 may proceed to generate and send any suitable authentication attempt message aam (e.g., as data 2008d) to AuthService subsystem 110 (e.g., using any suitable communication channel(s) and/or any suitable communication protocol(s)). Authentication attempt message aam may be configured to include any suitable data, including, but not limited to, any suitable authentication initiation information, any suitable image encryption and wrapping information, any suitable information that may be used for “authorized actions” after successful enrollment, and/or the like. For example, authentication attempt message aam may include any suitable enrollment initiation information, including, but not limited to, an “event” field that may be defined by some attempt identifier (e.g., “Attempt”), a “sessionType” field that may be defined by some authentication identifier (e.g., “AUTHENTICATION”) (e.g., rather than by some enrollment identifier as in operation 1408), a “customer” field that may be defined by some identifier (e.g., CRID) of the customer of the session (e.g., “some-company” (e.g., “CITIBANK” or “FACEBOOK” or “B'GOCK” or “ABC_CUSTOMER” or the like)), a “username” field that may be defined by some identifier (e.g., URID) of the end user (e.g., some.user@company.eu (e.g., “john.doe@doemail.com” or the like)), an “authorizationToken” field that may be defined by some string (e.g., the AuthToken generated at operation 1502), and/or the like. Additionally or alternatively, authentication attempt message aam may include any suitable image encryption and wrapping information, including, but not limited to, KIDkₙ for attestation signing key(s) kₙ of operation 1401 and/or operation 1501, AIDkₙ for the algorithm used (e.g., at operation 1401 and/or operation 1501) to generate the attestation signing keypair (skₙ, pkₙ), key pkₙ (e.g., of operation 1401 and/or operation 1501), KIDk_{c} for customer transaction data signing key(s) k_{c} of operation 1401 and/or operation 1501, AIDk_{c} for the algorithm used (e.g., at operation 1401 and/or operation 1501) to generate the customer transaction data signing keypair (sk_{c}, pk_{c}), key pk_{c} (e.g., of operation 1401 and/or operation 1501), AIDkᵣ for the algorithm used (e.g., at operation 1401 and/or operation 1501) to generate user data wrapping key kᵣ, KIDkᵣ for user data wrapping key kᵣ of operation 1401 and/or operation 1501, and/or the like. Additionally or alternatively, authentication attempt message aam may include any suitable information that may be used for “authorized actions” after successful enrollment, including, but not limited to, a “transactionData” field that may be defined by some string (e.g., TRDT) or other suitable data (e.g., a “string” that may be provided by third party subsystem 90 (e.g., at operation 1502 and/or operation 1506 or otherwise of process 1500 (e.g., via web browser 69w)) and that is to be signed after successful APSP authentication), a “seedEntropy” field that may be defined as either true or false (e.g., the APS can request to receive a user-related cryptographic key generated from a seed after successful authentication), and/or the like. In some embodiments, operation 1502 may be carried out after operation 1512 (e.g., after aii 2006d may be received by device 60) but prior to operation 1518, which may rely on the AuthToken of operation 1502.

At operation 1518, AuthService subsystem 110 may be configured to receive and attempt to validate any suitable portion(s) of authentication attempt message aam of data 2008d in any suitable manner. This may include attempting to validate any suitable authentication initiation information of the received authentication attempt message aam, including, but not limited to, an “authorizationToken”, “username”, “customer”, and/or the like, which may be done similarly to validation of enrollment attempt message eam of process 1400. For example, AuthService subsystem 110 may be configured to attempt to validate the AuthToken using any suitable AuthToken configuration data of operation 1401 and/or operation 1501 and/or otherwise for validating the AuthToken according to any appropriate tool(s) or framework(s), including, but not limited to, OIDC, OAuth 2.0, SAML 2.0, and/or the like. If validation fails, process 1500 may end or the AuthService may instruct the web browser to try again due to failure of the AuthToken. Once the aam has been validated at operation 1518 and once AuthService subsystem 110 receives an attestation document and a request for a new image encryption key (e.g., as data 2003d of an operation 1506 from enclave subsystem 130), AuthService subsystem 110 may advance to operation 1520.

At operation 1520, if the received authentication attempt message aam has been appropriately validated and an attestation document AD has been received at operation 1518, AuthService subsystem 110 may identify a unique APID of any suitable APID look-up data 2010u that may be stored on or accessible to AuthService subsystem 110 (e.g., from any suitable data 119dw) using any suitable session entity identifier(s) (e.g., CRID, URID, etc.) of the aam (e.g., as validated at operation 1518). Then, for example, also at operation 1520, AuthService subsystem 110 may use that identified APID to identify particular session user profile look-up data 2010d that may be stored on or accessible to AuthService subsystem 110 (e.g., from any suitable data 119dw) using that identified APID and then load any suitable session user profile data (e.g., wrapped private device keys s\hat{k}_{d} & s\hat{k}_{d}, wrapped user data key \hat{k}ₐ, public user/device keys pkᵤ, pk_{d}, pkₑ, session entity identifier(s), encryption metadata, session data, etc.) of that identified session user profile look-up data 2010d for further use during process 1500. Therefore, for example, when the CRID and URID of the aam of operation 1518 of the APSP authentication process for a particular browser session of process 1500 match the CRID and URID of the eam of any earlier operation 1410 of any earlier APSP enrollment for any browser session of process 1400, then the APID identified at operation 1520 of process 1500 may be the same as the APID used by operation 1464 of that process 1400, such that the session user profile data that may be loaded at operation 1520 (e.g., as a portion of session user profile look-up data 2010d) may be the same as the session user profile data that may have been previously stored (e.g., as a portion of session user profile look-up data 1932d) at that operation 1464 of that process 1400. However, if the session entity identifier(s) of the aam are unable to be used by process 1500 to surface any unique APID for use in surfacing any session user profile data that may have been stored during an earlier APS enrollment session, then operation 1520 may stop and terminate the APS authentication session of process 1500.

At operation 1522, once appropriate session user profile data 2010d has been identified and loaded at operation 1520, AuthService subsystem 110 may be configured to generate and send any suitable request for the decryption of wrapped user data key \hat{k}ₐ of data 2010d along with the received attestation document of data 2003d (e.g., as AD and decryption of user data key request data 2011ad) to KMS subsystem 120 (e.g., using any suitable communication channel(s) and/or any suitable communication protocol(s)). Such a decryption of user data key request may include any suitable information that may be available to AuthService subsystem 110 and useful to KMS subsystem 120 for fulfilling the request. For example, this decryption of user data key request may include any suitable request data that may be used by KMS subsystem 120 to understand the type of data being requested (e.g., the decryption of wrapped user data key \hat{k}ₐ) and any other suitable data that may be useful to KMS subsystem 120 (e.g., to gain some trust in the request and/or to enable the request), such as wrapped user data key \hat{k}ₐ (e.g., as may be known to AuthService subsystem 110 from loaded user profile data 2010d of operation 1520), a key identifier (e.g., KIDkᵣ) of user data wrapping key kᵣ (e.g., as may be known to KMS subsystem 120 from operation 1401 and/or operation 1501 and as may be known to AuthService subsystem 110 from received authentication attempt message aam and/or otherwise (e.g., at operation 1401 and/or operation 1501)), an algorithm identifier (e.g., AIDkᵣ) of the algorithm used to generate the user data wrapping key kᵣ (e.g., as may be known to KMS subsystem 120 from operation 1401 and/or operation 1501 and as may be known to AuthService subsystem 110 from received authentication attempt message aam and/or otherwise (e.g., at operation 1401 and/or operation 1501)), and/or an attestation document (e.g., as received by AuthService subsystem 110 at operation 1518). Additionally, at operation 1522, once appropriate session user profile data 2010d has been identified and loaded at operation 1520 and the attestation document and request for new image encryption key has been received as data 2003d, AuthService subsystem 110 may be configured to forward any suitable request for a new image encryption key from enclave subsystem 130 to device 60 (e.g., using any suitable communication channel(s) and/or any suitable communication protocol(s)) as AD and image encryption key request data 2011bd (e.g., any suitable request data that may be used by device 60 to understand the type of data being requested (e.g., a new image encryption key) and any other suitable data that may be useful to device 60 (e.g., to instill some trust in the request), such as any data from the eam (e.g., if useful). However, in some embodiments, device 60 may already have the eam (e.g., from operation 1516).

At operation 1523, KMS subsystem 120 may be configured to receive and attempt to execute the request for the decryption of wrapped user data key \hat{k}ₐ (e.g., the request of data 2011ad from AuthService subsystem 110). This may include KMS subsystem 120 receiving and attempting to validate the attestation document of data 2011ad (e.g., by using public attestation signing key pkₙ (e.g., as made available to KMS subsystem 120 at operation 1401 and/or operation 1501) to decrypt or unsign the contents of the received attestation document, and then comparing the now accessible enclave measurement ENCm of that attestation document with the enclave measurement ENCm previously made available to KMS subsystem 120 (e.g., at operation 1401 and/or operation 1501), and then validating the attestation document if the comparison is successful (e.g., the two ENCm's are the same)). Then, if/when the attestation document has been validated, KMS subsystem 120 may be configured to decrypt wrapped user data key \hat{k}ₐ (e.g., of data 2010d and data 2011ad) with an accessed user data wrapping key kᵣ to obtain user data key kₐ (e.g., as may be identified by key identifier KIDkᵣ (e.g., of data 2011ad), such as by using the algorithm identified by algorithm identifier AIDkᵣ) and then to encrypt that obtained user data key kₐ with public enclave instance key pkᵥ (e.g., as may be identified by the content of the validated attestation document of operation 1523) to define re-wrapped user data key [symbol] (e.g., [symbol] =Epkᵥ(kₐ)).

Then, at operation 1524, KMS subsystem 120 may be configured to send re-wrapped user data key \hat{k}′ₐ (e.g., as re-wrapped at operation 1523) as user data key response data 2012d back to AuthService subsystem 110 (e.g., using any suitable communication channel(s) and/or any suitable communication protocol(s)).

At operation 1530, device 60 may be configured to receive and attempt to execute the request for a new image encryption key (e.g., the request of data 2011bd from AuthService subsystem 110). This may include device 60 (e.g., web browser 69w or otherwise) receiving and attempting to validate the attestation document of data 2011bd (e.g., by using public attestation signing key pkₙ (e.g., as made available to device 60 at operation 1401 and/or operation 1501) to decrypt or unsign the contents of the received attestation document, and then comparing the now accessible enclave measurement ENCm of that attestation document with the enclave measurement ENCm previously made available to device 60 (e.g., at operation 1401 and/or operation 1501), and then validating the attestation document if the comparison is successful (e.g., the two ENCm's are the same)). Then, if/when the attestation document has been validated, device 60 may be configured to generate any suitable new image encryption key kᵢ (e.g., any suitable random data that may be generated by browser 69w, where the length of the random key may depend on the length of public enclave instance key pkᵥ (e.g., 16 bytes or otherwise)). Next, device 60 may encrypt this image encryption key kᵢ with public enclave instance key pkᵥ (e.g., as may be identified by the content of the validated attestation document of operation 1530) to define wrapped image encryption key \hat{k}ᵢ (e.g., \hat{k}ᵢ=Epkᵥ(kᵢ)). Then, device 60 may be configured to send this wrapped image encryption key \hat{k}ᵢ as image encryption key response data 2015d back to AuthService subsystem 110 (e.g., using any suitable communication channel(s) and/or any suitable communication protocol(s)).

At operation 1526, AuthService subsystem 110 may be configured to receive both re-wrapped user data key \hat{k}′ₐ of user data key response data 2012d from KMS subsystem 120 and to receive wrapped image encryption key \hat{k}ᵢ of image encryption key response data 2015d from device 60 and then to forward each one of those keys \hat{k}′ₐ and key \hat{k}ᵢ along with any other suitable data (e.g., any or all of the session user profile data of session user profile look-up data 2010d (e.g., wrapped private device keys s\hat{k}_{d} and s\hat{k}ₑ, public user/device keys, APID, etc.) and/or any or all of the data of authentication attempt message aam (e.g., TRDT, etc.)) to enclave subsystem 130 as at least a part of any suitable enclave data 2013d (e.g., using any suitable communication channel(s) and/or any suitable communication protocol(s) and/or protocol(s)).

At operation 1528, enclave subsystem 130 may receive such data 2013d, decrypt re-wrapped user data key [symbol] of data 2013d with private enclave instance key skᵥ (e.g., as made available at operation 1404 and/or option 1504 (e.g., as may be identified by and/or associated with the attestation document of the session)) to obtain user data key kₐ, decrypt wrapped private device key(s) s\hat{k}_{d} and s\hat{k}ₑ (e.g., of loaded data 2010d) with that obtained user data key kₐ to obtain private device key(s) sk_{d} and skₑ, decrypt wrapped image encryption key \hat{k}ᵢ of data 2013d with private enclave instance key skᵥ (e.g., as made available at operation 1404 and/or operation 1504 (e.g., as may be identified by and/or associated with the attestation document of the session)) to obtain image encryption key kᵢ, and to generate and send any suitable request for user authentication biometric data from user U via web browser 69w of device 60 by generating and sending any suitable user authentication biometrics request data 2014d to AuthService subsystem 110 (e.g., using any suitable communication channel(s) and/or any suitable communication protocol(s)).

At operation 1532, AuthService subsystem 110 may be configured to receive such user authentication biometrics request data 2014d from enclave subsystem 130 and forward such data as user authentication biometrics request data 2016d to device 60 (e.g., using any suitable communication channel(s) and/or any suitable communication protocol(s)).

Then, at operation 1533, user device 60 may be configured to receive and process such user authentication biometrics request data 2016d to generate any suitable user authentication biometrics request data 2016dp that may be presented to user U via any suitable device user interface using web browser 69w or otherwise, whereby device 60 may be enabled to capture at operation 1535 any suitable user authentication biometrics uab that may be presented by user U at operation 1534 as user authentication biometrics uab data 2017d. However, rather than user device 60 capturing such user authentication biometrics uab data and then processing such data for generating an ABS b on device 60, device 60 may capture (e.g., using any suitable sensor(s) 65) one or more frames of image data (e.g., during user presentation of user authentication biometrics uab) and any associated sensor data or fast data (e.g., any suitable environment data and/or motion data) that may be acquired by device 60 in between two or more image data frames, and then encrypt such data with image encryption key kᵢ (e.g., as generated by device 60 at operation 1530), and then send such encrypted authentication biometric frame data 2017f to AuthService subsystem 110 at operation 1535 (e.g., using any suitable communication channel(s) and/or any suitable communication protocol(s)), which may be forwarded as data 2018f to enclave subsystem 130 for generating an ABS b. Device 60 may be configured define a particular instance of data 2017f for a particular moment in time to include not only image data for an image that may capture uab at that particular moment in time but also any suitable other sensor data (e.g., environment data, motion data, etc.) that may have been collected by device 60 from after the moment in time of the previous instance of data 2017f to the moment in time of this particular instance of data 2017f (e.g., such that device 60 may share a combination of particular image data and associated movement data (e.g., as encrypted by image encryption key kᵢ) with enclave subsystem 130 (e.g., via AuthService subsystem 110) for further processing. Any suitable data packaging module for combining any suitable image data and associated movement data (e.g., environment data and/or motion data) into any suitable user authentication biometric data package(s) (e.g., as may be described in co-pending, commonly-assigned U.S. patent application Ser. No. 19/217,833, which is hereby incorporated by reference herein in its entirety) may be provided by enclave subsystem 130 for generating any suitable user authentication biometric data package(s) based on data 2017f (e.g., as decrypted by image encryption key kᵢ) prior to processing such package(s) with any suitable attack detector (e.g., as may be described in co-pending, commonly-assigned U.S. patent application Ser. No. 19/217,833, which is hereby incorporated by reference herein in its entirety).

Then, at operation 1536, AuthService subsystem 110 may be configured to receive such encrypted authentication biometric frame data 2017f from user device 60 and forward such data as encrypted authentication biometric frame data 2018f to enclave subsystem 130 (e.g., using any suitable communication channel(s) and/or any suitable communication protocol(s)).

At operation 1538, enclave subsystem 130 may receive any suitable encrypted authentication biometric frame data 2018f from AuthService subsystem 110, decrypt such data using image encryption key kᵢ (e.g., as obtained at operation 1528), and then process such decrypted authentication biometric frame data to determine if the user authentication biometrics are acceptable (e.g., determined to be genuine) or not acceptable (e.g., determined to be a spoof or indeterminable or the like) using any suitable attack detector (e.g., as may be described in co-pending, commonly-assigned U.S. patent application Ser. No. 19/217,833, which is hereby incorporated by reference herein in its entirety). If determined not to be acceptable, enclave subsystem 130 may request new user authentication biometric data from user U via web browser 69w of device 60 by generating and sending any suitable user authentication biometrics feedback data 2019d to AuthService subsystem 110 (e.g., using any suitable communication channel(s) and/or any suitable communication protocol(s)), which may then be forwarded by AuthService subsystem 110 to device 60 at operation 1540 as user enrollment biometrics feedback data 2020d (e.g., using any suitable communication channel(s) and/or any suitable communication protocol(s)). Then, at operation 1541, user device 60 may be configured to receive and process such user authentication biometrics feedback data 2020d to generate any suitable user authentication biometrics feedback data 2020dp that may be presented to user U via any suitable device user interface using web browser 69w or otherwise, whereby device 60 may be enabled to capture at another iteration of operation 1535 any suitable additional user authentication biometrics uab that may be presented by user U at operation 1534 as additional user authentication biometrics ueb data 2017d, where such operations 1534, 1535, 1536, 1538, 1540, and 1541 may together form any suitable operation loop 1543. Operation loop 1543 may be repeated any suitable number of times until enclave subsystem 130 determines at an instance of operation 1538 that the user authentication biometrics of the most recently processed decrypted authentication biometric frame data are acceptable (e.g., determined to be genuine), at which point process 1500 may advance from operation 1538 out of operation loop 1543 to operation 1544, where enclave subsystem 130 may generate an authentication biometric sample (“ABS”) b based on such acceptable user authentication biometrics.

User device 60 may be configured to capture such authentication biometrics uab as at least a portion of data 2017d for generating data 2017f that may be forwarded by AuthService subsystem 110 as data 2018f that may be appropriately processed by enclave subsystem 130 for determining whether acceptable for use in generating an ABS b (e.g., according to web browser 69w and/or any other suitable application(s) that may be running on device 60 (e.g., different users may use different biometrics, different devices may use different sensors, different types of data may be captured in addition to biometrics (e.g., device environment data, device motion data, etc.), and/or the set of characteristics and associated actions themselves may change from one authentication to the next, etc.)). For example, similarly to as shown by screen 700z of FIG. 7Z and screen 700aa of FIGS. 7AA, the UI of device 60 may optionally present a user approval request for accessing any suitable sensor(s) or other device components (e.g., a camera of device 60) for capturing user biometrics, a request which the user may accept or deny. If accepted or automatically allowed, the UI of APS device 60 may present instructions on how the user ought to present user authentication biometrics uab to user device 60 for capture. For example, as shown by screen 700ab of FIG. 7AB, while the user's face may be in the line of sight of a device camera sensor, device 60 may instruct the user to keep their face still, then look left, then look right, or carry out any other suitable instructions and then initiate further authentication processing, as shown by screen 700ac of FIG. 7AC (e.g., at operation 1544, once acceptable biometrics have been successfully captured). This may enable device 60 to capture user authentication biometrics uab in the form of a video or photograph sequence of the user's face rotating. This may enable “liveness” detection of the user (e.g., as may instructing the user to carry out any other suitable action while biometrics are captured (e.g., winking with one eye then with the other eye, or smiling then frowning, or saying a word or phrase, etc.) and/or adjusting one or more functionalities of the device (e.g., increasing an ambient light source of the device, etc.)). This presentation and/or feedback may help prevent spoofing and/or capturing biometrics of an unwilling user.

In some embodiments, operation loop 1543 may achieve improved efficiency if user device 60 (e.g., web browser 69w) is configured to conduct any suitable biometric acceptability determinations by processing data 2017d on board device 60 and immediately provide certain feedback to user U (e.g., as data 2020dp) without requiring such biometric acceptability determinations to be handled by enclave subsystem 130 (e.g., at one or more instances of operation 1538). For example, device 60 may be configured to make certain acceptability determinations and provide certain appropriate feedback on its own (e.g., face not in image, face too close to camera, etc.), thereby saving data bandwidth between device 60 and AuthService subsystem 110 and enclave subsystem 130 for communicating only user biometrics in data 2017f to AuthService subsystem 110 and in data 2018f to enclave subsystem 130 that meet a first threshold of acceptability determined by device 60 (e.g., only “good images” of a user's face may be included in data 2017f communicated to AuthService subsystem 110 and then as data 2018f to enclave subsystem 130). For example, such device-based acceptability determinations may be enabled through part of browser code (e.g., as part of APS library 1704 for enabling browser biometric analysis (e.g., in web assembly module 1708)). Therefore, some of the acceptability determination work of operation 1538 may be offloaded from enclave subsystem 130 to user device 60 at operation 1535 and operation 1541 (e.g., without any encryption, etc.) so an initial filter at a browser of user device 60 may enable initial quality check(s) and then only pass acceptable frames to enclave subsystem 130 (e.g., AuthService subsystem 110) for further analysis at operation 1538.

Then, at operation 1544, once enclave subsystem 130 has determined at an instance of operation 1538 that the user enrollment biometrics of the most recently processed decrypted authentication biometric frame data 2018f are acceptable (e.g., determined to be genuine), enclave subsystem 130 may generate an authentication biometric sample (“ABS”) b based on such acceptable user authentication biometrics in any suitable manner (e.g., similarly as described with respect to operation 422 of process 400).

Then, once enclave subsystem 130 has generated ABS b at operation 1544, enclave subsystem 130 may be enabled to run any suitable portion of any suitable privacy-preserving biometric matching technique for enabling authentication of user U with the biometrics of ABS b, such as by running any suitable privacy-preserving authentication protocol of operation 1560 with BAS subsystem 20 (e.g., using any suitable SMPC and/or OPRF and/or the like (e.g., as may be described by operations 424 to 440 of process 400 herein, as may be described by process 500 and/or process 700 of U.S. Pat. No. 11,936,775, and/or the like)). For example, the privacy-preserving biometric matching of operation 1560 may carry out any suitable biometric authentication in any suitable manner that may enable the comparison of the user's biometrics ueb and/or EBT B of operation 1444 with the user's biometrics uab and/or ABS b of operation 1544 using enclave subsystem 130 and BAS 20 without sharing either biometrics or EBT B or ABS b with BAS 20 and/or AuthService subsystem 110. For example, such a comparison may be made between any suitable embeddings (e.g., any suitable set(s) and/or vector(s) and/or matrix(ces)) that may be extracted from biometrics ueb and any suitable embeddings that may be extracted from biometrics uab, without BAS 20 and/or AuthService subsystem 110 having access to any such embeddings of either of the two biometrics (e.g., without BAS 20 or AuthService subsystem 110 obtaining any information about the embeddings (e.g., vectors (e.g., no numbers or properties related to such vectors)), thereby maintaining the security of the biometrics while still enabling effective biometric authentication. By running any suitable privacy-preserving authentication protocol or privacy-preserving biometric matching of operation 1560 with BAS subsystem 20 and enclave subsystem 130 (e.g., using any suitable application 139 (e.g., an APS application 139a)) rather than with BAS subsystem 20 and an APS user device (e.g., as described with respect to process 200), process 1500 may avoid any limitations that web browser 69w might present in enabling such authentication securely and efficiently. For example, this may avoid user device 60 having to generate any of its own device signing keys, device encryption keys, user keys, and/or the like. Additionally or alternatively, this may avoid user device 60 running any suitable biometric processing models (e.g., any suitable acceptability or liveness or attack detector models (e.g., for analyzing any suitable enrollment biometrics and/or any suitable authentication biometrics) and/or any suitable biometric authentication models and/or any suitable biometric enrollment models), but instead such model(s) may be run on any suitable AuthService subsystem 110 and/or on any suitable enclave subsystem 130 rather than on any web browser 69w and/or any APS application 69a or otherwise that may have limited resources or capabilities (e.g., a web browser may be 10% of the size of an APS SDK (e.g., an APS application 69a) and/or may not have advanced encryption capabilities, while certain subsystems 110 and/or 130 may not have such limitations).

In some embodiments, operation 1560 or otherwise of process 1500 may include operation 1546, where AuthService subsystem 110 may generate and send any suitable request for an input table as any suitable table request data 2023d to AuthService subsystem 110 (e.g., using any suitable communication channel(s) and/or any suitable communication protocol(s)), which may forward such data as table request data 2024d at operation 1548 to any suitable BAS 20 (e.g., using any suitable communication channel(s) and/or any suitable communication protocol(s)). For example, such table request data 2023d/2024d may be a request for any suitable random circuit(s) to be selected from any suitable pool that may be available for user U and BAS 20 may receive and process such a request and provide any suitable table response data 2025d at operation 1550 back to AuthService subsystem 110 (e.g., using any suitable communication channel(s) and/or any suitable communication protocol(s)), which may forward such data as table response data 2026d at operation 1552 to any enclave subsystem 130 (e.g., using any suitable communication channel(s) and/or any suitable communication protocol(s)), whereby this may allow enclave subsystem 130 not to store a list of circuits (e.g., across devices (e.g., as a generic web browser 69w may be used during process 1400 and process 1500 for various devices (e.g., for enabling shared circuits))). Alternatively, enclave subsystem 130 may select a circuit identifier and ask BAS 20 to use that specific circuit at operations 1546 and 1550 (e.g., similarly to operations 424 and 426 of process 400).

Next, operation 1560 or otherwise of process 1300 may include operation 1554, where enclave subsystem 130 may process the appropriate circuit or table data and share any suitable restricted table data as table restrict data 2027d to AuthService subsystem 110 (e.g., using any suitable communication channel(s) and/or any suitable communication protocol(s)), which may forward such data as table restrict data 2029 at operation 1558 to any suitable BAS 20 (e.g., using any suitable communication channel(s) and/or any suitable communication protocol(s)) (see, e.g., operations 428 to 432 and data 432d of process 400), and BAS 20 may receive, use, and evaluate such data in any suitable way and then respond to AuthService subsystem 110 at operation 1562 with any suitable compare data as compare response data 2031d (e.g., using any suitable communication channel(s) and/or any suitable communication protocol(s)), which may forward such data as compare response data 2032d at operation 1564 to enclave subsystem 130 (see, e.g., operations 434 and 436 and data 436d of process 400).

Next, operation 1560 or otherwise of process 1500 may include operation 1566, where enclave subsystem 130 may process such compare response data 2032d in any suitable manner to reconstruct seed s (see, e.g., operations 438 and 440 of process 400), where reconstructed seed s of operation 1566 of authentication process 1500 may be the same seed s of operation 1414 of the associated enrollment process 1400 (e.g., of the enrollment for the browser session that used the same APID as the browser session of the current authentication).

In some embodiments, once seed s has been reconstructed, operation 1560 or otherwise of process 1500 may include any suitable operation(s) 1568, where any suitable authorized actions may occur with enclave subsystem 130 and/or BAS 20 and/or otherwise, such as retrieving any suitable secret(s) using reconstructed seed s (e.g., private user key skᵤ) and generating any suitable challenge response for web browser 69w and/or third party subsystem 90 of the session using such secret(s). For example, at operation 1568 of authorization process 1500, enclave subsystem 130 may be configured to deterministically derive private user key skᵤ from reconstructed seed s, just as private user key skᵤ may have previously been deterministically derived from original seed s by enclave subsystem 130 at operation 1414 of enrollment process 1400 (also, see, e.g., operation 440 of process 400, operation 526 of process 500, operation 618 of process 600, and/or the like). Then, also at operation 1568 of authorization process 1500, enclave subsystem 130 may be configured to identify any suitable transaction data (e.g., TRDT) that may have been generated by third party subsystem 90 for the user transaction of the current session (e.g., as may be defined by third party subsystem 90 as a part of transaction data 2005d of operation 1510 and then shared with enclave subsystem 130 at operation 1526 (e.g., as a portion of authentication attempt message aam)) and then such transaction data may be processed in some way to enable verification of the authentication process by device 60 and/or third party subsystem 90. For example, in some embodiments, enclave subsystem 130 may be configured to encrypt or sign or otherwise manipulate or process such transaction data with private user key skᵤ as recently derived. Then, at operation 1570, enclave subsystem 130 may be configured to confirm such successful authentication by sharing any suitable success data with browser 69w of device 60 (e.g., as success data 2036d) and/or with third party subsystem 90 (e.g., as success data 2038d (e.g., from enclave subsystem 130 via AuthService subsystem 110 (e.g., as data 1717d and operation 1572) and/or via device 60 (e.g., at operation 1574))), where such success data may include the transaction data as encrypted or signed or otherwise manipulated or processed by private user key skᵤ from operation 1568 (e.g., as a transaction data challenge response (also see, e.g., operation 620 of process 600)). In some embodiments, operation 1570 may include enclave subsystem 130 using the reconstructed seed to rederive a seedEntropy string and include such a string in data 1717d. Then, at operation 1576, third party subsystem 90 may be configured to receive and process such success data to attempt to verify the transaction data challenge response (e.g., using public user key pkᵤ of the same keypair as private user key skᵤ, where such public user key pkᵤ may have been shared by AuthService subsystem 110 at an earlier stage (e.g., during an associated successful enrollment process 1400 (e.g., through data 2036d and/or data 2038d)), such that the requested transaction of operation 1508 may be fully executed by third party subsystem 90 (also see, e.g., operation 534 of process 500 and operation 622 of process 600). Therefore, if authentication is successful by enclave subsystem 130 and the ensuing verification of the transaction data challenge response is successful by third party subsystem 90, subsystem 90 may authenticate user U for the requested transaction (e.g., grant access to the third party customer's requested service) at operation 1576 (see, e.g., UI screen 700ad of FIG. 7AD and UI screen 700ae of FIG. 7AE that may be presented by third party subsystem 90 to user U (e.g., via web browser 69w of the session)). In such embodiments, this use of such a user keypair (skᵤ, pkᵤ) may be unique to a particular user U, in which case third party subsystem 90 may have to keep track of distinct public user keys pkᵤ for all its users in order to be enabled to verify transactions for all its users in this manner. A similar verification process may be enabled for a successful enrollment process 1400 (e.g., at operations 1460 to 1472).

In some embodiments, enclave subsystem 130 and/or BAS 20 may be configured to act as any suitable Certificate Authority (“CA”) (e.g., under the X.509 public key certificate standard). In such embodiments, third party subsystem 90 may be enabled to know the root public key of the certificate authority. During enrollment, the enclave CA and/or BAS CA may be configured to issue an end-user certificate that may include the user URID and/or the customer CRID of the session as well as the user's public user key pkᵤ, and may be signed under the CA private key. The certificate may be stored alongside other keys as a part of the user profile data on enclave subsystem 130. Then, when enclave subsystem 130 may send the transaction data challenge response to the third party subsystem (e.g., at operation 1570), the associated user's end-user certificate may be sent along with the transaction data challenge response, such that the third party subsystem may access the appropriate public user key pkᵤ at that time (e.g., by processing the certificate using the public key of the certificate authority). A similar verification process may be enabled for a successful enrollment process 1400 (e.g., at operations 1460 to 1472).

In some embodiments, core backend keys may be utilized, where, for each customer (e.g., each third party subsystem 90), KMS subsystem 120 may be configured to generate a “customer transaction data signing keypair” (sk_{c}, pk_{c}) (e.g., using any suitable asymmetric algorithm RSA or ECDSA or the like), such as at operation 1401 and/or operation 1501. The private key of this customer transaction data signing keypair may be stored at KMS subsystem 120 (e.g., at operation 1401 and/or operation 1501), while the public key of this customer transaction data signing keypair may be provided to its associated third party subsystem 90 (e.g., at operation 1401 and/or operation 1501) for subsequent validation. Then, at operation 1568, enclave subsystem 130 may be configured to send the transaction data (e.g., the transaction data challenge) to KMS 120 as any suitable data (not shown (e.g., via BAS 20)) for signing with the private key sk_{c} of the relevant customer transaction data signing keypair, and KMS 120 may return back this signature under the customer transaction data signing keypair to third party subsystem 90 (e.g., directly (not shown) or via BAS 20 and/or enclave subsystem 130 and/or AuthService subsystem 110 and/or device 60) to enable appropriate verification processing (e.g., at operation 1576) using the public key pk_{c} of this customer transaction data signing keypair. A similar verification process may be enabled for a successful enrollment process 1400 (e.g., at operations 1460 to 1472).

In some embodiments, process 1500 may include an operation 1578, at which any suitable biometrics may be updated using enclave subsystem 130 and BAS 20 (similarly see, e.g., operation 444 to 452 of process 400).

In some embodiments, process 1500 may include an operation 1580, at which any suitable data may be deleted by enclave subsystem 130 (e.g., for security purposes), such as user data key kₐ and/or image encryption key kᵢ and/or any other suitable sensitive data that has not yet been deleted (e.g., at operation 1578 (see, e.g., operation 452)), including, but not limited to, reconstructed seed s, re-derived private user key skᵤ, ABS b, EBT B, uab, unwrapped private device signing key sk_{d} and unwrapped private device encryption key skₑ, and/or any suitable elements of the privacy-preserving authentication protocol 1560.

In some embodiments, enclave subsystem 130 may be configured to communicate with one or more other subsystems directly and/or not via AuthService subsystem 110, such as when enclave subsystem 130 may be provided by an AMD secure encrypted virtualization (“SEV”) enclave or any other suitable enclave. Therefore, it is to be understood that, in some embodiments, enclave subsystem 130 may be configured to communicate directly with device 60, in which case AuthService subsystem 110 may not be utilized for forwarding such communications (e.g., at one, some, or all of operations 1532, 1536, 1540, and/or the like). Additionally or alternatively, it is to be understood that, in some embodiments, enclave subsystem 130 may be configured to communicate directly with KMS subsystem 120, in which case AuthService subsystem 110 may not be utilized for forwarding such communications. Additionally or alternatively, it is to be understood that, in some embodiments, enclave subsystem 130 may be configured to communicate directly with BAS subsystem 20, in which case AuthService subsystem 110 may not be utilized for forwarding such communications (e.g., at one, some, or all of operations 1548, 1552, 1558, 1564, 1568, and/or the like).

By utilizing any suitable enclave subsystem 130 that may be dedicated to protecting its data (e.g., even from its supervisor S) and that may be trusted by any other subsystems (e.g., device 60) using any suitable attestation (e.g., fortress solution 140″, fortress solution 140′″, etc.), enclave subsystem 130 may be configured to securely carryout any suitable privacy-preserving protocol(s) with BAS 20 for enabling web browser 69w to use the APS WebSDK without any sensitive data potentially being exposed to one or more potential adversaries. For example, although certain sensitive data may be deleted from AuthService subsystem 110 (e.g., at operation 1244 of process 1200 and/or at operation 1364 of process 1300), sensitive data may remain available to AuthService subsystem 110 during a particular browser session (e.g., key kᵢ and, thus biometrics ueb/uab, key kₐ and, thus certain private device keys, as well as seed s, may be generally available to AuthService subsystem 110 from operation 1218 to operation 1244 during user enrollment and/or from operation 1324 to operation 1364 during user authentication). Although such windows may be brief (e.g., 0.5-5.0 seconds) for a user to provide acceptable user enrollment biometrics (e.g., at operation 1226) or acceptable user authentication biometrics (e.g., at operation 1328), an untrustworthy or compromised provider P of AuthService subsystem 110 might technically be able to capture such data. Such a threat may be removed through additional use of a secure enclave subsystem 130 while also enabling the same webSDK functionality for browser 69w.

The operations shown in process 1500 of FIG. 15 are only illustrative and existing operations may be modified or omitted, additional operations may be added, and the order of certain operations may be altered.

### Additional KEY010 Language

Therefore, this disclosure provides new methods for securely outsourcing computations from thin clients, such as web browsers, mobile devices, medical devices, and wearable devices, to trusted cloud environments, using trusted execution environments (“TEE”s), such as Intel's Software Guard Extensions (“SGX”), AWS Nitro Enclaves, zkEVMs, and other techniques that may allow trusted execution. An APS WebSDK may be configured to handle web browser limitations while following the security and privacy principles of an APSP protocol that may use an APS mobile/device SDK. For example an APS WebSDK may be configured to be split between a browser client (e.g., on a device accessible by a user) and a remote user-trusted environment (e.g., an APS authorization server and/or any suitable trusted or isolated execution environment (e.g., an enclave (e.g., an Amazon Web Services (“AWS”) Nitro enclave)). Rather than conducting a privacy-preserving protocol between a data processing service server as a first party and a user device as a second party (e.g., the first party may be APS subsystem 100 and the second party may be device 60a (e.g., as in FIGS. 2A-4C for an APS device SDK)), a privacy-preserving protocol may be conducted between a first party provided by a data processing service server and a second party that may be split between a browser client of a user device and a remote user-trusted environment (e.g., the first party may be BAS 20 (e.g., APS subsystem 100) and the second party may be split between device 60 (e.g., web browser 69w) and any remote trusted environment (e.g., AuthService subsystem 110 or enclave subsystem 130 (e.g., individually or in combination), which can access KMS subsystem 120) (e.g., as in FIGS. 12-15 for an APS WebSDK)). For example, a first or service or server party in a privacy-preserving protocol may be provided by BAS 20 (e.g., any suitable data processing service that may be a biometric authentication service, medical service, financial service, or other service for processing private data) and a second or user or client party in the privacy-preserving protocol may be provided by a combination of user device 60 running web browser 69w and a FORTRESS solution (e.g., any suitable TEE solution or remote or server-side execution environment (e.g., remote from the user device) configured to be acting on behalf of the client (e.g., AuthService subsystem 110 and/or enclave subsystem 130)), where the user device of the second party may verify the integrity of the FORTESS solution of the second party and where the FORTESS solution of the second party may verify the integrity of the user device of the second party, such that the user device of the second party may obtain private data (e.g., user biometrics (e.g., through one or more device sensors)) and then share such private data with the FORTRESS solution of the second party in such a way that the private data may only be accessible in the FORTRESS solution of the second party, whereby the first party and the second party may be configured to perform any suitable privacy-preserving protocol (e.g., SMPC or any other suitable computation method(s)) that may not disclose the private data to the first party). This FORTRESS solution may enable the secure performance of computationally demanding SMPC protocols on server-side TEEs, while minimizing data breaches and unauthorized access. This may be achieved by offloading complex computations from client-side devices (e.g., use device 60) to FORTRESS, which may provide a secure, isolated environment for sensitive computations without exposing private data to the host operating system. Therefore, security concerns related to centralized databases storing biometric data, such as data breaches, insider attacks, and unauthorized access may be addressed. By using secure multi-party computation techniques, including, but not limited to, fully-homomorphic encryption, Yao's garbled circuits, arithmetic circuits, and partially-homomorphic encryption, server-side processing of encrypted biometric data may be enabled without direct access to such data, thereby ensuring that sensitive user information remains protected.

The client device may be configured to validate the integrity of the FORTRESS-side code running in the FORTRESS solution (e.g., using any suitable attestation with the trusted execution environment). Similarly, the FORTRESS solution may be configured to validate the integrity of the client device, the application performing the authentication, and its dependencies (e.g., the client device's operating system, browser, etc.). Also, the FORTRESS solution may be configured to authenticate the user prior to performing any computation on their behalf (e.g., using any suitable AuthToken processing).

Some SMPC computations may require long-term state to be kept on the client party. Such a long-term state may include, for example, private key material and information from prior executions. There are multiple options where the long-term client state can be kept, such as on the user device and/or on the FORTRESS solution. Additionally, access and use of the long-term state can be protected in different ways, as described herein.

The secure storage of sensitive cryptographic keys for secure biometric authentication may be enabled, as FORTRESS can store these keys in encrypted form on untrusted cloud storage or otherwise, minimizing the risk of unauthorized access. This approach may provide a number of benefits, including enhanced security through secure multi-party computation techniques, improved scalability due to the leverage of cloud infrastructure and flexible client implementation, reduced risk of data breaches and unauthorized access, and convenience for users who can conduct secure biometric authentication across different contexts and applications using various devices. Furthermore, the use of proof-of-authentication adds an additional layer of security by requiring both the encryption key and a verification of identity. A TEE's ability to store keys locally or utilize hardware tokens, portable flash storage, or cloud storage may also allow for flexible client implementation. This may be particularly useful in public kiosks and other user devices with limited long-term state capabilities, thereby enabling them to be integrated into the system while maintaining a high level of security. By using the TEE to manage sensitive cryptographic keys, FORTRESS may reduce the risk of unauthorized access to these critical components, making it an attractive solution for applications where secure biometric authentication is essential.

A trusted execution environment may be configured to perform sensitive computations, thereby eliminating the need for storing plaintext biometric data. This approach may address the significant concerns related to user privacy, data protection, and system security associated with many other methods.

Unlike secure multi-party computation techniques that may require resource-intensive computations, storage, and communication on the user device, the FORTRESS solution may shift these requirements to the TEE portion of the client party, thereby making it more suitable for low-powered user devices, battery-powered user devices, and user devices with limited connectivity. This approach may enable widespread adoption of biometric authentication across various industries without compromising security or user experience.

Unlike certain processes that may employ server-side encryption but fail to prevent insider attacks or data exposure during processing, the FORTRESS solution may ensure comprehensive security by using TEEs to protect biometric data during transmission, storage, and processing. This may provide an additional layer of protection against unauthorized access, side-channel attacks, and insider threats.

Unlike certain processes that may compromise on performance or functionality due to encryption and secure storage protocols, the FORTRESS solution may achieve a balance between security, usability, and performance by utilizing TEEs to offload sensitive computations from the user device portion of the client party. This may enable seamless integration with various front-ends without sacrificing user experience or introducing latency.

Unlike certain processes that may rely on specific cryptographic techniques or proprietary technologies, the FORTRESS solution may be designed to be platform-agnostic and adaptable to different trust environments, including AWS Nitro Enclaves, Intel SGX, and other trusted execution environment technologies. This may allow for widespread adoption across various industries without vendor lock-in.

By addressing such deficiencies of other processes and achieving a balance between security, usability, and performance, the FORTRESS solution may provide a comprehensive framework for safeguarding sensitive user information during biometric enrollment and biometric authentication.

This disclosure describes splitting processing and privacy-preserving biometric protocols between a client device and a FORTRESS solution. FORTRESS can be used by a client device in different ways, depending on the limitations associated with that particular device. In some embodiments, all processing and SMPC computations may occur on the FORTRESS solution, with the client device acting only as a relay to provide data from sensors, storage, or other sources. This approach may be particularly useful when the client device lacks sufficient computational resources, memory, or power to perform the various calculations of the protocol. Alternatively, some processing related to the SMPC protocol may occur on the client device, while the rest of the SMPC computations may be performed by the FORTRESS solution. For example, the client device may perform initial data filtering, compression, and encryption before sending the processed data to FORTRESS for further processing and SMPC computations. This approach may allow the client device to offload computationally intensive tasks to FORTRESS while still utilizing its own resources for less demanding operations. Further, this approach may allow the client and FORTRESS to split the secrets that may be required to run an SMPC protocol, if such secrets exist in a specific instance. In some other embodiments, some SMPC computations can be performed on the client device, while others are offloaded to FORTRESS (e.g., for a three-party privacy-preserving protocol (e.g., with the device, the fortress solution, and the BAS)). For example, the client device may perform certain computations that may not require access to sensitive data, while computations involving confidential information may be performed on FORTRESS. This approach may enable a flexible and dynamic splitting of processing and SMPC tasks between the client device and FORTRESS. The specific split of processing and SMPC tasks between the client device and FORTRESS may depend on any suitable factors, such as data size, computational complexity, security requirements, and communication latency. Various processes of this disclosure may allow for a flexible and adaptive approach to splitting these tasks, enabling optimized performance, efficiency, and security in various use cases. In some cases, FORTRESS may additionally or alternatively act as an aggregator of multiple client devices, collecting and processing data from multiple sources before performing SMPC computations. This approach may enable large-scale data analysis and processing while maintaining the confidentiality and integrity of individual client data.

In some embodiments, the FORTRESS solution may be configured to authenticate users before acting on their behalf. The authentication might be federated (e.g., the user may authenticate to a different system that may then relay the result to FORTRESS) (e.g., the AuthToken may be validated by any portion of a fortress solution that may be configured to do so (e.g., an AuthService subsystem, an enclave subsystem, etc.)) or direct (e.g., the user may authenticate directly to the FORTRESS solution, either through username/password credentials, biometrics, or any other authentication mechanism). When using certain biometric authentication, the same biometrics can be reused for subsequent SMBC-based biometric authentication (e.g., as described in U.S. Pat. Nos. 11,563,564 and 11,936,775), thereby allowing users to provide biometric samples only once. When FORTRESS utilizes biometric authentication, such as facial recognition, fingerprint scanning, or voice recognition, the biometric data collected from the user can be stored securely and reused for subsequent authentications (e.g., within the same session). Therefore, users may not need to provide their biometric samples multiple times to authenticate to FORTRESS and then to a third-party service, thereby making the overall experience more convenient and efficient. In such embodiments, FORTRESS may be configured to act as a proxy for the user's biometric data.

The system may be configured to enable the FORTRESS solution to validate the identity of a client device (e.g., using an AuthToken or otherwise). In some embodiments, the FORTRESS solution may employ any suitable attestation mechanisms to validate the authenticity and integrity of any suitable client-side code, thereby ensuring the trustworthiness of computations executed on the client device. For example, FORTRESS might utilize any suitable APIs, such as the Google Play Integrity API (also known as Google Play In-app Purchasing Protection), which may enable a server to verify that a particular client application has been installed from an authorized source and is running in its expected configuration. In some embodiments, the FORTRESS solution may authenticate client devices via various authentication methods to ensure confidence in the identity and legitimacy of clients participating in secure computations or operations. This robust approach may enable a high degree of trustworthiness, which may be essential for safeguarding sensitive information. One suitable method may be public-key cryptographic authentication (e.g., by utilizing public-key cryptography, FORTRESS can verify the authenticity of client devices by generating a digital signature that may be computed using the device's private key). Another potential approach may be to utilize shared secrets or passwords (e.g., clients may be required to possess and provide a pre-shared secret or password that may serve as a shared authentication token between the client and server). Device fingerprinting may be another method that may be employed by FORTRESS (e.g., by generating a unique identifier for each device through the analysis of various hardware (e.g., UUIDs) and software characteristics (e.g., browser version), a distinct “fingerprint” of each device can be created, which may allow FORTRESS to verify the identity of client devices). Certain potential methods may include OAuth authentication, OpenID Connect authentication, and/or any other relevant protocols or techniques that can be used by FORTRESS to authenticate clients in a secure and reliable manner.

The system may be configured to enable a client device to validate the integrity of the FORTRESS solution (e.g., using attestation or otherwise). Certain FORTRESS implementations may enable clients to validate the integrity of the hardware and/or software components that implement FORTRESS, thereby ensuring the trustworthiness of the system as a whole. This may allow clients to verify that the FORTRESS implementation is genuine and has not been tampered with by unauthorized parties. For example, when a FORTRESS solution may be based on AWS Nitro, the system may be configured to enable clients to utilize Enclave attestation to validate the integrity of the underlying hardware and/or software (e.g., this form of attestation may enable clients to verify that the AWS Nitro environment is executing correctly and has not been compromised). As another example, when a FORTRESS solution may be built on top of Intel SGX, the system may be configured to enable clients to utilize SGX attestation to provide clients with assurance about the integrity of the system (e.g., by utilizing SGX attestation, clients can verify that the Intel SGX environment is functioning correctly and that sensitive information is being processed securely within trusted execution environments). As another example, when a FORTRESS solution may be based on zkEVM, the system may be configured to utilize publicly available code and proofs of correct computation to demonstrate their trustworthiness, which may enable clients to verify the integrity and correctness of the zkEVM-based implementation by examining publicly disclosed information about the system's architecture and computations. By incorporating mechanisms for client device-side validation of FORTRESS implementations, the overall trustworthiness and robustness of the system can be significantly enhanced, thereby providing an additional layer of protection against potential security threats.

Several SMPC protocols may require one or more parties to store long-term state, such as key material, configuration information, output of previous runs of the protocol, and/or a list of protocol run identifiers. In cases where the client device and FORTRESS corresponds to a protocol party with long-term state, FORTRESS may be configured to provide any suitable option(s) for handling such long-term state, including, but not limited to, (1) the client device being capable of securely storing long-term state and FORTRESS relying on this capability, (2) the client device can securely store a small amount of information across SMPC instances but is unable to store the entirety of the long-term state (e.g., because of space constraints or security considerations) whereby FORTRESS may rely on interacting with the client device to run an instance of the SMPC protocol, (3) the client device cannot store any long-term information whereby FORTRESS may require the user or the client device to authenticate to it before running the SMPC protocol on the client device's behalf, and/or the like, where such options may cover a broad range of capabilities that might be available to client devices.

In some embodiments, where the client device is capable of securely storing long-term state and FORTRESS may rely on this capability, the client may be able to store long-term state locally, or on hardware tokens, portable flash storage, or cloud storage to store and retrieve this information. The former scenario may be applicable to user-owned smartphones, tablets, laptops, smart home devices, medical devices, or the like, while the latter scenario may apply to public kiosks and shared devices. In either case, the client device can access this state at the beginning of an SMPC instance, and provide it to FORTRESS to allow it to perform an SMPC execution. In such embodiments, FORTRESS may not retain a copy of the long-term state, so it cannot run the SMPC protocol without first interacting with the client.

In some embodiments, the client device can securely store a small amount of information across SMPC instances but is unable to store the entirety of the long-term state (e.g., because of space constraints or security considerations) whereby FORTRESS may rely on interacting with the client device to run an instance of the SMPC protocol. In such embodiments, to avoid sharing sensitive long-term state with FORTRESS, client devices can perform some of the SMPC computations locally, utilizing their own stored key material. For instance, the client can perform some lightweight computation on its input, such as encryption using an additively homomorphic encryption scheme or the selection of input keys for an execution of the protocol (e.g., as described in U.S. Pat. No. 11,563,564 and/or herein). This approach may minimize the need to transmit sensitive data to FORTRESS, further maintaining confidentiality and security throughout the computation process. In such embodiments, FORTRESS may not retain a copy of the long-term state, so it cannot run the SMPC protocol without first interacting with the client.

In some embodiments, the client device cannot store any long-term information whereby FORTRESS may require the user or the client device to authenticate to it before running the SMPC protocol on the client device's behalf In such embodiments, the client may not have the ability to store the SMPC protocol long-term state in its entirety (e.g., because the client device does not have sufficient storage space, because it does not have the networking capabilities to retrieve the state in its entirety, because it cannot securely store this state between SMPC runs, etc.). In such embodiments, FORTRESS can be configured to store the long-term state on behalf of the client. This state can, for example, be encrypted using a symmetric or asymmetric key, where the corresponding decryption key may be known only to the client device. During an SMPC instance, the client device can either provide the decryption key to FORTRESS, or decrypt the relevant portion of the long-term state locally and disclose the corresponding plaintext to FORTRESS. In this process, FORTRESS may authenticate the client device and/or the user. This approach may ensure that confidential data remains protected against unauthorized access, even when stored on untrusted cloud infrastructure. In order to ensure that FORTRESS may only act on behalf of authorized users or devices, FORTRESS can be configured to require the client device or the user to authenticate. For example, access to encryption keys that protect in FORTRESS storage can be protected by any suitable methods such as Signal Protocol (see, e.g., https://signal.org/blog/secure-value-recovery/).

Authentication to FORTRESS can be performed directly between the client device and FORTRESS (e.g., via password, biometrics, public key cryptography, or a hardware token, or via federation, for example using the OAuth2 protocol). In case of federated authentication, the user and/or the device may first authenticate to any suitable third party that may be acting as an Identity and Access Management (“IAM”) system, and the IAM system may then relay the authentication result to FORTRESS. Alternatively, with direct authentication, FORTRESS may verify the credentials of the user and/or the device. Direct authentication may be especially useful when FORTRESS acts as a client party for SMPC-based biometric authentication. In this case, the same biometric sample can be used for both direct authentication to FORTRESS and SMPC-based biometric authentication. In some embodiments, if a user device uses biometrics to authenticate with the third party subsystem for authenticating a browser session (e.g., at operation 1202, operation 1302, operation 1402, operation 1502, etc.), then such biometrics may be retained (e.g., by the device or third party subsystem during the current session (e.g., as properly encrypted) and such retention may be indicated by the AuthToken or otherwise by the attempt message to the fortress solution, such that the fortress solution may be configured to request that those same biometrics be shared with the fortress solution when requested (e.g., at operation 1225, operation 1327, operation 1429, operation 1533, etc.) rather than prompting the user to present additional biometrics for the fortress solution.

As described with respect to FIGS. 12-15, privacy-preserving biometric authentication may be performed via SMPC using a data processing service (e.g., BAS 20) as a server party of the SMPC and a client device in combination with FORTRESS as a client party of the SMPC. As compared to processes 200 and 400 of FIGS. 2A-4C, which may show how privacy-preserving biometric authentication can be performed using a dedicated APS application 69a on a user device without the need for FORTRESS, processes 1200-200 of FIGS. 12-15 show how FORTRESS may be utilized to relax the requirements on the user device (e.g., the client device may no longer need to run a dedicated APS application on the client device to interact directly with the server party for the SMPC, but instead can run a generic web browser on the client device to interact with FORTRESS, which may in turn interact directly with the server party for the SMPC.

### Additional IDV Concepts

As disclosed in co-pending commonly assigned U.S. patent application Ser. No. 19/366,921, which is hereby incorporated by reference herein in its entirety, a system may be configured to use any suitable identity verification (“IDV”) bridge instance to enable the creation of privacy-preserving user profiles that may decouple sensitive biometric data collection from identity verification processes. An IDV bridge may allow customers to process images of users without sending them to the APSP (e.g., without sharing any biometric data), while still enabling the customers to enroll such users into the APSP. However, in some embodiments, rather than using an IDV bridge, a FORTRESS solution (e.g., AuthService subsystem 110 and/or enclave subsystem 130) may be used for achieving those same goals of an IDV bridge, whereby the customer subsystem may communicate directly with FORTRESS.

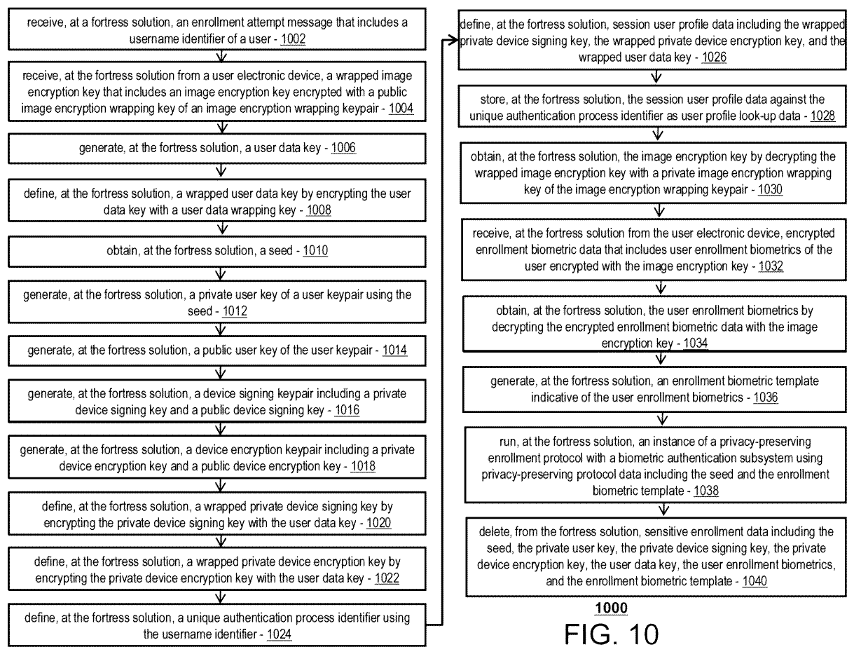

### FIG. 10

FIG. 10 is a flowchart of an illustrative process 1000 for enrolling a user of a user electronic device using a fortress solution that is remote from the electronic device and a biometric authentication subsystem (e.g., user U of user device 60, BAS 20, and fortress solution 140/140″/140′″ of FIGS. 12 and 14). At operation 1002, process 1000 may include receiving, at the fortress solution, an enrollment attempt message including a username identifier of the user (e.g., eam 1704d/1904d with a URID). At operation 1004, process 1000 may include receiving, at the fortress solution from the user electronic device, a wrapped image encryption key that includes an image encryption key encrypted with a public image encryption wrapping key of an image encryption wrapping keypair (e.g., eam 1704d with wrapped image encryption key \hat{k}ᵢ (e.g., at operation 1206), data 1915d with wrapped image encryption key \hat{k}ᵢ (e.g., at operation 1430), etc.). At operation 1006, process 1000 may include generating, at the fortress solution, a user data key (e.g., user data key kₐ (e.g., at operation 1215, operation 1419, etc.)). At operation 1008, process 1000 may include defining, at the fortress solution, a wrapped user data key by encrypting the user data key with a user data wrapping key (e.g., wrapped user data key \hat{k}ₐ (e.g., at operation 1215, operation 1419, etc.)). At operation 1010, process 1000 may include obtaining, at the fortress solution, a seed (e.g., seed s (e.g., at operation 1218, operation 1414, etc.)). At operation 1012, process 1000 may include generating, at the fortress solution, a private user key of a user keypair using the seed (e.g., private user key skᵤ (e.g., at operation 1218, operation 1414, etc.)). At operation 1014, process 1000 may include generating, at the fortress solution, a public user key of the user keypair (e.g., public user key pkᵤ (e.g., at operation 1218, operation 1414, etc.)). At operation 1016, process 1000 may include generating, at the fortress solution, a device signing keypair including a private device signing key and a public device signing key (e.g., private device signing key sk_{d} and private device signing key pk_{d} (e.g., at operation 1218, operation 1414, etc.)). At operation 1018, process 1000 may include generating, at the fortress solution, a device encryption keypair including a private device encryption key and a public device encryption key (e.g., private device encryption key skₑ and private device encryption key pkₑ (e.g., at operation 1218, operation 1414, etc.)). At operation 1020, process 1000 may include defining, at the fortress solution, a wrapped private device signing key by encrypting the private device signing key with the user data key (e.g., wrapped private device signing key s\hat{k}_{d} (e.g., at operation 1218, operation 1424, etc.)). At operation 1022, process 1000 may include defining, at the fortress solution, a wrapped private device encryption key by encrypting the private device encryption key with the user data key (e.g., wrapped private device encryption key s\hat{k}ₑ (e.g., at operation 1218, operation 1424, etc.)). At operation 1024, process 1000 may include defining, at the fortress solution, a unique authentication process identifier using the username identifier (e.g., unique authentication process identifier APID using URID (e.g., at operation 1218, operation 1464, etc.)). At operation 1026, process 1000 may include defining, at the fortress solution, session user profile data including the wrapped private device signing key, the wrapped private device encryption key, and the wrapped user data key (e.g., session user profile data of data 1709d of operation 1218, session user profile data of data 1932d of operation 1464, etc.). At operation 1028, process 1000 may include storing, at the fortress solution, the session user profile data against the unique authentication process identifier as user profile look-up data (e.g., data 1709d of operation 1218, data 1932d of operation 1464, etc.). At operation 1030, process 1000 may include obtaining, at the fortress solution, the image encryption key by decrypting the wrapped image encryption key with a private image encryption wrapping key of the image encryption wrapping keypair (e.g., at operation 1221, operation 1424, etc.). At operation 1032, process 1000 may include receiving, at the fortress solution from the user electronic device, encrypted enrollment biometric data that includes user enrollment biometrics of the user encrypted with the image encryption key (e.g., as data 1713f at operation 1228, as data 1917f at operation 1438, etc.). At operation 1034, process 1000 may include obtaining, at the fortress solution, the user enrollment biometrics by decrypting the encrypted enrollment biometric data with the image encryption key (e.g., at operation 1228, at operation 1438, etc.). At operation 1036, process 1000 may include generating, at the fortress solution, an enrollment biometric template indicative of the user enrollment biometrics (e.g., at operation 1232, at operation 1444, etc.). At operation 1038, process 1000 may include running, at the fortress solution, an instance of a privacy-preserving enrollment protocol with the biometric authentication subsystem using privacy-preserving protocol data including the seed and the enrollment biometric template (e.g., at operation 1260, at operation 1480, etc.). At operation 1040, process 1000 may include deleting, from the fortress solution, sensitive enrollment data including the seed, the private user key, the private device signing key, the private device encryption key, the user data key, the user enrollment biometrics, and the enrollment biometric template (e.g., at operation 1244, at operation 1462, etc.). In some embodiments, the unique authentication process identifier may be the username identifier (e.g., when there is no CRID). In some embodiments, the enrollment attempt message may further include a customer identifier of a third party subsystem (e.g., CRID), the defining the unique authentication process identifier includes using the username identifier and the customer identifier, and process 1000 may further include storing, at the fortress solution, the unique authentication process identifier against the username identifier and the customer identifier as identifier look-up data (e.g., as data 1709u at operation 1218, as data 1932u at operation 1464, etc.), where, in some additional embodiments, the user electronic device may be running a web browser presenting a website of the third party subsystem (e.g., browser 69w (e.g., website 1700)) and the receiving the enrollment attempt message may include receiving the enrollment attempt message from the user electronic device (e.g., at operation 1210, operation 1410, etc.), where, in some additional embodiments, the web browser may include a user data wrapping key identifier for the user data wrapping key (e.g., KIDkᵣ of data 1702), and where, in some additional embodiments, the session user profile data may also include the user data wrapping key identifier for the user data wrapping key (e.g., data 1709d may include KIDkᵣ, data 1932d may include KIDkᵣ, etc.). In some embodiments, the session user profile data may also include a user data wrapping key identifier for the user data wrapping key (e.g., data 1709d may include session data with a KIDkᵣ, data 1932d may include KIDkᵣ, etc.). In some embodiments, the session user profile data may also include the public user key, the public device signing key, and the public device encryption key. In some embodiments, the generating the enrollment biometric template of operation 1036 may include generating the enrollment biometric template using at least one model, and the session user profile data may also include a model identifier for the at least one model (e.g., data 1709d may include session data with a “current_pipeline_id” field, data 1932d may include session data with a “current_pipeline_id” field, etc.). In some embodiments, the enrollment attempt message may also include an authorization token (e.g., from operation 1202, operation 1402, etc.). In some embodiments, the enrollment attempt message may also include a key identifier of the image encryption wrapping keypair (e.g., KIDk_{w}, attestation document, etc.), where, in some embodiments, the obtaining the image encryption key of operation 1030 may include identifying, at the fortress solution, the private image encryption wrapping key of the image encryption wrapping keypair using the key identifier of the image encryption wrapping keypair (e.g., KIDk_{w}, attestation document, etc.) and decrypting the wrapped image encryption key with the identified private image encryption wrapping key of the image encryption wrapping keypair (e.g., key sk_{w} at operation 1221, key skᵥ at operation 1424, etc.). In some embodiments, the privacy-preserving protocol data may also include the public user key, the public device signing key, the public device encryption key, the private user key, and the private device signing key. In some embodiments, the sensitive enrollment data may also include the image encryption key. In some embodiments, the instance of the privacy-preserving enrollment protocol may be configured to store authentication circuit information on the biometric authentication subsystem (see, e.g., process 200). In some embodiments, no biometric identifier information of the user is accessible to the biometric authentication subsystem (see, e.g., processes 200-400). In some embodiments, the running of operation 1038 may include identifying, at the fortress solution, a transformed matching function that is operative to output a success key in response to successfully evaluating the transformed matching function using a first input and a second input, generating, at the fortress solution, a restricted enrollment input by restricting the first input using the enrollment biometric template, encrypting, at the fortress solution, with the success key, seed information that includes at least a portion of the seed, and sending, from the fortress solution to the biometric authentication subsystem, enrollment data including the encrypted seed information and the transformed matching function and the restricted enrollment input (see, e.g., operation 1260, operation 1480, processes 200-400, etc.), where, in some embodiments, process 1000 may also include generating, at the fortress solution, an inner key and the seed information includes the at least a portion of the seed encrypted with the inner key (see, e.g., processes 200-400, 1300, and 1500), where in some embodiments, process 1000 may also include, after the running and the deleting, receiving, at the fortress solution from the biometric authentication subsystem, the seed information, recovering, at the fortress solution, the seed using the received seed information, and using, at the fortress solution, the recovered seed to enable a secure operation (see, e.g., processes 200-400, 1300, and 1500), and where, in some embodiments, process 1000 may also include, after the sending, generating, at the fortress solution, an authentication biometric sample indicative of user authentication biometrics of the user, generating, at the fortress solution, a restricted authentication input by restricting the second input using the authentication biometric sample, and transmitting, from the fortress solution to the biometric authentication subsystem, the restricted authentication input (see, e.g., processes 200-400, 1300, and 1500). In some embodiments, process 1000 may also include encrypting, at the fortress solution, with the success key, enrollment biometric template information that includes at least a portion of the enrollment biometric template, wherein the enrollment data further includes the encrypted enrollment biometric template information (see, e.g., operation 1260, operation 1480, processes 200-400, etc.). In some embodiments, the fortress solution includes a key management service subsystem (e.g., KMS 120) and an authorization service subsystem (e.g., AuthService subsystem 110) that is remote from the key management service subsystem, the generating the user data key of operation 1006 may include generating the user data key at the key management service subsystem (e.g., at operation 1215, operation 1419, etc.), the defining the wrapped user data key of operation 1008 may include defining the wrapped user data key at the key management service subsystem (e.g., at operation 1215, operation 1419, etc.), the user data wrapping key (e.g., key kᵣ) may only be available to the key management service subsystem, and the generating the private user key of operation 1012 may include generating the private user key at the authorization service subsystem (e.g., at operation 1218, operation 1414, etc.). In some embodiments, the fortress solution includes a key management service subsystem (e.g., KMS 120) and an enclave subsystem (e.g., enclave subsystem 130) that is remote from the key management service subsystem, the generating the user data key of operation 1006 may include generating the user data key at the key management service subsystem (e.g., at operation 1215, operation 1419, etc.), the defining the wrapped user data key of operation 1008 may include defining the wrapped user data key at the key management service subsystem (e.g., at operation 1215, operation 1419, etc.), the user data wrapping key (e.g., key kᵣ) may only be available to the key management service subsystem, and process 1000 may also include validating, at the key management service subsystem, an attestation document of the enclave subsystem to obtain a public enclave instance key of an enclave instance keypair (e.g., at operation 1419) and defining, at the key management service subsystem, a re-wrapped user data key by encrypting the user data key with the public enclave instance key (e.g., at operation 1419), and the defining the wrapped private device signing key of operation 1020 may include obtaining, at the enclave subsystem, the user data key by decrypting the re-wrapped user data key with a private enclave instance key of the enclave instance keypair (e.g., at operation 1424) and encrypting, at the enclave subsystem, the private device signing key with the obtained user data key (e.g., at operation 1424).

The operations shown in process 1000 of FIG. 10 are only illustrative and that existing operations may be modified or omitted, additional operations may be added, and the order of certain operations may be altered.

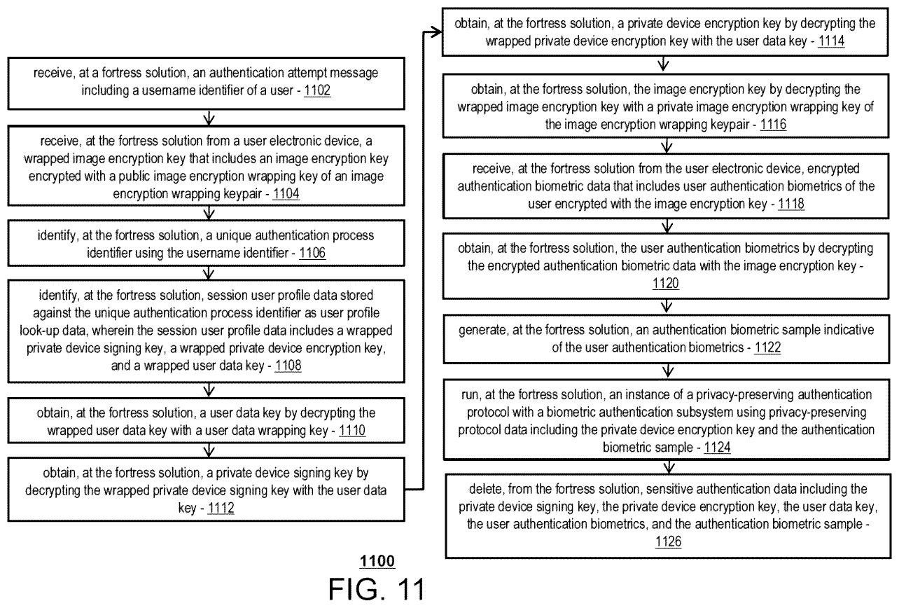

### FIG. 11

FIG. 11 is a flowchart of an illustrative process 1100 for authenticating a user of a user electronic device using a fortress solution remote from the electronic device and a biometric authentication subsystem (e.g., user U of user device 60, BAS 20, and fortress solution 140/140′″ of FIGS. 13 and 15). At operation 1102, process 1100 may include receiving, at the fortress solution, an authentication attempt message including a username identifier of the user (e.g., aam 1806d, aam 2008d, etc. with a URID). At operation 1104, process 1100 may include receiving, at the fortress solution from the user electronic device, a wrapped image encryption key that includes an image encryption key encrypted with a public image encryption wrapping key of an image encryption wrapping keypair (e.g., aam 1806d with wrapped image encryption key \hat{k}ᵢ (e.g., at operation 1310), data 2015d with wrapped image encryption key \hat{k}ᵢ (e.g., at operation 1530), etc.). At operation 1106, process 1100 may include identifying, at the fortress solution, a unique authentication process identifier using the username identifier (e.g., unique authentication process identifier APID using URID (e.g., at operation 1316, operation 1520, etc.)). At operation 1108, process 1100 may include identifying, at the fortress solution, session user profile data stored against the unique authentication process identifier as user profile look-up data, wherein the session user profile data includes a wrapped private device signing key, a wrapped private device encryption key, and a wrapped user data key (e.g., session user profile data of data 1808d of operation 1316, session user profile data of data 2010d of operation 1520, etc.). At operation 1110, process 1100 may include obtaining, at the fortress solution, a user data key by decrypting the wrapped user data key with a user data wrapping key (e.g., decrypt wrapped user data key \hat{k}ₐ with user data wrapping key kᵣ to obtain user data key kₐ (e.g., at operation 1319, operation 1523, etc.)). At operation 1112, process 1100 may include obtaining, at the fortress solution, a private device signing key by decrypting the wrapped private device signing key with the user data key (e.g., decrypt wrapped private device signing key s\hat{k}_{d} with user data key kₐ (e.g., at operation 1322, operation 1528, etc.)). At operation 1114, process 1100 may include obtaining, at the fortress solution, a private device encryption key by decrypting the wrapped private device encryption key with the user data key (e.g., decrypt wrapped private device encryption key s\hat{k}ₑ with user data key kₐ (e.g., at operation 1322, operation 1528, etc.)). At operation 1116, process 1100 may include obtaining, at the fortress solution, the image encryption key by decrypting the wrapped image encryption key with a private image encryption wrapping key of the image encryption wrapping keypair (e.g., decrypt wrapped image encryption key \hat{k}ᵢ with private image encryption wrapping key sk_{w} (e.g., at operation 1323) or with private enclave instance key skᵥ (e.g., at operation 1528) to obtain image encryption key kᵢ). At operation 1118, process 1100 may include receiving, at the fortress solution from the user electronic device, encrypted authentication biometric data that includes user authentication biometrics of the user encrypted with the image encryption key (e.g., data 1814f at operation 1330, data 2017f at operation 1538, etc.). At operation 1120, process 1100 may include obtaining, at the fortress solution, the user authentication biometrics by decrypting the encrypted authentication biometric data with the image encryption key (e.g., at operation 1330, at operation 1538, etc.). At operation 1122, process 1100 may include generating, at the fortress solution, an authentication biometric sample indicative of the user authentication biometrics (e.g., at operation 1336, at operation 1544, etc.). At operation 1124, process 1100 may include running, at the fortress solution, an instance of a privacy-preserving authentication protocol with the biometric authentication subsystem using privacy-preserving protocol data including the private device encryption key and the authentication biometric sample (e.g., at operation 1360, at operation 1560, etc.). At operation 1126, process 1100 may include deleting, from the fortress solution, sensitive authentication data including the private device signing key, the private device encryption key, the user data key, the user authentication biometrics, and the authentication biometric sample (e.g., at operation 1364, at operation 1580, etc.). In some embodiments, the unique authentication process identifier is the username identifier (e.g., when there is no CRID). In some embodiments, the authentication attempt message may also include a customer identifier of a third party subsystem (e.g., CRID) and the identifying the unique authentication process identifier of process 1106 may include using the username identifier and the customer identifier, where, in some embodiments, the user electronic device may be running a web browser presenting a website of the third party subsystem (e.g., browser 69w (e.g., website 1700)) and the receiving the authentication attempt message of operation 1102 may include receiving the authentication attempt message from the user electronic device (e.g., at operation 1314, operation 1518, etc.), where, in some embodiments, the web browser may include a user data wrapping key identifier for the user data wrapping key (e.g., KIDkᵣ of data 1702), and where, in some embodiments, the session user profile data may also include the user data wrapping key identifier for the user data wrapping key (e.g., data 1808d may include KIDkᵣ, data 2010d may include KIDkᵣ, etc.). In some embodiments, the session user profile data may also include a user data wrapping key identifier for the user data wrapping key (e.g., data 1808d may include KIDkᵣ, data 2010d may include KIDkᵣ, etc.). In some embodiments, no biometric identifier information of the user is accessible to the biometric authentication subsystem (see, e.g., processes 200-400). In some embodiments, the running of operation 1124 may include receiving, at the fortress solution from the biometric authentication subsystem, seed information and process 1100 may also include recovering, at the fortress solution, a seed using the received seed information and using, at the fortress solution, the recovered seed to enable a secure operation (see, e.g., processes 200-400), wherein, in some embodiments, the sensitive authentication data also includes the seed and/or the using the recovered seed includes deriving a private user key using the recovered seed (see, e.g., processes 200-400), and/or where, in some embodiments, the sensitive authentication data may also include the seed and the private user key (see, e.g., processes 200-400). In some embodiments, process 1100 may also include, prior to the receiving the authentication attempt message at operation 1102, identifying, at the fortress solution, a transformed matching function that is operative to output a success key in response to successfully evaluating the transformed matching function using a first input and a second input, generating, at the fortress solution, a restricted enrollment input by restricting the first input using an enrollment biometric template, encrypting, at the fortress solution, with the success key, seed information that includes at least a portion of a seed, and sending, from the fortress solution to the biometric authentication subsystem, enrollment data including the encrypted seed information and the transformed matching function and the restricted enrollment input (see, e.g., processes 200-400, 1200, 1400, etc.), where, in some embodiments, the running of operation 1124 may include generating, at the fortress solution, a restricted authentication input by restricting the second input using the authentication biometric sample and transmitting, from the fortress solution to the biometric authentication subsystem, the restricted authentication input. In some embodiments, the authentication attempt message of operation 1102 may also include an authorization token (e.g., from operation 1302, operation 1502, etc.). In some embodiments, the authentication attempt message of operation 1102 may also include a key identifier of the image encryption wrapping keypair (e.g., KIDk_{w}, attestation document, etc.). In some embodiments, the session user profile data may also include a public user key, a public device signing key, and a public device encryption key, where, in some embodiments, the privacy-preserving protocol data may also include the public user key, the public device signing key, the public device encryption key, the private user key, and the private device signing key. In some embodiments, the session user profile data may also include a model identifier and the generating the authentication biometric sample of operation 1122 includes generating the authentication biometric sample using at least one model identified by the model identifier. In some embodiments, the sensitive authentication data may also include the image encryption key. In some embodiments, the instance of the privacy-preserving authentication protocol may be configured to compare the authentication biometric sample with an enrollment biometric template (see, e.g., processes 200-400). In some embodiments, the fortress solution includes a key management service subsystem (e.g., KMS 120) and an authorization service subsystem (e.g., AuthService subsystem 110) that is remote from the key management service subsystem, the obtaining the user data key of operation 1110 may include decrypting the wrapped user data key with the user data wrapping key at the key management service subsystem (e.g., at operation 1319, at operation 1519, etc.), the user data wrapping key may only be available to the key management service subsystem (e.g., key kᵣ), and the obtaining the private device signing key of operation 1112 may include decrypting the wrapped private device signing key with the user data key at the authorization service subsystem (e.g., at operation 1322, at operation 1528, etc.). In some embodiments, the fortress solution may include a key management service subsystem (e.g., KMS 120) and an enclave subsystem (e.g., enclave subsystem 130) that is remote from the key management service subsystem, the obtaining the user data key of operation 1110 may include decrypting the wrapped user data key with the user data wrapping key at the key management service subsystem (e.g., at operation 1319, at operation 1519, etc.), the user data wrapping key (e.g., key kᵣ) may only be available to the key management service subsystem, process 1100 may also include validating, at the key management service subsystem, an attestation document of the enclave subsystem to obtain a public enclave instance key of an enclave instance keypair (e.g., at operation 1523) and defining, at the key management service subsystem, a re-wrapped user data key by encrypting the user data key with the public enclave instance key (e.g., at operation 1523), the obtaining the user data key of operation 1110 may also include decrypting the re-wrapped user data key with a private enclave instance key of the enclave instance keypair at the enclave subsystem (e.g., at operation 1528), and the obtaining the private device signing key of operation 1112 may include decrypting the wrapped private device signing key with the user data key at the enclave subsystem (e.g., at operation 1528).

The operations shown in process 1100 of FIG. 11 are only illustrative and that existing operations may be modified or omitted, additional operations may be added, and the order of certain operations may be altered.

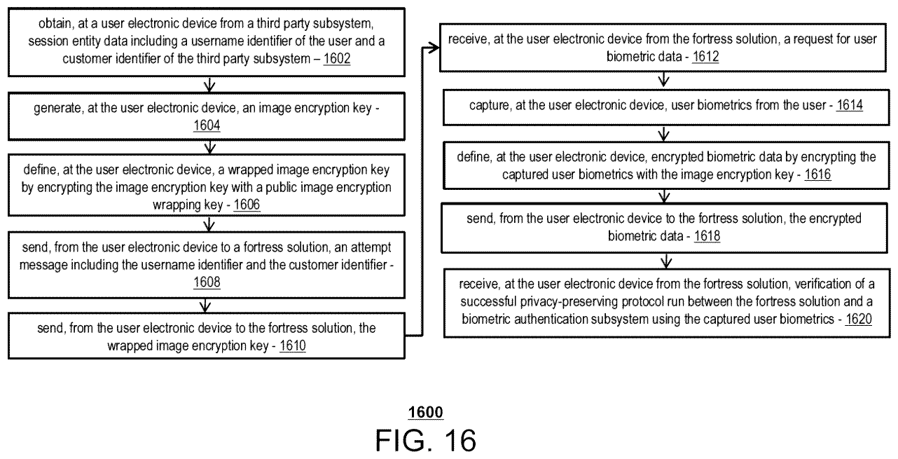

### FIG. 16

FIG. 16 is a flowchart of an illustrative process 1600 for authenticating a user of a user electronic device running a web browser presenting a website of a third party subsystem using a fortress solution and a biometric authentication subsystem (e.g., user U of user device 60, BAS 20, and fortress solution 140/140′/140″/140′″ of FIGS. 12-15). At operation 1602, process 1600 may include obtaining, at the user electronic device from the third party subsystem, session entity data including a username identifier of the user and a customer identifier of the third party subsystem (e.g., at operation 1202, operation 1302, operation 1402, operation 1502, etc.). At operation 1604, process 1600 may include generating, at the user electronic device, an image encryption key (e.g., at operation 1206, operation 1310, operation 1430, operation 1530, etc.). At operation 1606, process 1600 may include defining, at the user electronic device, a wrapped image encryption key by encrypting the image encryption key with a public image encryption wrapping key (e.g., at operation 1206, operation 1310, operation 1430, operation 1530, etc.). At operation 1608, process 1600 may include sending, from the user electronic device to the fortress solution, an attempt message including the username identifier and the customer identifier (e.g., at operation 1208, operation 1312, operation 1408, operation 1516, etc.). At operation 1610, process 1600 may include sending, from the user electronic device to the fortress solution, the wrapped image encryption key (e.g., at operation 1208, operation 1312, operation 1430, operation 1530, etc.). At operation 1612, process 1600 may include receiving, at the user electronic device from the fortress solution, a request for user biometric data (e.g., at operation 1225, operation 1327, operation 1429, operation 1533, etc.). At operation 1614, process 1600 may include capturing, at the user electronic device, user biometrics from the user (e.g., at operation 1227, operation 1329, operation 1431, operation 1535, etc.). At operation 1616, process 1600 may include defining, at the user electronic device, encrypted biometric data by encrypting the captured user biometrics with the image encryption key (e.g., at operation 1227, operation 1329, operation 1431, operation 1535, etc.). At operation 1618, process 1600 may include sending, from the user electronic device to the fortress solution, the encrypted biometric data (e.g., at operation 1227, operation 1329, operation 1431, operation 1535, etc.). At operation 1620, process 1600 may include receiving, at the user electronic device from the fortress solution, verification of a successful privacy-preserving protocol run between the fortress solution and the biometric authentication subsystem using the captured user biometrics (e.g., data 1723d at operation 1227, data 1827d at operation 1356, data 1934d at operation 1470, data 2036d at operation 1574, etc.).

The operations shown in process 1600 of FIG. 16 are only illustrative and that existing operations may be modified or omitted, additional operations may be added, and the order of certain operations may be altered.

### ADDITIONAL DISCLOSURE

One, some, or all of the processes described with respect to FIGS. 1-17 and otherwise may each be partially or entirely implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of FIG. 1E). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from a central network controller device to a router device or from a data device to any network device. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure (e.g., any or each module of system 1) may be provided as a software construct, firmware construct, one or more hardware components, or a combination thereof. For example, any, each, or at least one module or component or subsystem of any suitable system may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of any suitable system of the disclosure (e.g., system 1) may be stored in or otherwise accessible to a subsystem in any suitable manner (e.g., in memory 13 (e.g., as at least a portion of application 19a and/or model 19m)). Any or each module of any suitable system of the disclosure (e.g., system 1) may be implemented using any suitable technologies (e.g., as one or more integrated circuit devices), and different modules may or may not be identical in structure, capabilities, and operation. Any or all of the modules or other components of any suitable system of the disclosure (e.g., system 1) may be mounted on an expansion card, mounted directly on a system motherboard, or integrated into a system chipset component (e.g., into a “north bridge” chip). At least a portion of one or more of the modules of any suitable system of the disclosure (e.g., system 1) may be stored in or otherwise accessible to any suitable components in any suitable manner. Any or each module of any suitable system of the disclosure (e.g., system 1) may be implemented using any suitable technologies (e.g., as one or more integrated circuit devices), and different modules may or may not be identical in structure, capabilities, and operation. Any or all of the modules or other components of any suitable system of the disclosure (e.g., system 1) may be mounted on an expansion card, mounted directly on a system motherboard, or integrated into a system chipset component (e.g., into a “north bridge” chip).

Any or each module of any suitable system of the disclosure (e.g., system 1) may be a dedicated system implemented using one or more expansion cards adapted for various bus standards. For example, all of the modules may be mounted on different interconnected expansion cards or all of the modules may be mounted on one expansion card. With respect to system 1, by way of example only, modules of system 1 may interface with a motherboard or processor assembly 12 (e.g., of subsystem 100) through an expansion slot (e.g., a peripheral component interconnect (“PCI”) slot or a PCI express slot). Alternatively, modules of system 1 need not be removable but may include one or more dedicated modules that may include memory (e.g., RAM) dedicated to the utilization of the module. In other embodiments, modules of system 1 may be at least partially integrated into a subsystem (e.g., subsystem 100 (e.g., a server)). For example, a module of system 1 may utilize a portion of memory 13 of a subsystem. Any or each module of system 1 may include its own processing circuitry and/or memory. Alternatively, any or each module of system 1 may share processing circuitry and/or memory with any other module of system 1 and/or processor assembly 12 and/or memory assembly 13 of a subsystem (e.g., subsystem 100).

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof).

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Any suitable biometric system model (e.g., biometric authentication model, biometric user profile generation model, etc. (e.g., one or more BAS models 1360)) may be developed and/or generated for use in evaluating and/or predicting output states. For example, a model may be a learning engine for an experiencing entity, where the learning engine may be operative to use any suitable machine learning (“ML”) (e.g., the system's ability to learn automatically from past events to affect future behavior) to use certain monitored system data for a particular environment (e.g., at a particular time and/or with respect to one or more planned activities) in order to predict, estimate, and/or otherwise generate an output state. For example, the learning engine may include any suitable neural network (e.g., an artificial neural network) that may be initially configured, trained on one or more sets of monitored system data that is associated with known or otherwise determined or confirmed states or data from any suitable sources, and then used to predict further states based on another set of monitored system data.

A neural network or neuronal network or artificial neural network may be hardware-based, software-based, or any combination thereof, such as any suitable model (e.g., an analytical model, a computational model, etc.), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. The neural network may be used to estimate or approximate functions that can depend on a large number of inputs and that may be generally unknown. The neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

Different input neurons of the neural network may be associated with respective different types of monitored system data categories and may be activated by monitored system data of the respective monitored system data categories (e.g., each possible category of monitored system data variable information may be associated with one or more particular respective input neurons of the neural network and monitored system data for the particular monitored system data category may be operative to activate the associated input neuron(s)). The weight assigned to the output of each neuron may be initially configured using any suitable determinations that may be made by a custodian or processor of the model based on the data available to that custodian.

The initial configuring of the learning engine or management model for a particular system (e.g., the initial weighting and arranging of neurons of a neural network of the learning engine) may be done using any suitable data accessible to a custodian of the management model, such as data associated with the configuration of other learning engines of the system (e.g., learning engines or management models for other systems), data associated with the particular system (e.g., initial background data accessible by the model custodian about the particular system composition, location, past uses, and/or the like), data assumed or inferred by the model custodian using any suitable guidance, and/or the like. For example, a model custodian may be operative to capture any suitable initial background data about a particular system in any suitable manner, which may be enabled by any suitable user interface provided to an appropriate subsystem or device accessible to one, some, or each operator or entity with knowledge of the particular system (e.g., a model app or website). The model custodian may provide a data collection portal for enabling any suitable entity to provide initial background data for the particular system. The data may be uploaded in bulk or manually entered in any suitable manner.

A management model custodian may receive not only monitored system data for at least one monitored system data category for a particular system experience but also a system output product state for that system experience. This may be enabled by monitoring any suitable system data for a system. The management model custodian may provide a data collection portal for enabling any suitable entity(ies) to provide such data. The system output state may be received and may be derived from the system in any suitable manner.

A learning engine or model (e.g., a service system management model) for a system may be using the received monitored system data for the system experience (e.g., as inputs of a neural network of the learning engine) and using the received system output product state for the system experience (e.g., as an output of the neural network of the learning engine). Any suitable training methods or algorithms (e.g., learning algorithms) may be used to train the neural network of the learning engine, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network. A loop (e.g., a receipt and train loop) of receiving monitored system data and a system output product state for a system experience (e.g., a particular system in a particular environment at a particular moment) and then training the system model using the received monitored system data and system output product state may be repeated any suitable number of times for the same system(s) in different system experiences (e.g., in same or different environments at different moments) and the same learning engine for more effectively training the learning engine for the system, where the received monitored system data and the received system output product state of different receipt and train loops may be for different environments or for the same environment (e.g., at different times and/or with respect to different planned activities) and/or may be received from the same source or from different sources of the system, while the training of different receipt and train loops may be done for the same learning engine using whatever monitored system data and system output product state was received for the particular receipt and train loop. The number and/or type(s) of the one or more monitored system data categories for which monitored system data may be received for one receipt and train loop may be the same or different in any way(s) than the number and/or type(s) of the one or more monitored system data categories for which monitored system data may be received for a second receipt and train loop.

A trained model may then receive input data from any suitable source using any suitable methods for use by the model. The trained model may then use this new input data to generate output data using the learning engine or model. For example, the new input data may be utilized as input(s) to the neural network of the learning engine similarly to how other input data accessed for a receipt and train loop may be utilized as input(s) to the neural network of the learning engine at a training portion of the receipt and train loop, and such utilization of the learning engine with respect to the new input data may result in the neural network providing an output indicative of data that may represent the learning engine's predicted or estimated result.

The processing power and speed of any suitable biometric system and its various models may be configured to determine continuously an updated system output product state of a system and present associated information or otherwise adjust a managed element based on the determined system output product state automatically and instantaneously or substantially instantaneously based on any new received monitored system data that may be generated by the system, such that management of the system may run quickly and smoothly. This may enable the system to operate as effectively and as efficiently as possible.

The use of one or more suitable models or engines or neural networks or the like may enable prediction or any suitable determination of an output product state of a system in a system experience. Such models (e.g., neural networks) running on any suitable processing units (e.g., graphical processing units (“GPUs”) that may be available to the system) provide significant speed improvements in efficiency and accuracy with respect to prediction over other types of algorithms and human-conducted analysis of data, as such models can provide estimates in a few milliseconds or less, thereby improving the functionality of any computing device on which they may be run. Due to such efficiency and accuracy, such models enable a technical solution for enabling the generation of any suitable control data (e.g., for controlling any suitable functionality of any suitable managed element) using any suitable real-time data (e.g., data made available to the models) that may not be possible without the use of such models, as such models may increase performance of their computing device(s) by requiring less memory, providing faster response times, and/or increased accuracy and/or reliability. Due to the condensed time frame and/or the time within which a decision with respect to system data ought to be made to provide a desirable use experience, such models offer the unique ability to provide accurate determinations with the speed necessary to enable effective and efficient use management.

To facilitate the discussion regarding the operation of one or more systems of the disclosure, reference is made to various screens 700a-700ae that may be representative of a graphical user interface of any suitable device 60 during any suitable process(es) of the system (e.g., as shown in FIGS. 7A-7AE). The operations described may be achieved with a wide variety of graphical elements and visual schemes. Therefore, the embodiments of FIGS. 7A-7AE are not intended to be limited to the precise user interface conventions adopted herein. Rather, embodiments may include a wide variety of user interface styles. In some other embodiments, in addition to or as an alternative to graphical and/or visual schemes, any suitable audible and/or haptic user interface conventions may be utilized.

As may be used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As may be used herein, the terms “computer,” “personal computer,” “device,” “computing device,” “router device,” and “controller device” may refer to any programmable computer system that is known or that will be developed in the future. In certain embodiments, a computer will be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As may be used herein, the terms “component,” “module,” and “system,” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

One aspect of the present technology may be the gathering and use of data available from various sources to improve the detection of a user. The present disclosure contemplates that in some instances, this gathered data may include personal information data that uniquely identifies or can be used to contact or locate a specific person. Such personal information data can include demographic data, location-based data, telephone numbers, email addresses, social network identifiers, home addresses, office addresses, data or records relating to a user's health or level of fitness (e.g., vital signs measurements, facial expression measurements, medication information, exercise information, etc.) and/or mindfulness, date of birth, or any other identifying or personal information.

The present disclosure recognizes that the use of such personal information data, in the present technology, can be used to the benefit of users. For example, the personal information data can be used to improve the determination of biometric enrollment and/or biometric authenticity. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (“HIPAA”); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location detection services, the present technology can be configured to allow users to select to “opt in” or “opt out” of participation in the collection of personal information data during registration for services or anytime thereafter. In addition to providing “opt in” or “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the determination of biometric enrollment and/or biometric authenticity can be made based on non-personal information data or a bare minimum amount of personal information, such as the content being requested by the device associated with a user, other non-personal information available to the device, or publicly available information.

While there have been described systems, methods, and computer-readable media for privacy-preserving biometric matching using remote user-trusted environments, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” “roll” and “pitch” and “yaw,” “clockwise” and “counter-clockwise,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

1. A method for enrolling a user of a user electronic device using a fortress solution that is remote from the electronic device and a biometric authentication subsystem, the method comprising:
receiving, at the fortress solution, an enrollment attempt message comprising a username identifier of the user;
receiving, at the fortress solution from the user electronic device, a wrapped image encryption key that comprises an image encryption key encrypted with a public image encryption wrapping key of an image encryption wrapping keypair;
generating, at the fortress solution, a user data key;
defining, at the fortress solution, a wrapped user data key by encrypting the user data key with a user data wrapping key;
obtaining, at the fortress solution, a seed;
generating, at the fortress solution, a private user key of a user keypair using the seed;
generating, at the fortress solution, a public user key of the user keypair;
generating, at the fortress solution, a device signing keypair comprising:
a private device signing key; and
a public device signing key;
generating, at the fortress solution, a device encryption keypair comprising:
a private device encryption key; and
a public device encryption key;
defining, at the fortress solution, a wrapped private device signing key by encrypting the private device signing key with the user data key;
defining, at the fortress solution, a wrapped private device encryption key by encrypting the private device encryption key with the user data key;
defining, at the fortress solution, a unique authentication process identifier using the username identifier;
defining, at the fortress solution, session user profile data comprising:
the wrapped private device signing key;
the wrapped private device encryption key; and
the wrapped user data key;
storing, at the fortress solution, the session user profile data against the unique authentication process identifier as user profile look-up data;
obtaining, at the fortress solution, the image encryption key by decrypting the wrapped image encryption key with a private image encryption wrapping key of the image encryption wrapping keypair;
receiving, at the fortress solution from the user electronic device, encrypted enrollment biometric data that comprises user enrollment biometrics of the user encrypted with the image encryption key;
obtaining, at the fortress solution, the user enrollment biometrics by decrypting the encrypted enrollment biometric data with the image encryption key;
generating, at the fortress solution, an enrollment biometric template indicative of the user enrollment biometrics;
running, at the fortress solution, an instance of a privacy-preserving enrollment protocol with the biometric authentication subsystem using privacy-preserving protocol data comprising:
the seed; and
the enrollment biometric template; and
deleting, from the fortress solution, sensitive enrollment data comprising:
the seed;
the private user key;
the private device signing key;
the private device encryption key;
the user data key;
the user enrollment biometrics; and
the enrollment biometric template.

2. (canceled)

3. The method of claim 1, wherein:
the enrollment attempt message further comprises a customer identifier of a third party subsystem;
the defining the unique authentication process identifier comprises using the username identifier and the customer identifier; and
the method further comprises storing, at the fortress solution, the unique authentication process identifier against the username identifier and the customer identifier as identifier look-up data.

4. The method of claim 3, wherein:
the user electronic device is running a web browser presenting a website of the third party subsystem; and
the receiving the enrollment attempt message comprises receiving the enrollment attempt message from the user electronic device.

5-7. (canceled)

8. The method of claim 1, wherein the session user profile data further comprises:
the public user key;
the public device signing key; and
the public device encryption key.

9. The method of claim 1, wherein:
the generating the enrollment biometric template comprises generating the enrollment biometric template using at least one model; and
the session user profile data further comprises a model identifier for the at least one model.

10. (canceled)

11. The method of claim 1, wherein the enrollment attempt message further comprises a key identifier of the image encryption wrapping keypair.

12. The method of claim 11, wherein the obtaining the image encryption key comprises:
identifying, at the fortress solution, the private image encryption wrapping key of the image encryption wrapping keypair using the key identifier of the image encryption wrapping keypair; and
decrypting the wrapped image encryption key with the identified private image encryption wrapping key of the image encryption wrapping keypair.

13. The method of claim 1, wherein the privacy-preserving protocol data further comprises:
the public user key;
the public device signing key;
the public device encryption key;
the private user key; and
the private device signing key.

14. (canceled)

15. The method of claim 1, wherein the instance of the privacy-preserving enrollment protocol is configured to store authentication circuit information on the biometric authentication subsystem.

16. (canceled)

17. The method of claim 1, wherein the running comprises:
identifying, at the fortress solution, a transformed matching function that is operative to output a success key in response to successfully evaluating the transformed matching function using a first input and a second input;
generating, at the fortress solution, a restricted enrollment input by restricting the first input using the enrollment biometric template;
encrypting, at the fortress solution, with the success key, seed information that comprises at least a portion of the seed; and
sending, from the fortress solution to the biometric authentication subsystem, enrollment data comprising the encrypted seed information and the transformed matching function and the restricted enrollment input.

18. The method of claim 17, wherein:
the method further comprises generating, at the fortress solution, an inner key; and
the seed information comprises the at least a portion of the seed encrypted with the inner key.

19-21. (canceled)

22. The method of claim 1, wherein:
the fortress solution comprises:
a key management service subsystem; and
an authorization service subsystem that is remote from the key management service subsystem;
the generating the user data key comprises generating the user data key at the key management service subsystem;
the defining the wrapped user data key comprises defining the wrapped user data key at the key management service subsystem;
the user data wrapping key is only available to the key management service subsystem; and
the generating the private user key comprises generating the private user key at the authorization service subsystem.

23. The method of claim 1, wherein:
the fortress solution comprises:
a key management service subsystem; and
an enclave subsystem that is remote from the key management service subsystem;
the generating the user data key comprises generating the user data key at the key management service subsystem;
the defining the wrapped user data key comprises defining the wrapped user data key at the key management service subsystem;
the user data wrapping key is only available to the key management service subsystem;
the method further comprises:
validating, at the key management service subsystem, an attestation document of the enclave subsystem to obtain a public enclave instance key of an enclave instance keypair; and
defining, at the key management service subsystem, a re-wrapped user data key by encrypting the user data key with the public enclave instance key; and
the defining the wrapped private device signing key comprises:
obtaining, at the enclave subsystem, the user data key by decrypting the re-wrapped user data key with a private enclave instance key of the enclave instance keypair; and
encrypting, at the enclave subsystem, the private device signing key with the obtained user data key.

24. A method for authenticating a user of a user electronic device using a fortress solution remote from the electronic device and a biometric authentication subsystem, the method comprising:
receiving, at the fortress solution, an authentication attempt message comprising a username identifier of the user;
receiving, at the fortress solution from the user electronic device, a wrapped image encryption key that comprises an image encryption key encrypted with a public image encryption wrapping key of an image encryption wrapping keypair;
identifying, at the fortress solution, a unique authentication process identifier using the username identifier;
identifying, at the fortress solution, session user profile data stored against the unique authentication process identifier as user profile look-up data, wherein the session user profile data comprises:
a wrapped private device signing key;
a wrapped private device encryption key; and
a wrapped user data key;
obtaining, at the fortress solution, a user data key by decrypting the wrapped user data key with a user data wrapping key;
obtaining, at the fortress solution, a private device signing key by decrypting the wrapped private device signing key with the user data key;
obtaining, at the fortress solution, a private device encryption key by decrypting the wrapped private device encryption key with the user data key;
obtaining, at the fortress solution, the image encryption key by decrypting the wrapped image encryption key with a private image encryption wrapping key of the image encryption wrapping keypair;
receiving, at the fortress solution from the user electronic device, encrypted authentication biometric data that comprises user authentication biometrics of the user encrypted with the image encryption key;
obtaining, at the fortress solution, the user authentication biometrics by decrypting the encrypted authentication biometric data with the image encryption key;
generating, at the fortress solution, an authentication biometric sample indicative of the user authentication biometrics;
running, at the fortress solution, an instance of a privacy-preserving authentication protocol with the biometric authentication subsystem using privacy-preserving protocol data comprising:
the private device encryption key; and
the authentication biometric sample; and
deleting, from the fortress solution, sensitive authentication data comprising:
the private device signing key;
the private device encryption key;
the user data key;
the user authentication biometrics; and
the authentication biometric sample.

25. (canceled)

26. The method of claim 24, wherein:
the authentication attempt message further comprises a customer identifier of a third party subsystem; and
the identifying the unique authentication process identifier comprises using the username identifier and the customer identifier.

27. The method of claim 26, wherein:
the user electronic device is running a web browser presenting a website of the third party subsystem; and
the receiving the authentication attempt message comprises receiving the authentication attempt message from the user electronic device.

28-35. (canceled)

36. The method of claim 24, further comprising, prior to the receiving the authentication attempt message:
identifying, at the fortress solution, a transformed matching function that is operative to output a success key in response to successfully evaluating the transformed matching function using a first input and a second input;
generating, at the fortress solution, a restricted enrollment input by restricting the first input using an enrollment biometric template;
encrypting, at the fortress solution, with the success key, seed information that comprises at least a portion of a seed; and
sending, from the fortress solution to the biometric authentication subsystem, enrollment data comprising the encrypted seed information and the transformed matching function and the restricted enrollment input.

37. The method of claim 36, wherein the running comprises:
generating, at the fortress solution, a restricted authentication input by restricting the second input using the authentication biometric sample; and
transmitting, from the fortress solution to the biometric authentication subsystem, the restricted authentication input.

38-41. (canceled)

42. The method of claim 24, wherein:
the session user profile data further comprises a model identifier; and
the generating the authentication biometric sample comprises generating the authentication biometric sample using at least one model identified by the model identifier.

43-46. (canceled)

47. A method for authenticating a user of a user electronic device running a web browser presenting a website of a third party subsystem using a fortress solution and a biometric authentication subsystem, the method comprising:
obtaining, at the user electronic device from the third party subsystem, session entity data comprising:
a username identifier of the user; and
a customer identifier of the third party subsystem;
generating, at the user electronic device, an image encryption key;
defining, at the user electronic device, a wrapped image encryption key by encrypting the image encryption key with a public image encryption wrapping key;
sending, from the user electronic device to the fortress solution, an attempt message comprising the username identifier and the customer identifier;
sending, from the user electronic device to the fortress solution, the wrapped image encryption key;
receiving, at the user electronic device from the fortress solution, a request for user biometric data;
capturing, at the user electronic device, user biometrics from the user;
defining, at the user electronic device, encrypted biometric data by encrypting the captured user biometrics with the image encryption key;
sending, from the user electronic device to the fortress solution, the encrypted biometric data; and
receiving, at the user electronic device from the fortress solution, verification of a successful privacy-preserving protocol run between the fortress solution and the biometric authentication subsystem using the captured user biometrics.

48. (canceled)
